(19) United States
(12) Patent Application Publication
(10) Pub. No.: US 2016/0032038 A1
(43) Pub. Date: Feb. 4, 2016

(54) POLYMERIC IONIC SALT CATALYSTS AND METHODS OF PRODUCING THEREOF

(71) Applicant: MIDORI USA, INC., Cambridge, MA (US)

(72) Inventors: Brian M. BAYNES, Winchester, MA (US); John M. GEREMIA, Watertown, MA (US); Joseph ANDOH, Nashua, NH (US)

(73) Assignee: MIDORI USA, INC., Cambridge, MA (US)

(21) Appl. No.: 14/776,490

(22) PCT Filed: Mar. 12, 2014
(86) PCT No.: PCT/US14/24177

§ 371 Date: Sep. 14, 2015

Related U.S. Application Data
(60) Provisional application No. 61/786,230, filed on Mar. 14, 2013.

(51) Int. Cl. C08F 226/06; C13K 1/02; C08G 8/28; C13K 13/00; B01J 31/06; C08F 214/14

(52) U.S. Cl. CPC C08F 226/06; B01J 31/06; C08F 214/14; C08G 8/28; C13K 13/002; C13K 13/007; C13K 1/02

(57) ABSTRACT

Provided herein are polymeric ionic salt catalysts that are useful in the non-enzymatic saccharification processes. The catalysts described herein hydrolyze cellulosic materials to produce monosaccharides and/or disaccharides. Saccharification of lignocellulosic materials, such as biomass waste products of agriculture, forestry and waste treatment, are of great economic and environmental relevance. As part of biomass energy utilization, attempts have been made to obtain ethanol (bioethanol) by hydrolyzing cellulose or hemicellulose, which are major constituents of plants.

### CROSS-REFERENCE TO RELATED APPLICATIONS

This application claims priority to U.S. Provisional Patent Application No. 61/786,230, filed Mar. 14, 2013, which is incorporated herein by reference in its entirety.

### FIELD

The present disclosure relates generally to polymeric ionic salt catalysts and methods of producing such polymers. These polymers can be used as catalysts in the non-enzymatic saccharification of biomass to produce monosaccharides, oligosaccharides, and related products.

### BACKGROUND

Saccharification of lignocellulosic materials, such as biomass waste products of agriculture, forestry and waste treatment, are of great economic and environmental relevance. As part of biomass energy utilization, attempts have been made to obtain ethanol (bioethanol) by hydrolyzing cellulose or hemicellulose, which are major constituents of plants. The hydrolysis products, which include sugars and simple carbohydrates, can then be subjected to further biological and/or chemical conversion to produce fuels or other commodity chemicals. For example, ethanol is utilized as a fuel or mixed into a fuel such as gasoline. Major constituents of plants include, for example, cellulose (a polymer glucose, which is a six-carbon sugar), hemicellulose (a branched polymer of five- and six-carbon sugars), lignin, and starch. Current methods for liberating sugars from lignocellulosic materials, however, are inefficient on a commercial scale based on yields, as well as the water and energy used.

Work from the 1980's on the hydrolysis of β-glycosidic bonds using perfluoronated solid superacid microporous resins, such as Dupont Nafion®, attempted to develop catalytic methods for use in digesting cellulose. Batch reactors and continuous-flow fixed-bed tube reactors were used to demonstrate hydrolysis of cello-oligosaccharides to monomeric sugars; however, these processes were unable to achieve appreciable digestion of cellulose or hemicellulose, and in particular, the crystalline domains of cellulose.

As such, there is an ongoing need for new catalysts that can efficiently generate sugar and sugar-containing products from biomass on a commercially-viable scale.

### SUMMARY

The present disclosure addresses this need by providing polymeric materials that can be used to digest the hemicellulose and cellulose, including the crystalline domains of cellulose, in biomass. Specifically, the polymeric materials disclosed herein can hydrolyze the cellulose and/or hemicellulose into monosaccharides and/or oligosaccharides.

Disclosed herein are polymers that include acidic monomers and ionic monomers connected to form a polymeric backbone,

wherein a plurality of acidic monomers independently comprises at least one Bronsted-Lowry acid in acidic form, and at least one Bronsted-Lowry acid in conjugate base form having at least one associated cationic moiety, wherein at least one of the acidic monomers comprises a linker connecting the Bronsted-Lowry acid in conjugate base form to the polymeric backbone,

wherein each ionic monomer independently comprises at least one nitrogen-containing cationic group or phosphorous-containing cationic group, and

wherein at least one of the ionic monomers comprises a linker connecting the nitrogen-containing cationic group or the phosphorous-containing cationic group to the polymeric backbone.

Also disclosed herein are polymers that include acidic monomers and ionic monomers connected to form a polymeric backbone,

wherein a plurality of acidic monomers independently comprises at least one Bronsted-Lowry acid in acidic form, and at least one Bronsted-Lowry acid in conjugate base form having at least one associated cationic moiety, and

wherein at least one ionic monomer comprises at least one cationic group.

The linkers can be selected from unsubstituted or substituted alkylene, unsubstituted or substituted cycloalkylene, unsubstituted or substituted alkenylene, unsubstituted or substituted arylene, unsubstituted or substituted arylalkylene and unsubstituted or substituted heteroarylene as described herein. In some embodiments, the linker is an unsubstituted or substituted C5 or C6 arylene. In certain embodiments, the linker is an unsubstituted or substituted phenylene. In one exemplary embodiment, the linker is unsubstituted phenylene. In another exemplary embodiment, the linker is substituted phenylene (e.g., hydroxy-substituted phenylene).

The polymeric backbone can be selected from polyethylene, polypropylene, polyvinyl alcohol, polystyrene, polyurethane, polyvinyl chloride, polyphenol-aldehyde, polytetrafluoroethylene, polybutylene terephthalate, polycaprolactam, poly(acrylonitrile butadiene styrene), polyalkyleneammonium, polyalkylenediammonium, polyalkylenepyrrolium, polyalkyleneimidazolium, polyalkylenepyrazolium, polyalkyleneoxazolium, polyalkylenethiazolium, polyalkylenepyridinium, polyalkylenepyrimidinium, polyalkylenepyrazinium, polyalkylenepyradizimium, polyalkylenethiazinium, polyalkylenemorpholinium, polyalkylenepiperidinium, polyalkylenepiperizinium, polyalkylenepyrollizinium, polyalkylenetriphenylphosphonium, polyalkylenetrimethylphosphonium, polyalkylenetriethylphosphonium, polyalkylenetripropylphosphonium, polyalkylenetributylphosphonium, polyalkylenetrichlorophosphonium, polyalkylenetrifluorophosphonium, and polyalkylenediazolium, polyarylalkyleneammonium, polyarylalkylenediammonium, polyarylalkylenepyrrolium, polyarylalkyleneimidazolium, polyarylalkylenepyrazolium, polyarylalkyleneoxazolium, polyarylalkylenethiazolium, polyarylalkylenepyridinium, polyarylalkylenepyrimidinium, polyarylalkylenepyrazinium, polyarylalkylenepyradizimium, polyarylalkylenethiazinium, polyarylalkylenemorpholinium, polyarylalkylenepiperidinium, polyarylalkylenepiperizinium, polyarylalkylenepyrollizinium, polyarylalkylenetriphenylphosphonium, polyarylalkylenetrimethylphosphonium, polyarylalkylenetriethylphosphonium, polyarylalkylenetripropylphosphonium, polyarylalkylenetributylphosphonium, polyarylalkylenetrichlorophosphonium, polyarylalkylenetrifluorophosphonium, and polyarylalkylenediazolium.

Cationic polymeric backbones can be associated with one or more anions, including but not limited to, F⁻, Cl⁻, Br⁻, I⁻, NO₂⁻, NO₃⁻, SO₄²⁻, R⁷SO₄⁻, R⁷CO₂⁻, PO₄²⁻, R⁷PO₃⁻, and R⁷PO₂⁻, where R⁷ is selected from hydrogen, C₁₋₄alkyl, and C₁₋₄heteroalkyl. In one embodiment, each anion can be selected from Cl⁻, Br⁻, I⁻, HSO₄⁻, HCO₂⁻, CH₃CO₂⁻, and NO₃⁻. In other embodiments, the anion is acetate. In other embodiments, the anion is bisulfate. In other embodiments, the anion is chloride. In other embodiments, the anion is nitrate.

In some instances, the polymers described herein can be cross-linked. In other embodiments, the polymers described herein can be substantially not cross-linked

In other embodiments, provided herein are solid particles that have at least one polymer as disclosed herein coated on the surface of the solid core.

Exemplary polymers disclosed herein can include at least one acidic-ionic monomer connected to the polymeric backbone, wherein at least one acidic-ionic monomer comprises at least one Bronsted-Lowry acid in conjugate base form having at least one associated cationic moiety, and at least one cationic group, and wherein at least one of the acidic-ionic monomers comprises a linker connecting the acidic-ionic monomer to the polymeric backbone.

Disclosed herein are polymers having at least one catalytic property selected from:

a) disruption of at least one hydrogen bond in cellulosic materials;

b) intercalation of the polymer into crystalline domains of cellulosic materials; and

c) cleavage of at least one glycosidic bond in cellulosic materials.

Provided herein are compositions comprising biomass and at least one polymer as disclosed herein. Also provided are compositions having at least one polymer as disclosed herein, one or more sugars and residual biomass.

Described herein are methods for degrading biomass into one or more sugars, comprising:

a) providing biomass;

b) combining the biomass with a disclosed polymer for a period of time sufficient to produce a degraded mixture, wherein the degraded mixture comprises a liquid phase and a solid phase, wherein the liquid phase comprises one or more sugars, and wherein the solid phase comprises residual biomass;

c) isolating at least a portion of the liquid phase from the solid phase; and

d) recovering the one or more sugars from the isolated portion of the liquid phase.

Furthermore, in some embodiments, the isolating of at least a portion of the liquid phase from the solid phase produces a residual biomass mixture, and wherein the method further comprises:

i) providing a second biomass;

ii) combining the second biomass with the residual biomass mixture for a period of time sufficient to produce a second degraded mixture, wherein the second degraded mixture comprises a second liquid phase and a second solid phase, wherein the second liquid phase comprises one or more second sugars, and wherein the second solid phase comprises second residual biomass;

iii) isolating at least a portion of the second liquid phase from the second solid phase; and

iv) recovering the one or more second sugars from the isolated second liquid phase.

In some embodiments, the biomass or second biomass can be pretreated prior to step a) or i), respectively. Disclosed herein is a method for pretreating biomass before hydrolysis of the biomass to produce one or more sugars, comprising:

a) providing biomass;

b) combining the biomass with a disclosed polymer for a period of time sufficient to partially degrade the biomass; and

c) pretreating the partially degraded biomass before hydrolysis to produce one or more sugars.

Provided herein are methods of preparing disclosed polymers that include

a) providing a starting polymer;

b) combining the starting polymer with a nitrogen-containing compound or a phosphorous-containing compound to produce an ionic polymer having at least one cationic group;

c) combining the ionic polymer with an effective acidifying reagent to produce an intermediate polymer; and

d) combining the intermediate polymer with an effective amount of one or more ionic salts to produce the disclosed polymer;

wherein the steps a), b), c), and d) are performed in the order a), b), c), and d); or in the order a), c), d), and b); or in the order a), c), b), and d).

### DESCRIPTION OF THE FIGURES

The following description sets forth exemplary compositions, methods, parameters and the like. It should be recognized, however, that such description is not intended as a limitation on the scope of the present disclosure but is instead provided as a description of exemplary embodiments.

FIG. 1 illustrates a portion of an exemplary polymer that has a polymeric backbone and side chains.

FIG. 2 illustrates a portion of an exemplary polymer, in which a side chain with the acidic group is connected to the polymeric backbone by a linker and in which a side chain with the cationic group is connected directly to the polymeric backbone.

FIG. 3 illustrates the coordination of two Bronsted-Lowry acids in conjugate form that are associated with the same divalent metal cation.

FIG. 4A illustrates a portion of an exemplary polymer, in which the monomers are randomly arranged in an alternating sequence.

FIG. 4B illustrates a portion of an exemplary polymer, in which the monomers are arranged in blocks of monomers, and the block of acidic monomers alternates with the block of ionic monomers.

FIGS. 5A and 5B illustrate a portion of exemplary polymers with cross-linking within a given polymeric chain.

FIGS. 6A and 6B illustrate a portion of exemplary polymers with cross-linking between two polymeric chains.

FIG. 7A illustrates a portion of an exemplary polymer with a polyethylene backbone.

FIG. 7B illustrates a portion of an exemplary polymer with a polyvinylalcohol backbone.

FIG. 7C illustrates a portion of an exemplary polymer with an ionomeric backbone.

### DETAILED DESCRIPTION

The following description sets forth exemplary methods, parameters and the like. It should be recognized, however, that such description is not intended as a limitation on the scope of the present disclosure but is instead provided as a description of exemplary embodiments.

While specific embodiments of the present disclosure have been discussed, the specification is illustrative and not restrictive. Many variations of this disclosure will become apparent to those skilled in the art upon review of this specification. The full scope of the disclosure should be determined by reference to the claims, along with their full scope of equivalents, and the specification, along with such variations.

When ranges are used herein for physical properties, such as molecular weight, or chemical properties, such as chemical formulae, all combinations and subcombinations of ranges and specific embodiments therein are intended to be included. Unless otherwise indicated, all numbers expressing quantities of ingredients, reaction conditions, and so forth used in the specification and claims are to be understood as being modified in all instances by the term “about.” The term “about” when referring to a number or a numerical range means that the number or numerical range referred to is an approximation within experimental variability (or within statistical experimental error), and thus the number or numerical range can vary from, for example, but not limited to, between 0.1% and 15% of the stated number or numerical range. Accordingly, unless indicated to the contrary, the numerical parameters set forth in this specification and attached claims are approximations that can vary depending upon the desired properties sought to be obtained by the present disclosure.

Unless defined otherwise, all technical and scientific terms used herein have the same meaning as is commonly understood by one of skill in the art to which this specification pertains.

As used in the specification and claims, the singular form “a”, “an” and “the” includes plural references unless the context clearly dictates otherwise.

The term “associated cationic moiety” refers to a cation that is in proximity to a Bronsted-Lowry conjugate base due to, e.g., structural placement in a molecule or molecular matrix, placement in a reaction intermediate or transition state, or placement due to ionic attraction and/or bonding from atom(s) having opposite electronic charge.

The term “Bronsted-Lowry acid” refers to a molecule, or substituent thereof, in neutral or ionic form that is capable of donating a proton (hydrogen cation, H⁺). The term “Bronsted-Lowry base” refers to a molecule or substituent thereof in neutral (e.g., NH₃) or anionic form (e.g., Cl⁻) that is capable of accepting a proton (hydrogen cation, H⁺). For example, combining a Bronsted-Lowry acid HA with water (HA+H₂O [symbol] A⁻+H₃O⁺) gives the conjugate base A⁻ and protonated water. Conversely, combining a Bronsted-Lowry base B: with water (B: +H₂O [symbol] HB⁺+OH⁻) gives the conjugate acid HB⁺ and hydroxide. Combining a Bronsted-Lowry acid HA with a Bronsted-Lowry base B: (HA+B: [symbol] BH⁺A⁻) gives a salt BH⁺A⁻.

“Homopolymer” refers to a polymer having at least two monomer units, and where all the units contained within the polymer are derived from the same monomer in the same manner. A non-limiting example is polyethylene, where ethylene monomers are linked to form a uniform repeating chain (—CH₂—CH₂—CH₂—). Another non-limiting example is polyvinyl chloride, having a structure (—CH₂—CHCl—CH₂—CHCl—) where the —CH₂—CHCl— repeating unit is derived from the H₂C═CHCl monomer.

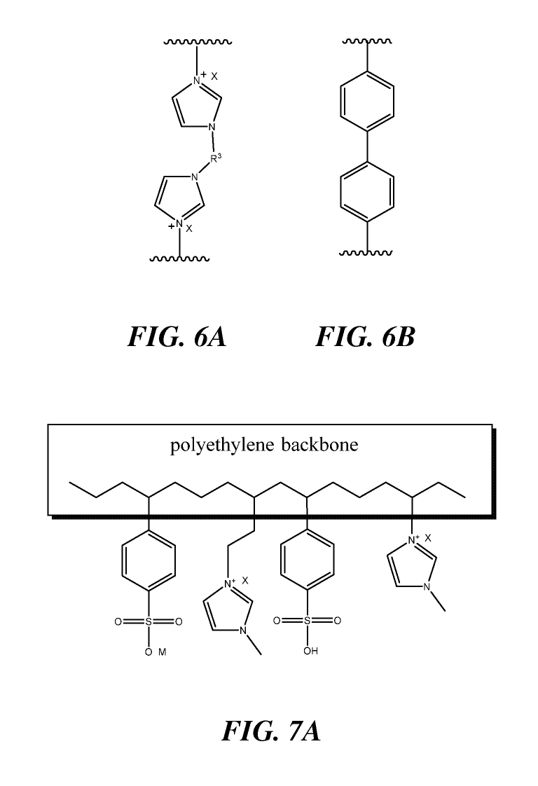

“Heteropolymer” refers to a polymer having at least two monomer units, and where at least one monomeric unit differs from the other monomeric units in the polymer. Heteropolymer also refers to polymers having difunctionalized, or trifunctionalized, monomer units that can be incorporated in the polymer in different ways. The different monomer units in the polymer can be in a random order, in an alternating sequence of any length of a given monomer, or in blocks of monomers. A non-limiting example is polyethyleneimidazolium, where if in an alternating sequence, would be the polymer depicted in FIG. 6C. Another non-limiting example is polystyrene-co-divinylbenzene, where if in an alternating sequence, could be (—CH₂—CH(phenyl)-CH₂—CH(4-ethylenephenyl)-CH₂—CH(phenyl)-CH₂—CH(4-ethylenephenyl)-). Here, the ethenyl functionality could be at the 2, 3, or 4 position on the phenyl ring.

As used herein, [symbol] denotes a generic polymeric backbone to which one or more substituents or side chains may be attached, as denoted by a straight perpendicular line descending from the [symbol] mark.

When a range of values is listed, it is intended to encompass each value and sub-range within the range. For example “C₁₋₆ alkyl” is intended to encompass, C₁, C₂, C₃, C₄, C₅, C₆, C₁₋₆, C₁₋₅, C₁₋₄, C₁₋₃, C₁₋₂, C₂₋₆, C₂₋₅, C₂₋₄, C₂₋₃, C₃₋₆, C₃₋₅, C₃₋₄, C₄₋₆, C₄₋₅, and C₅₋₆ alkyl.

“Alkyl” refers to a straight or branched hydrocarbon chain group consisting solely of carbon and hydrogen atoms, containing no unsaturation, having from one to ten carbon atoms (e.g., C₁-C₁₀ alkyl, 1-10C, C1-C10 or C1-10). Whenever it appears herein, a numerical range such as “1 to 10” refers to each integer in the given range; e.g., “1 to 10 carbon atoms” means that the alkyl group can consist of 1 carbon atom, 2 carbon atoms, 3 carbon atoms, etc., up to and including 10 carbon atoms, although the present definition also covers the occurrence of the term “alkyl” where no numerical range is designated. In some embodiments, it is a C₁-C₆ alkyl group. In some embodiments, alkyl groups have 1 to 10, 1 to 6, or 1 to 3 carbon atoms. Representative saturated straight chain alkyls include -methyl, -ethyl, -n-propyl, -n-butyl, -n-pentyl, and -n-hexyl; while saturated branched alkyls include -isopropyl, -sec-butyl, -isobutyl, -tert-butyl, -isopentyl, 2-methylbutyl, 3-methylbutyl, 2-methylpentyl, 3-methylpentyl, 4-methylpentyl, 2-methylhexyl, 3-methylhexyl, 4-methylhexyl, 5-methylhexyl, 2,3-dimethylbutyl, and the like. The alkyl is attached to the rest of the molecule by a single bond, for example, methyl (Me), ethyl (Et), n-propyl, 1-methylethyl (iso-propyl), n-butyl, n-pentyl, 1,1-dimethylethyl (t-butyl), 3-methylhexyl, 2-methylhexyl, and the like. When an alkyl residue having a specific number of carbons is named, all geometric isomers having that number of carbons are intended to be encompassed and described; thus, for example, “butyl” is meant to include n-butyl, sec-butyl, iso-butyl, and tert-butyl; “propyl” includes n-propyl, and iso-propyl. As used herein, “alkylene” refers to the same residues as alkyl, but having bivalency. Examples of alkylene include methylene (—CH₂—), ethylene (—CH₂CH₂—), propylene (—CH₂CH₂CH₂—), butylene (—CH₂CH₂CH₂CH₂—). Unless stated otherwise in the specification, an alkyl group is optionally substituted by one or more of substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Perhaloalkyl” refers to an alkyl group in which all of the hydrogen atoms have been replaced with a halogen selected from fluoro, chloro, bromo, and iodo. In some embodiments, all of the hydrogen atoms are each replaced with fluoro. In some embodiments, all of the hydrogen atoms are each replaced with chloro. Examples of perhaloalkyl groups include —CF₃, —CF₂CF₃, —CF₂CF₂CF₃, —CCl₃, —CFCl₂, —CF₂Cl and the like.

“Alkylaryl” refers to an -(alkyl)aryl group where aryl and alkyl are as disclosed herein and which are optionally substituted by one or more of the substituents described as suitable substituents for aryl and alkyl respectively. The “alkylaryl” is bonded to the parent molecular structure through the alkyl group.

The term “alkoxy” refers to the group —O-alkyl, including from 1 to 10 carbon atoms of a straight, branched, cyclic configuration and combinations thereof, attached to the parent molecular structure through an oxygen atom. Examples include methoxy, ethoxy, propoxy, isopropoxy, cyclopropyloxy, cyclohexyloxy and the like. “Lower alkoxy” refers to alkoxy groups containing one to six carbons. In some embodiments, C₁-C₄ alkoxy is an alkoxy group which encompasses both straight and branched chain alkyls of from 1 to 4 carbon atoms. Unless stated otherwise in the specification, an alkoxy group is optionally substituted by one or more substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Alkenyl” refers to a straight or branched hydrocarbon chain group consisting solely of carbon and hydrogen atoms, containing at least one double bond, and having from two to ten carbon atoms (i.e., C2-C10 alkenyl). Whenever it appears herein, a numerical range such as “2 to 10” refers to each integer in the given range; e.g., “2 to 10 carbon atoms” means that the alkenyl group can consist of 2 carbon atoms, 3 carbon atoms, etc., up to and including 10 carbon atoms. In certain embodiments, an alkenyl comprises two to eight carbon atoms. In other embodiments, an alkenyl comprises two to five carbon atoms (e.g., C2-C5 alkenyl). When an alkenyl residue having a specific number of carbons is named, all geometric isomers having that number of carbons are intended to be encompassed and described; thus, for example, “butenyl” is meant to include n-butenyl, sec-butenyl, and iso-butenyl. Examples of alkenyl can include —CH═CH₂, —CH₂—CH═CH₂ and —CH₂—CH═CH—CH═CH₂. The alkenyl is attached to the parent molecular structure by a single bond, for example, ethenyl (i.e., vinyl), prop 1 enyl (i.e., allyl), but 1 enyl, pent 1 enyl, penta 1,4 dienyl, and the like. The one or more carbon-carbon double bonds can be internal (such as in 2-butenyl) or terminal (such as in 1-butenyl). Examples of C2-4 alkenyl groups include ethenyl (C2), 1-propenyl (C3), 2-propenyl (C3), 1-butenyl (C4), 2-butenyl (C4), butadienyl (C4) and the like. Examples of C2-6 alkenyl groups include the aforementioned C2-4 alkenyl groups as well as pentenyl (C5), pentadienyl (C5), hexenyl (C6) and the like. Additional examples of alkenyl include heptenyl (C7), octenyl (C8), octatrienyl (C8) and the like. As used herein, “alkenylene” refers to the same residues as alkenyl, but having bivalency. Examples of alkenylene include ethylene (—CH═CH—), propylene (—CH₂—CH═CH—) and butylene (—CH₂—CH═CH—CH₂—). Alkenyl contains only C and H when unsubstituted. Unless stated otherwise in the specification, an alkenyl group is optionally substituted by one or more substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Amino” or “amine” refers to a —N(R^{b})₂, —N(R^{b})R^{b}—, or —R_{b}N(R_{b})R_{b}— group, where each R^{b} is independently selected from hydrogen, alkyl, alkenyl, alkynyl, haloalkyl, heteroalkyl (bonded through a chain carbon), cycloalkyl, cycloalkylalkyl, aryl, aralkyl, heterocycloalkyl (bonded through a ring carbon), heterocycloalkylalkyl, heteroaryl (bonded through a ring carbon) or heteroarylalkyl, unless stated otherwise in the specification, each of which moiety can itself be optionally substituted as described herein. When a —N(R^{b})₂ group has two R^{b} other than hydrogen, they can be combined with the nitrogen atom to form a 3-, 4-, 5-, 6-, or 7-membered ring. For example, —N(R^{b})₂ is meant to include, but not be limited to, 1-pyrrolidinyl and 4-morpholinyl. Unless stated otherwise in the specification, an amino group is optionally substituted by one or more substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

The term “amino” also refers to N-oxides of the groups —N⁺(H)(R^{a})O⁻, and —N⁺(R^{a})(R^{a})O—, R^{a} as described above, where the N-oxide is bonded to the parent molecular structure through the N atom. N-oxides can be prepared by treatment of the corresponding amino group with, for example, hydrogen peroxide or m-chloroperoxybenzoic acid. The person skilled in the art is familiar with reaction conditions for carrying out the N-oxidation.

“Amide” or “amido” refers to a chemical moiety with formula —C(O)N(R^{b})₂ or —NR^{b}C(O)R^{b}, where R^{b} is independently selected from hydrogen, alkyl, alkenyl, alkynyl, haloalkyl, heteroalkyl (bonded through a chain carbon), cycloalkyl, cycloalkylalkyl, aryl, aralkyl, heterocycloalkyl (bonded through a ring carbon), heterocycloalkylalkyl, heteroaryl (bonded through a ring carbon) or heteroarylalkyl, unless stated otherwise in the specification, each of which moiety can itself be optionally substituted as described herein. In some embodiments, this group is a C₁-C₄ amido or amide group, which includes the amide carbonyl in the total number of carbons in the group. When a —C(O)N(R^{b})₂ has two R^{b} other than hydrogen, they can be combined with the nitrogen atom to form a 3-, 4-, 5-, 6-, or 7-membered ring. For example, N(R^{b})₂ portion of a —C(O)N(R^{b})₂ group is meant to include, but not be limited to, 1-pyrrolidinyl and 4-morpholinyl. Unless stated otherwise in the specification, an amido R^{b} group is optionally substituted by one or more substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Aromatic” or “aryl” refers to a group with six to ten ring atoms (e.g., C₆-C₁₀ aromatic or C₆-C₁₀ aryl) which has at least one ring having a conjugated pi electron system which is carbocyclic (e.g., phenyl, fluorenyl, and naphthyl). The aromatic carbocyclic group can have a single ring (e.g., phenyl) or multiple condensed rings (e.g., naphthyl or anthryl), which condensed rings may or may not be aromatic. For example, bivalent radicals formed from substituted benzene derivatives and having the free valences at ring atoms are named as substituted phenylene radicals. In other embodiments, bivalent radicals derived from univalent polycyclic hydrocarbon radicals whose names end in “-yl” by removal of one hydrogen atom from the carbon atom with the free valence are named by adding “-idene” to the name of the corresponding univalent radical, e.g., a naphthyl group with two points of attachment is termed naphthylidene. An aryl group having more than one ring where at least one ring is non-aromatic can be connected to the parent structure at either an aromatic ring position or at a non-aromatic ring position. Whenever it appears herein, a numerical range such as “6 to 10 aryl” refers to each integer in the given range; e.g., “6 to 10 ring atoms” means that the aryl group can consist of 6 ring atoms, 7 ring atoms, etc., up to and including 10 ring atoms. The term includes monocyclic or fused-ring polycyclic (i.e., rings which share adjacent pairs of ring atoms) groups. Examples of aryl can include phenyl, phenol, and benzyl. Unless stated otherwise in the specification, an aryl moiety can be optionally substituted by one or more substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Aralkyl” or “arylalkyl” refers to an (aryl)alkyl-group where aryl and alkyl are as disclosed herein and which are optionally substituted by one or more of the substituents described as suitable substituents for aryl and alkyl respectively. The “aralkyl/arylalkyl” is bonded to the parent molecular structure through the alkyl group. The terms “aralkenyl/arylalkenyl” and “aralkynyl/arylalkynyl” mirror the above description of “aralkyl/arylalkyl” wherein the “alkyl” is replaced with “alkenyl” or “alkynyl” respectively, and the “alkenyl” or “alkynyl” terms are as described herein.

“Azide” refers to a —N₃ radical.

“Carbamate” refers to any of the following groups: —O—(C═O)—NR^{b}—, —O—(C═O)—N(R^{b})₂, —N(R^{b})—(C═O)—O—, and —N(R^{b})—(C═O)—OR^{b}, wherein each R^{b} is independently selected from alkyl, alkenyl, alkynyl, haloalkyl, heteroalkyl (bonded through a chain carbon), cycloalkyl, cycloalkylalkyl, aryl, aralkyl, heterocycloalkyl (bonded through a ring carbon), heterocycloalkylalkyl, heteroaryl (bonded through a ring carbon) or heteroarylalkyl, unless stated otherwise in the specification, each of which moiety can itself be optionally substituted as described herein.

“Cyano” refers to a —CN group.

“Cycloalkyl” refers to a monocyclic or polycyclic group that contains only carbon and hydrogen, and can be saturated, or partially unsaturated. Partially unsaturated cycloalkyl groups can be termed “cycloalkenyl” if the carbocycle contains at least one double bond, or “cycloalkynyl” if the carbocycle contains at least one triple bond. The cycloalkyl can consist of one ring, such as cyclohexyl, or multiple rings, such as adamantyl. A cycloalkyl with more than one ring can be fused, spiro or bridged, or combinations thereof. Cycloalkyl groups include groups having from 3 to 10 ring atoms (i.e., C₃-C₁₀ cycloalkyl). Whenever it appears herein, a numerical range such as “3 to 10” refers to each integer in the given range; e.g., “3 to 10 carbon atoms” means that the cycloalkyl group can consist of 3 carbon atoms, 4 carbon atoms, 5 carbon atoms, etc., up to and including 10 carbon atoms. The term “cycloalkyl” also includes bridged and spiro-fused cyclic structures containing no heteroatoms. The term also includes monocyclic or fused-ring polycyclic (i.e., rings which share adjacent pairs of ring atoms) groups. In some embodiments, it is a C₃-C₈ cycloalkyl group. In some embodiments, it is a C₃-C₅ cycloalkyl group. Illustrative examples of cycloalkyl groups include, but are not limited to the following moieties: C₃₋₆ carbocyclyl groups include, without limitation, cyclopropyl (C₃), cyclobutyl (C₄), cyclopentyl (C₅), cyclopentenyl (C₅), cyclohexyl (C₆), cyclohexenyl (C₆), cyclohexadienyl (C₆) and the like. Examples of C₃₋₈ carbocyclyl groups include the aforementioned C₃₋₆ carbocyclyl groups as well as cycloheptyl (C₇), cycloheptadienyl (C₇), cycloheptatrienyl (C₇), cyclooctyl (C₈), bicyclo[2.2.1]heptanyl, bicyclo[2.2.2]octanyl, and the like. Examples of C₃₋₁₀ carbocyclyl groups include the aforementioned C₃₋₈ carbocyclyl groups as well as octahydro-1H-indenyl, decahydronaphthalenyl, spiro[4.5]decanyl and the like. As used herein, “cycloalkylene” refers to the same residues as cycloalkyl, but having bivalency. Unless stated otherwise in the specification, a cycloalkyl group is optionally substituted by one or more substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Ether” refers to a —R^{b}—O—R^{b}— group where each R^{b} is independently selected from hydrogen, alkyl, alkenyl, alkynyl, haloalkyl, heteroalkyl (bonded through a chain carbon), cycloalkyl, cycloalkylalkyl, aryl, aralkyl, heterocycloalkyl (bonded through a ring carbon), heterocycloalkylalkyl, heteroaryl (bonded through a ring carbon) or heteroarylalkyl, unless stated otherwise in the specification, each of which moiety can itself be optionally substituted as described herein.

“Halo”, “halide”, or, alternatively, “halogen” means fluoro, chloro, bromo or iodo. The terms “haloalkyl,” “haloalkenyl,” “haloalkynyl” and “haloalkoxy” include alkyl, alkenyl, alkynyl and alkoxy structures that are substituted with one or more halo groups or with combinations thereof. For example, the terms “fluoroalkyl” and “fluoroalkoxy” include haloalkyl and haloalkoxy groups, respectively, in which the halo is fluorine, such as, but not limited to, trifluoromethyl, difluoromethyl, 2,2,2-trifluoroethyl, 1-fluoromethyl-2-fluoroethyl, and the like. Each of the alkyl, alkenyl, alkynyl and alkoxy groups can be optionally substituted as defined herein.

“Heteroalkyl” includes optionally substituted alkyl, alkenyl and alkynyl groups, respectively, and which have one or more skeletal chain atoms selected from an atom other than carbon, e.g., oxygen, nitrogen, sulfur, phosphorus or combinations thereof. A numerical range can be given, e.g., C₁-C₄ heteroalkyl which refers to the chain length in total, which in this example is 4 atoms long. For example, a —CH₂OCH₂CH₃ group is referred to as a “C₄” heteroalkyl, which includes the heteroatom center in the atom chain length description. Connection to the rest of the parent molecular structure can be through either a heteroatom or a carbon in the heteroalkyl chain. Exemplary heteroalkyl groups include, without limitation, ethers such as methoxyethanyl (—CH₂CH₂OCH₃), ethoxymethanyl (—CH₂OCH₂CH₃), (methoxymethoxy)ethanyl (—CH₂CH₂OCH₂OCH₃), (methoxymethoxy)methanyl (—CH₂OCH₂OCH₃) and (methoxyethoxy)methanyl (—CH₂OCH₂CH₂OCH₃) and the like; amines such as —CH₂CH₂NHCH₃, —CH₂CH₂N(CH₃)₂, —CH₂NHCH₂CH₃, —CH₂N(CH₂CH₃)(CH₃) and the like. A heteroalkyl group can be optionally substituted by one or more substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Heteroaryl” or, alternatively, “heteroaromatic” refers to a refers to a group of a 5-18 membered monocyclic or polycyclic (e.g., bicyclic or tricyclic) aromatic ring system (e.g., having 6, 10 or 14 π electrons shared in a cyclic array) having ring carbon atoms and 1-6 ring heteroatoms provided in the aromatic ring system, wherein each heteroatom is independently selected from nitrogen, oxygen, phosphorous and sulfur (“5-18 membered heteroaryl”). A heteroaryl group may have a single ring (e.g., pyridyl, pyridinyl, imidazolyl) or multiple condensed rings (e.g., indolizinyl, benzothienyl) which condensed rings may or may not be aromatic. A heteroaryl group having more than one ring where at least one ring is non-aromatic can be connected to the parent structure at either an aromatic ring position or at a non-aromatic ring position. In one variation, a heteroaryl group having more than one ring where at least one ring is non-aromatic is connected to the parent structure at an aromatic ring position. Heteroaryl polycyclic ring systems can include one or more heteroatoms in one or both rings. Whenever it appears herein, a numerical range such as “5 to 18” refers to each integer in the given range; e.g., “5 to 18 ring atoms” means that the heteroaryl group can consist of 5 ring atoms, 6 ring atoms, etc., up to and including 18 ring atoms. For example, bivalent radicals derived from univalent heteroaryl radicals whose names end in “-yl” by removal of one hydrogen atom from the atom with the free valence are named by adding “-idene” to the name of the corresponding univalent radical, e.g., a pyridyl group with two points of attachment is a pyridylidene.

For example, an N-containing “heteroaromatic” or “heteroaryl” moiety refers to an aromatic group in which at least one of the skeletal atoms of the ring is a nitrogen atom. One or more heteroatom(s) in the heteroaryl group can be optionally oxidized. One or more nitrogen atoms, if present, are optionally quaternized. “Heteroaryl” also includes ring systems substituted with one or more oxide (—O—) substituents, such as pyridinyl N-oxides. The heteroaryl is attached to the parent molecular structure through any atom of the ring(s).

“Heteroaryl” also includes ring systems wherein the heteroaryl ring, as defined above, is fused with one or more aryl groups wherein the point of attachment is either on the aryl or on the heteroaryl ring, or wherein the heteroaryl ring, as defined above, is fused with one or more carbocycyl or heterocycyl groups wherein the point of attachment is on the heteroaryl ring. For polycyclic heteroaryl groups wherein one ring does not contain a heteroatom (e.g., indolyl, quinolinyl, carbazolyl and the like) the point of attachment can be on either ring, i.e., either the ring bearing a heteroatom (e.g., 2-indolyl) or the ring that does not contain a heteroatom (e.g., 5-indolyl). In some embodiments, a heteroaryl group is a 5-10 membered aromatic ring system having ring carbon atoms and 1-4 ring heteroatoms provided in the aromatic ring system, wherein each heteroatom is independently selected from nitrogen, oxygen, phosphorous, and sulfur (“5-10 membered heteroaryl”). In some embodiments, a heteroaryl group is a 5-8 membered aromatic ring system having ring carbon atoms and 1-4 ring heteroatoms provided in the aromatic ring system, wherein each heteroatom is independently selected from nitrogen, oxygen, phosphorous, and sulfur (“5-8 membered heteroaryl”). In some embodiments, a heteroaryl group is a 5-6 membered aromatic ring system having ring carbon atoms and 1-4 ring heteroatoms provided in the aromatic ring system, wherein each heteroatom is independently selected from nitrogen, oxygen, phosphorous, and sulfur (“5-6 membered heteroaryl”). In some embodiments, the 5-6 membered heteroaryl has 1-3 ring heteroatoms selected from nitrogen, oxygen, phosphorous, and sulfur. In some embodiments, the 5-6 membered heteroaryl has 1-2 ring heteroatoms selected from nitrogen, oxygen, phosphorous, and sulfur. In some embodiments, the 5-6 membered heteroaryl has 1 ring heteroatom selected from nitrogen, oxygen, phosphorous, and sulfur.

Examples of heteroaryls include, but are not limited to, azepinyl, acridinyl, benzimidazolyl, benzindolyl, 1,3-benzodioxolyl, benzofuranyl, benzooxazolyl, benzo[d]thiazolyl, benzothiadiazolyl, benzo[b][1,4]dioxepinyl, benzo[b][1,4]oxazinyl, 1,4-benzodioxanyl, benzonaphthofuranyl, benzoxazolyl, benzodioxolyl, benzodioxinyl, benzoxazolyl, benzopyranyl, benzopyranonyl, benzofuranyl, benzofuranonyl, benzofurazanyl, benzothiazolyl, benzothienyl (benzothiophenyl), benzothieno[3,2-d]pyrimidinyl, benzotriazolyl, benzo[4,6]imidazo[1,2-a]pyridinyl, carbazolyl, cinnolinyl, cyclopenta[d]pyrimidinyl, 6,7-dihydro-5H-cyclopenta[4,5]thieno[2,3-d]pyrimidinyl, 5,6-dihydrobenzo[h]quinazolinyl, 5,6-dihydrobenzo[h]cinnolinyl, 6,7-dihydro-5H-benzo[6,7]cyclohepta[1,2-c]pyridazinyl, dibenzofuranyl, dibenzothiophenyl, furanyl, furazanyl, furanonyl, furo[3,2-c]pyridinyl, 5,6,7,8,9,10-hexahydrocycloocta[d]pyrimidinyl, 5,6,7,8,9,10-hexahydrocycloocta[d]pyridazinyl, 5,6,7,8,9,10-hexahydrocycloocta[d]pyridinyl, isothiazolyl, imidazolyl, indazolyl, indolyl, indazolyl, isoindolyl, indolinyl, isoindolinyl, isoquinolyl, indolizinyl, isoxazolyl, 5,8-methano-5,6,7,8-tetrahydroquinazolinyl, naphthyridinyl, 1,6-naphthyridinonyl, oxadiazolyl, 2-oxoazepinyl, oxazolyl, oxiranyl, 5,6,6a,7,8,9,10,10a-octahydrobenzo[h]quinazolinyl, 1-phenyl-1H-pyrrolyl, phenazinyl, phenothiazinyl, phenoxazinyl, phthalazinyl, pteridinyl, purinyl, pyranyl, pyrrolyl, pyrazolyl, pyrazolo[3,4-d]pyrimidinyl, pyridinyl, pyrido[3,2-d]pyrimidinyl, pyrido[3,4-d]pyrimidinyl, pyrazinyl, pyrimidinyl, pyridazinyl, pyrrolyl, quinazolinyl, quinoxalinyl, quinolinyl, isoquinolinyl, tetrahydroquinolinyl, 5,6,7,8-tetrahydroquinazolinyl, 5,6,7,8-tetrahydrobenzo[4,5]thieno[2,3-d]pyrimidinyl, 6,7,8,9-tetrahydro-5H-cyclohepta[4,5]thieno[2,3-d]pyrimidinyl, 5,6,7,8-tetrahydropyrido[4,5-c]pyridazinyl, thiazolyl, thiadiazolyl, thiapyranyl, triazolyl, tetrazolyl, triazinyl, thieno[2,3-d]pyrimidinyl, thieno[3,2-d]pyrimidinyl, thieno[2,3-c]pridinyl, and thiophenyl (i.e., thienyl). Unless stated otherwise in the specification, a heteroaryl moiety is optionally substituted by one or more substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Heterocyclyl”, “heterocycloalkyl” or ‘heterocarbocyclyl” refer to any 3- to 18-membered non-aromatic monocyclic or polycyclic moiety comprising at least one heteroatom selected from nitrogen, oxygen, phosphorous and sulfur. A heterocyclyl group can be a monocyclic, bicyclic, tricyclic or tetracyclic ring system, wherein the polycyclic ring systems can be a fused, bridged or spiro ring system. Heterocyclyl polycyclic ring systems can include one or more heteroatoms in one or both rings. A heterocyclyl group can be saturated or partially unsaturated. Partially unsaturated heterocycloalkyl groups can be termed “heterocycloalkenyl” if the heterocyclyl contains at least one double bond, or “heterocycloalkynyl” if the heterocyclyl contains at least one triple bond. Whenever it appears herein, a numerical range such as “3 to 18” refers to each integer in the given range; e.g., “5 to 18 ring atoms” means that the heterocyclyl group can consist of 5 ring atoms, 6 ring atoms, etc., up to and including 18 ring atoms. For example, bivalent radicals derived from univalent heterocyclyl radicals whose names end in “-yl” by removal of one hydrogen atom from the atom with the free valence are named by adding “-idene” to the name of the corresponding univalent radical, e.g., a piperidine group with two points of attachment is a piperidylidene.

An N-containing heterocyclyl moiety refers to an non-aromatic group in which at least one of the skeletal atoms of the ring is a nitrogen atom. The heteroatom(s) in the heterocyclyl group is optionally oxidized. One or more nitrogen atoms, if present, are optionally quaternized. “Heterocyclyl” also includes ring systems substituted with one or more oxide (—O—) substituents, such as piperidinyl N-oxides. The heterocyclyl is attached to the parent molecular structure through any atom of the ring(s).

“Heterocyclyl” also includes ring systems wherein the heterocycyl ring, as defined above, is fused with one or more carbocycyl groups wherein the point of attachment is either on the carbocycyl or heterocyclyl ring, or ring systems wherein the heterocyclyl ring, as defined above, is fused with one or more aryl or heteroaryl groups, wherein the point of attachment is on the heterocyclyl ring. In some embodiments, a heterocyclyl group is a 5-10 membered non-aromatic ring system having ring carbon atoms and 1-4 ring heteroatoms, wherein each heteroatom is independently selected from nitrogen, oxygen and sulfur (“5-10 membered heterocyclyl”). In some embodiments, a heterocyclyl group is a 5-8 membered non-aromatic ring system having ring carbon atoms and 1-4 ring heteroatoms, wherein each heteroatom is independently selected from nitrogen, oxygen and sulfur (“5-8 membered heterocyclyl”). In some embodiments, a heterocyclyl group is a 5-6 membered non-aromatic ring system having ring carbon atoms and 1-4 ring heteroatoms, wherein each heteroatom is independently selected from nitrogen, oxygen and sulfur (“5-6 membered heterocyclyl”). In some embodiments, the 5-6 membered heterocyclyl has 1-3 ring heteroatoms selected from nitrogen, oxygen and sulfur. In some embodiments, the 5-6 membered heterocyclyl has 1-2 ring heteroatoms selected from nitrogen, oxygen and sulfur. In some embodiments, the 5-6 membered heterocyclyl has 1 ring heteroatom selected from nitrogen, oxygen and sulfur.

Exemplary 3-membered heterocyclyls containing 1 heteroatom include, without limitation, azirdinyl, oxiranyl, thiorenyl. Exemplary 4-membered heterocyclyls containing 1 heteroatom include, without limitation, azetidinyl, oxetanyl and thietanyl. Exemplary 5-membered heterocyclyls containing 1 heteroatom include, without limitation, tetrahydrofuranyl, dihydrofuranyl, tetrahydrothiophenyl, dihydrothiophenyl, pyrrolidinyl, dihydropyrrolyl and pyrrolyl-2,5-dione. Exemplary 5-membered heterocyclyls containing 2 heteroatoms include, without limitation, dioxolanyl, oxathiolanyl and dithiolanyl. Exemplary 5-membered heterocyclyls containing 3 heteroatoms include, without limitation, triazolinyl, oxadiazolinyl, and thiadiazolinyl. Exemplary 6-membered heterocyclyl groups containing 1 heteroatom include, without limitation, piperidinyl, tetrahydropyranyl, dihydropyridinyl, and thianyl. Exemplary 6-membered heterocyclyl groups containing 2 heteroatoms include, without limitation, piperazinyl, morpholinyl, dithianyl, dioxanyl. Exemplary 6-membered heterocyclyl groups containing 2 heteroatoms include, without limitation, triazinanyl. Exemplary 7-membered heterocyclyl groups containing 1 heteroatom include, without limitation, azepanyl, oxepanyl and thiepanyl. Exemplary 8-membered heterocyclyl groups containing 1 heteroatom include, without limitation, azocanyl, oxecanyl and thiocanyl. Exemplary bicyclic heterocyclyl groups include, without limitation, indolinyl, isoindolinyl, dihydrobenzofuranyl, dihydrobenzothienyl, tetrahydrobenzothienyl, tetrahydrobenzofuranyl, tetrahydroindolyl, tetrahydroquinolinyl, tetrahydroisoquinolinyl, decahydroquinolinyl, decahydroisoquinolinyl, octahydrochromenyl, octahydroisochromenyl, decahydronaphthyridinyl, decahydro-1,8-naphthyridinyl, octahydropyrrolo[3,2-b]pyrrole, indolinyl, phthalimidyl, naphthalimidyl, chromanyl, chromenyl, 1H-benzo[e][1,4]diazepinyl, 1,4,5,7-tetrahydropyrano[3,4-b]pyrrolyl, 5,6-dihydro-4H-furo[3,2-b]pyrrolyl, 6,7-dihydro-5H-furo[3,2-b]pyranyl, 5,7-dihydro-4H-thieno[2,3-c]pyranyl, 2,3-dihydro-1H-pyrrolo[2,3-b]pyridinyl, 2,3-dihydrofuro[2,3-b]pyridinyl, 4,5,6,7-tetrahydro-1H-pyrrolo[2,3-b]pyridinyl, 4,5,6,7-tetrahydrofuro[3,2-c]pyridinyl, 4,5,6,7-tetrahydrothieno[3,2-b]pyridinyl, 1,2,3,4-tetrahydro-1,6-naphthyridinyl, and the like.

Unless stated otherwise, heterocyclyl moieties are optionally substituted by one or more substituents which independently include: alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —S(O)ₜRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)ₜN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Imino” refers to the “—(C═N)—R^{b}” group where R^{b} is selected from hydrogen, alkyl, alkenyl, alkynyl, haloalkyl, heteroalkyl (bonded through a chain carbon), cycloalkyl, cycloalkylalkyl, aryl, aralkyl, heterocycloalkyl (bonded through a ring carbon), heterocycloalkylalkyl, heteroaryl (bonded through a ring carbon) or heteroarylalkyl, unless stated otherwise in the specification, each of which moiety can itself be optionally substituted as described herein.

“Moiety” refers to a specific segment or functional group of a molecule. Chemical moieties are often recognized chemical entities embedded in or appended to a molecule.

“Nitro” refers to the —NO₂ group.

As used herein, the term “unsubstituted” means that for carbon atoms, only hydrogen atoms are present besides those valencies linking the atom to the parent molecular group. A non-limiting example is propyl (—CH₂—CH₂—CH₃). For nitrogen atoms, valencies not linking the atom to the parent molecular group are either hydrogen or an electron pair. For sulfur atoms, valencies not linking the atom to the parent molecular group are either hydrogen, oxygen or electron pair(s).

As used herein, the term “substituted” or “substitution” means that at least one hydrogen present on a group (e.g., a carbon or nitrogen atom) is replaced with a permissible substituent, e.g., a substituent which upon substitution for the hydrogen results in a stable compound, e.g., a compound which does not spontaneously undergo transformation such as by rearrangement, cyclization, elimination, or other reaction. Unless otherwise indicated, a “substituted” group can have a substituent at one or more substitutable positions of the group, and when more than one position in any given structure is substituted, the substituent is either the same or different at each position. Substituents include one or more group(s) individually and independently selected from alkyl, alkoxy, alkylaryl, cycloalkyl, aralkyl, aryl, aryloxy, amino, amido, carbamate, carbonyl, heteroalkyl, heteroaryl, heterocycloalkyl, cyano, halo, haloalkoxy, haloalkyl, ether, thio, alkylthio, arylthio, —ORₐ, —SRₐ, —N(Rₐ)₂, —C(O)Rₐ, —C(O)N(Rₐ)₂, —N(Rₐ)C(O)Rₐ, —N(Rₐ)S(O)tRₐ (where t is 1 or 2), and —S(O)tN(Rₐ)₂ (where t is 1 or 2), where each Rₐ is independently hydrogen, alkyl, haloalkyl, cycloalkyl, aryl, aralkyl, heterocycloalkyl, or heteroaryl and each of these moieties can be optionally substituted as defined herein.

“Sulfanyl”, “sulfide”, and “thio” each refer to the groups: —S—R^{b}, wherein R^{b} is selected from alkyl, alkenyl, alkynyl, haloalkyl, heteroalkyl (bonded through a chain carbon), cycloalkyl, cycloalkylalkyl, aryl, aralkyl, heterocycloalkyl (bonded through a ring carbon), heterocycloalkylalkyl, heteroaryl (bonded through a ring carbon) or heteroarylalkyl, unless stated otherwise in the specification, each of which moiety can itself be optionally substituted as described herein. For instance, an ‘alkylthio” refers to the “alkyl-S—” group, and “arylthio” refers to the “aryl-S—” group, each of which are bound to the parent molecular group through the S atom. The terms “thiol”, “mercapto”, and “mercaptan” each refer to the group —R^{c}SH.

“Sulfinyl” refers to the —S(O)—R^{b} group, wherein R^{b} is selected from hydrogen, alkyl, alkenyl, alkynyl, haloalkyl, heteroalkyl (bonded through a chain carbon), cycloalkyl, cycloalkylalkyl, aryl, aralkyl, heterocycloalkyl (bonded through a ring carbon), heterocycloalkylalkyl, heteroaryl (bonded through a ring carbon) or heteroarylalkyl, unless stated otherwise in the specification, each of which moiety can itself be optionally substituted as described herein.

“Sulfonyl” refers to the —S(O₂)—R^{b} group, wherein R^{b} is selected from hydrogen, alkyl, alkenyl, alkynyl, haloalkyl, heteroalkyl (bonded through a chain carbon), cycloalkyl, cycloalkylalkyl, aryl, aralkyl, heterocycloalkyl (bonded through a ring carbon), heterocycloalkylalkyl, heteroaryl (bonded through a ring carbon) or heteroarylalkyl, unless stated otherwise in the specification, each of which moiety can itself be optionally substituted as described herein.

“Sulfonamidyl” or “sulfonamido” refers to a —S(═O)₂—NR^{b}R^{b} or —N(R^{b})—S(═O)₂-group, where each R^{b} is independently selected from hydrogen, alkyl, alkenyl, alkynyl, haloalkyl, heteroalkyl (bonded through a chain carbon), cycloalkyl, cycloalkylalkyl, aryl, aralkyl, heterocycloalkyl (bonded through a ring carbon), heterocycloalkylalkyl, heteroaryl (bonded through a ring carbon) or heteroarylalkyl, unless stated otherwise in the specification, each of which moiety can itself be optionally substituted as described herein. The R^{b} groups in —NR^{b}R^{b} of the —S(═O)₂—NR^{b}R^{b} group can be taken together with the nitrogen to which they are attached to form a 4-, 5-, 6-, or 7-membered ring. In some embodiments, the term designates a C₁-C₄ sulfonamido, wherein each R in sulfonamido contains 1 carbon, 2 carbons, 3 carbons, or 4 carbons total.

“Sulfoxyl” refers to a —S(═O)₂OH group.

Where substituent groups are specified by their conventional chemical formulae, written from left to right, they equally encompass the chemically identical substituents that would result from writing the structure from right to left, e.g., —CH₂O— is equivalent to —OCH₂—.

Described herein are polymers that can be used, in some embodiments, as an acid catalyst to hydrolyze cellulosic materials to produce monosaccharides, as well as oligosaccharides. For example, the polymeric catalysts provided herein can disrupt the hydrogen bond superstructure typically found in natural cellulosic materials, allowing the acidic pendant groups of the polymer to come into chemical contact with the interior glycosidic bonds in the crystalline domains of cellulose.

Disclosed herein are polymers that include acidic monomers and ionic monomers connected to form a polymeric backbone,

wherein a plurality of acidic monomers independently comprises at least one Bronsted-Lowry acid in acidic form, and at least one Bronsted-Lowry acid in conjugate base form having at least one associated cationic moiety, wherein at least one of the acidic monomers comprises a linker connecting the Bronsted-Lowry acid in conjugate base form to the polymeric backbone,

wherein each ionic monomer independently comprises at least one nitrogen-containing cationic group or phosphorous-containing cationic group, and

wherein at least one of the ionic monomers comprises a linker connecting the nitrogen-containing cationic group or the phosphorous-containing cationic group to the polymeric backbone.

In some embodiments, the acidic monomers can be selected from Formulas IA-VIA:

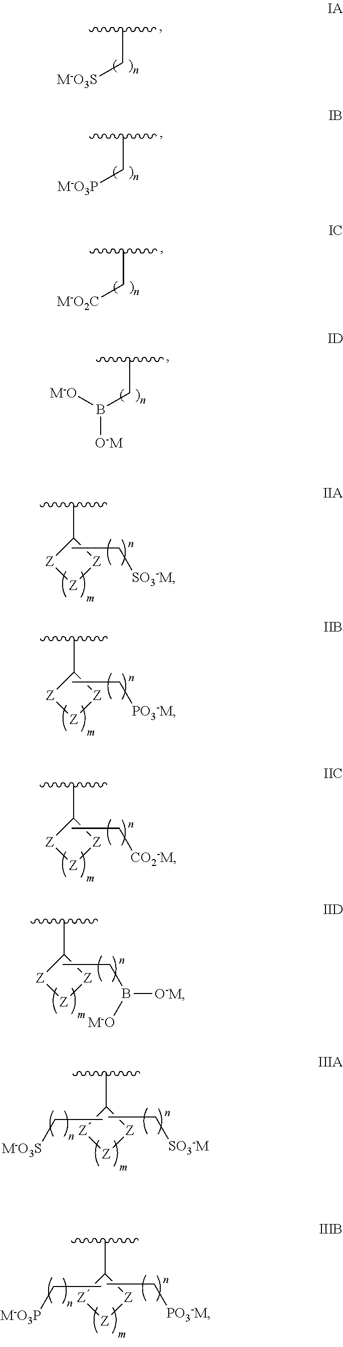

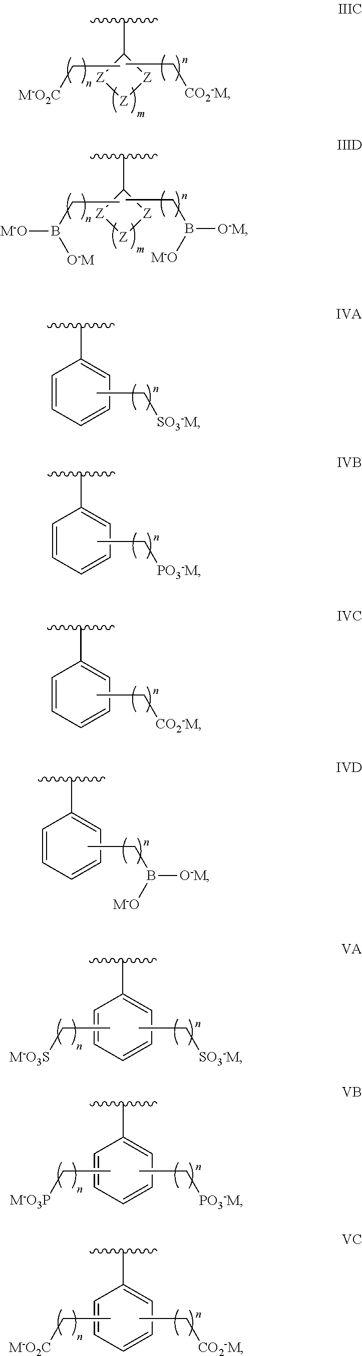

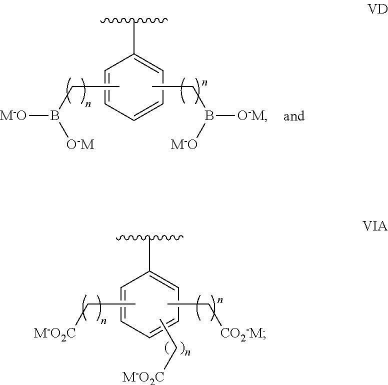

wherein for the Bronsted-Lowry acid in acidic form, at least one M in a Formula selected from IA-VIA is hydrogen;

wherein for the Bronsted-Lowry acid in conjugate base form having at least one associated cationic moiety, each M is independently selected from Li⁺, Na⁺, K⁺, N(R¹)₄⁺, Zn²⁺, Mg²⁺, and Ca²⁺, where Zn²⁺, Mg²⁺ and Ca²⁺ are each independently associated with at least two Bronsted-Lowry acids in conjugate base form at any M position on any acidic monomer;

each Z is independently selected from C(R²)(R³), N(R⁴), 5, S(R⁵)(R⁶), S(O)(R⁵)(R⁶), SO₂, and O, where any two adjacent Z may be joined by a double bond;

each m is independently selected from 0, 1, 2, and 3;

each n is independently selected from 0, 1, 2, and 3;

each R¹, R², R³ and R⁴ is independently selected from hydrogen, alkyl, heteroalkyl, cycloalkyl, heterocyclyl, aryl, and heteroaryl;

each R⁵ and R⁶ is independently selected from alkyl, heteroalkyl, cycloalkyl, heterocyclyl, aryl, and heteroaryl; and

where any two adjacent Z can be taken together to form a group selected from cycloalkyl, heterocycloalkyl, aryl and heteroaryl.

In some embodiments, the polymer can be selected from Formulas IA, IB, IVA, and IVB. In other embodiments, the polymer can be selected from Formulas IIA, IIB, ITC, IVA, IVB, and IVC. In other embodiments, the polymer can be selected from IIIA, IIIB, and IIIC. In some embodiments, the polymer can be selected from VA, VB, and VC. In some embodiments, the polymer can be selected from IA. In other embodiments, the polymer can be selected from IB.

In some embodiments, M can be selected from Na⁺, K⁺, N(R¹)₄⁺, Mg²⁺, and Ca²⁺. In other embodiments, M can be selected from Na⁺, Mg²⁺, and Ca²⁺, such as from Mg²⁺ and Ca²⁺. In some embodiments, Z can be chosen from C(R²)(R³), N(R⁴), SO₂, and O. In some embodiments, any two adjacent Z can be taken together to form a group selected from a heterocycloalkyl, aryl, and heteroaryl. In other embodiments, any two adjacent Z can be joined by a double bond. Any combination of these embodiments is also contemplated.

In some embodiments, m is selected from 2 or 3, such as 3. In other embodiments, n is selected from 1, 2, and 3, such as 2 or 3. In some embodiments, R¹ can be selected from hydrogen, alkyl and heteroalkyl. In some embodiments, R¹ can be selected from hydrogen, methyl, or ethyl. In some embodiments, each R², R³, and R⁴ can be independently selected from hydrogen, alkyl, heterocyclyl, aryl, and heteroaryl. In other embodiments, each R², R³ and R⁴ can be independently selected from heteroalkyl, cycloalkyl, heterocyclyl, and heteroaryl. In some embodiments, each R⁵ and R⁶ can be independently selected from alkyl, heterocyclyl, aryl, and heteroaryl. In another embodiment, any two adjacent Z can be taken together to form a group selected from cycloalkyl, heterocycloalkyl, aryl and heteroaryl.

In some embodiments, the polymer described herein contains monomers that have at least one Bronsted-Lowry acid and at least one cationic group. The Bronsted-Lowry acid and the cationic group can be on different monomers or on the same monomer.

In one aspect, provided is a polymer having acidic monomers and ionic monomers that are connected to form a polymeric backbone, in which each acidic monomer has at least one Bronsted-Lowry acid, and each ionic monomer independently has at least one nitrogen-containing cationic group or phosphorous-containing cationic group. In some embodiments, each acidic monomer has one Bronsted-Lowry acid. In other embodiments, some of the acidic monomers have one Bronsted-Lowry acid, while others have two Bronsted-Lowry acids. In some embodiments, each ionic monomer has one nitrogen-containing cationic group or phosphorous-containing cationic group. In other embodiments, some of the ionic monomers have one nitrogen-containing cationic group or phosphorous-containing cationic group, while others have two nitrogen-containing cationic groups or phosphorous-containing cationic groups.

Suitable Bronsted-Lowry acids can include any Bronsted-Lowry acid that can form a covalent bond with a carbon. The Bronsted-Lowry acids can have a pK value of less than about 7, less than about 6, less than about 5, less than about 4, less than about 3, less than about 2, less than about 1, or less than zero. In some embodiments, the Bronsted-Lowry acid at each occurrence can be independently selected from sulfonic acid, phosphonic acid, acetic acid, and isophthalic acid.

The acidic monomers in the polymeric catalyst can either all have the same Bronsted-Lowry acid, or can have different Bronsted-Lowry acids. In an exemplary embodiment, each Bronsted-Lowry acid in the polymeric catalyst is sulfonic acid. In another exemplary embodiment, each Bronsted-Lowry acid in the polymeric catalyst is phosphonic acid. In yet another exemplary embodiment, the Bronsted-Lowry acid in some monomers of the polymeric catalyst is sulfonic acid, while the Bronsted-Lowry acid in other monomers of the polymeric catalyst is phosphonic acid.

In some embodiments, at least one of the acidic monomers can have a linker to form an acidic side chain, wherein each acidic side chain is independently selected from:

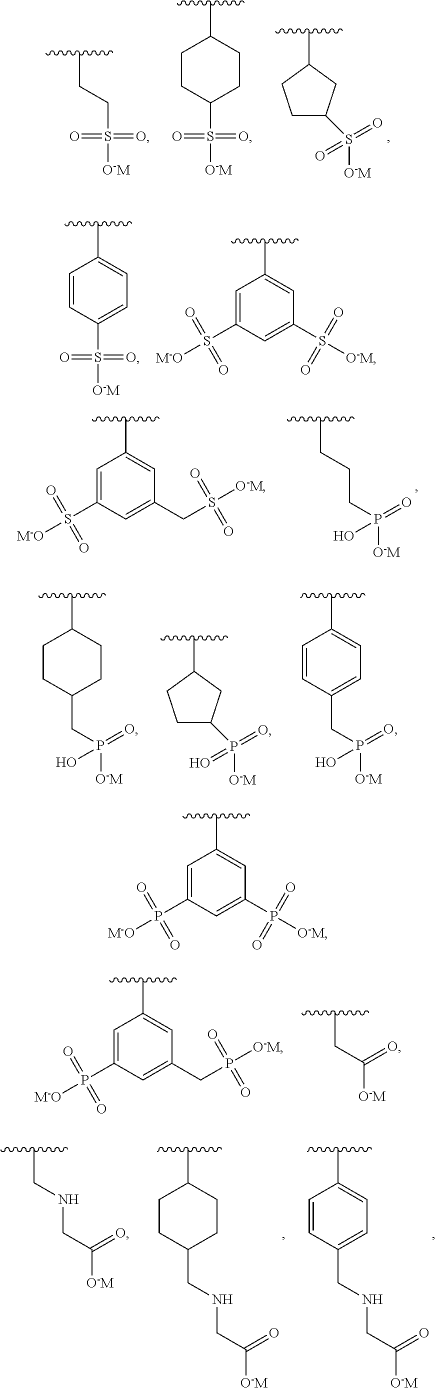

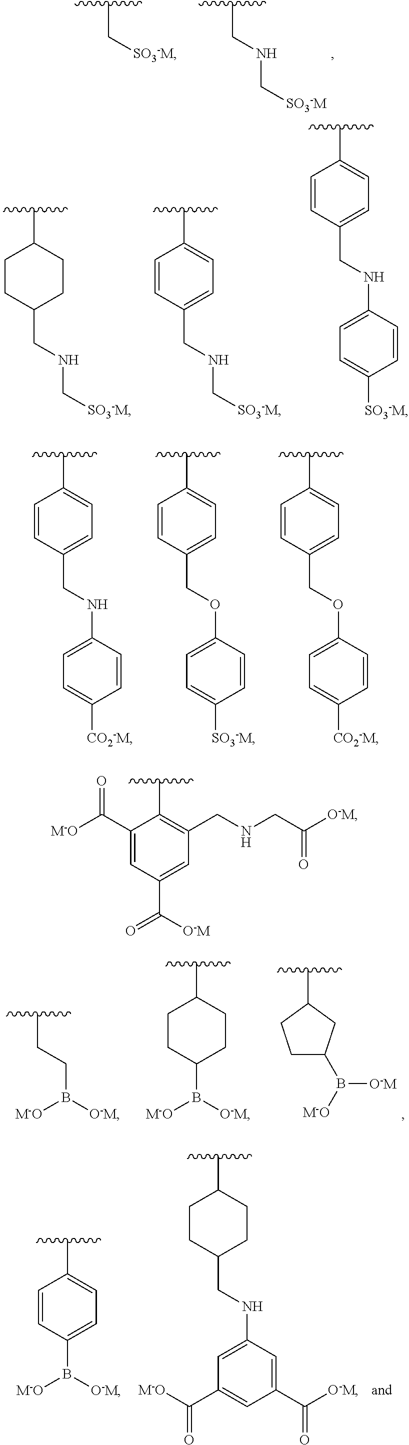

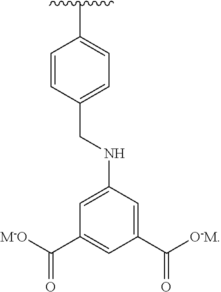

In some embodiments, the acidic side chain is independently selected from:

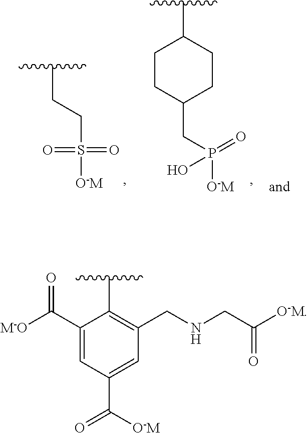

In some embodiments, the acidic side chain is independently selected from:

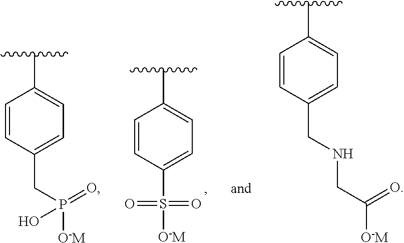

In some embodiments, the acidic side chain is independently selected from:

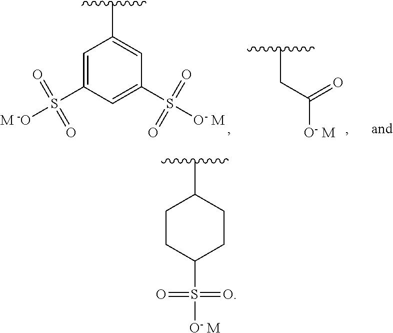

In other embodiments, the acidic monomers can have a side chain with a Bronsted-Lowry acid that is directly connected to the polymeric backbone. Side chains with a Bronsted-Lowry acid directly connected to the polymeric backbone can include, for example,

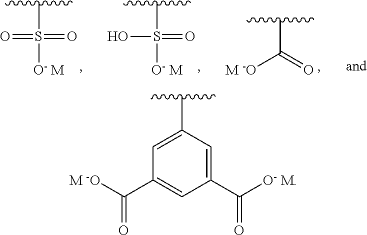

In some embodiments, the ionic monomers can have one cationic group. In other embodiments, the ionic monomers can have two or more cationic groups, as is chemically feasible. When the ionic monomers have two or more cationic groups, the cationic groups can be the same or different.

In some embodiments, each cationic group in the polymeric catalyst is a nitrogen-containing cationic group. In other embodiments, each cationic group in the polymeric catalyst is a phosphorous-containing cationic group. In yet other embodiments, the cationic group in some monomers of the polymeric catalyst is a nitrogen-containing cationic group, whereas the cationic group in other monomers of the polymeric catalyst is a phosphorous-containing cationic group. In an exemplary embodiment, each cationic group in the polymeric catalyst is imidazolium. In another exemplary embodiment, the cationic group in some monomers of the polymeric catalyst is imidazolium, while the cationic group in other monomers of the polymeric catalyst is pyridinium. In yet another exemplary embodiment, each cationic group in the polymeric catalyst is a substituted phosphonium. In yet another exemplary embodiment, the cationic group in some monomers of the polymeric catalyst is triphenyl phosphonium, while the cationic group in other monomers of the polymeric catalyst is imidazolium.

In some embodiments, the nitrogen-containing cationic group at each occurrence can be independently selected from pyrrolium, imidazolium, pyrazolium, oxazolium, thiazolium, pyridinium, pyrimidinium, pyrazinium, pyradizimium, thiazinium, morpholinium, piperidinium, piperizinium, and pyrollizinium. In other embodiments, the nitrogen-containing cationic group at each occurrence can be independently selected from imidazolium, pyridinium, pyrimidinium, morpholinium, piperidinium, and piperizinium. In some embodiments, the nitrogen-containing cationic group can be imidazolium.

In some embodiments, the phosphorous-containing cationic group at each occurrence can be independently selected from triphenyl phosphonium, trimethyl phosphonium, triethyl phosphonium, tripropyl phosphonium, tributyl phosphonium, trichloro phosphonium, and trifluoro phosphonium. In other embodiments, the phosphorous-containing cationic group at each occurrence can be independently selected from triphenyl phosphonium, trimethyl phosphonium, and triethyl phosphonium. In other embodiments, the phosphorous-containing cationic group can be triphenyl phosphonium.

In some embodiments, each ionic monomer is independently selected from Formulas VIIA-XIB:

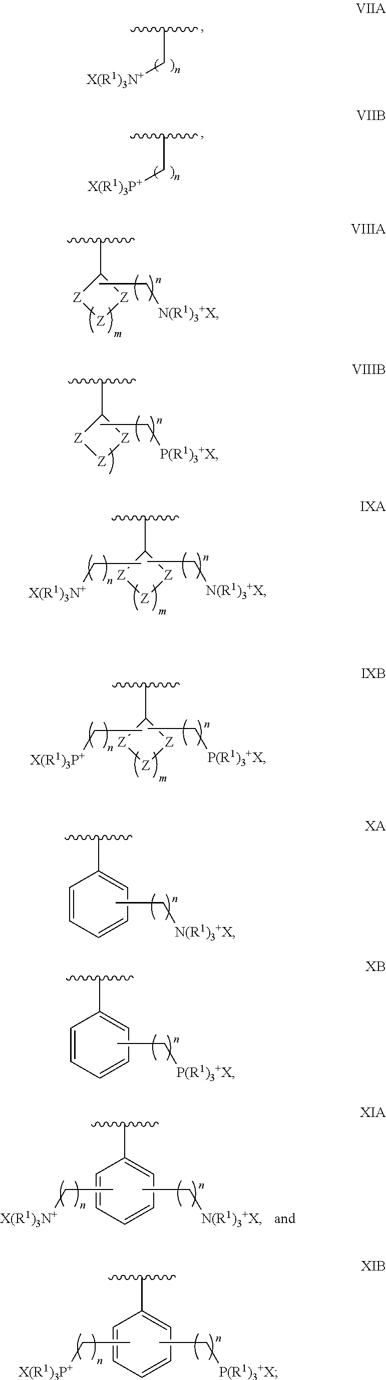

wherein each Z is independently selected from C(R²)(R³), N(R⁴), S, S(R⁵)(R⁶), S(O)(R⁵)(R⁶), SO₂, and O, where any two adjacent Z may be joined by a double bond;

each X is independently selected from F⁻, Cl⁻, Br⁻, I⁻, NO₂⁻, NO₃⁻, SO₄²⁻, R⁷SO₄⁻, R⁷CO₂⁻, PO₄²⁻, R⁷PO₃⁻, and R⁷PO₂⁻, where SO₄²⁻ and PO₄²⁻ are each independently associated with at least two cationic groups at any X position on any ionic monomer, and

each m is independently selected from 0, 1, 2, and 3;

each n is independently selected from 0, 1, 2, and 3;

each R¹, R², R³ and R⁴ is independently selected from hydrogen, alkyl, heteroalkyl, cycloalkyl, heterocyclyl, aryl, and heteroaryl;

each R⁵ and R⁶ is independently selected from alkyl, heteroalkyl, cycloalkyl, heterocyclyl, aryl, and heteroaryl;

where any two adjacent Z can be taken together to form a group selected from cycloalkyl, heterocycloalkyl, aryl and heteroaryl; and

each R⁷ is independently selected from hydrogen, C₁₋₄alkyl, and C₁₋₄heteroalkyl.

In some embodiments, Z can be chosen from C(R²)(R³), N(R⁴), SO₂, and O. In some embodiments, any two adjacent Z can be taken together to form a group selected from a heterocycloalkyl, aryl and heteroaryl. In other embodiments, any two adjacent Z can be joined by a double bond. In some embodiments, each X can be selected from Cl⁻, NO₃⁻, SO₄²⁻, R⁷SO₄⁻, and R⁷CO₂⁻, where R⁷ can be selected from hydrogen and C₁₋₄alkyl. In another embodiment, each X can be selected from Cl⁻, Br⁻, I⁻, HSO₄⁻, HCO₂⁻, CH₃CO₂⁻, and NO₃⁻. In other embodiments, X is acetate. In other embodiments, X is bisulfate. In other embodiments, X is chloride. In other embodiments, X is nitrate.

In some embodiments, m is selected from 2 or 3, such as 3. In other embodiments, n is selected from 1, 2, and 3, such as 2 or 3. In some embodiments, R¹ can be selected from hydrogen, alkyl, and heteroalkyl. In some embodiments, R¹ can be selected from hydrogen, methyl, or ethyl. In some embodiments, each R², R³, and R⁴ can be independently selected from hydrogen, alkyl, heterocyclyl, aryl, and heteroaryl. In other embodiments, each R², R³ and R⁴ can be independently selected from heteroalkyl, cycloalkyl, heterocyclyl, and heteroaryl. In some embodiments, each R⁵ and R⁶ can be independently selected from alkyl, heterocyclyl, aryl, and heteroaryl. In another embodiment, any two adjacent Z can be taken together to form a group selected from cycloalkyl, heterocycloalkyl, aryl and heteroaryl.

In some embodiments, the nitrogen-containing cationic group and the linker can form a nitrogen-containing side chain, wherein each nitrogen-containing side chain can be independently selected from:

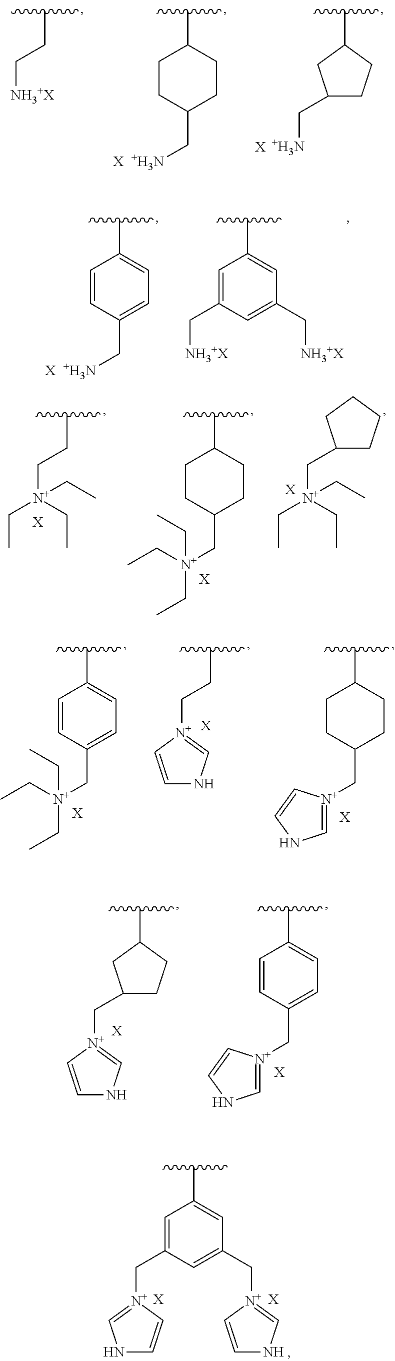

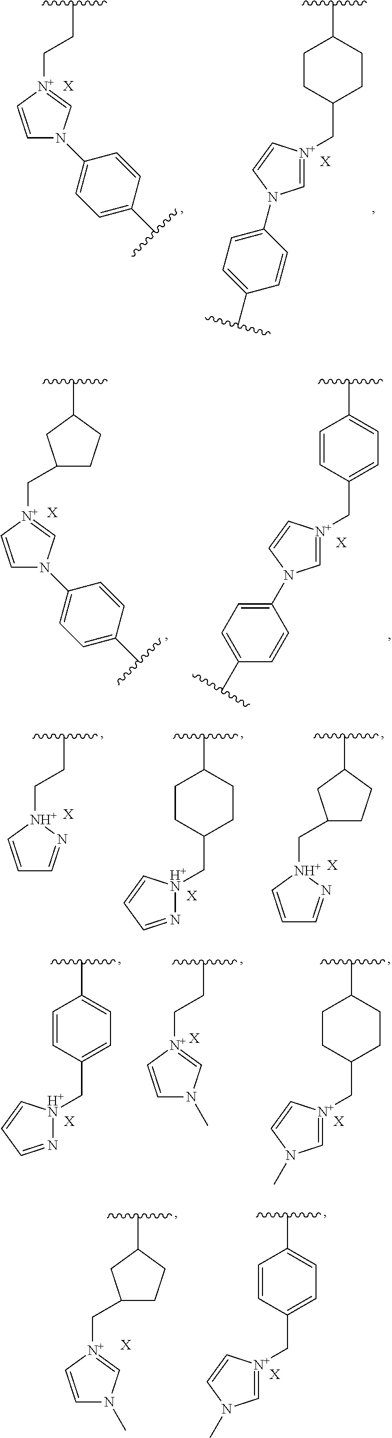

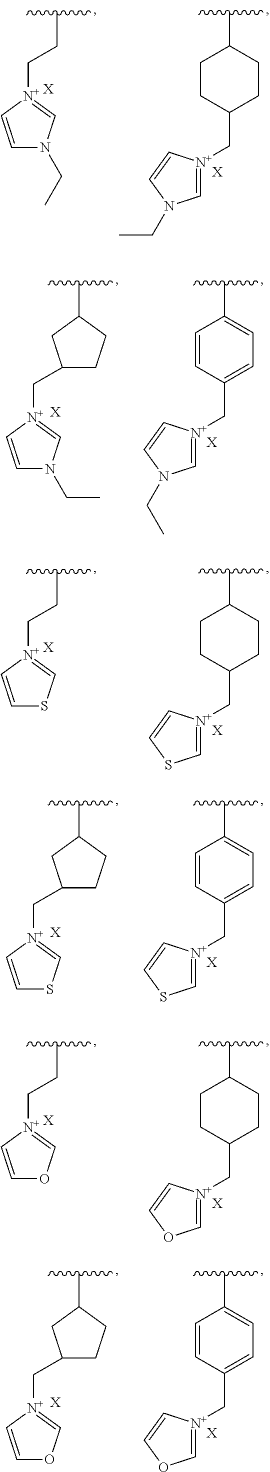

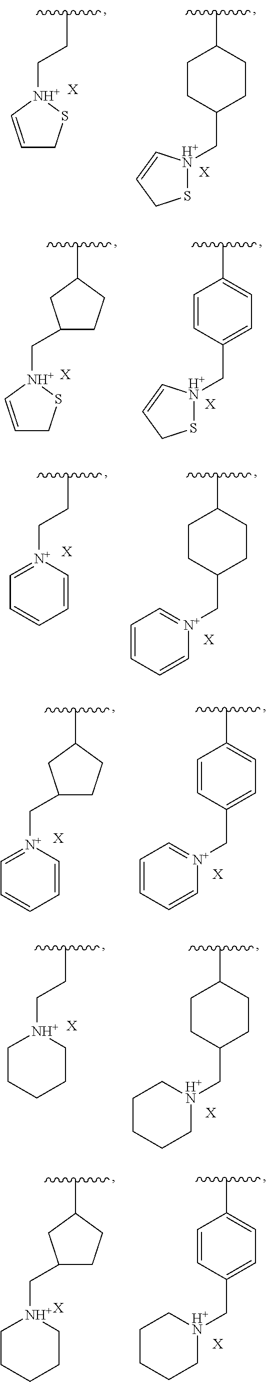

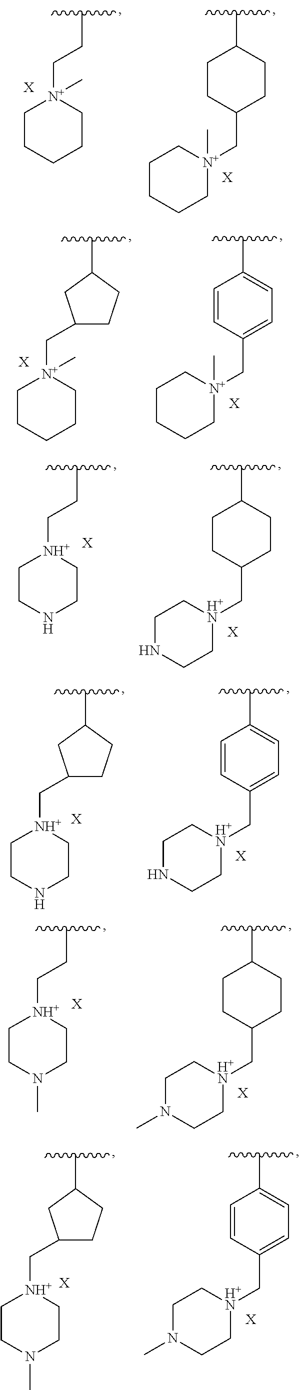

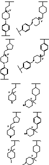

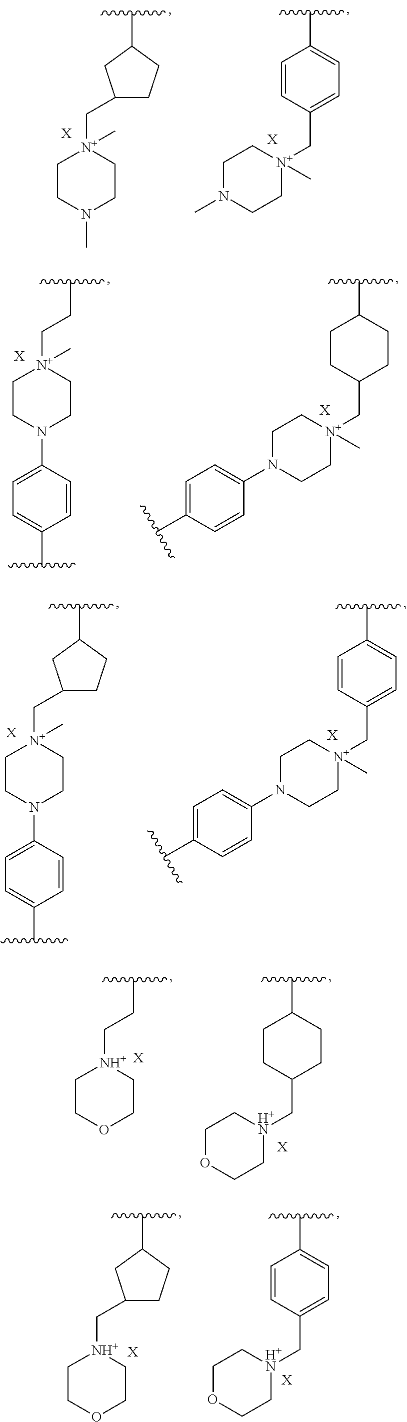

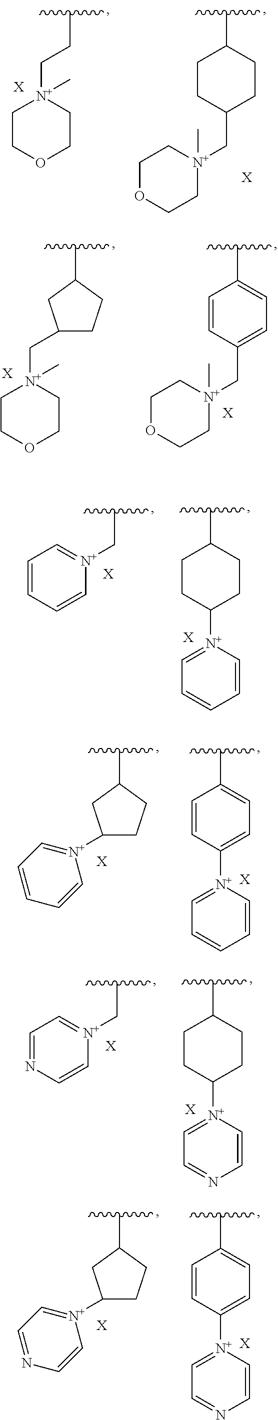

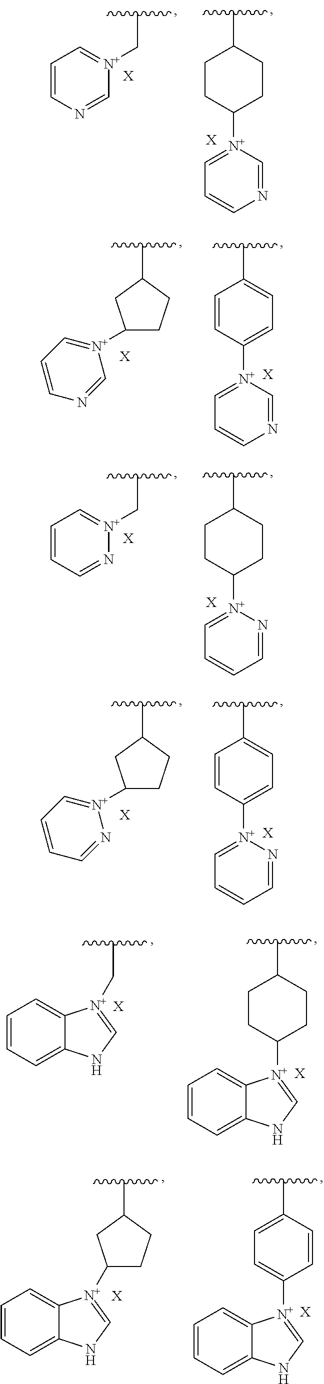

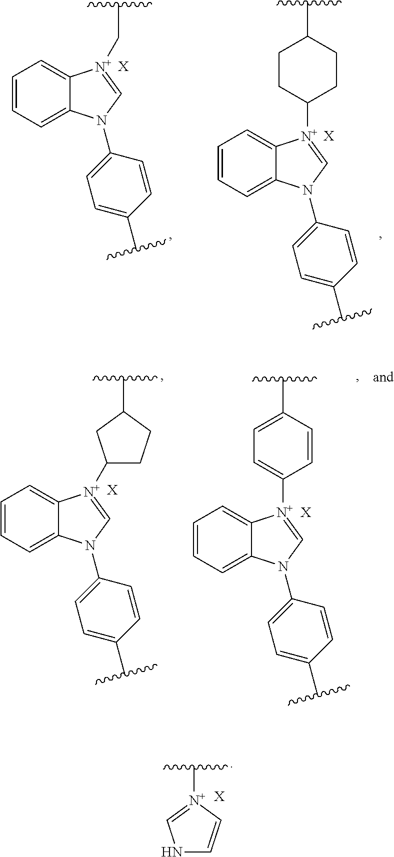

In other embodiments, each nitrogen-containing side chain can be independently selected from:

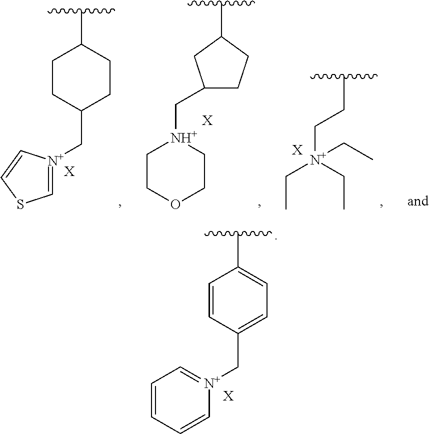

In other embodiments, each nitrogen-containing side chain can be independently selected from:

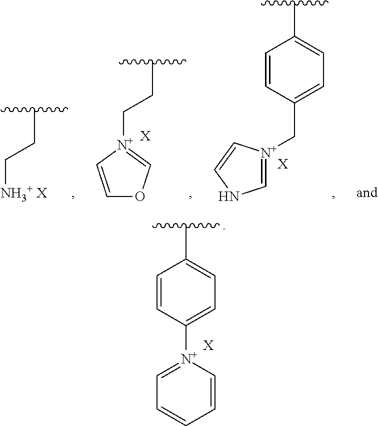

In other embodiments, each nitrogen-containing side chain can be independently selected from:

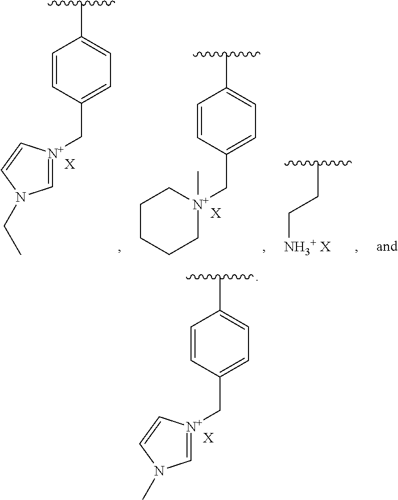

In other embodiments, each nitrogen-containing side chain can be independently selected from:

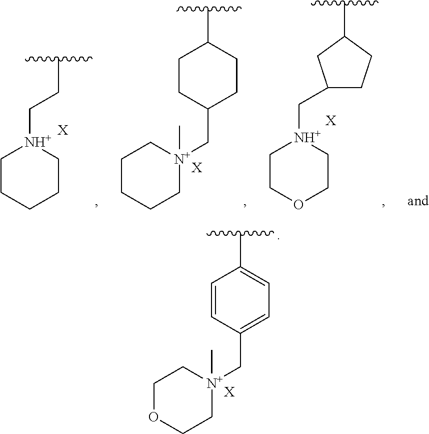

In other embodiments, each nitrogen-containing side chain can be independently selected from:

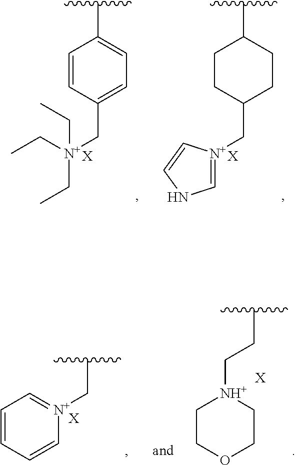

In other embodiments, each nitrogen-containing side chain can be independently selected from:

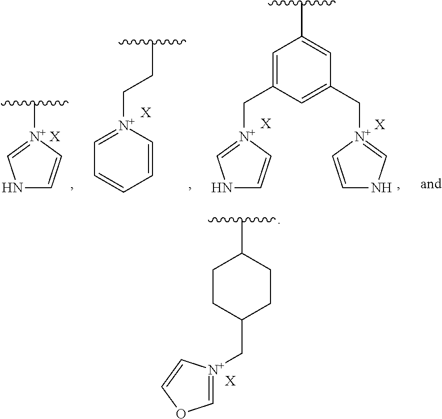

In other embodiments, the ionic monomers can have a side chain with a cationic group that is directly connected to the polymeric backbone. Side chains with a nitrogen-containing cationic group directly connected to the polymeric backbone can include, for example,

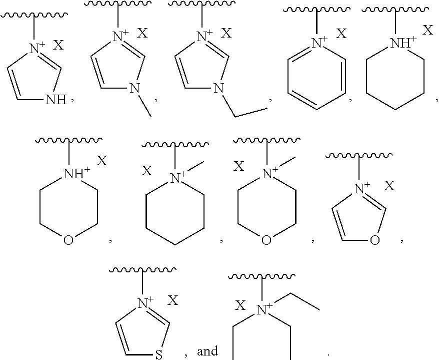

In some embodiments, the nitrogen-containing cationic group can be an N-oxide, where the negatively charged oxide (O−) is not readily dissociable from the nitrogen cation. Non-limiting examples of such groups include, for example,

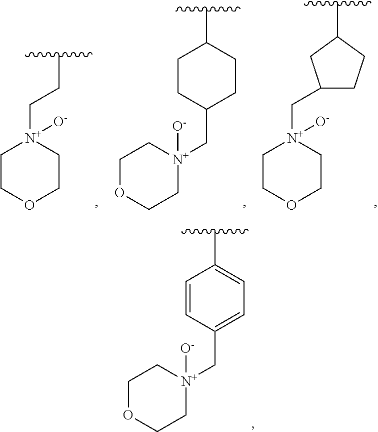 [SMILES: *CC[N+]1([O-])CCOCC1 ; *C1CCC(C[N+]2([O-])CCOCC2)CC1 ; *C1CCC(C[N+]2([O-])CCOCC2)C1 ; *c1ccc(C[N+]2([O-])CCOCC2)cc1]

In some embodiments, the phosphorous-containing cationic group and the linker can form a phosphorous-containing side chain, wherein each phosphorous-containing side chain can be independently selected from:

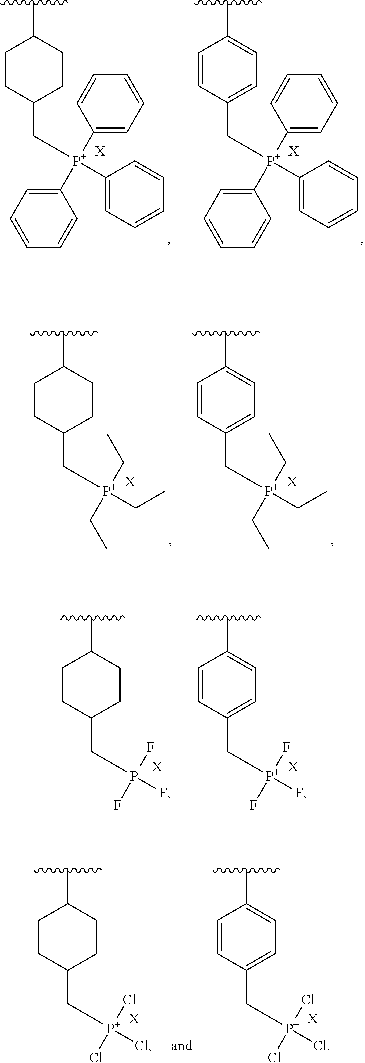

In other embodiments, each phosphorous-containing side chain can be independently selected from:

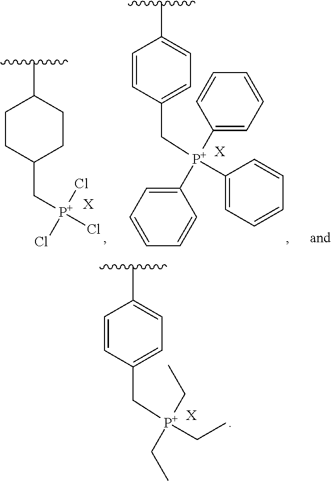

In other embodiments, each phosphorous-containing side chain can be independently selected from:

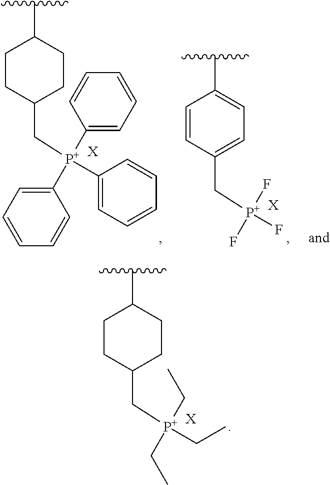

Side chains with a phosphorous-containing cationic group directly connected to the polymeric backbone can include, for example,

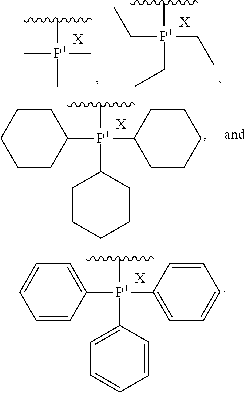

In some embodiments, the cationic group can coordinate with a Bronsted-Lowry acid in the polymeric catalyst. At least a portion of the Bronsted-Lowry acids and the cationic groups in the polymeric catalyst can form inter-monomer ionic associations. Inter-monomeric ionic associations result in salts forming between monomers in the polymeric catalyst as they associate with the cationic moiety. In some exemplary embodiments, the ratio of acidic monomers engaged in inter-monomer ionic associations to the total number of acidic monomers can be at most about 90% internally-coordinated, at most about 80% internally-coordinated, at most about 70% internally-coordinated, at most about 60% internally-coordinated, at most about 50% internally-coordinated, at most about 40% internally-coordinated, at most about 30% internally-coordinated, at most about 20% internally-coordinated, at most about 10% internally-coordinated, at most about 5% internally-coordinated, at most about 1% internally-coordinated, or less than about 1% internally-coordinated.

Some of the monomers in the polymeric catalyst contain both the Bronsted-Lowry acid and the cationic group in the same monomer. Such monomers are referred to as “acidic-ionic monomers”. In certain embodiments, the Bronsted-Lowry acid at each occurrence in the acidic-ionic monomer is independently selected from sulfonic acid, phosphonic acid, acetic acid, isophthalic acid, and boronic acid. In certain embodiments, the Bronsted-Lowry acid at each occurrence is independently sulfonic acid or phosphonic acid. In one embodiment, the Bronsted-Lowry acid at each occurrence is sulfonic acid.

In some embodiments, the nitrogen-containing cationic group at each occurrence in the acidic-ionic monomer is independently selected from pyrrolium, imidazolium, pyrazolium, oxazolium, thiazolium, pyridinium, pyrimidinium, pyrazinium, pyradizimium, thiazinium, morpholinium, piperidinium, piperizinium, and pyrollizinium. In one embodiment, the nitrogen-containing cationic group is imidazolium.

In some embodiments, the phosphorous-containing cationic group at each occurrence in the acidic-ionic monomer is independently selected from triphenyl phosphonium, trimethyl phosphonium, triethyl phosphonium, tripropyl phosphonium, tributyl phosphonium, trichloro phosphonium, and trifluoro phosphonium. In one embodiment, the phosphorous-containing cationic group is triphenyl phosphonium.

The ionic monomers may either all have the same cationic group, or may have different cationic groups. In some embodiments, each cationic group in the polymer is a nitrogen-containing cationic group. In other embodiments, each cationic group in the polymer is a phosphorous-containing cationic group. In yet other embodiments, the cationic group in some monomers of the polymer is a nitrogen-containing cationic group, whereas the cationic group in other monomers of the polymer is a phosphorous-containing cationic group. In an exemplary embodiment, each cationic group in the polymer is imidazolium. In another exemplary embodiment, the cationic group in some monomers of the polymer is imidazolium, while the cationic group in other monomers of the polymer is pyridinium. In yet another exemplary embodiment, each cationic group in the polymer is a substituted phosphonium. In yet another exemplary embodiment, the cationic group in some monomers of the polymer is triphenyl phosphonium, while the cationic group in other monomers of the polymer is imidazolium.

In exemplary embodiments, a side chain of an acidic-ionic monomer can contain imidazolium and acetic acid, or pyridinium and boronic acid. In some embodiments, the polymer can include at least one acidic-ionic monomer connected to the polymeric backbone, wherein at least one acidic-ionic monomer comprises at least one Bronsted-Lowry acid in conjugate base form having at least one associated cationic moiety, and at least one cationic group, and wherein at least one of the acidic-ionic monomers comprises a linker connecting the acidic-ionic monomer to the polymeric backbone. The cationic group can be a nitrogen-containing cationic group or a phosphorous-containing cationic group as described herein. The linker can be selected from unsubstituted or substituted alkylene, unsubstituted or substituted cycloalkylene, unsubstituted or substituted alkenylene, unsubstituted or substituted arylene, and unsubstituted or substituted heteroarylene, where the terms unsubstituted and substituted have the meanings as disclosed herein.

In certain embodiments, the linker is unsubstituted or substituted arylene, unsubstituted or substituted heteroarylene. In certain embodiments, the linker is unsubstituted or substituted arylene. In one embodiment, the linker is phenylene. In another embodiment, the linker is hydroxyl-substituted phenylene.

In some embodiments, the Bronsted-Lowry acid in conjugate base form having at least one associated cationic moiety, the cationic group and the linker form an acidic-ionic side chain, wherein each acidic-ionic side chain is independently selected from:

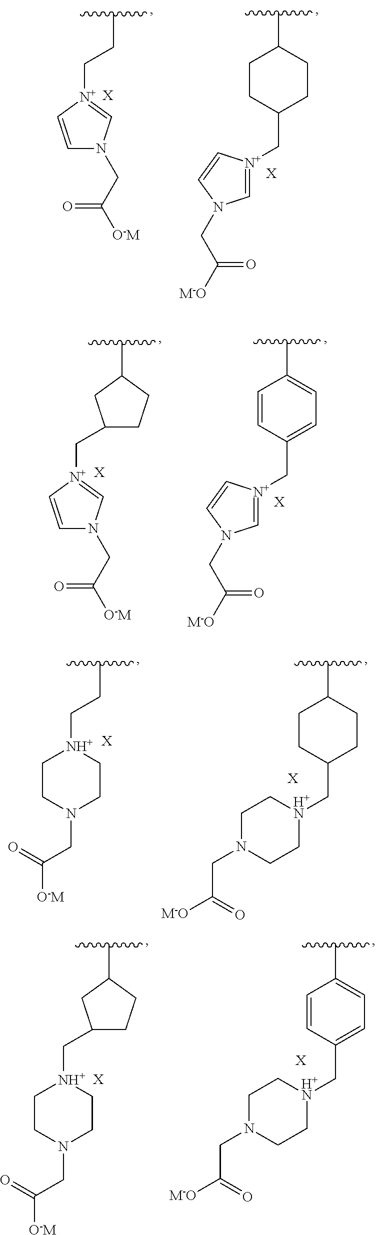

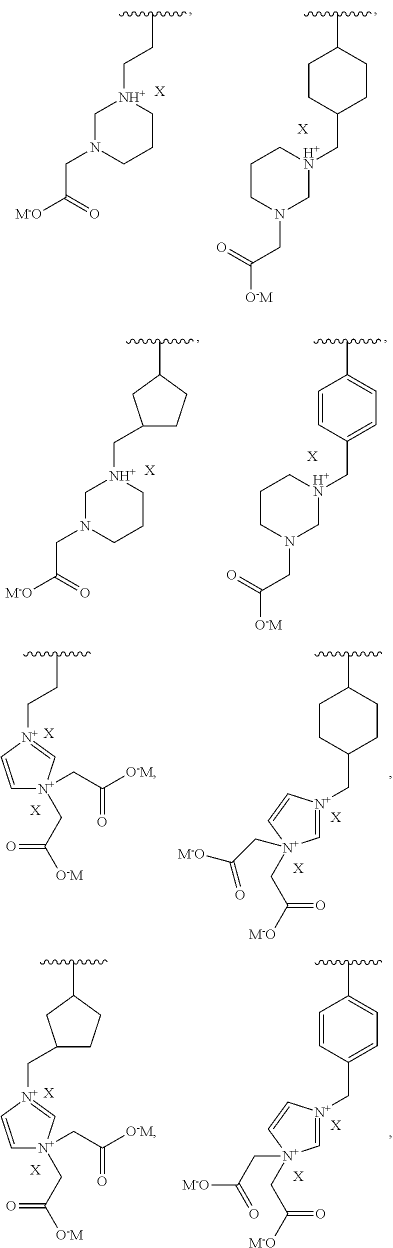

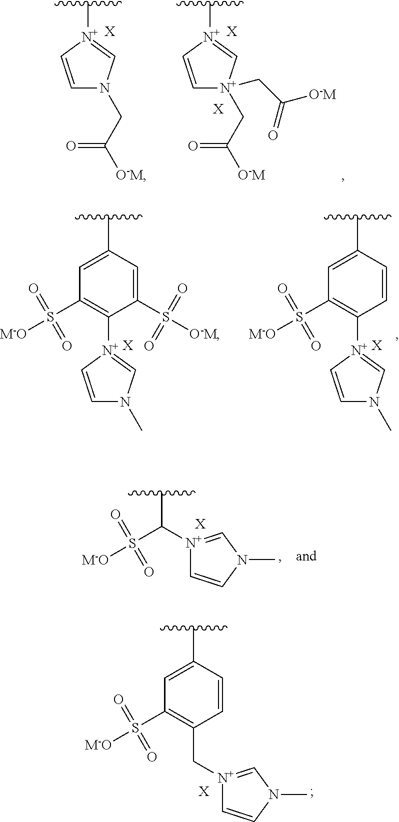

wherein each M is independently selected from Li⁺, Na⁺, K⁺, N(R¹)₄⁺, Zn²⁺, Mg²⁺, and Ca²⁺, where Zn²⁺, Mg²⁺ and Ca²⁺ are each independently associated with at least two cationic groups at any M position on any ionic monomer;

each R¹ is independently selected from hydrogen, alkyl, heteroalkyl, cycloalkyl, heterocyclyl, aryl, and heteroaryl;

each X is independently selected from F⁻, Cl⁻, Br⁻, I⁻, NO₂⁻, NO₃⁻, SO₄²⁻, R⁷SO₄⁻, R⁷CO₂⁻, PO₄²⁻, R⁷PO₃⁻, and R⁷PO₂⁻, where SO₄²⁻ and PO₄²⁻ are each independently associated with at least two Bronsted-Lowry acids in conjugate base form at any X position on any side chain, and

each R⁷ is independently selected from hydrogen, C₁₋₄alkyl, and C₁₋₄heteroalkyl.

In some embodiments, M can be selected from Na⁺, K⁺, N(R¹)₄⁺, Mg²⁺, and Ca²⁺. In other embodiments, M can be selected from Na⁺, Mg²⁺, and Ca²⁺. In certain embodiments, M is Mg²⁺ or Ca²⁺. In another embodiment, M is Zn²⁺.

In some embodiments, R¹ can be selected from hydrogen, alkyl, and heteroalkyl. In some embodiments, R¹ can be selected from hydrogen, methyl, or ethyl. In some embodiments, each X can be selected from Cl⁻, NO₃⁻, SO₄²⁻, R⁷SO₄⁻, and R⁷CO₂⁻, where R⁷ can be selected from hydrogen and C₁₋₄alkyl. In another embodiment, each X can be selected from Cl⁻, Br⁻, I⁻, HSO₄⁻, HCO₂⁻, CH₃CO₂⁻, and NO₃⁻. In other embodiments, X is acetate. In other embodiments, X is bisulfate. In other embodiments, X is chloride. In other embodiments, X is nitrate. In some embodiments, M is Zn²⁺, and X is Cl⁻.

In some embodiments, each acidic-ionic side chain can be independently selected from:

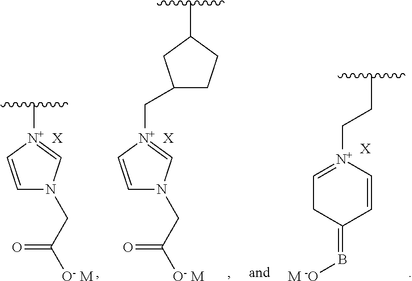

In some embodiments, each acidic-ionic side chain can be independently selected from:

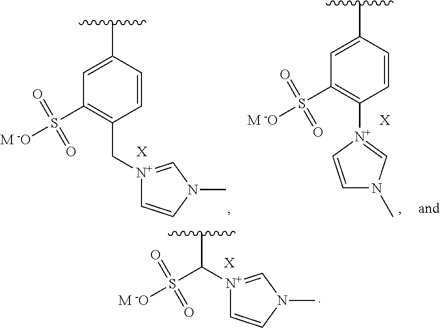

In some embodiments, some or all of the acidic monomers connected to the polymeric backbone by a linker can have the same linker, or independently have different linkers. Similarly, some or all of the ionic monomers connected to the polymeric backbone by a linker can have the same linker, or independently have different linkers. Further, some or all of the acidic monomers connected to the polymeric backbone by a linker can have the same or different linkers as some or all of the ionic monomers connected to the polymeric backbone by a linker. In other embodiments, the monomers can have a side chain containing both a Bronsted-Lowry acid and a cationic group, where the Bronsted-Lowry acid is directly connected to the polymeric backbone, the cationic group is directly connected to the polymeric backbone, or both the Bronsted-Lowry acid and the cationic group are directly connected to the polymeric backbone.

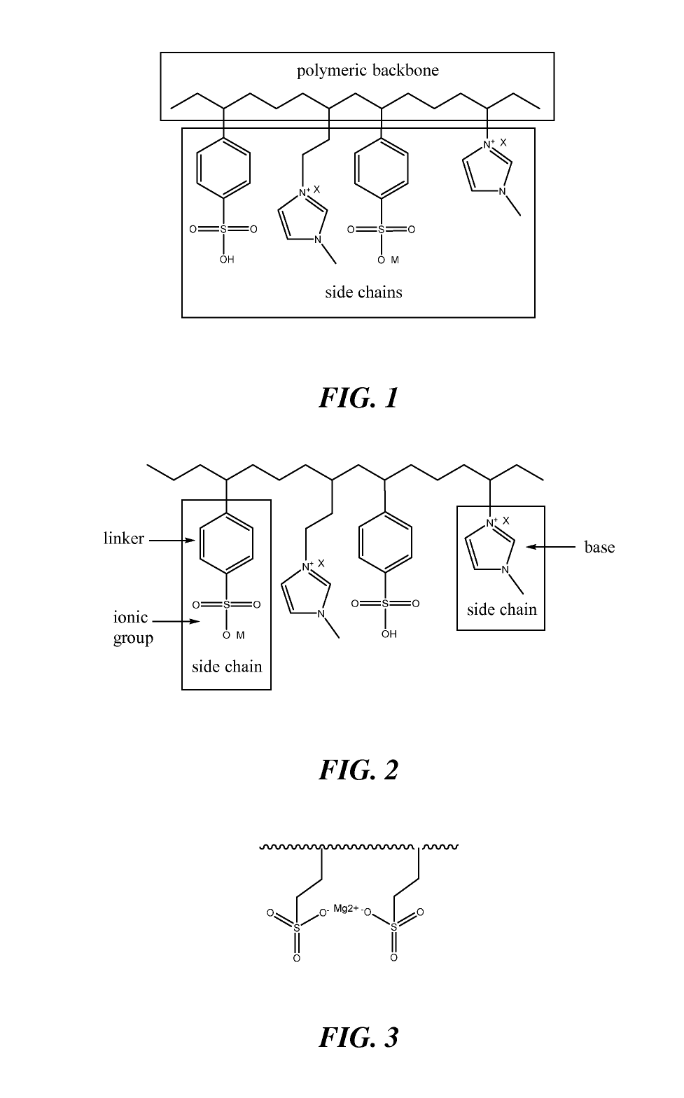

Some of the acidic and ionic monomers can also include a linker that connects the Bronsted-Lowry acid and cationic group, respectively, to the polymeric backbone. For the acidic monomers, the Bronsted-Lowry acid and the linker together form a side chain. Similarly, for the ionic monomers, the cationic group and the linker together form a side chain. With reference to the portion of the exemplary polymeric catalyst depicted in FIG. 1, the side chains are pendant from the polymeric backbone.

With reference to the portion of an exemplary polymeric catalyst depicted in FIG. 2, the Bronsted-Lowry acid and the cationic group in the side chains of the monomers can be directly connected to the polymeric backbone or connected to the polymeric backbone by a linker.

In some embodiments, the linker can be independently selected from unsubstituted or substituted alkylene, unsubstituted or substituted cycloalkylene, unsubstituted or substituted alkenylene, unsubstituted or substituted arylene, and unsubstituted or substituted heteroarylene, where the terms unsubstituted and substituted have the meanings as disclosed herein. In certain embodiments, the linker is unsubstituted or substituted arylene, unsubstituted or substituted heteroarylene. In certain embodiments, the linker is unsubstituted or substituted arylene. In one embodiment, the linker is phenylene. In another embodiment, the linker is hydroxyl-substituted phenylene. The term “substituted” is as defined above and also includes all substituents disclosed for any particular genus, e.g., those described for “alkyl” apply to “alkylene”. One of ordinary skill in the art would readily appreciate that adding an “ene” suffix to a chemical genus term indicates that the genus term, such as alkyl, is connected to a parent molecular entity, such as the polymeric backbone.

The polymeric catalyst described herein can further include monomers having a side chain containing a non-functional group, such as a hydrophobic group. In some embodiments, the hydrophobic group can be connected directly to the polymeric backbone. Suitable hydrophobic groups can include, for example, unsubstituted or substituted alkyl, unsubstituted or substituted cycloalkyl, unsubstituted or substituted aryl, and unsubstituted or substituted heteroaryl, where the terms unsubstituted and substituted have the meanings as disclosed herein. In some embodiments, the hydrophobic group can be unsubstituted or substituted C5 or C6 aryl. In certain embodiments, the hydrophobic group can be unsubstituted or substituted phenyl. In one exemplary embodiment, the hydrophobic group can be unsubstituted phenyl. Further, it should be understood that the hydrophobic monomers can either all have the same hydrophobic group, or can have different hydrophobic groups. In some embodiments, the hydrophobic group is directly connected to the polymeric backbone.

In some embodiments, the polymeric backbone is formed from one or more substituted or unsubstituted monomers. Polymerization processes using a wide variety of monomers are well known in the art (see, e.g., International Union of Pure and Applied Chemistry, et al., IUPAC Gold Book, Polymerization. (2000)). One such process involves monomer(s) with unsaturated substitution, such as vinyl, propenyl, butenyl, or other such substituent(s). These types of monomers can undergo radical initiation and chain polymerization.

In other embodiments, monomers having heteroatoms can be combined with one or more difunctionalized compounds, such as, but not limited to, dihaloalkanes, di(alkylsulfonyloxy)alkanes, and di(arylsulfonyloxy)alkanes to form polymers. The monomers have at least two heteroatoms to link with the difunctionalized alkane to create the polymeric chain. These difunctionalized compounds can be further substituted as described herein. In some embodiments, the difunctionalized compound(s) can be selected from 1,2-dichloroethane, 1,2-dichloropropane, 1,3-dichloropropane, 1,2-dichlorobutane, 1,3-dichlorobutane, 1,4-dichlorobutane, 1,2-dichloropentane, 1,3-dichloropentane, 1,4-dichloropentane, 1,5-dichloropentane, 1,2-dibromoethane, 1,2-dibromopropane, 1,3-dibromopropane, 1,2-dibromobutane, 1,3-dibromobutane, 1,4-dibromobutane, 1,2-dibromopentane, 1,3-dibromopentane, 1,4-dibromopentane, 1,5-dibromopentane, 1,2-diiodoethane, 1,2-diiodopropane, 1,3-diiodopropane, 1,2-diiodobutane, 1,3-diiodobutane, 1,4-diiodobutane, 1,2-diiodopentane, 1,3-diiodopentane, 1,4-diiodopentane, 1,5-diiodopentane, 1,2-dimethanesulfoxyethane, 1,2-dimethanesulfoxypropane, 1,3-dimethanesulfoxypropane, 1,2-dimethanesulfoxybutane, 1,3-dimethanesulfoxybutane, 1,4-dimethanesulfoxybutane, 1,2-dimethanesulfoxypentane, 1,3-dimethanesulfoxypentane, 1,4-dimethanesulfoxypentane, 1,5-dimethanesulfoxypentane, 1,2-diethanesulfoxyethane, 1,2-diethanesulfoxypropane, 1,3-diethanesulfoxypropane, 1,2-diethanesulfoxybutane, 1,3-diethanesulfoxybutane, 1,4-diethanesulfoxybutane, 1,2-diethanesulfoxypentane, 1,3-diethanesulfoxypentane, 1,4-diethanesulfoxypentane, 1,5-diethanesulfoxypentane, 1,2-dibenzenesulfoxyethane, 1,2-dibenzenesulfoxypropane, 1,3-dibenzenesulfoxypropane, 1,2-dibenzenesulfoxybutane, 1,3-dibenzenesulfoxybutane, 1,4-dibenzenesulfoxybutane, 1,2-dibenzenesulfoxypentane, 1,3-dibenzenesulfoxypentane, 1,4-dibenzenesulfoxypentane, 1,5-dibenzenesulfoxypentane, 1,2-di-p-toluenesulfoxyethane, 1,2-di-p-toluenesulfoxypropane, 1,3-di-p-toluenesulfoxypropane, 1,2-di-p-toluenesulfoxybutane, 1,3-di-p-toluenesulfoxybutane, 1,4-di-p-toluenesulfoxybutane, 1,2-di-p-toluenesulfoxypentane, 1,3-di-p-toluene sulfoxypentane, 1,4-di-p-toluene sulfoxypentane, and 1,5-di-p-toluene sulfoxypentane.

In some embodiments, the polymeric backbone comprises two or more substituted or unsubstituted monomers, wherein the monomers are each independently formed from one or more moieties selected from ethylene, propylene, hydroxyethylene, acetaldehyde, styrene, divinyl benzene, isocyanates, vinyl chloride, vinyl phenols, tetrafluoroethylene, butylene, terephthalic acid, caprolactam, acrylonitrile, butadiene, ammonias, diammonias, pyrrole, imidazole, pyrazole, oxazole, thiazole, pyridine, pyrimidine, pyrazine, pyradizimine, thiazine, morpholine, piperidine, piperizines, pyrollizine, triphenylphosphonate, trimethylphosphonate, triethylphosphonate, tripropylphosphonate, tributylphosphonate, trichlorophosphonate, trifluorophosphonate, and diazole, where the terms unsubstituted and substituted have the meanings as disclosed herein.

In some embodiments, the acidic monomers, the ionic monomers, the acidic-ionic monomers and the hydrophobic monomers, where present, can be arranged in alternating sequence or in a random order as blocks of monomers. In some embodiments, each block has not more than twenty, fifteen, ten, six, or three monomers.

The polymers disclosed herein have Bronsted-Lowry acidic group in conjugate base form having at least one associated cationic moiety. In some embodiments, the cationic moiety is monovalent, while in others, the cationic moiety is divalent. In the case of divalent cations, such as, but not limited to Mg²⁺ and Ca²⁺, the cation is associated with two conjugate bases, as depicted in FIG. 3. The two conjugate bases can be on the same polymer or associate between 2 different polymer strands.

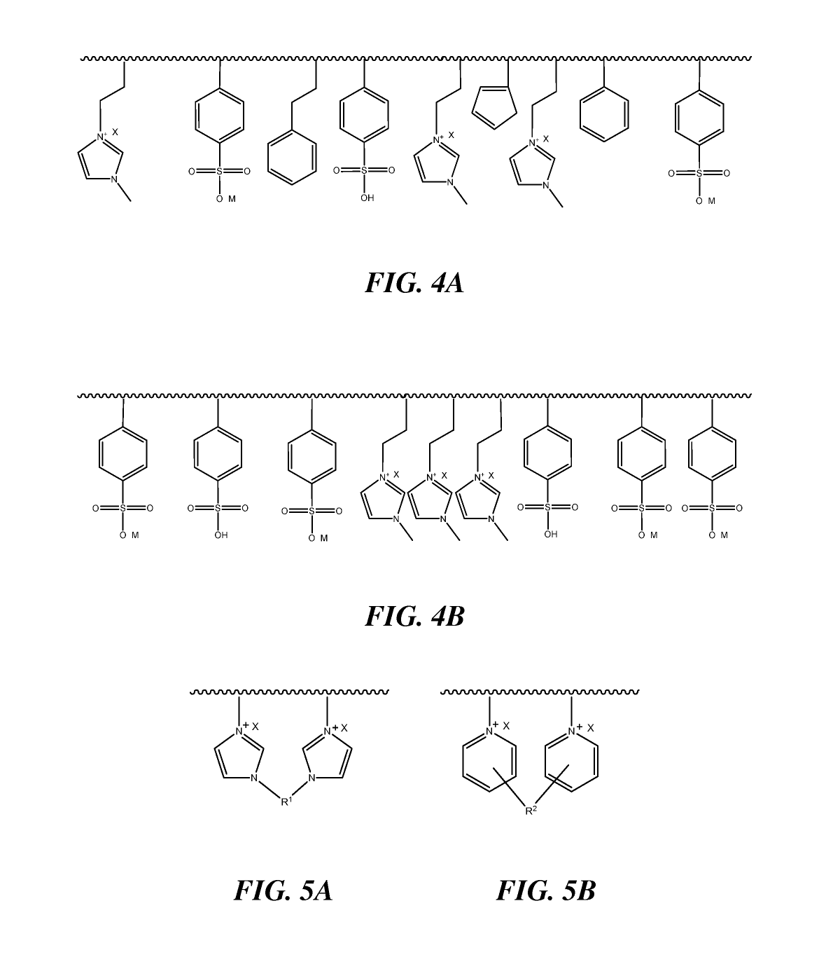

In some embodiments, the polymeric catalyst can be randomly arranged in an alternating sequence. With reference to the portion of the exemplary polymeric catalyst depicted in FIG. 4, the monomers are randomly arranged in an alternating sequence.

In other embodiments, the polymeric catalyst can be randomly arranged as blocks of monomers. With reference to the portion of the exemplary polymeric catalyst depicted in FIG. 4B, the monomers are arranged in blocks of monomers. In certain embodiments where the acidic monomers and the ionic monomers are arranged in blocks of monomers, each block has no more than 20, 19, 18, 17, 16, 15, 14, 13, 12, 11, 10, 9, 8, 7, 6, 5, 4, or 3 monomers.

The polymeric catalysts described herein can also be cross-linked. Such cross-linked polymers can be prepared by introducing cross-linking groups. In some embodiments, cross-linking can occur within a given polymeric chain, with reference to the portion of the exemplary polymeric catalysts depicted in FIGS. 5A and 5B. In other embodiments, cross-linking can occur between two or more polymeric chains, as depicted in FIGS. 6A, and 6B.

Suitable cross-linking groups that can be used to form a cross-linked polymer with the polymers described herein include, for example, substituted or unsubstituted divinyl alkanes, substituted or unsubstituted divinyl cycloalkanes, substituted or unsubstituted divinyl aryls, substituted or unsubstituted heteroaryls, dihaloalkanes, dihaloalkenes, and dihaloalkynes, where the terms unsubstituted and substituted have the meanings as disclosed herein. For example, cross-linking groups can include divinylbenzene, diallylbenzene, dichlorobenzene, divinylmethane, dichloromethane, divinylethane, dichloroethane, divinylpropane, dichloropropane, divinylbutane, dichlorobutane, ethylene glycol, and resorcinol. In one embodiment, the crosslinking group is divinyl benzene.

In some embodiments, the polymer is cross-linked. In certain embodiments, at least about 1%, at least about 2%, at least about 3%, at least about 4%, at least about 5%, at least about 6%, at least about 7%, at least about 8%, at least about 9%, at least about 10%, at least about 15%, at least about 20%, at least about 30%, at least about 40%, at least about 50%, at least about 60%, at least about 70%, at least about 80%, at least about 90% or at least about 99% of the polymer is cross-linked.

In some embodiments, the polymers described herein are not substantially cross-linked, such as less than about 0.9% cross-linked, less than about 0.5% cross-linked, less than about 0.1% cross-linked, less than about 0.01% cross-linked, or less than 0.001% cross-linked.

The polymeric backbone described herein can include, for example, polyalkylenes, polyalkenyl alcohols, polycarbonate, polyarylenes, polyaryletherketones, and polyamide-imides. In certain embodiments, the polymeric backbone can be selected from polyethylene, polypropylene, polyvinyl alcohol, polystyrene, polyurethane, polyvinyl chloride, polyphenol-aldehyde, polytetrafluoroethylene, polybutylene terephthalate, polycaprolactam, and poly(acrylonitrile butadiene styrene).

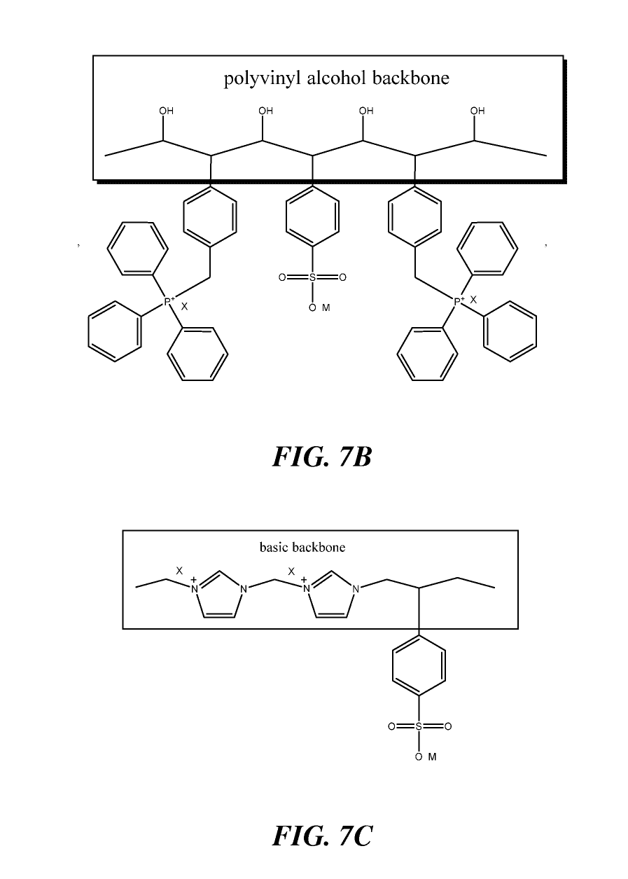

With reference to FIG. 7A, in one exemplary embodiment, the polymeric backbone is polyethylene. With reference to FIG. 7B, in another exemplary embodiment, the polymeric backbone is polyvinyl alcohol.

The polymeric backbone described herein can also include an ionic group integrated as part of the polymeric backbone. Such polymeric backbones can also be called “ionomeric backbones”. In certain embodiments, the polymeric backbone can be selected from polyalkyleneammonium, polyalkylenediammonium, polyalkylenepyrrolium, polyalkyleneimidazolium, polyalkylenepyrazolium, polyalkyleneoxazolium, polyalkylenethiazolium, polyalkylenepyridinium, polyalkylenepyrimidinium, polyalkylenepyrazinium, polyalkylenepyradizimium, polyalkylenethiazinium, polyalkylenemorpholinium, polyalkylenepiperidinium, polyalkylenepiperizinium, polyalkylenepyrollizinium, polyalkylenetriphenylphosphonium, polyalkylenetrimethylphosphonium, polyalkylenetriethylphosphonium, polyalkylenetripropylphosphonium, polyalkylenetributylphosphonium, polyalkylenetrichlorophosphonium, polyalkylenetrifluorophosphonium, and polyalkylenediazolium, polyarylalkyleneammonium, polyarylalkylenediammonium, polyarylalkylenepyrrolium, polyarylalkyleneimidazolium, polyarylalkylenepyrazolium, polyarylalkyleneoxazolium, polyarylalkylenethiazolium, polyarylalkylenepyridinium, polyarylalkylenepyrimidinium, polyarylalkylenepyrazinium, polyarylalkylenepyradizimium, polyarylalkylenethiazinium, polyarylalkylenemorpholinium, polyarylalkylenepiperidinium, polyarylalkylenepiperizinium, polyarylalkylenepyrollizinium, polyarylalkylenetriphenylphosphonium, polyarylalkylenetrimethylphosphonium, polyarylalkylenetriethylphosphonium, polyarylalkylenetripropylphosphonium, polyarylalkylenetributylphosphonium, polyarylalkylenetrichlorophosphonium, polyarylalkylenetrifluorophosphonium, and polyarylalkylenediazolium.

Cationic polymeric backbones can be associated with one or more anions, including but not limited to, F⁻, Cl⁻, Br⁻, I⁻, NO₂⁻, NO₃⁻, SO₄²⁻, R⁷SO₄⁻, R⁷CO₂⁻, PO₄²⁻, R⁷PO₃⁻, and R⁷PO₂⁻, where R⁷ is selected from hydrogen, C₁₋₄alkyl, and C₁₋₄heteroalkyl. In one embodiment, each X can be selected from Cl⁻, Br⁻, I⁻, HSO₄⁻, HCO₂⁻, CH₃CO₂⁻, and NO₃⁻. In other embodiments, X is acetate. In other embodiments, X is bisulfate. In other embodiments, X is chloride. In other embodiments, X is nitrate.

In some embodiments, the polymeric backbone is selected from polyethylene, polypropylene, polyvinyl alcohol, polystyrene, polyurethane, polyvinyl chloride, polyphenol-aldehyde, polytetrafluoroethylene, polybutylene terephthalate, polycaprolactam, and poly(acrylonitrile butadiene styrene). In certain embodiments, the polymeric backbone is polyethyelene or polypropylene. In one embodiment, the polymeric backbone is polyethylene. In another, the polymeric backbone is polyvinyl alcohol. In yet another embodiment, the polymeric backbone is polystyrene.

With reference to FIG. 7C, in yet another exemplary embodiment, the polymeric backbone is a polyalkyleneimidazolium.

In other embodiments, the polymeric backbone is alkyleneimidazolium, which refers to an alkylene moiety, in which one or more of the methylene units of the alkylene moiety has been replaced with imidazolium. In one embodiment, the polymeric backbone is selected from polyethyleneimidazolium, polyprolyeneimidazolium, and polybutyleneimidazolium. It should further be understood that, in other embodiments of the polymeric backbone, when a nitrogen-containing cationic group or a phosphorous-containing cationic group follows the term “alkylene”, one or more of the methylene units of the alkylene moiety is substituted with that particular nitrogen-containing cationic group or phosphorous-containing cationic group.

Further, the number of atoms between side chains in the polymeric backbone can vary. In some embodiments, there are between zero and twenty atoms, zero and ten atoms, zero and six atoms, or zero and three atoms between side chains attached to the polymeric backbone.

In some embodiments, the polymer can be a homopolymer having at least two monomer units, and where all the units contained within the polymer are derived from the same monomer in the same manner. In other embodiments, the polymer can be a heteropolymer having at least two monomer units, and where at least one monomeric unit contained within the polymer that differs from the other monomeric units in the polymer. The different monomer units in the polymer can be in a random order, in an alternating sequence of any length of a given monomer, or in blocks of monomers.

Other exemplary polymers include, but are not limited to, polyalkylene backbones that are substituted with one or more groups selected from hydroxyl, carboxylic acid, unsubstituted and substituted phenyl, halides, unsubstituted and substituted amines, unsubstituted and substituted ammonias, unsubstituted and substituted pyrroles, unsubstituted and substituted imidazoles, unsubstituted and substituted pyrazoles, unsubstituted and substituted oxazoles, unsubstituted and substituted thiazoles, unsubstituted and substituted pyridines, unsubstituted and substituted pyrimidines, unsubstituted and substituted pyrazines, unsubstituted and substituted pyradizines, unsubstituted and substituted thiazines, unsubstituted and substituted morpholines, unsubstituted and substituted piperidines, unsubstituted and substituted piperizines, unsubstituted and substituted pyrollizines, unsubstituted and substituted triphenylphosphonates, unsubstituted and substituted trimethylphosphonates, unsubstituted and substituted triethylphosphonates, unsubstituted and substituted tripropylphosphonates, unsubstituted and substituted tributylphosphonates, unsubstituted and substituted trichlorophosphonates, unsubstituted and substituted trifluorophosphonates, and unsubstituted and substituted diazoles, where the terms unsubstituted and substituted have the meanings as disclosed herein.

For the polymers as described herein, multiple naming conventions are well recognized in the art. For instance, a polyethylene backbone with a direct bond to an unsubstituted phenyl group (—CH₂—CH(phenyl)-CH₂—CH(phenyl)-) is also known as polystyrene. Should that phenyl group be substituted with an ethenyl group, the polymer can be named a polydivinylbenzene (—CH₂—CH(4-vinylphenyl)-CH₂—CH(4-vinylphenyl)-). Further non-limiting examples of heteropolymers include those that are functionalized after polymerization.

A non-limiting example would be polystyrene-co-divinylbenzene: (—CH₂—CH(phenyl)-CH₂—CH(4-ethylenephenyl)-CH₂—CH(phenyl)-CH₂—CH(4-ethylenephenyl)-). Here, the ethenyl functionality could be at the 2, 3, or 4 position on the phenyl ring.

In some embodiments, a linker exists between the polyalkylene backbone and the substituent groups that can be independently selected from unsubstituted or substituted alkylene, unsubstituted or substituted cycloalkylene, unsubstituted or substituted arylalkylene unsubstituted or substituted alkenylene, unsubstituted or substituted arylene, and unsubstituted or substituted heteroarylene, where the terms unsubstituted and substituted have the meanings as disclosed herein.

In some embodiments, the acidic and ionic monomers make up a substantial portion of the polymeric catalyst. In certain embodiments, the acidic and ionic monomers make up at least about 30%, at least about 40%, at least about 50%, at least about 60%, at least about 70%, at least about 80%, at least about 90%, at least about 95%, or at least about 99% of the monomers of the polymer, based on the ratio of the number of acidic and ionic monomers to the total number of monomers present in the polymeric catalyst.

The ratio of the total number of acidic monomers to the total number of ionic monomers can be varied to tune the strength of the polymeric catalyst. In some embodiments, the total number of acidic monomers exceeds the total number of ionic monomers in the polymeric catalyst. In other embodiments, the total number of acidic monomers can be at least about 2, at least about 3, at least about 4, at least about 5, at least about 6, at least about 7, at least about 8, at least about 9 or at least about 10 times the total number of ionic monomers in the polymeric catalyst. In certain embodiments, the ratio of the total number of acidic monomers to the total number of ionic monomers can be about 1:1, about 2:1, about 3:1, about 4:1, about 5:1, about 6:1, about 7:1, about 8:1, about 9:1 or about 10:1.

In some embodiments, the total number of ionic monomers exceeds the total number of acidic monomers in the polymeric catalyst. In other embodiments, the total number of ionic monomers can be at least about 2, at least about 3, at least about 4, at least about 5, at least about 6, at least about 7, at least about 8, at least about 9 or at least about 10 times the total number of acidic monomers in the polymeric catalyst. In certain embodiments, the ratio of the total number of ionic monomers to the total number of acidic monomers can be about 1:1, about 2:1, about 3:1, about 4:1, about 5:1, about 6:1, about 7:1, about 8:1, about 9:1 or about 10:1.

The polymeric catalysts described herein can be characterized by the chemical functionalization of the polymeric catalyst. In some embodiments, the polymeric catalyst can have between about 0.1 and about 20 mmol, between about 0.1 and about 15 mmol, between about 0.01 and about 12 mmol, between about 0.01 and about 10 mmol, between about 1 and about 8 mmol, between about 2 and about 7 mmol, between about 3 and about 6 mmol, between about 1 and about 5, or between about 3 and about 5 mmol of the Bronsted-Lowry acid per gram of the polymeric catalyst. In some embodiments where the polymeric catalyst has at least some monomers with side chains having sulfonic acid as the Bronsted-Lowry acid, the polymeric catalyst can have between about 0.05 to about 10 mmol of the sulfonic acid per gram of the polymeric catalyst. In other embodiments where the polymeric catalyst has at least some monomers with side chains having phosphonic acid as the Bronsted-Lowry acid, the polymeric catalyst can have between about 0.01 and about 12 mmol of the phosphonic acid per gram of the polymeric catalyst. In other embodiments where the polymeric catalyst has at least some monomers with side chains having acetic acid as the Bronsted-Lowry acid, the polymeric catalyst can have between about 0.01 and about 12 mmol of the carboxylic acid per gram of the polymeric catalyst. In other embodiments where the polymeric catalyst has at least some monomers with side chains having isophthalic acid as the Bronsted-Lowry acid, the polymeric catalyst can have between about 0.01 and about 5 mmol of the isophthalic acid per gram of the polymeric catalyst. In other embodiments where the polymeric catalyst has at least some monomers with side chains having boronic acid as the Bronsted-Lowry acid, the polymeric catalyst can have between about 0.01 and about 20 mmol of the boronic acid per gram of the polymeric catalyst. In other embodiments where the polymeric catalyst has at least some monomers with side chains having a perfluorinated acid, such as trifluoroacetic acid, as the Bronsted-Lowry acid, the polymeric catalyst can have between about 0.01 and about 5 mmol of the perfluorinated acid per gram of the polymeric catalyst.

In some embodiments, each ionic monomer further includes a counterion for each nitrogen-containing cationic group or phosphorous-containing cationic group. In certain embodiments, the counterion at each occurence is independently selected from halide, nitrate, sulfate, formate, acetate, or organosulfonate. In some embodiments, the counterion is fluoride, chloride, bromide, or iodide. In one embodiment, the counterion is chloride. In another embodiment, the counterion is sulfate. In yet another embodiment, the counterion is acetate.

In some embodiments, the counterion is derived from acids selected from hydrofluoric acid, hydrochloric acid, hydrobromic acid, hydroioidic acid, nitric acid, nitrous acid, sulfuric acid, carbonic acid, phosphoric acid, phosphorous acid, acetic acid, formic acid, citric acid, methanesulfonic acid, ethanesulfonic acid, benzenesulfonic acid, dodecylsulfonic acid, and benzene phosphonic acid.

In some embodiments, the polymeric catalyst can have between about 0.01 and about 10 mmol, between about 0.01 and about 8.0 mmol, between about 0.01 and about 4 mmol, between about 1 and about 10 mmol, between about 2 and about 8 mmol, or between about 3 and about 6 mmol of the ionic group. In such embodiments, the ionic group includes the cationic group listed, as well as any suitable counterion described herein (e.g., halide, nitrate, sulfate, formate, acetate, or organosulfonate).

In some embodiments, the polymer has a total amount of nitrogen-containing cationic groups and counterions or a total amount of phosphorous-containing cationic groups and counterions of between about 0.01 and about 10 mmol, between about 0.05 and about 10 mmol, between about 1 and about 8 mmol, between about 2 and about 6 mmol, or between about 3 and about 5 mmol per gram of polymer.

In some embodiments where the polymeric catalyst has at least some monomers with side chains having imidazolium as part of the ionic group, the polymeric catalyst can have between about 0.01 and about 8 mmol of the ionic group per gram of the polymeric catalyst. In other embodiments where the polymeric catalyst has at least some monomers with side chains having pyridinium as part of the ionic group, the polymeric catalyst can have between about 0.01 and about 8 mmol of the ionic group per gram of the polymeric catalyst.

In other embodiments where the polymeric catalyst has at least some monomers with side chains having triphenyl phosphonium as part of the ionic group, the polymeric catalyst can have between about 0.01 and about 4 mmol of the ionic group per gram of the polymeric catalyst.

It should be understood that the polymeric catalyst can include any of the Bronsted-Lowry acids, cationic groups, counterions, linkers, hydrophobic groups, cross-linking groups, and polymeric backbones described herein, as if each and every combination were listed separately. For example, in one embodiment, the polymeric catalyst can include benzenesulfonic acid (i.e., a sulfonic acid with a phenyl linker) connected to a polystyrene backbone, and an imidazolium chloride connected directly to the polystyrene backbone. In another embodiment, the polymeric catalyst can include boronyl-benzyl-pyridinium chloride (i.e., a boronic acid and pyridinium chloride in the same monomer unit with a phenyl linker) connected to a polystyrene backbone. In yet another embodiment, the polymeric catalyst can include benzenesulfonic acid and an imidazolium sulfate moiety each individually connected to a polyvinyl alcohol backbone.

Exemplary polymeric catalysts described herein include:
poly[styrene-co-4-vinylbenzeneR⁸ sulfonate-co-3-methyl-1-(4-vinylbenzyl)-3H-imidazol-1-ium chloride-co-divinylbenzene];
poly[styrene-co-4-vinylbenzeneR⁸ sulfonate-co-3-methyl-1-(4-vinylbenzyl)-3H-imidazol-1-ium bisulfate-co-divinylbenzene];
poly[styrene-co-4-vinylbenzeneR⁸ sulfonate-co-3-methyl-1-(4-vinylbenzyl)-3H-imidazol-1-ium acetate-co-divinylbenzene];
poly[styrene-co-4-vinylbenzeneR⁸ sulfonate-co-3-methyl-1-(4-vinylbenzyl)-3H-imidazol-1-ium nitrate-co-divinylbenzene];
poly[styrene-co-4-vinylbenzeneR⁸ sulfonate-co-3-ethyl-1-(4-vinylbenzyl)-3H-imidazol-1-ium chloride-co-divinylbenzene];
poly[styrene-co-4-vinylbenzeneR⁸ sulfonate-co-3-ethyl-1-(4-vinylbenzyl)-3H-imidazol-1-ium bisulfate-co-divinylbenzene];
poly[styrene-co-4-vinylbenzeneR⁸ sulfonate-co-3-ethyl-1-(4-vinylbenzyl)-3H-imidazol-1-ium acetate-co-divinylbenzene];
poly[styrene-co-4-vinylbenzeneR⁸ sulfonate-co-3-ethyl-1-(4-vinylbenzyl)-3H-imidazol-1-ium nitrate-co-divinylbenzene];
poly[styrene-co-4-vinylbenzeneR⁸ sulfonate-co-1-(4-vinylbenzyl)-3H-imidazol-1-ium chloride-co-divinylbenzene];
poly[styrene-co-4-vinylbenzeneR⁸ sulfonated-co-1-(4-vinylbenzyl)-3H-imidazol-1-ium iodide-co-divinylbenzene];
poly[styrene-co-4-vinylbenzeneR⁸ sulfonate-co-1-(4-vinylbenzyl)-3H-imidazol-1-ium bromide-co-divinylbenzene];
poly[styrene-co-4-vinylbenzeneR⁸ sulfonate-co-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-3H-imidazol-1-ium acetate-co-divinylbenzene];
poly[styrene-co-4-vinylbenzeneR⁸ sulfonate-co-3-methyl-1-(4-vinylbenzyl)-3H-benzoimidazol-1-ium chloride-co-divinylbenzene];
poly[styrene-co-4-vinylbenzeneR⁸ sulfonate-co-3-methyl-1-(4-vinylbenzyl)-3H-benzoimidazol-1-ium bisulfate-co-divinylbenzene];
poly[styrene-co-4-vinylbenzeneR⁸ sulfonate-co-3-methyl-1-(4-vinylbenzyl)-3H-benzoimidazol-1-ium acetate-co-divinylbenzene];
poly[styrene-co-4-vinylbenzeneR⁸ sulfonate-co-3-methyl-1-(4-vinylbenzyl)-3H-benzoimidazol-1-ium formate-co-divinylbenzene];
poly[styrene-co-4-vinylbenzeneR⁸ sulfonate-co-1-(4-vinylbenzyl)-pyridinium-chloride-co-divinylbenzene];
poly[styrene-co-4-vinylbenzeneR⁸ sulfonate-co-1-(4-vinylbenzyl)-pyridinium-bisulfate-co-divinylbenzene];
poly[styrene-co-4-vinylbenzeneR⁸ sulfonate-co-1-(4-vinylbenzyl)-pyridinium-acetate-co-divinylbenzene];
poly[styrene-co-4-vinylbenzeneR⁸ sulfonate-co-1-(4-vinylbenzyl)-pyridinium-nitrate-co-divinylbenzene];
poly[styrene-co-4-vinylbenzeneR⁸ sulfonate-co-1-(4-vinylbenzyl)-pyridinium-chloride-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bromide-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-iodide-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bisulfate-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-acetate-co-3-methyl-1-(4-vinylbenzyl)-3H-imidazol-1-ium bisulfate-co-divinylbenzene];
poly[styrene-co-4-vinylbenzeneR⁸ sulfonate-co-4-methyl-4-(4-vinylbenzyl)-morpholin-4-ium chloride-co-divinylbenzene];
poly[styrene-co-4-vinylbenzeneR⁸ sulfonate-co-4-methyl-4-(4-vinylbenzyl)-morpholin-4-ium bisulfate-co-divinylbenzene];
poly[styrene-co-4-vinylbenzeneR⁸ sulfonate-co-4-methyl-4-(4-vinylbenzyl)-morpholin-4-ium acetate-co-divinylbenzene];
poly[styrene-co-4-vinylbenzeneR⁸ sulfonate-co-4-methyl-4-(4-vinylbenzyl)-morpholin-4-ium formate-co-divinylbenzene];
poly[styrene-co-4-vinylbenzeneR⁸ sulfonate-co-triphenyl-(4-vinylbenzyl)-phosphonium chloride-co-divinylbenzene];
poly[styrene-co-4-vinylbenzeneR⁸ sulfonate-co-triphenyl-(4-vinylbenzyl)-phosphonium bisulfate-co-divinylbenzene];
poly[styrene-co-4-vinylbenzeneR⁸ sulfonate-co-triphenyl-(4-vinylbenzyl)-phosphonium acetate-co-divinylbenzene];
poly[styrene-co-4-vinylbenzeneR⁸ sulfonate-co-1-methyl-1-(4-vinylbenzyl)-piperdin-1-ium chloride-co-divinylbenzene];
poly[styrene-co-4-vinylbenzeneR⁸ sulfonate-co-1-methyl-1-(4-vinylbenzyl)-piperdin-1-ium bisulfate-co-divinylbenzene];
poly[styrene-co-4-vinylbenzeneR⁸ sulfonate-co-1-methyl-1-(4-vinylbenzyl)-piperdin-1-ium acetate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-4-vinylbenzeneR⁸ sulfonate-co-triethyl-(4-vinylbenzyl)-ammonium chloride-co-divinylbenzene];
poly[styrene-co-4-vinylbenzeneR⁸ sulfonate-co-triethyl-(4-vinylbenzyl)-ammonium bisulfate-co-divinylbenzene];
poly[styrene-co-4-vinylbenzeneR⁸ sulfonate-co-triethyl-(4-vinylbenzyl)-ammonium acetate-co-divinylbenzene];
poly[styrene-co-3-methyl-1-(4-vinylbenzyl)-3H-imidazol-1-ium chloride-co-4-R⁸ boronate-1-(4-vinylbenzyl)-pyridinium chloride-co-divinylbenzene];
poly[styrene-co-3-methyl-1-(4-vinylbenzyl)-3H-imidazol-1-ium chloride-co-1-(4-vinylphenyl)methylR⁸ phosphonate-co-divinylbenzene];
poly[styrene-co-3-methyl-1-(4-vinylbenzyl)-3H-imidazol-1-ium bisulfate-co-1-(4-vinylphenyl)methylR⁸ phosphonate-co-divinylbenzene];
poly[styrene-co-3-methyl-1-(4-vinylbenzyl)-3H-imidazol-1-ium acetate-co-1-(4-vinylphenyl)methylR⁸ phosphonate-co-divinylbenzene];
poly[styrene-co-3-methyl-1-(4-vinylbenzyl)-3H-imidazol-1-ium nitrate-co-1-(4-vinylphenyl)methylR⁸ phosphonate-co-divinylbenzene];
poly[styrene-co-4-vinylbenzeneR⁸ sulfonate-co-vinylbenzylchloride-co-1-methyl-2-vinyl-pyridinium chloride-co-divinylbenzene];
poly[styrene-co-4-vinylbenzeneR⁸ sulfonate-co-vinylbenzylchloride-co-1-methyl-2-vinyl-pyridinium bisulfate-co-divinylbenzene];
poly[styrene-co-4-vinylbenzeneR⁸ sulfonate-co-vinylbenzylchloride-co-1-methyl-2-vinyl-pyridinium acetate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-4-vinylphenylR⁸ phosphonate-co-3-methyl-1-(4-vinylbenzyl)-3H-imidazol-1-ium chloride-co-divinylbenzene];
poly[styrene-co-4-vinylphenylR⁸ phosphonate-co-3-methyl-1-(4-vinylbenzyl)-3H-imidazol-1-ium bisulfate-co-divinylbenzene];
poly[styrene-co-4-vinylphenylR⁸ phosphonate-co-3-methyl-1-(4-vinylbenzyl)-3H-imidazol-1-ium acetate-co-divinylbenzene];
poly[styrene-co-3-R⁸ methylcarboxylate-1-(4-vinylbenzyl)-3H-imidazol-1-ium chloride-co-divinylbenzene];
poly[styrene-co-3-R⁸ methylcarboxylate-1-(4-vinylbenzyl)-3H-imidazol-1-ium bisulfate-co-divinylbenzene];
poly[styrene-co-3-R⁸ methylcarboxylate-1-(4-vinylbenzyl)-3H-imidazol-1-ium acetate-co-divinylbenzene];
poly[styrene-co-5-(4-vinylbenzylamino)-R⁸ isophthalate-co-3-methyl-1-(4-vinylbenzyl)-3H-imidazol-1-ium chloride-co-divinylbenzene];
poly[styrene-co-5-(4-vinylbenzylamino)-R⁸ isophthalate-co-3-methyl-1-(4-vinylbenzyl)-3H-imidazol-1-ium bisulfate-co-divinylbenzene];
poly[styrene-co-5-(4-vinylbenzylamino)-R⁸ isophthalate-co-3-methyl-1-(4-vinylbenzyl)-3H-imidazol-1-ium acetate-co-divinylbenzene];
poly[styrene-co-(4-vinylbenzylamino)-R⁸ acetate-co-3-methyl-1-(4-vinylbenzyl)-3H-imidazol-1-ium chloride-co-divinylbenzene];
poly[styrene-co-(4-vinylbenzylamino)-R⁸ acetate-co-3-methyl-1-(4-vinylbenzyl)-3H-imidazol-1-ium bisulfate-co-divinylbenzene];
poly[styrene-co-(4-vinylbenzylamino)-R⁸ acetate-co-3-methyl-1-(4-vinylbenzyl)-3H-imidazol-1-ium acetate-co-divinylbenzene];
poly(styrene-co-4-vinylbenzeneR⁸ sulfonate-co-vinylbenzylmethylimidazolium chloride-co-vinylbenzylmethylmorpholinium chloride-co-vinylbenzyltriphenyl phosphonium chloride-co-divinylbenzene);
poly(styrene-co-4-vinylbenzeneR⁸ phosphonate-co-vinylbenzylmethylimidazolium chloride-co-vinylbenzylmethylmorpholinium chloride-co-vinylbenzyltriphenyl phosphonium chloride-co-divinylbenzene);
poly(styrene-co-4-vinylbenzeneR⁸ sulfonate-co-vinylbenzylmethylimidazolium bisulfate-co-vinylbenzylmethylmorpholinium bisulfate-co-vinylbenzyltriphenyl phosphonium bisulfate-co-divinylbenzene);
poly(styrene-co-4-vinylbenzeneR⁸ phosphonate-co-vinylbenzylmethylimidazolium bisulfate-co-vinylbenzylmethylmorpholinium bisulfate-co-vinylbenzyltriphenyl phosphonium bisulfate-co-divinylbenzene);
poly(styrene-co-4-vinylbenzeneR⁸ sulfonate-co-vinylbenzylmethylimidazolium acetate-co-vinylbenzylmethylmorpholinium acetate-co-vinylbenzyltriphenyl phosphonium acetate-co-divinylbenzene);
poly(styrene-co-4-vinylbenzeneR⁸ phosphonate-co-vinylbenzylmethylimidazolium acetate-co-vinylbenzylmethylmorpholinium acetate-co-vinylbenzyltriphenyl phosphonium acetate-co-divinylbenzene);
poly(styrene-co-4-vinylbenzeneR⁸ sulfonate-co-vinylbenzylmethylmorpholinium chloride-co-vinylbenzyltriphenylphosphonium chloride-co-divinylbenzene);
poly(styrene-co-4-vinylbenzeneR⁸ phosphonate-co-vinylbenzylmethylmorpholinium chloride-co-vinylbenzyltriphenylphosphonium chloride-co-divinylbenzene);
poly(styrene-co-4-vinylbenzeneR⁸ sulfonate-co-vinylbenzylmethylmorpholinium bisulfate-co-vinylbenzyltriphenylphosphonium bisulfate-co-divinylbenzene);
poly(styrene-co-4-vinylbenzeneR⁸ phosphonate-co-vinylbenzylmethylmorpholinium bisulfate-co-vinylbenzyltriphenylphosphonium bisulfate-co-divinylbenzene);
poly(styrene-co-4-vinylbenzeneR⁸ sulfonate-co-vinylbenzylmethylmorpholinium acetate-co-vinylbenzyltriphenylphosphonium bisulfate-co-divinylbenzene);
poly(styrene-co-4-vinylbenzeneR⁸ phosphonate-co-vinylbenzylmethylmorpholinium acetate-co-vinylbenzyltriphenylphosphonium bisulfate-co-divinylbenzene)
poly(styrene-co-4-vinylbenzeneR⁸ sulfonate-co-vinylmethylimidazolium chloride-co-divinylbenzene);
poly(styrene-co-4-vinylbenzeneR⁸ sulfonate-co-vinylmethylimidazolium bisulfate-co-divinylbenzene);
poly(styrene-co-4-vinylbenzeneR⁸ sulfonate-co-vinylmethylimidazolium acetate-co-divinylbenzene);
poly(styrene-co-4-vinylbenzeneR⁸ sulfonate-co-vinylmethylimidazolium nitrate-co-divinylbenzene);
poly(styrene-co-4-vinylbenzeneR⁸ phosphonate-co-vinylmethylimidazolium chloride-co-divinylbenzene);
poly(styrene-co-4-vinylbenzeneR⁸ phosphonate-co-vinylmethylimidazolium bisulfate-co-divinylbenzene);
poly(styrene-co-4-vinylbenzeneR⁸ phosphonate-co-vinylmethylimidazolium acetate-co-divinylbenzene);
poly(styrene-co-4-vinylbenzeneR⁸ sulfonate-co-vinylbenzyltriphenylphosphonium chloride-co-divinylbenzene);
poly(styrene-co-4-vinylbenzeneR⁸ sulfonate-co-vinylbenzyltriphenylphosphonium bisulfate-co-divinylbenzene);
poly(styrene-co-4-vinylbenzeneR⁸ sulfonate-co-vinylbenzyltriphenylphosphonium acetate-co-divinylbenzene);
poly(styrene-co-4-vinylbenzeneR⁸ phosphonate-co-vinylbenzyltriphenylphosphonium chloride-co-divinylbenzene);
poly(styrene-co-4-vinylbenzeneR⁸ phosphonate-co-vinylbenzyltriphenylphosphonium bisulfate-co-divinylbenzene);
poly(styrene-co-4-vinylbenzeneR⁸ phosphonate-co-vinylbenzyltriphenylphosphonium acetate-co-divinylbenzene);
poly(styrene-co-4-vinylbenzeneR⁸ sulfonate-co-vinylbenzylmethylimidazolium chloride-co-divinylbenzene);
poly(styrene-co-4-vinylbenzeneR⁸ sulfonate-co-vinylbenzylmethylimidazolium bisulfate-co-divinylbenzene);
poly(styrene-co-4-vinylbenzeneR⁸ sulfonate-co-vinylbenzylmethylimidazolium acetate-co-divinylbenzene);
poly(styrene-co-4-vinylbenzeneR⁸ phosphonate-co-vinylbenzylmethylimidazolium chloride-co-divinylbenzene);
poly(styrene-co-4-vinylbenzeneR⁸ phosphonate-co-vinylbenzylmethylimidazolium bisulfate-co-divinylbenzene);
poly(styrene-co-4-vinylbenzeneR⁸ phosphonate-co-vinylbenzylmethylimidazolium acetate-co-divinylbenzene);
poly(styrene-co-4-vinylbenzeneR⁸ sulfonate-co-vinylbenzyltriphenylphosphonium chloride-co-divinylbenzene);
poly(styrene-co-4-vinylbenzeneR⁸ sulfonate-co-vinylbenzyltriphenylphosphonium bisulfate-co-divinylbenzene);
poly(styrene-co-4-vinylbenzeneR⁸ sulfonate-co-vinylbenzyltriphenylphosphonium acetate-co-divinylbenzene);
poly(styrene-co-4-vinylbenzeneR⁸ phosphonate-co-vinylbenzyltriphenylphosphonium chloride-co-divinylbenzene);
poly(styrene-co-4-vinylbenzeneR⁸ phosphonate-co-vinylbenzyltriphenylphosphonium bisulfate-co-divinylbenzene);
poly(styrene-co-4-vinylbenzeneR⁸ phosphonate-co-vinylbenzyltriphenylphosphonium acetate-co-divinylbenzene);
poly(butyl-vinylimidazolium chloride-co-butylimidazolium bisulfate-co-4-vinylbenzeneR⁸ sulfonate);
poly(butyl-vinylimidazolium bisulfate-co-butylimidazolium bisulfate-co-4-vinylbenzeneR⁸ sulfonate);
poly(benzyl alcohol-co-4-vinylbenzylalcohol R⁸ sulfonate-co-vinylbenzyltriphenylphosphonium chloride-co-divinylbenzyl alcohol); and
poly(benzyl alcohol-co-4-vinylbenzylalcohol R⁸ sulfonate-co-vinylbenzyltriphenylphosphonium bisulfate-co-divinylbenzyl alcohol).

In some embodiments, exemplary polymers can include:
poly[styrene-co-4-vinylbenzeneR⁸ sulfonate-co-3-methyl-1-(4-vinylbenzyl)-3H-imidazol-1-ium nitrate-co-divinylbenzene];
poly[styrene-co-4-vinylbenzeneR⁸ sulfonate-co-1-(4-vinylbenzyl)-3H-imidazol-1-ium iodide-co-divinylbenzene];
poly[styrene-co-4-vinylbenzeneR⁸ sulfonate-co-3-methyl-1-(4-vinylbenzyl)-3H-benzoimidazol-1-ium chloride-co-divinylbenzene];
poly[styrene-co-4-vinylbenzeneR⁸ sulfonate-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bisulfate-co-divinylbenzene];
poly[styrene-co-4-vinylbenzene R⁸ sulfonate-co-1-(4-vinylbenzyl)-pyridinium-chloride-co-3-methyl-1-(4-vinylbenzyl)-3H-imidazol-1-ium bisulfate-co-divinylbenzene];
poly[styrene-co-4-vinylbenzeneR⁸ sulfonate-co-4-methyl-4-(4-vinylbenzyl)-morpholin-4-ium chloride-co-divinylbenzene];
poly[styrene-co-4-vinylbenzeneR⁸ sulfonate-co-1-(4-vinylbenzyl)-3H-imidazol-1-ium bisulfate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-3-methyl-1-(4-vinylbenzyl)-3H-imidazol-1-ium bisulfate-co-1-(4-vinylphenyl)methylR⁸ phosphonate-co-divinylbenzene];
poly[styrene-co-4-vinylbenzeneR⁸ sulfonate-co-vinylbenzylchloride-co-1-methyl-2-vinyl-pyridinium bisulfate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-4-vinylbenzeneR⁸ sulfonate-co-triphenyl-(4-vinylbenzyl)-phosphonium bisulfate-co-divinylbenzene];
poly[styrene-co-5-(4-vinylbenzylamino)-R⁸ isophthalate acid-co-3-methyl-1-(4-vinylbenzyl)-3H-imidazol-1-ium chloride-co-divinylbenzene];
poly(styrene-co-4-vinylbenzeneR⁸ sulfonate-co-vinylbenzylmethylimidazolium chloride-co-vinylbenzylmethylmorpholinium chloride-co-vinylbenzyltriphenyl phosphonium chloride-co-divinylbenzene);
poly(styrene-co-4-vinylbenzeneR⁸ sulfonate-co-vinylmethylimidazolium acetate-co-divinylbenzene);
poly(styrene-co-4-vinylbenzeneR⁸ sulfonate-co-vinylbenzyltriphenylphosphonium chloride-co-divinylbenzene);
poly(styrene-co-4-vinylbenzeneR⁸ phosphate-co-vinylbenzyltriphenylphosphonium chloride-co-divinylbenzene);
poly(styrene-co-4-vinylbenzeneR⁸ phosphate-co-vinylbenzyltriphenylphosphonium bisulfate-co-divinylbenzene); and
poly(styrene-co-4-vinylbenzeneR⁸ sulfonate-co-vinylbenzyltriphenylphosphonium chloride-co-divinylbenzene).

In some embodiments, exemplary polymers can include:
poly[styrene-co-4-vinylbenzeneR⁸ sulfonate-co-1-(4-vinylbenzyl)-pyridinium-chloride-co-3-methyl-1-(4-vinylbenzyl)-3H-imidazol-1-ium bisulfate-co-divinylbenzene];
poly[styrene-co-4-vinylbenzeneR⁸ sulfonate-co-vinylbenzylchloride-co-1-methyl-2-vinyl-pyridinium bisulfate-co-divinylbenzene];
poly(styrene-co-4-vinylbenzeneR⁸ phosphonate-co-vinylbenzyltriphenylphosphonium chloride-co-divinylbenzene);
poly[styrene-co-4-vinylbenzeneR⁸ sulfonate-co-1-(4-vinylbenzyl)-3H-imidazol-1-ium bisulfate-co-divinylbenzene]; and
poly(styrene-co-4-vinylbenzeneR⁸ sulfonate-co-vinylmethylimidazolium acetate-co-divinylbenzene).

In some embodiments, exemplary polymers can include:
poly[styrene-co-4-vinylbenzeneR⁸ sulfonate-co-3-methyl-1-(4-vinylbenzyl)-3H-benzoimidazol-1-ium chloride-co-divinylbenzene];
poly[styrene-co-4-vinylbenzeneR⁸ sulfonate-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bisulfate-co-divinylbenzene];
poly(styrene-co-4-vinylbenzeneR⁸ sulfonate-co-vinylbenzylmethylimidazolium chloride-co-vinylbenzylmethylmorpholinium chloride-co-vinylbenzyltriphenyl phosphonium chloride-co-divinylbenzene); and
poly[styrene-co-4-vinylbenzeneR⁸ sulfonate-co-4-(4-vinylbenzyl)-morpholine-4-oxide-co-divinyl benzene].

In some embodiments, exemplary polymers can include:
poly[styrene-co-4-vinylbenzeneR⁸ sulfonate-co-4-(4-vinylbenzyl)-morpholine-4-oxide-co-divinyl benzene];
poly(styrene-co-4-vinylbenzeneR⁸ sulfonate-co-vinylbenzyltriphenylphosphonium chloride-co-divinylbenzene);
poly[styrene-co-4-vinylbenzeneR⁸ sulfonate-1-(4-vinylbenzyl)-3H-imidazol-1-ium iodide-co-divinylbenzene];
poly[styrene-co-4-vinylbenzeneR⁸ sulfonate-co-triphenyl-(4-vinylbenzyl)-phosphonium bisulfate-co-divinylbenzene]; and
poly[styrene-co-3-methyl-1-(4-vinylbenzyl)-3H-imidazol-1-ium bisulfate-co-1-(4-vinylphenyl)methylR⁸ phosphonate-co-divinylbenzene].

For all polymers disclosed herein where the variable R⁸ is included in the name of the polymer, that name stands for a group of nine distinct polymers. It should be understood that R⁸ can be selected from lithium (i.e., Li⁺), potassium (i.e., K⁺), ammonium (i.e., N(H)₄⁺), tetramethylammonium (i.e., N(Me)₄⁺), tetraethylammonium (i.e., N(Et)₄⁺), zinc (i.e., Zn²⁺), magnesium (i.e., Mg²⁺), and calcium (i.e., Ca²⁺). Divalent cations, such as Zn²⁺, Mg²⁺ and Ca²⁺, are each independently associated with at least two Bronsted-Lowry acids in conjugate base form on any acidic monomer. However, it should be understood that this disclosure contemplates polymers having any suitable cationic moiety, such as those formulae and examples bearing an “M” variable.

In some embodiments, R⁸ is selected from K⁺ and N(H)₄⁺. In other embodiments, R⁸ is selected from Mg²⁺ and Ca²⁺. In some embodiments, R⁸ is Li⁺. In some embodiments, R⁸ is K⁺. In some embodiments, R⁸ is N(H)₄⁺. In some embodiments, R⁸ is N(Me)₄⁺. In some embodiments, R⁸ is N(Et)₄⁺. In some embodiments, R⁸ is Zn²⁺. In some embodiments, R⁸ is Mg²⁺. In some embodiments, R⁸ is Ca²⁺.

For example, the name “poly[styrene-co-4-vinylbenzeneR⁸ sulfonate-co-4-(4-vinylbenzyl)-morpholine-4-oxide-co-divinyl benzene]” discloses poly[styrene-co-4-vinylbenzenelithium sulfonate-co-4-(4-vinylbenzyl)-morpholine-4-oxide-co-divinyl benzene]; poly[styrene-co-4-vinylbenzenepotassium sulfonate-co-4-(4-vinylbenzyl)-morpholine-4-oxide-co-divinyl benzene]; poly[styrene-co-4-vinylbenzenetetramethylammonium sulfonate-co-4-(4-vinylbenzyl)-morpholine-4-oxide-co-divinyl benzene]; poly[styrene-co-4-vinylbenzenetetraethylammonium sulfonate-co-4-(4-vinylbenzyl)-morpholine-4-oxide-co-divinyl benzene]; poly[styrene-co-4-vinylbenzenezinc sulfonate-co-4-(4-vinylbenzyl)-morpholine-4-oxide-co-divinyl benzene]; poly[styrene-co-4-vinylbenzenemagnesium sulfonate co-4-(4-vinylbenzyl)-morpholine-4-oxide-co-divinyl benzene]; and poly[styrene-co-4-vinylbenzenecalcium sulfonate-co-4-(4-vinylbenzyl)-morpholine-4-oxide-co-divinyl benzene].

The catalysts described herein have one or more catalytic properties. As used herein, a “catalytic property” of a material is a physical and/or chemical property that increases the rate and/or extent of a reaction involving the material. The catalytic properties can include at least one of the following properties: a) disruption of a hydrogen bond in cellulosic materials; b) intercalation of the catalyst into crystalline domains of cellulosic materials; and c) cleavage of a glycosidic bond in cellulosic materials. In other embodiments, the catalysts that have two or more of the catalytic properties described above, or all three of the catalytic properties described above. In certain embodiments, the polymeric catalysts described herein have the ability to catalyze a chemical reaction by donation of a proton, and can be regenerated during the reaction process. In some embodiments, the polymeric catalysts described herein have a greater specificity for cleavage of a glycosidic bond than dehydration of a monosaccharide.

In certain embodiments, the catalysts described herein have the ability to catalyze a chemical reaction by donation of a proton, and can be regenerated during the reaction process.

In some embodiments, the catalysts described herein have a greater specificity for cleavage of a glycosidic bond than dehydration of a monosaccharide.

In some embodiments, the polymer is substantially insoluble in water or an organic solvent.

The polymers described herein can form solid particles. One of skill in the art would recognize the various known techniques and methods to make solid particles. For example, a solid particle can be formed through the procedures of emulsion or dispersion polymerization, which are known to one of skill in the art. In other embodiments, the solid particles can be formed by grinding or breaking the polymer into particles, which are also techniques and methods that are known to one of skill in the art. Methods known in the art to prepare solid particles include coating the polymers described herein on the surface of a solid core. Suitable materials for the solid core can include an inert material (e.g., aluminum oxide, corn cob, crushed glass, chipped plastic, pumice, silicon carbide, or walnut shell) or a magnetic material. Polymeric coated core particles can be made by dispersion polymerization to grow a cross-linked polymer shell around the core material, or by spray coating or melting.

In some embodiments, the polymer catalyst can be a solid-supported polymer catalyst. In certain embodiments, the solid-supported polymer catalyst can include a support and a plurality of acidic groups attached to the support. In certain embodiments, the support can be selected from biochar, carbon, silica, silica gel, alumina, magnesia, titania, zirconia, clays (e.g., kaolinite), magnesium silicate, silicon carbide, zeolites (e.g., mordenite), ceramics, and any combinations thereof. In certain embodiments, the acidic groups at each occurrence can be independently selected from sulfonic acid, phosphonic acid, acetic acid, isophthalic acid, and boronic acid.

In other embodiments, the polymer may include a support and a plurality of acidic groups and cationic groups attached to the support. In certain embodiments, the support is selected from biochar, carbon, amorphous carbon, activated carbon, silica, silica gel, alumina, magnesia, titania, zirconia, clays (e.g., kaolinite), magnesium silicate, silicon carbide, zeolites (e.g., mordenite), ceramics, and any combinations thereof. In certain embodiments, the acidic groups are selected from sulfonic acid, phosphonic acid, acetic acid, isophthalic acid, and boronic acid. In certain embodiments, the ionic groups are selected from pyrrolium, imidazolium, pyrazolium, oxazolium, thiazolium, pyridinium, pyrimidinium, pyrazinium, pyradizimium, thiazinium, morpholinium, piperidinium, piperizinium, and pyrollizinium, phosphonium, trimethyl phosphonium, triethyl phosphonium, tripropyl phosphonium, tributyl phosphonium, trichloro phosphonium, triphenyl phosphonium and trifluoro phosphonium.

Provided is also a solid particle that includes a solid core and any of the polymers described herein, in which the polymer is coated on the surface of the solid core. The carbon support can have a surface area from about 0.01 to about 50 m²/g of dry material. The carbon support can have a density from about 0.5 to about 2.5 kg/L. The support can be characterized using any suitable instrumental analysis methods or techniques known in the art, including for example, scanning electron microscopy (SEM), powder X-ray diffraction (XRD), Raman spectroscopy, and Fourier Transform infrared spectroscopy (FTIR). The carbon support can be prepared from carbonaceous materials, including for example, shrimp shell, chitin, coconut shell, wood pulp, paper pulp, cotton, cellulose, hard wood, soft wood, wheat straw, sugarcane bagasse, cassava stem, corn stover, oil palm residue, bitumen, asphaltum, tar, coal, pitch, and any combinations thereof. One of skill in the art would recognize suitable methods to prepare the carbon supports used herein. See e.g., M. Inagaki, L. R. Radovic, Carbon, vol. 40, p. 2263 (2002), or A. G. Pandolfo and A. F. Hollenkamp, “Review: Carbon Properties and their role in supercapacitors,” Journal of Power Sources, vol. 157, pp. 11-27 (2006).

In other embodiments, the material can be silica, silica gel, alumina, or silica-alumina. One of skill in the art would recognize suitable methods to prepare these silica- or alumina-based solid supports used herein. See e.g., Catalyst supports and supported catalysts, by A. B. Stiles, Butterworth Publishers, Stoneham Mass., 1987.

In yet other embodiments, the material can be a combination of a carbon support, with one or more other supports selected from silica, silica gel, alumina, magnesia, titania, zirconia, clays (e.g., kaolinite), magnesium silicate, silicon carbide, zeolites (e.g., mordenite), ceramics.

The solid supported acid catalyst particle can have a solid core where the polymer is coated on the surface of the solid core. In some embodiments, at least about 5%, at least about 10%, at least about 20%, at least about 30%, at least about 40%, or at least about 50% of the catalytic activity of the solid particle can be present on or near the exterior surface of the solid particle. In some embodiments, the solid core can have an inert material or a magnetic material. In one embodiment, the solid core is made up of iron.

In some embodiments, the solid particle is substantially free of pores, for example, having no more than about 50%, no more than about 40%, no more than about 30%, no more than about 20%, no more than about 15%, no more than about 10%, no more than about 5%, or no more than about 1% of pores. Porosity can be measured by methods well known in the art, such as determining the Brunauer-Emmett-Teller (BET) surface area using the absorption of nitrogen gas on the internal and external surfaces of a material (Brunauer, S. et al., J. Am. Chem. Soc. 1938, 60:309). Other methods include measuring solvent retention by exposing the material to a suitable solvent (such as water), then removing it thermally to measure the volume of interior pores. Other solvents suitable for porosity measurement of the polymeric catalysts include, but are not limited to, polar solvents such as DMF, DMSO, acetone, and alcohols.

In other embodiments, the solid particles include a microporous gel resin. In yet other embodiments, the solid particles include a macroporous gel resin.

In some embodiments, solid particle catalysts have greater ease of handling. The solid nature of the polymeric catalysts can provide for ease of recycling (e.g., by filtering the catalyst), without requiring distillation or extraction methods. For example, the density and size of the particle can be selected such that the catalyst particles can be separated from the materials used in a process for the break-down of biomaterials. Particles can be selected based on sedimentation rate, e.g., relative to materials used or produced in a reaction mixture, particle density, or particle size. Alternatively, solid particles coated with the polymeric catalysts that have a magnetically active core can be recovered by electromagnetic methods known to one of skill in the art.

In other embodiments, the solid particle having the polymer coating has at least one catalytic property selected from:

a) disruption of at least one hydrogen bond in cellulosic materials;

b) intercalation of the polymer into crystalline domains of cellulosic materials; and

c) cleavage of at least one glycosidic bond in cellulosic materials.

Disclosed herein are compositions that include at least one polymer as described herein and biomass. The term “biomass” can refer to any type of feedstock that is derived from plant matter. In some embodiments, biomass encompasses plant-based materials that have a cellulosic component. In these cases, the biomass can include one or more of cellulose, hemicellulose, or a combination thereof. The cellulose can be in crystalline form, non-crystalline form or a mixture thereof. Compositions containing at least one disclosed polymer and biomass can further comprise a solvent, such as water or an organic solvent. In yet other embodiments, the biomass also contains lignin.

Also disclosed herein are chemically-hydrolyzed biomass compositions that include at least one polymer as described herein, one or more sugars and residual biomass. The sugars can include one or more monosaccharides, one or more oligosaccharides, or a mixture thereof. In some embodiments, the one or more sugars are two or more sugars having at least one C4-C6 monosaccharide and at least one oligosaccharide. In other embodiments, the sugars are selected from glucose, galactose, fructose, xylose, and arabinose.

### Saccharification Using the Polymer Catalysts

In one aspect, provided are methods for saccharification of cellulosic materials (e.g., biomass) using the polymeric catalysts described herein. The cellulosic materials provided for the methods described herein may be obtained from any source (including any commercially available sources).

Saccharification refers to the hydrolysis of cellulosic materials (e.g., biomass) into one or more sugars, by breaking down the complex carbohydrates of cellulose (and hemicellulose, where present) in the biomass. The one or more sugars can be monosaccharides and/or oligosaccharides. As used herein, “oligosaccharide” refers to a compound containing two or more monosaccharide units linked by glycosidic bonds. In certain embodiments, the one or more sugars can be selected from glucose, cellobiose, xylose, xylulose, arabinose, mannose and galactose.

In some embodiments, the cellulosic material can be subjected to a one-step or a multi-step hydrolysis process. For example, in some embodiments, the cellulosic material can be first contacted with the catalyst, and then the resulting product is contacted with one or more enzymes in a second hydrolysis reaction (e.g., using enzymes).

The one or more sugars obtained from hydrolysis of cellulosic material can be used in a subsequent fermentation process to produce biofuels (e.g., ethanol) and other bio-based chemicals. For example, in some embodiments, the one or more sugars obtained by the methods described herein can undergo subsequent bacterial or yeast fermentation to produce biofuels and other bio-based chemicals.

Provided is also a saccharification intermediate that includes any of the polymers described herein hydrogen-bonded to biomass. In certain embodiments of the saccharification intermediate, the ionic moiety of the polymer is hydrogen-bonded to the carbohydrate alcohol groups present in cellulose, hemicellulose, and other oxygen-containing components of biomass. In certain embodiments of the saccharification intermediate, the acidic moiety of the polymer is hydrogen-bonded to the carbohydrate alcohol groups present in cellulose, hemicellulose, and other oxygen-containing components of lignocellulosic biomass, including the glycosidic linkages between sugar monomers. In some embodiments, the biomass has cellulose, hemicellulose or a combination thereof.

Further, it should be understood that any method known in the art that includes pretreatment, enzymatic hydrolysis (saccharification), fermentation, or a combination thereof, can be used with the catalysts in the methods described herein. The catalysts can be used before or after pretreatment methods to make the cellulose (and hemicellulose, where present) in the biomass more accessible to hydrolysis.

### Degradation of Cellulosic Materials to Sugars

Cellulosic materials can be contacted with the polymeric catalysts described herein to render the cellulosic material more susceptible to hydrolysis. In some instances, the cellulosic material can also be hydrolyzed into sugars suitable for use in producing bio-based polymers.

a) Cellulosic Materials

Cellulosic materials can include any material containing cellulose and/or hemicellulose. In certain embodiments, cellulosic materials can be lignocellulosic materials that contain lignin in addition to cellulose and/or hemicellulose. Cellulose is a polysaccharide that includes a linear chain of beta-(1-4)-D-glucose units. Hemicellulose is also a polysaccharide; however, unlike cellulose, hemicellulose is a branched polymer that typically includes shorter chains of sugar units. Hemicellulose can include a diverse number of sugar monomers including, for example, xylans, xyloglucans, arabinoxylans, galactans, arabinogalactans, and mannans.

Cellulosic materials can typically be found in biomass. In some embodiments, the cellulosic materials used with the polymeric catalysts described herein contains a substantial proportion of cellulosic material, such as about 5%, about 10%, about 15%, about 20%, about 25%, about 50%, about 75%, about 90% or greater than about 90% cellulose. In some embodiments, the cellulosic material can include herbaceous materials, agricultural residues, forestry residues, municipal solid waste, waste paper, and pulp and paper mill residues. In other embodiments, the cellulosic material includes corns, natural fibers, sugarcanes, sugarbeets, citrus fruits, woody plants, potatoes, plant oils, other polysaccharides such as pectin, chitin, levan, or pullulan, or a combination thereof. In certain embodiments, the cellulosic material includes corn stover, corn fiber, or corn cob. In other embodiments, the cellulosic material includes bagasse, rice straw, wheat straw, switch grass or miscanthus, or a combination thereof. In yet other embodiments, the cellulosic material can also include chemical cellulose (e.g., Avicel®), industrial cellulose (e.g., paper or paper pulp), bacterial cellulose, or algal cellulose. As described herein and known in the art, the cellulosic materials can be used as obtained from the source, or can be subjected to one or pretreatments. For example, pretreated corn stover (“PCS”) is a cellulosic material derived from corn stover by treatment with heat and/or dilute sulfuric acid, and is suitable for use with the polymeric catalysts described herein.

Several different crystalline structures of cellulose are known in the art. For example, crystalline cellulose are forms of cellulose where the linear beta-(1-4)-glucan chains can be packed into a three-dimensional superstructure. The aggregated beta-(1-4)-glucan chains are typically held together via inter- and intra-molecular hydrogen bonds. Steric hindrance resulting from the structure of crystalline cellulose can impede access of the reactive species, such as enzymes or chemical catalysts, to the beta-glycosidic bonds in the glucan chains. In contrast, non-crystalline cellulose and amorphous cellulose are forms of cellulose in which individual beta-(1-4)-glucan chains are not appreciably packed into a hydrogen-bonded super-structure, where access of reactive species to the beta-glycosidic bonds in the cellulose is hindered.

One of skill in the art would recognize that natural sources of cellulose can include a mixture of crystalline and non-crystalline domains. The regions of a beta-(1-4)-glucan chain where the sugar units are present in their crystalline form are referred to herein as the “crystalline domains” of the cellulosic material. Generally, the beta-(1-4)-glucan chains present in natural cellulose exhibit a number average degree of polymerization between about 1,000 and about 4,000 anhydroglucose (“AHG”) units (i.e., about 1,000-4,000 glucose molecules linked via beta-glycosidic bonds), while the number average degree of polymerization for the crystalline domains is typically between about 200 and about 300 AHG units. See e.g., R. Rinaldi, R. Palkovits, and F. Schüth, Angew. Chem. Int. Ed., 47, 8047-8050 (2008); Y.-H. P. Zhang and L. R. Lynd, Biomacromolecules, 6, 1501-1515 (2005).

Typically, cellulose has multiple crystalline domains that are connected by non-crystalline linkers that can include a small number of anhydroglucose units. One of skill in the art would recognize that traditional methods to digest biomass, such as dilute acidic conditions, can digest the non-crystalline domains of natural cellulose, but not the crystalline domains. Dilute acid treatment does not appreciably disrupt the packing of individual beta-(1-4)-glucan chains into a hydrogen-bonded super-structure, nor does it hydrolyze an appreciable number of glycosidic bonds in the packed beta-(1-4)-glucan chains. Consequently, treatment of natural cellulosic materials with dilute acid reduces the number average degree of polymerization of the input cellulose to approximately 200-300 anhydroglucose units, but does not further reduce the degree of polymerization of the cellulose to below about 150-200 anhydroglucose units (which is the typical size of the crystalline domains).

In certain embodiments, the polymeric catalysts described herein can be used to digest natural cellulosic materials. The polymeric catalysts can be used to digest crystalline cellulose by a chemical transformation in which the average degree of polymerization of cellulose is reduced to a value less than the average degree of polymerization of the crystalline domains. Digestion of crystalline cellulose can be detected by observing reduction of the average degree of polymerization of cellulose. In certain embodiments, the polymeric catalysts can reduce the average degree of polymerization of cellulose from at least about 300 AGH units to less than about 200 AHG units.

It should be understood that the polymeric catalysts described herein can be used to digest crystalline cellulose, as well as microcrystalline cellulose. One of skill in the art would recognize that crystalline cellulose typically has a mixture of crystalline and amorphous or non-crystalline domains, whereas microcrystalline cellulose typically refers to a form of cellulose where the amorphous or non-crystalline domains have been removed by chemical processing such that the residual cellulose substantially has only crystalline domains.

b) Pretreatment of Cellulosic Materials

Provided is also a method for pretreating biomass before hydrolysis of the biomass to produce one or more sugars, by: a) providing biomass; b) contacting the biomass with any of the polymers described herein and a solvent for a period of time sufficient to partially degrade the biomass; and c) pretreating the partially degraded biomass before hydrolysis to produce one or more sugars. In some embodiments, the biomass has cellulose, hemicellulose, or a combination thereof. In other embodiments, the biomass also has lignin.

Moreover, in some embodiments, the polymeric catalysts described herein can be used with cellulosic material that has been pretreated. In other embodiments, the polymeric catalysts described herein can be used with cellulosic material before pretreatment.

Any pretreatment process known in the art can be used to disrupt plant cell wall components of cellulosic materials, including, for example, chemical or physical pretreatment processes. See, e.g., Chandra et al., Substrate pretreatment: The key to effective enzymatic hydrolysis of lignocellulosics?, Adv. Biochem. Engin./Biotechnol., 108: 67-93 (2007); Galbe and Zacchi, Pretreatment of lignocellulosic materials for efficient bioethanol production, Adv. Biochem. Engin./Biotechnol., 108: 41-65 (2007); Hendriks and Zeeman, Pretreatments to enhance the digestibility of lignocellulosic biomass, Bioresource Technol., 100: 10-18 (2009); Mosier et al., Features of promising technologies for pretreatment of lignocellulosic biomass, Bioresource Technol., 96: 673-686 (2005); Taherzadeh and Karimi, Pretreatment of lignocellulosic wastes to improve ethanol and biogas production: A review, Int. J. of Mol. Sci., 9: 1621-1651 (2008); Yang and Wyman, Pretreatment: the key to unlocking low-cost cellulosic ethanol, Biofuels Bioproducts and Biorefining (Biofpr), 2: 26-40 (2008). Examples of suitable pretreatment methods are described by Schell et al. (Appl. Biochem. and Biotechnol., 105-108: 69-85 (2003) and Mosier et al. (Bioresource Technol., 96: 673-686 (2005), and in U.S. Patent Application No. 2002/0164730.

Suitable pretreatments may include, for example, washing, solvent-extraction, solvent-swelling, comminution, milling, steam pretreatment, explosive steam pretreatment, dilute acid pretreatment, hot water pretreatment, alkaline pretreatment, lime pretreatment, wet oxidation, wet explosion, ammonia fiber explosion, organosolvent pretreatment, biological pretreatment, ammonia percolation, ultrasound, electroporation, microwave, supercritical CO2, supercritical H₂O, ozone, and gamma irradiation, or a combination thereof. One of skill in the art would recognize the conditions suitable to pretreat biomass. See e.g., U.S. Patent Application No. 2002/0164730; Schell et al., Appl. Biochem. Biotechnol., 105-108: 69-85 (2003); Mosier et al., Bioresource Technol., 96: 673-686 (2005); Duff and Murray, Bioresource Technol., 855: 1-33 (1996); Galbe and Zacchi, Appl. Microbiol. Biotechnol., 59: 618-628 (2002); Ballesteros et al., Appl. Biochem. Biotechnol., 129-132: 496-508 (2006); Varga et al., Appl. Biochem. Biotechnol., 113-116: 509-523 (2004); Sassner et al., Enzyme Microb. Technol., 39: 756-762 (2006); Schell et al., Bioresource Technol., 91: 179-188 (2004); Lee et al., Adv. Biochem. Eng. Biotechnol., 65: 93-115 (1999); Wyman et al., Bioresource Technol., 96: 1959-1966 (2005); Mosier et al., Bioresource Technol., 96: 673-686 (2005); Schmidt and Thomsen, Bioresource Technol., 64: 139-151 (1998); Palonen et al., Appl. Biochem. Biotechnol., 117: 1-17 (2004); Varga et al., Biotechnol. Bioeng., 88: 567-574 (2004); Martin et al., J. Chem. Technol. Biotechnol., 81: 1669-1677 (2006); WO 2006/032282; Gollapalli et al., Appl. Biochem. Biotechnol., 98: 23-35 (2002); Chundawat et al., Biotechnol. Bioeng., 96: 219-231 (2007); Alizadeh et al., Appl. Biochem. Biotechnol., 121: 1133-1141 (2005); Teymouri et al., Bioresource Technol., 96: 2014-2018 (2005); Pan et al., Biotechnol. Bioeng., 90: 473-481 (2005); Pan et al., Biotechnol. Bioeng., 94: 851-861 (2006); Kurabi et al., Appl. Biochem. Biotechnol., 121: 219-230 (2005); Hsu, T.-A., Pretreatment of Biomass, in Handbook on Bioethanol: Production and Utilization, Wyman, C. E., ed., Taylor & Francis, Washington, D.C., 179-212 (1996); Ghosh and Singh, Physicochemical and biological treatments for enzymatic/microbial conversion of cellulosic biomass, Adv. Appl. Microbiol., 39: 295-333 (1993); McMillan, J. D., Pretreating lignocellulosic biomass: a review, in Enzymatic Conversion of Biomass for Fuels Production, Himmel, M. E., Baker, J. O., and Overend, R. P., eds., ACS Symposium Series 566, American Chemical Society, Washington, D.C., Chapter 15 (1994); Gong, C. S., Cao, N. J., Du, J., and Tsao, G. T., Ethanol production from renewable resources, in Advances in Biochemical Engineering/Biotechnology, Scheper, T., ed., Springer-Verlag Berlin Heidelberg, Germany, 65: 207-241 (1999); Olsson and Hahn-Hagerdal, Fermentation of lignocellulosic hydrolysates for ethanol production, Enz. Microb. Tech., 18: 312-331 (1996); and Vallander and Eriksson, Production of ethanol from lignocellulosic materials: State of the art, Adv. Biochem. Eng./Biotechnol., 42: 63-95(1990).

In other embodiments, the polymeric catalysts described herein can be used with cellulosic material that has not been pretreated. Further, the cellulosic material can also be subjected to other processes instead of or in addition to pretreatment including, for example, particle size reduction, pre-soaking, wetting, washing, or conditioning.

Moreover, the use of the term “pretreatment” does not imply or require any specific timing of the steps of the methods described herein. For example, the cellulosic material can be pretreated before hydrolysis. Alternatively, the pretreatment can be carried out simultaneously with hydrolysis. In some embodiments, the pretreatment step itself results in some conversion of cellulosic material to sugars (for example, even in the absence of the polymeric catalysts described herein).

Several common methods that can be used to pretreat cellulose materials for use with the polymeric catalysts are described below.

Steam Pretreatment

Cellulosic material can be heated to disrupt the plant cell wall components (e.g., lignin, hemicellulose, cellulose) to make the cellulose and/or hemicellulose more accessible to enzymes. Cellulosic material is typically passed to or through a reaction vessel, where steam is injected to increase the temperature to the required temperature and pressure is retained therein for the desired reaction time.

In certain embodiments where steam pretreatment is employed to pretreat the cellulosic materials, the pretreatment can be performed at a temperature between about 140° C. and about 230° C., between about 160° C. and about 200° C., or between about 170° C. and about 190° C. It should be understood, however, that the optimal temperature range for steam pretreatment can vary depending on the polymeric catalyst used.

In certain embodiments, the residence time for the steam pretreatment is about 1 to about 15 minutes, about 3 to about 12 minutes, or about 4 to about 10 minutes. It should be understood, however, that the optimal residence time for steam pretreatment can vary depending on the temperature range and the polymeric catalyst used.

In some embodiments, steam pretreatment can be combined with an explosive discharge of the material after the pretreatment, which is known as steam explosion—a rapid flashing to atmospheric pressure and turbulent flow of the material to increase the accessible surface area by fragmentation. See Duff and Murray, Bioresource Technol., 855: 1-33 (1996); Galbe and Zacchi, Appl. Microbiol. Biotechnol., 59: 618-628 (2002); U.S. Patent Application No. 2002/0164730.

During steam pretreatment, acetyl groups in hemicellulose can be cleaved, and the resulting acid can autocatalyze the partial hydrolysis of the hemicellulose to monosaccharides and/or oligosaccharides. One of skill in the art would recognize, however, that lignin (when present in the cellulosic material) is removed to only a limited extent. Thus, in certain embodiments, a catalyst such as sulfuric acid (typically about 0.3% to about 3% w/w) can be added prior to steam pretreatment, to decrease the time and temperature, increase the recovery, and improve enzymatic hydrolysis. See Ballesteros et al., Appl. Biochem. Biotechnol., 129-132: 496-508 (2006); Varga et al., Appl. Biochem. Biotechnol., 113-116: 509-523 (2004); Sassner et al., Enzyme Microb. Technol., 39: 756-762 (2006).

Chemical Pretreatment

Chemical pretreatment of cellulosic materials can promote the separation and/or release of cellulose, hemicellulose, and/or lignin by chemical processes. Examples of suitable chemical pretreatment processes include, for example, dilute acid pretreatment, lime pretreatment, wet oxidation, ammonia fiber/freeze explosion (AFEX), ammonia percolation (APR), and organosolvent pretreatments.

In one embodiment, dilute or mild acid pretreatment can be employed. Cellulosic material can be mixed with a dilute acid and water to form a slurry, heated by steam to a certain temperature, and after a residence time flashed to atmospheric pressure. Suitable acids for this pretreatment method can include, for example, sulfuric acid, acetic acid, citric acid, nitric acid, phosphoric acid, tartaric acid, succinic acid, hydrogen chloride, or mixtures thereof. In one variation, sulfuric acid is used. The dilute acid treatment can be conducted in a pH range of about 1-5, a pH range of about 1-4, or a pH range of about 1-3. The acid concentration can be in the range from about 0.01 to about 20 wt % acid, about 0.05 to about 10 wt % acid, about 0.1 to about 5 wt % acid, or about 0.2 to about 2.0 wt % acid. The acid is contacted with cellulosic material, and can be held at a temperature in the range of about 160-220° C., or about 165-195° C., for a period of time ranging from seconds to minutes (e.g., about 1 second to about 60 minutes). The dilute acid pretreatment can be performed with a number of reactor designs, including for example plug-flow reactors, counter-current reactors, and continuous counter-current shrinking bed reactors. See Duff and Murray (1996), supra; Schell et al., Bioresource Technol., 91: 179-188 (2004); Lee et al., Adv. Biochem. Eng. Biotechnol., 65: 93-115 (1999).

In another embodiment, an alkaline pretreatment can be employed. Examples of suitable alkaline pretreatments include, for example, lime pretreatment, wet oxidation, ammonia percolation (APR), and ammonia fiber/freeze explosion (AFEX). Lime pretreatment can be performed with calcium carbonate, sodium hydroxide, or ammonia at temperatures of about 85° C. to about 150° C., and at residence times from about 1 hour to several days. See Wyman et al., Bioresource Technol., 96: 1959-1966 (2005); Mosier et al., Bioresource Technol., 96: 673-686 (2005).

In yet another embodiment, wet oxidation can be employed. Wet oxidation is a thermal pretreatment that can be performed, for example, at about 180° C. to about 200° C. for about 5-15 minutes with addition of an oxidative agent such as hydrogen peroxide or over-pressure of oxygen. See Schmidt and Thomsen, Bioresource Technol., 64: 139-151 (1998); Palonen et al., Appl. Biochem. Biotechnol., 117: 1-17 (2004); Varga et al., Biotechnol. Bioeng., 88: 567-574 (2004); Martin et al., J. Chem. Technol. Biotechnol., 81: 1669-1677 (2006). Wet oxidation can be performed, for example, at about 1-40% dry matter, about 2-30% dry matter, or about 5-20% dry matter, and the initial pH can also be increased by the addition of alkali (e.g., sodium carbonate). A modification of the wet oxidation pretreatment method, known as wet explosion—a combination of wet oxidation and steam explosion, can handle dry matter up to about 30%. In wet explosion, the oxidizing agent can be introduced during pretreatment after a certain residence time, and the pretreatment can end by flashing to atmospheric pressure. See WO 2006/032282.

In yet another embodiment, pretreatment methods using ammonia can be employed. See e.g., WO 2006/110891; WO 2006/11899; WO 2006/11900; and WO 2006/110901. For example, ammonia fiber explosion (AFEX) involves treating cellulosic material with liquid or gaseous ammonia at moderate temperatures (e.g., about 90-100° C.) and at high pressure (e.g., about 17-20 bar) for a given duration (e.g., about 5-10 minutes), where the dry matter content can be in some instances as high as about 60%. See Gollapalli et al., Appl. Biochem. Biotechnol., 98: 23-35 (2002); Chundawat et al., Biotechnol. Bioeng., 96: 219-231 (2007); Alizadeh et al., Appl. Biochem. Biotechnol., 121: 1133-1141 (2005); Teymouri et al., Bioresource Technol., 96: 2014-2018 (2005). AFEX pretreatment can depolymerize cellulose, partial hydrolyze hemicellulose, and, in some instances, cleave some lignin-carbohydrate complexes.

Organosolvent Pretreatment

An organosolvent solution can be used to delignify cellulosic material. In one embodiment, an organosolvent pretreatment involves extraction using aqueous ethanol (e.g., about 40-60% ethanol) at an elevated temperature (e.g., about 160-200° C.) for a period of time (e.g., about 30-60 minutes). See Pan et al., Biotechnol. Bioeng., 90: 473-481 (2005); Pan et al., Biotechnol. Bioeng., 94: 851-861 (2006); Kurabi et al., Appl. Biochem. Biotechnol., 121: 219-230 (2005). In one variation, sulfuric acid is added to the organosolvent solution as a catalyst to delignify the cellulosic material. One of skill in the art would recognize that an organosolvent pretreatment can typically breakdown the majority of hemicellulose.

Physical Pretreatment

Physical pretreatment of cellulosic materials can promote the separation and/or release of cellulose, hemicellulose, and/or lignin by physical processes. Examples of suitable physical pretreatment processes can involve irradiation (e.g., microwave irradiation), steaming/steam explosion, hydrothermolysis, and combinations thereof.

Physical pretreatment can involve high pressure and/or high temperature. In one embodiment, the physical pretreatment is steam explosion. In some variations, high pressure refers to a pressure in the range of about 300-600 psi, about 350-550 psi, or about 400-500 psi, or about 450 psi. In some variations, high temperature refers to temperatures in the range of about 100-300° C., or about 140-235° C.

In another embodiment, the physical pretreatment is a mechanical pretreatment. Suitable examples of mechanical pretreatment can include various types of grinding or milling (e.g., dry milling, wet milling, or vibratory ball milling). In some variations, mechanical pretreatment is performed in a batch-process, such as in a steam gun hydrolyzer system that uses high pressure and high temperature (e.g., a Sunds Hydrolyzer available from Sunds Defibrator AB, Sweden).

Combined Physical and Chemical Pretreatment

In some embodiments, cellulosic material can be pretreated both physically and chemically. For instance, in one variation, the pretreatment step can involve dilute or mild acid treatment and high temperature and/or pressure treatment. It should be understood that the physical and chemical pretreatments can be carried out sequentially or simultaneously. In other variation, the pretreatment can also include a mechanical pretreatment, in addition to chemical pretreatment.

Biological Pretreatment

Biological pretreatment techniques can involve applying lignin-solubilizing microorganisms. See, e.g., Hsu, T.-A., Pretreatment of Biomass, in Handbook on Bioethanol: Production and Utilization, Wyman, C. E., ed., Taylor & Francis, Washington, D.C., 179-212 (1996); Ghosh and Singh, Physicochemical and biological treatments for enzymatic/microbial conversion of cellulosic biomass, Adv. Appl. Microbiol., 39: 295-333 (1993); McMillan, J. D., Pretreating lignocellulosic biomass: a review, in Enzymatic Conversion of Biomass for Fuels Production, Himmel, M. E., Baker, J. O., and Overend, R. P., eds., ACS Symposium Series 566, American Chemical Society, Washington, D.C., chapter 15 (1994); Gong, C. S., Cao, N. J., Du, J., and Tsao, G. T., Ethanol production from renewable resources, in Advances in Biochemical Engineering/Biotechnology, Scheper, T., ed., Springer-Verlag Berlin Heidelberg, Germany, 65: 207-241 (1999); Olsson and Hahn-Hagerdal, Fermentation of lignocellulosic hydrolysates for ethanol production, Enz. Microb. Tech., 18: 312-331 (1996); and Vallander and Eriksson, Production of ethanol from lignocellulosic materials: State of the art, Adv. Biochem. Eng./Biotechnol., 42: 63-95(1990). In some embodiments, pretreatment can be performed in an aqueous slurry. In other embodiments, the cellulosic material is present during pretreatment in amounts between about 10-80 wt %, between about 20-70 wt %, or between about 30-60 wt %, or about 50 wt %. Furthermore, after pretreatment, the pretreated cellulosic material can be unwashed or washed using any method known in the art (e.g., washed with water) before hydrolysis to produce one or more sugars or use with the polymeric catalyst.

In one embodiment, the pretreatment of biomass is performed using a method selected from: washing, solvent-extraction, solvent-swelling, comminution, milling, steam pretreatment, explosive steam pretreatment, dilute acid pretreatment, hot water pretreatment, alkaline pretreatment, lime pretreatment, wet oxidation, wet explosion, ammonia fiber explosion, organosolvent pretreatment, biological pretreatment, ammonia percolation, ultrasound, electroporation, microwave, supercritical CO₂, supercritical H₂O, ozone, and gamma irradiation.

Also provided is a use of a polymer as disclosed herein for partially digesting biomass before pretreatment using one or more methods selected from the group consisting of washing, solvent-extraction, solvent-swelling, comminution, milling, steam pretreatment, explosive steam pretreatment, dilute acid pretreatment, hot water pretreatment, alkaline pretreatment, lime pretreatment, wet oxidation, wet explosion, ammonia fiber explosion, organosolvent pretreatment, biological pretreatment, ammonia percolation, ultrasound, electroporation, microwave, supercritical CO₂, supercritical H₂O, ozone, and gamma irradiation.

c) Saccharification Conditions

The methods provided herein involve contacting the cellulosic material with a polymeric catalyst under conditions sufficient to hydrolyze at least a portion of the cellulosic material into sugars. In some embodiments, the cellulosic material can be contacted with the polymeric catalyst in the presence of a solvent.

Further, it should be understood that any method known in the art that includes pretreatment, enzymatic hydrolysis (saccharification), fermentation, or a combination thereof, can be used with the polymeric catalysts in the methods described herein. The polymeric catalysts can be used before or after pretreatment methods to make the cellulose (and hemicellulose, where present) in the biomass more accessible to hydrolysis.

The methods described can be performed in reactors or vessels under controlled pH, temperature, and mixing conditions. In some embodiments, the reaction mixture is agitated by a mixing device during the reaction. In other embodiments, the reaction mixture is not agitated. One skilled in the art would recognize that suitable processing time, temperature and pH conditions can vary depending on the amount and the nature of the cellulosic material. These factors are described in further detail below.

Solvent

In certain embodiments, the cellulosic material is contacted with the polymeric catalyst in an aqueous environment. One suitable aqueous solvent is water, which can be obtained from various sources. In some embodiments, water sources with lower concentrations of ionic species are used. In some embodiments where the aqueous solvent is water, the water has less than about 10% of ionic species (e.g., salts of sodium, phosphorous, ammonium, magnesium, or other species found naturally in lignocellulosic biomass).

Moreover, in embodiments where the cellulosic material is hydrolyzed into sugars, water is consumed on a mole-for-mole basis with the sugars produced. In certain embodiments, the methods described herein can further include monitoring the amount of water present in the reaction and/or the ratio of water to cellulosic material over a period of time. In other embodiments, the methods described herein can further include supplying water directly to the reaction, for example, in the form of steam or steam condensate. For example, in some embodiments, the hydration conditions in the reaction vessel are such that the water-to-cellulosic material ratio is about 5:1, about 4:1, about 3:1, about 2:1, about 1:1, about 1:2, about 1:3, about 1:4, about 1:5, or less than about 1:5. It should be understood, however, that the ratio of water to cellulosic material can be adjusted based on the specific polymeric catalyst used.

Processing Time, Temperature and pH Conditions

In some embodiments, the cellulosic material can be in contact with the polymeric catalyst for up to about 48 hours. In other embodiments, the cellulosic material can be in contact with the polymeric catalyst from less than about 10 hours, less than about 4 hours or less than about 1 hour.

In some embodiments, the cellulosic material can be in contact with the polymeric catalyst at temperature in the range of about 25° C. to about 150° C. In other embodiments, the cellulosic material can be in contact with the polymeric catalyst in the range of about 30° C. to about 140° C., or about 80° C. to about 130° C., or about 100° C. to about 130° C.

In some embodiments, the biomass has cellulose and hemicellulose, and the biomass is contacted with the polymer and the solvent at a temperature and/or at a pressure suitable to preferentially hydrolyze the cellulose or suitable to preferentially hydrolyze the hemicellulose.

The pH is generally affected by the intrinsic properties of the polymeric catalyst used. In some embodiments, the acidic moiety of the polymeric catalyst can affect the pH of the reaction to degrade the cellulosic material. For example, the use of the sulfonic acid moiety in a polymeric catalyst results in a reaction pH of about 3. In other embodiments, a pH between about 0 and about 6 is used to degrade the cellulosic material. The reacted effluent typically has a pH of at least about 4, or a pH that is compatible with other processes such as enzymatic treatment. It should be understood, however, that the pH can be modified and controlled by the addition of acids, bases or buffers.

Moreover, the pH can vary within the reaction vessel. For example, high acidity at or near the surface of the catalyst can be observed, whereas regions distal to the catalyst surface can have a substantially neutral pH. Thus, one of skill would recognize that determination of the solution pH should account for such spatial variation.

It should also be understood that, in certain embodiments, the methods described herein to degrade the cellulosic material can further include monitoring the reaction pH, and optionally adjusting the pH within the reaction vessel. In some embodiments, the pH near the surface of the polymeric catalyst is below about 7, below about 6, or below about 5.

Amount and Nature of the Cellulosic Material Used

The amount of the cellulosic material used in the methods described herein can be in a ratio relative to the amount solvent used. In some embodiments, the amount of the cellulosic material used can be characterized by the dry solids content. In certain embodiments, dry solids content refers to the total solids of a slurry as a percentage on a dry weight basis. In some embodiments, the dry solids content of the cellulosic materials is between about 5 wt % to about 95 wt %, between about 10 wt % to about 80 wt %, between about 15 to about 75 wt %, or between about 15 to about 50 wt %.

In some embodiments, the cellulosic material is pretreated as described above. Provided is also a method of hydrolyzing pretreated biomass to produce one or more sugars, by: a) providing biomass pretreated according any of the pretreatment methods described herein; and b) hydrolyzing the pretreated biomass to produce one or more sugars. In some embodiments, the pretreated biomass is chemically hydrolyzed or enzymatically hydrolyzed. In some embodiments, the one or more sugars are selected from the group consisting of glucose, galactose, fructose, xylose, and arabinose.

Amount of Polymeric Catalyst Used

The amount of polymeric catalyst used in the methods described herein can depend on several factors including, for example, type and composition of the cellulosic material used and the reaction conditions (e.g., temperature, time, and pH). In one embodiment, the weight ratio of the polymeric catalyst to the cellulosic material is about 0.1 g/g to about 50 g/g, about 0.1 g/g to about 25 g/g, about 0.1 g/g to about 10 g/g, about 0.1 g/g to about 5 g/g, about 0.1 g/g to about 2 g/g, about 0.1 g/g to about 1 g/g, or about 0.1 g/g to about 1.0 g/g.

Batch Versus Continuous Processing

Generally, the polymeric catalyst and the cellulosic material are introduced into an interior chamber of a reaction vessel, either concurrently or sequentially. The reaction can be performed in a batch process or a continuous process. For example, in one embodiment, the reaction is performed in a batch process, where the contents of the reaction vessel are continuously mixed or blended, and all or a substantial amount of the products of the reaction are removed. In one variation, the reaction is performed in a batch process, where the contents of the reaction vessel are initially intermingled or mixed, but no further physical mixing is performed. In another variation, the reaction is performed in a batch process, wherein once further mixing of the contents, or periodic mixing of the contents of the reaction vessel, is performed (e.g., at one or more times per hour), all or a substantial amount of the products of the reaction are removed after a certain period of time.

In other embodiments, the reaction is performed in a continuous process, where the contents flow through the reaction vessel with an average continuous flow rate but with no explicit mixing. After introduction of the polymeric catalyst and the cellulosic material into the reaction vessel, the contents of the reaction vessel are continuously or periodically mixed or blended, and after a period of time, less than all of the products of the reaction are removed. In one variation, the reaction is performed in a continuous process, where the mixture containing the catalyst and cellulosic material is not actively mixed. Additionally, mixing of catalyst and the cellulosic material can occur as a result of the redistribution of polymeric catalysts settling by gravity, or the non-active mixing that occurs as the material flows through a continuous reaction vessel.

Reaction Vessels

The reaction vessels used for the methods described herein can be open or closed reaction vessels suitable for use in containing the chemical reactions described herein. In some embodiments, the reaction vessel can be of lab bench scale, such as a glass vial or flask. On larger scales, suitable reaction vessels can include, for example, a fed-batch stirred reactor, a batch stirred reactor, a continuous flow stirred reactor with ultrafiltration, a continuous plug-flow column reactor, an attrition reactor, or a reactor with intensive stirring induced by an electromagnetic field. See e.g., Fernanda de Castilhos Corazza, Flavio Faria de Moraes, Gisella Maria Zanin and Ivo Neitzel, Optimal control in fed-batch reactor for the cellobiose hydrolysis, Acta Scientiarum. Technology, 25: 33-38 (2003); Gusakov, A. V., and Sinitsyn, A. P., Kinetics of the enzymatic hydrolysis of cellulose: 1. A mathematical model for a batch reactor process, Enz. Microb. Technol., 7: 346-352 (1985); Ryu, S. K., and Lee, J. M., Bioconversion of waste cellulose by using an attrition bioreactor, Biotechnol. Bioeng. 25: 53-65(1983); Gusakov, A. V., Sinitsyn, A. P., Davydkin, I. Y., Davydkin, V. Y., Protas, O. V., Enhancement of enzymatic cellulose hydrolysis using a novel type of bioreactor with intensive stirring induced by electromagnetic field, Appl. Biochem. Biotechnol., 56: 141-153(1996). Other suitable reactor types can include, for example, fluidized bed, upflow blanket, immobilized, and extruder type reactors for hydrolysis and/or fermentation.

In certain embodiments where the reaction is performed as a continuous process, the reaction vessel can include a continuous mixer, such as a screw mixer in larger scale reactions or a stir bar for smaller scales. The reaction vessels can be generally fabricated from materials that are capable of withstanding the physical and chemical forces exerted during the processes described herein. In some embodiments, such materials used for the reaction vessel are capable of tolerating high concentrations of strong liquid acids; however, in other embodiments, such materials may not be resistant to strong acids.

At the start of the hydrolysis on larger scale, the reaction vessel can be filled with cellulosic material by a top-load feeder containing a hopper capable of holding cellulosic material. Further, the reaction vessel typically contains an outlet means for removal of contents (e.g., a sugar-containing solution) from the reaction vessel. Optionally, such outlet means is connected to a device capable of processing the contents removed from the reaction vessel. Alternatively, the removed contents are stored. In some embodiments, the outlet means of the reaction vessel is linked to a continuous incubator into which the reacted contents are introduced. Further, the outlet means provides for removal of residual cellulosic material by, e.g., a screw feeder, by gravity, or a low shear screw.

It should also be understood that additional cellulosic material and/or catalyst can be added to the reaction vessel, either at the same time or one after the other.

Recovery of Sugars

In some embodiments, the methods described herein further include recovering the sugars that are produced from the hydrolysis of the cellulosic material. In another embodiment, the methods for degrading cellulosic material using the polymeric catalysts described herein further include recovering the degraded or converted cellulosic material.

The sugars, which are typically soluble, can be separated from the insoluble residual cellulosic material using technology well known in the art such as, for example, centrifugation, hydroseparation, filtration, and gravity settling.

Separation of the sugars can be performed in the hydrolysis reaction vessel or in a separator vessel. In an exemplary embodiment, the method for degrading cellulosic material is performed in a system with a hydrolysis reaction vessel and a separator vessel. Reaction vessel effluent containing the monosaccharides and/or oligosaccharides is transferred into a separator vessel and is washed with a solvent (e.g., water), by adding the solvent into the separator vessel and then separating the solvent in a continuous centrifuge. Alternatively, in another exemplary embodiment, a reaction vessel effluent containing residual solids (e.g., residual cellulosic materials) is removed from the reaction vessel and washed, for example, by conveying the solids on a porous base (e.g., a mesh belt) through a solvent (e.g., water) wash stream. Following contact of the stream with the reacted solids, a liquid phase containing the monosaccharides and/or oligosaccharides is generated. Optionally, residual solids can be separated by a cyclone. Suitable types of cyclones used for the separation can include, for example, tangential cyclones, spark and rotary separators, and axial and multi-cyclone units.

In another embodiment, separation of the sugars is performed by batch or continuous differential sedimentation. Reaction vessel effluent is transferred to a separation vessel, optionally combined with water and/or enzymes for further treatment of the effluent. Over a period of time, solid biomaterials (e.g., residual treated biomass), the solid catalyst, and the sugar-containing aqueous material can be separated by differential sedimentation into a plurality of phases (or layers). Generally, the catalyst layer can sediment to the bottom, and depending on the density of the residual biomass, the biomass phase can be on top of, or below, the aqueous phase. When the phase separation is performed in a batch mode, the phases are sequentially removed, either from the top of the vessel or an outlet at the bottom of the vessel. When the phase separation is performed in a continuous mode, the separation vessel contains one or more than one outlet means (e.g., two, three, four, or more than four), generally located at different vertical planes on a lateral wall of the separation vessel, such that one, two, or three phases are removed from the vessel. The removed phases are transferred to subsequent vessels or other storage means. By these processes, one of skill in the art would be able to capture (1) the catalyst layer and the aqueous layer or biomass layer separately, or (2) the catalyst, aqueous, and biomass layers separately, allowing efficient catalyst recycling, retreatment of biomass, and separation of sugars. Moreover, controlling rate of phase removal and other parameters allows for increased efficiency of catalyst recovery. Subsequent to removal of each of the separated phases, the catalyst and/or biomass can be separately washed by the aqueous layer to remove adhered sugar molecules.

In some embodiments, the sugars isolated from the vessel can be subjected to further processing steps (e.g., as in drying, fermentation) to produce biofuels and other bio-products. In some embodiments, the monosaccharides that are isolated can be at least about 1% pure, at least about 5% pure, at least about 10% pure, at least about 20% pure, at least about 40% pure, at least about 60% pure, at least about 80% pure, at least about 90% pure, at least about 95% pure, at least about 99% pure, or greater than about 99% pure, as determined by analytical procedures known in the art, such as, but not limited to, determination by high performance liquid chromatography (HPLC), functionalization and analysis by gas chromatography, mass spectrometry, spectrophotometric procedures based on chromophore complexation and/or carbohydrate oxidation-reduction chemistry.

The residual biomass isolated from the vessels can be useful as a combustion fuel or as a feed source of non-human animals such as livestock.

Rate and Yield

The use of the polymeric catalysts described herein can increase the rate and/or yield of saccharification compared to other methods known in the art. The ability of the polymeric catalyst to hydrolyze the cellulose and hemicellulose components of the cellulosic material to soluble sugars can be measured by determining the effective first-order rate constant,

$${k}_{1} ( species i ) = - \frac{ln ( 1 - {X}_{i} )}{Δ t} ,$$

where Δt is the duration of the reaction and Xᵢ is the extent of reaction for species i (e.g., glucan, xylan, arabinan). In some embodiments, the polymeric catalysts described herein are capable of degrading the cellulosic material into one or more sugars at a first-order rate constant of at least about 0.001 per hour, at least about 0.01 per hour, at least about 0.1 per hour, at least about 0.2 per hour, at least about 0.3 per hour, at least about 0.4 per hour, at least about 0.5 per hour, or at least about 0.6 per hour.

The hydrolysis yield of the cellulose and hemicellulose components of the cellulosic material to soluble sugars by the polymeric catalyst can be measured by determining the degree of polymerization of the residual cellulosic material. The lower the degree of polymerization of the residual cellulosic material, the greater the hydrolysis yield. In some embodiments, the polymeric catalysts described herein are capable of converting cellulosic material into one or more sugars and residual cellulosic material, wherein the residual cellulosic material has a degree of polymerization of less than about 300, less than about 250, less than about 200, less than about 150, less than about 100, less than about 90, less than about 80, less than about 70, less than about 60, or less than about 50.

d) Saccharide Composition

The polymeric catalysts described above can be used to degrade cellulosic materials into a saccharide composition. In some embodiments, the saccharide composition can be in the form of a hydrolysate, produced from the hydrolysis of the cellulosic materials.

Saccharification refers to the hydrolysis of cellulosic materials (e.g., biomass) into one or more saccharides (or sugars) by breaking down the complex carbohydrates of cellulose (and hemicellulose, where present) in the biomass. In some embodiments, the biomass has cellulose, hemicellulose, or a combination thereof. In yet other embodiments, the biomass also has lignin. The one or more sugars can be monosaccharides and/or oligosaccharides. As used herein, “oligosaccharide” refers to a compound containing two or more monosaccharide units linked by glycosidic bonds. In certain embodiments, the one or more sugars are selected from glucose, cellobiose, xylose, xylulose, arabinose, mannose and galactose. In other embodiments, the one or more sugars are selected from glucose, galactose, fructose, xylose, and arabinose.

It should be understood that the cellulosic material can be subjected to a one-step or a multi-step hydrolysis process. For example, in some embodiments, the cellulosic material is first contacted with the polymeric catalyst, and then the resulting product is contacted with one or more enzymes in a second hydrolysis reaction (e.g., using enzymes).

In some embodiments, the saccharide composition includes at least one C5 saccharide and at least one C6 saccharide. A “C5 saccharide” refers to a five-carbon sugar (or pentose), whereas a “C6 saccharide” refers to a six-carbon sugar (or hexose). Examples of C5 saccharides include, but are not limited to, arabinose, lyxose, ribose, xylose, ribulose, and xylulose. Examples of C6 saccharides include, but are not limited to, allose, altrose, glucose, mannose, gulose, idose, galactose, talose, psicose, fructose, sorbose and tagatose. These saccharides can have chiral centers, and in some embodiments, the saccharide composition can include C5 saccharides and/or C6 saccharides that can be present as either the D- or L-isomer. In some embodiments, one isomer can be present in a greater amount that the other isomer. In other embodiments, the saccharide composition can include a racemic mixture of the C5 saccharides and/or C6 saccharides.

In some embodiments, the sugar composition has at least about 0.1%, at least about 0.2%, at least about 0.3%, at least about 0.4%, at least about 0.5%, at least about 0.6%, at least about 0.7%, at least about 0.8%, at least about 0.9%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, or at least about 15% by weight a mixture of sugars, wherein the mixture of sugars comprises one or more C4-C6 monosaccharides and one or more oligosaccharides.

In certain embodiments, the saccharide composition includes at least one C5 saccharide and at least one C6 saccharide in a ratio suitable for fermentation to produce ethylene glycol or other fermentation products. In one embodiment, the saccharide composition includes two C5 saccharides and one C6 saccharide present in a ratio suitable for fermentation to produce one or more components suitable for use in a bio-based polymer.

For example, in one embodiment, the saccharide composition includes xylose, glucose and arabinose. In one embodiment, the xylose, glucose and arabinose can be present in a ratio of at least about 5 to about 1 to about 1, at least about 10 to about 1 to about 1, at least about 15 to about 1 to about 1, at least about 20 to about 1 to about 1. In one embodiment, the xylose, glucose and arabinose is present in a ratio of about 20 to about 1 to about 1. In another embodiment, the xylose, glucose and arabinose can be present in a ratio of about 1 to about 2 to about 1, about 1 to about 5 to about 1, about 1 to about 7 to about 1, or about 1 to about 10 to about 1. In another embodiment, the xylose, glucose and arabinose can be present in a ratio of about 1 to about 10 to about 1, about 1 to about 20 to about 1, about 1 to about 50 to about 1, about 1 to about 70 to about 1, or about 1 to about 100 to about 1. In yet another embodiment, the xylose, glucose, and arabinose is present in a ratio of about 10 to about 10 to about 1. In some embodiments, the xylose, glucose and arabinose can be present in a ratio of at least about 1 to about 0.1 to about 1, at least about 1 to about 0.5 to about 1, at least about 1 to about 1 to about 1, at least about 1 to about 1.5 to about 1, or at least about 1 to about 2 to about 1. In some embodiments, the xylose, glucose and arabinose can be present in a ratio of at least about 0.1 to about 1 to about 1, at least about 0.5 to about 1 to about 1, at least about 1.5 to about 1 to about 1, or at least about 2 to about 1 to about 1.

It should be understood that the ratio of the C5 and C6 saccharides present in saccharide composition can be varied based on the reaction conditions described above in degrading cellulosic materials. Further, it should be understood that obtaining a given ratio of the saccharides can vary depending the types of saccharides, the component of the bio-based polymer produced by fermentation, and the type of fermentation host used, as further described below.

In other embodiments, the saccharide composition has a concentration suitable for fermentation without prior concentration (e.g., by evaporation). It should also be understood that the saccharide composition can vary based on the type of cellulosic material used, as well as the reaction conditions described above in degrading cellulosic material.

The one or more sugars obtained from hydrolysis of cellulosic material can be used in a subsequent fermentation process to produce biofuels (e.g., ethanol) and other bio-based chemicals (e.g., bio-based polymers). For example, in some embodiments, the one or more sugars obtained by the methods described herein can undergo subsequent bacterial or yeast fermentation to produce biofuels and other bio-based chemicals. In certain embodiments, the ratio and concentration of sugars present in the saccharide composition can be varied depending on the fermentation host.

Provided herein is a chemically-hydrolyzed biomass composition having at least one polymeric catalyst, one or more sugars, and residual biomass. The one or more sugars can be one or more monosaccharides, one or more oligosaccharides, or a mixture thereof. In some embodiments, the one or more sugars can be two or more sugars having at least one C4-C6 monosaccharide and at least one oligosaccharide. The sugars can be selected from glucose, galactose, fructose, xylose, and arabinose.

### Methods for Degrading Biomass

Disclosed herein are methods for degrading biomass into one or more sugars, that include:

a) providing biomass;

b) combining the biomass with a polymeric catalyst for a period of time sufficient to produce a degraded mixture, wherein the degraded mixture comprises a liquid phase and a solid phase, wherein the liquid phase comprises one or more sugars, and wherein the solid phase comprises residual biomass;

c) isolating at least a portion of the liquid phase from the solid phase; and

d) recovering the one or more sugars from the isolated portion of the liquid phase.

The biomass can contain cellulose, hemicellulose, or a combination thereof. In some embodiments, a solvent, such as water, is added to the biomass and the polymeric catalyst.

In some embodiments, the biomass is combined with a composition having an effective amount of the polymeric catalyst. In some embodiments, the residual biomass has a portion of this composition. The composition can be isolated from the solid phase, either before or after isolation step c). In some embodiments, isolating a portion of the composition from the solid phase occurs substantially contemporaneously with step c). “Substantially contemporaneously” as used herein refers to two or more steps occurring during time periods that overlap at least about 5%, at least about 10%, at least about 20%, at least about 30%, at least about 40% or at least about 50% of the time.

In some embodiments, the biomass includes cellulose and hemicellulose, and during the above method, the biomass is combined with the polymer at a temperature and at a pressure suitable to

a) hydrolyze the cellulose to a greater extent than the hemicellulose, or

b) hydrolyze the hemicellulose to a greater extent than the cellulose.

Further, in some embodiments, isolating at least a portion of the liquid phase from the solid phase in step c) produces a residual biomass mixture. The method further includes:

i) providing a second biomass;

ii) combining the second biomass with the residual biomass mixture for a period of time sufficient to produce a second degraded mixture, wherein the second degraded mixture comprises a second liquid phase and a second solid phase, wherein the second liquid phase comprises one or more second sugars, and wherein the second solid phase comprises second residual biomass;

iii) isolating at least a portion of the second liquid phase from the second solid phase; and

iv) recovering the one or more second sugars from the isolated second liquid phase.

In some embodiments, the second biomass comprises cellulose, hemicellulose, or a combination thereof. In other embodiments, the residual biomass mixture comprises at least a portion of the composition that has an effective amount of the polymeric catalyst.

In some embodiments, the second biomass and the residual biomass mixture are combined with a second polymer as disclosed herein. In some embodiments, the second biomass and the residual biomass mixture are combined with a second solvent, such as water. In some embodiments, the second residual biomass has at least a portion of the composition that has an effective amount of the polymeric catalyst. This composition, or a portion thereof, can be isolated from the second residual biomass. The portion can be isolated from the second solid phase, either before or after step iv). In some embodiments, isolating a portion of the composition from the second solid phase occurs substantially contemporaneously with step iv).

The one or more sugars produced in these methods can be selected from one or more monosaccharides, one or more oligosaccharides, or a combination thereof. The one or more monosaccharides can include one or more C4-C6 monosaccharides. The monosaccharides can be selected from glucose, galactose, fructose, xylose, and arabinose.

In some embodiments, the biomass can be pretreated before combining the biomass with the polymer. In some embodiments, the second biomass can be pretreated before combining the second biomass with the residual biomass mixture. Pretreatment methods can include, but are not limited to, washing, solvent-extraction, solvent-swelling, comminution, milling, steam pretreatment, explosive steam pretreatment, dilute acid pretreatment, hot water pretreatment, alkaline pretreatment, lime pretreatment, wet oxidation, wet explosion, ammonia fiber explosion, organosolvent pretreatment, biological pretreatment, ammonia percolation, ultrasound, electroporation, microwave, supercritical CO₂, supercritical H₂O, ozone, and gamma irradiation, or any combination thereof.

Disclosed herein is a method for pretreating biomass before hydrolysis of the biomass to produce one or more sugars, comprising:

a) providing biomass;

b) combining the biomass with a disclosed polymer for a period of time sufficient to partially degrade the biomass; and

c) pretreating the partially degraded biomass before hydrolysis to produce one or more sugars.

Step b) can further include combining the biomass and the polymer with a solvent, such as water. The biomass of step a) can include cellulose, hemicellulose, or a combination thereof. In some embodiments, pretreating the partially degraded biomass can include washing, solvent-extraction, solvent-swelling, comminution, milling, steam pretreatment, explosive steam pretreatment, dilute acid pretreatment, hot water pretreatment, alkaline pretreatment, lime pretreatment, wet oxidation, wet explosion, ammonia fiber explosion, organosolvent pretreatment, biological pretreatment, ammonia percolation, ultrasound, electroporation, microwave, supercritical CO₂, supercritical H₂O, ozone, and gamma irradiation, or a combination thereof.

Further, the pretreated partially degraded biomass can be hydrolyzed to produce one or more sugars. Either chemical or enzymatic hydrolysis methods can be used. The one or more sugars can include glucose, galactose, fructose, xylose, and arabinose.

### Fermentation of the Saccharide Composition

The saccharide composition obtained from hydrolysis of cellulosic material can be used in downstream processes to produce biofuels and other bio-based chemicals. In one embodiment, the saccharide composition obtained from hydrolysis of cellulosic material can be used to produce bio-based polymers, or component(s) thereof. In other embodiments, the saccharide composition obtained from hydrolysis of cellulosic material using the polymeric catalyst described herein can be fermented to produce one or more downstream products (e.g., ethanol and other biofuels, polymers, vitamins, lipids, proteins).

a) Fermentation Product Mixture

The saccharide composition can undergo fermentation to produce one or more difunctional compounds. Such difunctional compounds can have an n-carbon chain, with a first functional group and a second functional group. In some embodiments, the first and second functional groups can be independently selected from —OH, —NH₂, —COH, and —COOH.

The difunctional compounds can include, but are not limited to, alcohols, carboxylic acids, hydroxyacids, or amines. Exemplary difunctional alcohols can include ethylene glycol, 1,3-propanediol, and 1,4-butanediol. Exemplary difunctional carboxylic acids can include succinic acid, adipic acid, and pimelic acid. Exemplary difunctional hydroxyacids can include glycolic acid and 3-hydroxypropanoic acid. Exemplary difunctional amines can include 1,4-diaminobutane, 1,5-diaminopentane, and 1,6-diaminohexane.

In some embodiments, the methods described herein include contacting the saccharide composition with a fermentation host to produce a fermentation product mixture that can include ethylene glycol, succinic acid, adipic acid, or butanediol, or a combination thereof.

In some embodiments, the difunctional compounds can be isolated from the fermentation product mixture, and/or further purified. Any suitable isolation and purification techniques known in the art can be used.

b) Fermentation Host

The fermentation host can be bacteria or yeast. In one embodiment, the fermentation host is bacteria. In some embodiments, the bacteria are classified in the family of Enterobacteriaceae. Examples of genera in the family include Aranicola, Arsenophonus, Averyella, Biostraticola, Brenneria, Buchnera, Budvicia, Buttiauxella, Candidatus, Curculioniphilus, Cuticobacterium, Candidatus Ishikawaella, Macropleicola, Phlomobacter, Candidatus Riesia, Candidatus Stammerula, Cedecea, Citrobacter, Cronobacter, Dickeya, Edwardsiella, Enterobacter, Erwinia, Escherichia, Ewingella, Grimontella, Hafnia, Klebsiella, Kluyvera, Leclercia, Leminorella, Margalefia, Moellerella, Morganella, Obesumbacterium, Pantoea, Pectobacterium, Photorhabdus, Phytobacter, Plesiomonas, Pragia, Proteus, Providencia, Rahnella, Raoultella, Salmonella, Samsonia, Serratia, Shigella, Sodalis, Tatumella, Thorasellia, Tiedjeia, Trabulsiella, Wigglesworthia, Xenorhabdus, Yersinia, and Yokenella. In one embodiment, the bacteria are Escherichia coli (E. coli).

In some embodiments, the fermentation host is genetically modified. In one embodiment, the fermentation host is genetically modified E. coli. For example, the fermentation host can be genetically modified to enhance the efficiency of specific pathways encoded by certain genes. In one embodiment, the fermentation host can be modified to enhance expression of endogenous genes that can positively regulate specific pathways. In another embodiment, the fermentation host can be further modified to suppress expression of certain endogenous genes.

c) Fermentation Conditions

Any suitable fermentation conditions in the art can be employed to ferment the saccharide composition described herein to produce bio-based products, and components thereof.

In some embodiments, saccharification described above can be combined with fermentation in a separate or a simultaneous process. The fermentation can use the aqueous sugar phase or, if the sugars are not substantially purified from the reacted biomass, the fermentation can be performed on a mixture of sugars and reacted biomass. Such methods include, for example, separate hydrolysis and fermentation (SHF), simultaneous saccharification and fermentation (SSF), simultaneous saccharification and cofermentation (SSCF), hybrid hydrolysis and fermentation (HHF), separate hydrolysis and co-fermentation (SHCF), hybrid hydrolysis and co-fermentation (HHCF), and direct microbial conversion (DMC).

For example, SHF uses separate process steps to first enzymatically hydrolyze cellulosic material to fermentable sugars (e.g., glucose, cellobiose, cellotriose, and pentose sugars), and then ferment the sugars to ethanol.

In SSF, the enzymatic hydrolysis of cellulosic material and the fermentation of sugars to ethanol are combined in one step. See Philippidis, G. P., Cellulose bioconversion technology, in Handbook on Bioethanol: Production and Utilization, Wyman, C. E., ed., Taylor & Francis, Washington, D.C., 179-212 (1996).

SSCF involves the cofermentation of multiple sugars. See Sheehan, J., and Himmel, M., Enzymes, energy and the environment: A strategic perspective on the U.S. Department of Energy's research and development activities for bioethanol, Biotechnol. Prog., 15: 817-827 (1999).

HHF involves a separate hydrolysis step, and in addition a simultaneous saccharification and hydrolysis step, which can be carried out in the same reaction vessel. The steps in an HHF process can be carried out at different temperatures; for example, high temperature enzymatic saccharification followed by SSF at a lower temperature that the fermentation strain can tolerate.

DMC combines all three processes (enzyme production, hydrolysis, and fermentation) in one or more steps where the same organism is used to produce the enzymes for conversion of the cellulosic material to fermentable sugars and to convert the fermentable sugars into a final product. See Lynd, L. R., Weimer, P. J., van Zyl, W. H., and Pretorius, I. S., Microbial cellulose utilization: Fundamentals and biotechnology, Microbiol. Mol. Biol. Reviews, 66: 506-577 (2002).

### General Methods of Preparing the Polymeric Catalysts

The solid-supported acid catalysts described herein can be formed by attaching one or more catalytic chemical moieties to the chemically accessible components of the solid support using any chemical reactions suitable to functionalize carboxyl, amino, silyl, phenol, graphene, alcohol, or aldehyde groups on the solid support. For example, these solid-supported acid catalysts can be formed by first activating an inert solid matrix to attach reactive sites to the solid matrix. One of skill in the art would recognize the various methods and techniques that may be employed to activate inert solids. For instance, the solid may be treated with a strong acid or a strong base to increase the density of heteroatomic species covalently bonded to the solid matrix. The activated solid matrix can then be functionalized with acid groups or ionic groups by chemically attaching them to the activated sites.

The polymers described herein can be made using polymerization techniques known in the art, including, for example, techniques to initiate polymerization of a plurality of monomer units.

In some embodiments, the polymeric catalysts described herein can be formed by first forming an intermediate polymer functionalized with the ionic group, but is free or substantially free of the acidic group. The intermediate polymer can then be functionalized with the acidic group. In other embodiments, the polymeric catalysts described herein can be formed by first forming an intermediate polymer functionalized with the acidic group, but is free or substantially free of the ionic group. The intermediate polymer can then be functionalized with the ionic group. In yet other embodiments, the polymeric catalysts described herein can be formed by polymerizing monomers with both acidic and ionic groups.

Provided is also a method of preparing any of the polymers described herein, by:

a) providing a starting polymer;

b) combining the starting polymer with a nitrogen-containing compound or phosphorous-containing compound to produce an ionic polymer having at least one cationic group;

and c) combining the ionic polymer with an effective acidifying reagent to produce an intermediate polymer; and

d) combining the intermediate polymer with an effective amount of one or more ionic salts to produce the polymer;

wherein the steps a), b), c), and d) are performed in the order a), b), c), and d); or in the order a), c), d), and b); or in the order a), c), b), and d).

In some embodiments, the starting polymer is selected from polyethylene, polypropylene, polyvinyl alcohol, polycarbonate, polystyrene, polyurethane, or a combination thereof. In certain embodiments, the starting polymer is a polystyrene. In certain embodiments, the starting polymer is poly(styrene-co-vinylbenzylhalide-co-divinylbenzene). In another embodiment, the starting polymer is poly(styrene-co-vinylbenzylchloride-co-divinylbenzene).

In some embodiments of the method to prepare any of the polymers described herein, the nitrogen-containing compound is selected from a pyrrolium compound, an imidazolium compound, a pyrazolium compound, an oxazolium compound, a thiazolium compound, a pyridinium compound, a pyrimidinium compound, a pyrazinium compound, a pyradizimium compound, a thiazinium compound, a morpholinium compound, a piperidinium compound, a piperizinium compound, and a pyrollizinium compound. In certain embodiments, the nitrogen-containing compound is an imidazolium compound.

In some embodiments of the method to prepare any of the polymers described herein, the phosporus-containing compound is selected from a triphenyl phosphonium compound, a trimethyl phosphonium compound, a triethyl phosphonium compound, a tripropyl phosphonium compound, a tributyl phosphonium compound, a trichloro phosphonium compound, and a trifluoro phosphonium compound.

In some embodiments of the method to prepare any of the polymers described herein, the acid is selected from sulfuric acid, phosphoric acid, hydrochloric acid, acetic acid and boronic acid. In one embodiment, the acid is sulfuric acid.

In some embodiments, the ionic salt is selected from lithium chloride, lithium bromide, lithium nitrate, lithium sulfate, lithium phosphate, sodium chloride, sodium bromide, sodium sulfate, sodium hydroxide, sodium phosphate, potassium chloride, potassium bromide, potassium nitrate, potassium sulfate, potassium phosphate, ammonium chloride, ammonium bromide, ammonium phosphate, ammonium sulfate, tetramethylammonium chloride, tetramethylammonium bromide, tetraethylammonium chloride, di-methylimidazolium chloride, methylbutylimidazoliumchloride, di-methylmorpholinium chloride, zinc (II) chloride, zinc (II) bromide, magnesium (II) chloride, and calcium (II) chloride.

Provided is also a method of preparing any of the polymers described herein having a polystyrene backbone, by: a) providing a polystyrene; b) reacting the polystyrene with a nitrogen-containing compound to produce an ionic polymer; and c) reacting the ionic polymer with an acid to produce a third polymer. In certain embodiments, the polystyrene is poly(styrene-co-vinylbenzylhalide-co-divinylbenzene). In one embodiment, the polystyrene is poly(styrene-co-vinylbenzylchloride-co-divinylbenzene).

In some embodiments of the method to prepare any of the polymers described herein having a polystyrene backbone, the nitrogen-containing compound is selected from a pyrrolium compound, an imidazolium compound, a pyrazolium compound, an oxazolium compound, a thiazolium compound, a pyridinium compound, a pyrimidinium compound, a pyrazinium compound, a pyradizimium compound, a thiazinium compound, a morpholinium compound, a piperidinium compound, a piperizinium compound, and a pyrollizinium compound. In certain embodiments, the nitrogen-containing compound is an imidazolium compound.

In some embodiments of the method to prepare any of the polymers described herein having a polystyrene backbone, the acid is selected from sulfuric acid, chlorosulfonic acid, phosphoric acid, hydrochloric acid, acetic acid and boronic acid. In one embodiment, the acid is sulfuric acid.

In some embodiments, the polymer has one or more catalytic properties selected from:

a) disruption of at least one hydrogen bond in cellulosic materials;

b) intercalation of the polymer into crystalline domains of cellulosic materials; and

c) cleavage of at least one glycosidic bond in cellulosic materials.

Provided herein are also such intermediate polymers, including those obtained at different points within a synthetic pathway for producing the fully functionalized polymers described herein. In some embodiments, the polymers described herein can be made, for example, on a scale of at least about 100 g, at least about 1 kg, at least about 20 kg, at least about 100 kg, at lest about 500 kg, or at least about 1 ton in a batch or continuous process.

The entire disclosure of each of the patent documents and non-patent literature referred to herein is incorporated by reference in its entirety for all purposes. This application incorporates by reference in its entirety U.S. application Ser. No. 13/406,490, U.S. application Ser. No. 13/406,517, and U.S. application Ser. No. 13/657,724.

### ENUMERATED EMBODIMENTS

The following enumerated embodiments are representative of some aspects of the invention.

1. A polymer comprising acidic monomers and ionic monomers connected to form a polymeric backbone,

wherein a plurality of acidic monomers independently comprises at least one Bronsted-Lowry acid in acidic form, and at least one Bronsted-Lowry acid in conjugate base form having at least one associated cationic moiety, wherein at least one of the acidic monomers comprises a linker connecting the Bronsted-Lowry acid in conjugate base form to the polymeric backbone,

wherein each ionic monomer independently comprises at least one nitrogen-containing cationic group or phosphorous-containing cationic group, and

wherein at least one of the ionic monomers comprises a linker connecting the nitrogen-containing cationic group or the phosphorous-containing cationic group to the polymeric backbone.

2. The polymer according to embodiment 1, wherein the acidic monomers are each independently selected from Formulas IA-VIA:

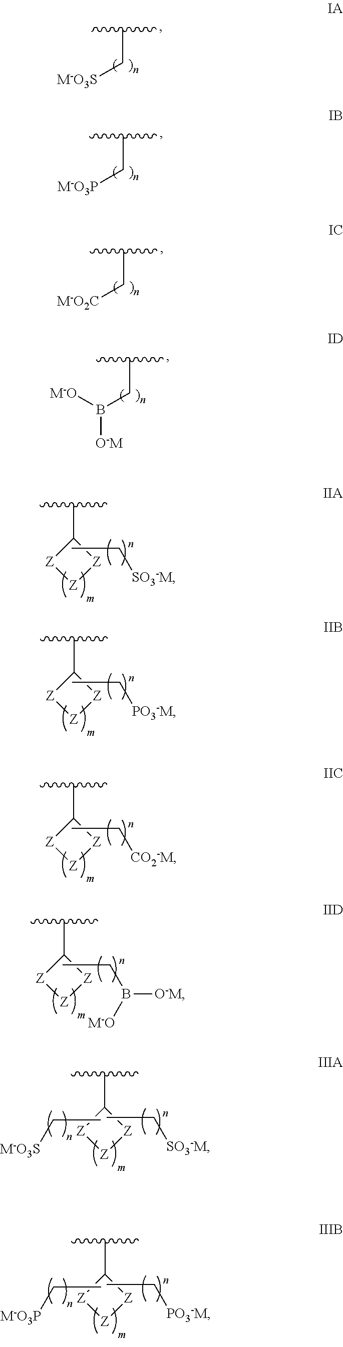

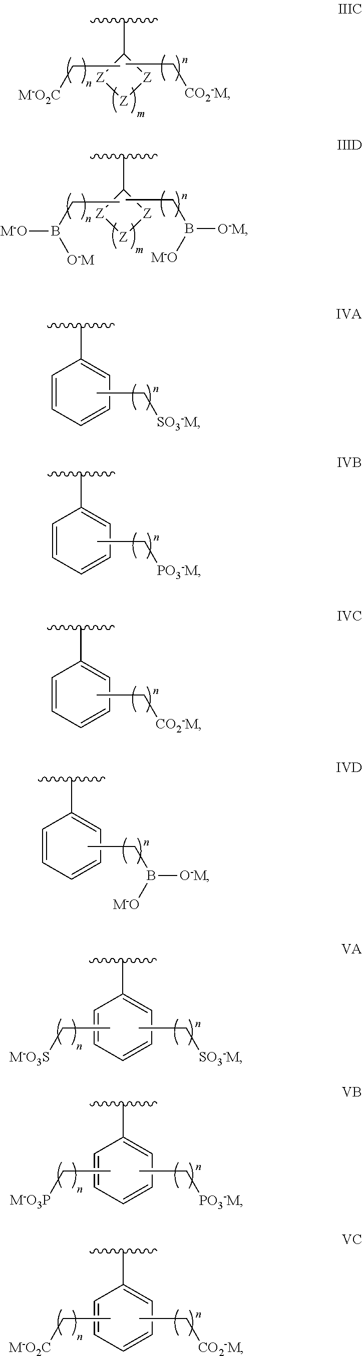

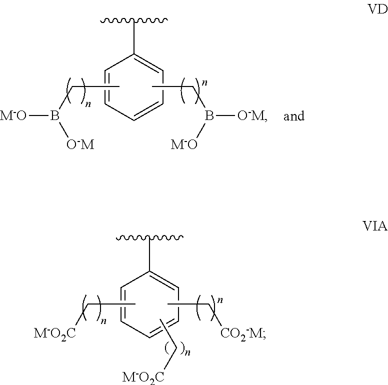

wherein for the Bronsted-Lowry acid in acidic form, at least one M in a Formula selected from IA-VIA is hydrogen;

wherein for the Bronsted-Lowry acid in conjugate base form having at least one associated cationic moiety, each M is independently selected from Li⁺, Na⁺, K⁺, N(R¹)₄⁺, Zn²⁺, Mg²⁺, and Ca²⁺, where Zn²⁺, Mg²⁺ and Ca²⁺ are each independently associated with at least two Bronsted-Lowry acids in conjugate base form at any M position on any acidic monomer;

each Z is independently selected from C(R²)(R³), N(R⁴), S, S(R⁵)(R⁶), S(O)(R⁵)(R⁶), SO₂, and O, where any two adjacent Z may be joined by a double bond;

each m is independently selected from 0, 1, 2, and 3;

each n is independently selected from 0, 1, 2, and 3;

each R¹, R², R³ and R⁴ is independently selected from hydrogen, alkyl, heteroalkyl, cycloalkyl, heterocyclyl, aryl, and heteroaryl;

each R⁵ and R⁶ is independently selected from alkyl, heteroalkyl, cycloalkyl, heterocyclyl, aryl, and heteroaryl; and

where any two adjacent Z can be taken together to form a group selected from cycloalkyl, heterocycloalkyl, aryl and heteroaryl.

3. The polymer according to embodiment 2, wherein each M is independently selected from Mg²⁺ and Ca²⁺.
4. The polymer according to embodiment 2 or 3, wherein at least one of the acidic monomers comprises a linker to form an acidic side chain, wherein each acidic side chain is independently selected from:

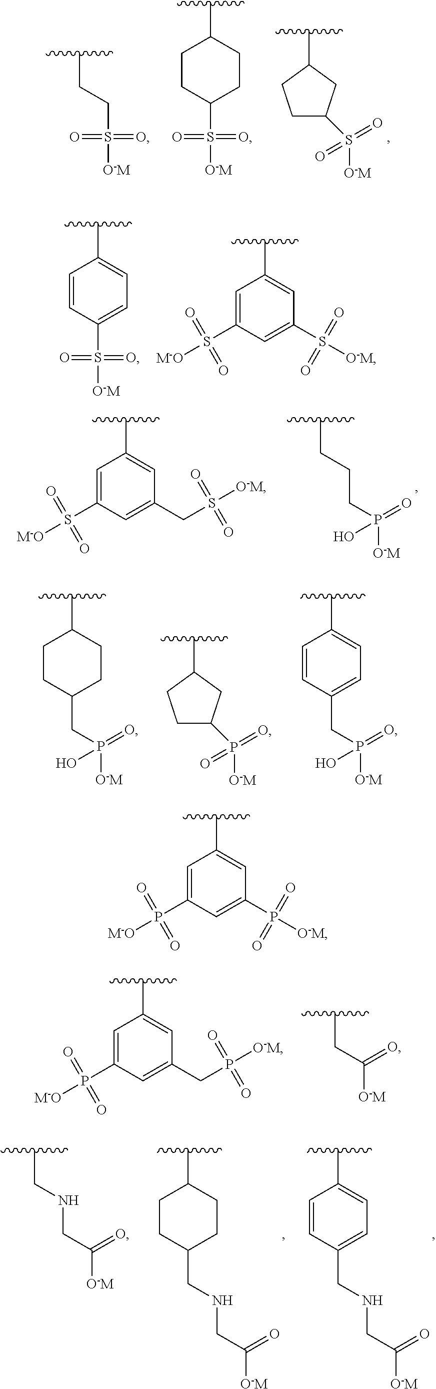

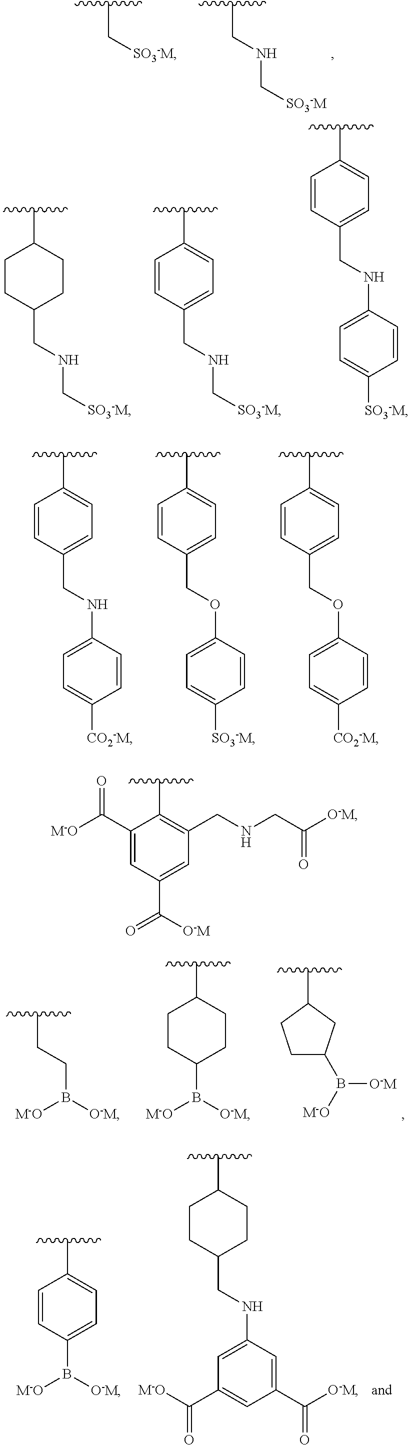

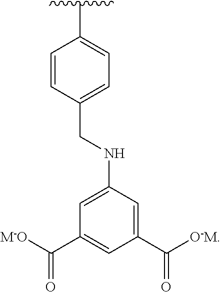

5. The polymer according to embodiment 4, wherein each acidic side chain is independently selected from:

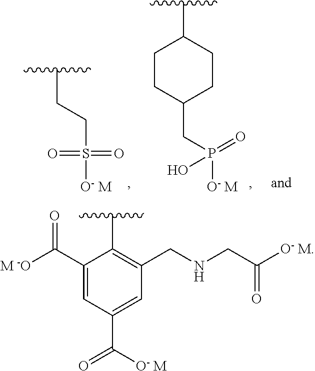

6. The polymer according to embodiment 4, wherein each acidic side chain is independently selected from:

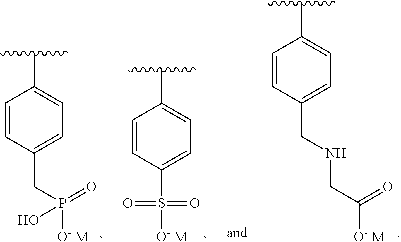

7. The polymer according to embodiment 4, wherein each acidic side chain is independently selected from:

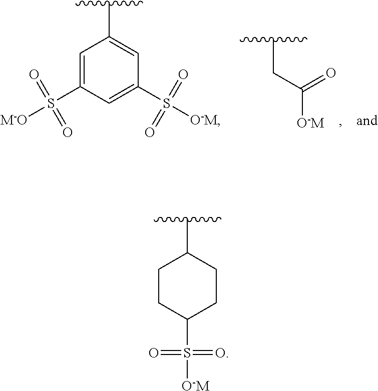

8. The polymer according to any one of embodiments 1 to 7, wherein the nitrogen-containing cationic group at each occurrence is independently selected from pyrrolium, imidazolium, pyrazolium, oxazolium, thiazolium, pyridinium, pyrimidinium, pyrazinium, pyradizimium, thiazinium, morpholinium, piperidinium, piperizinium, and pyrollizinium.
9. The polymer according to any one of embodiments 1 to 7, wherein the phosphorous-containing cationic group at each occurrence is independently selected from triphenyl phosphonium, trimethyl phosphonium, triethyl phosphonium, tripropyl phosphonium, tributyl phosphonium, trichloro phosphonium, and trifluoro phosphonium.
10. The polymer according to any one of embodiments 1 to 9, wherein each ionic monomer is independently selected from Formulas VIIA-XIB:

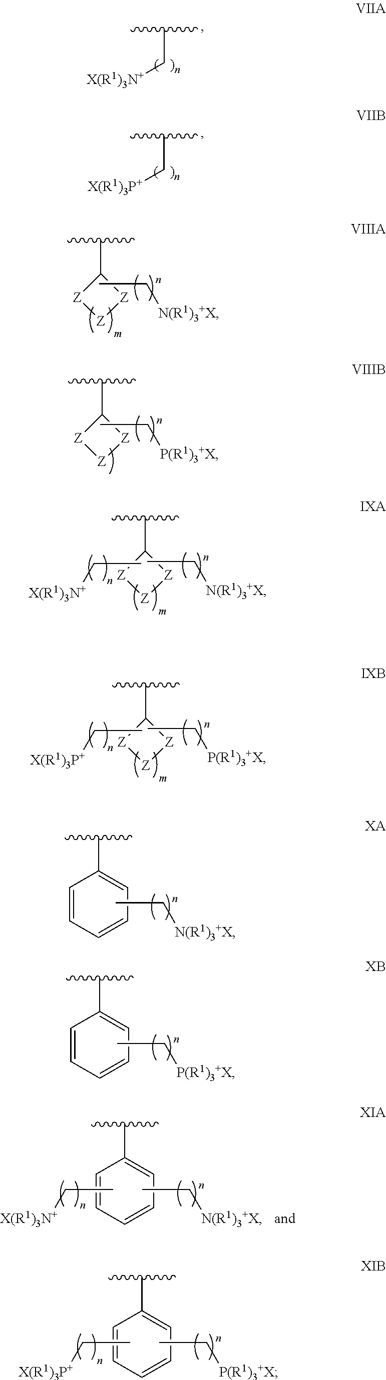

wherein each Z is independently selected from C(R²)(R³), N(R⁴), S, S(R⁵)(R⁶), S(O)(R⁵)(R⁶), SO₂, and O, where any two adjacent Z can be joined by a double bond;

each X is independently selected from F⁻, Cl⁻, Br⁻, I⁻, NO₂⁻, NO₃⁻, SO₄²⁻, R⁷SO₄⁻, R⁷CO₂⁻, PO₄²⁻, R⁷PO₃⁻, and R⁷PO₂⁻, where SO₄²⁻ and PO₄²⁻ are each independently associated with at least two cationic groups at any X position on any ionic monomer, and

each m is independently selected from 0, 1, 2, and 3;

each n is independently selected from 0, 1, 2, and 3;

each R¹, R², R³ and R⁴ is independently selected from hydrogen, alkyl, heteroalkyl, cycloalkyl, heterocyclyl, aryl, and heteroaryl;

each R⁵ and R⁶ is independently selected from alkyl, heteroalkyl, cycloalkyl, heterocyclyl, aryl, and heteroaryl;

where any two adjacent Z can be taken together to form a group selected from cycloalkyl, heterocycloalkyl, aryl and heteroaryl; and

each R⁷ is independently selected from hydrogen, C₁₋₄alkyl, and C₁₋₄heteroalkyl.

11. The polymer according to any one of embodiments 1 to 10, wherein the nitrogen-containing cationic group and the linker form a nitrogen-containing side chain, wherein each nitrogen-containing side chain is independently selected from:

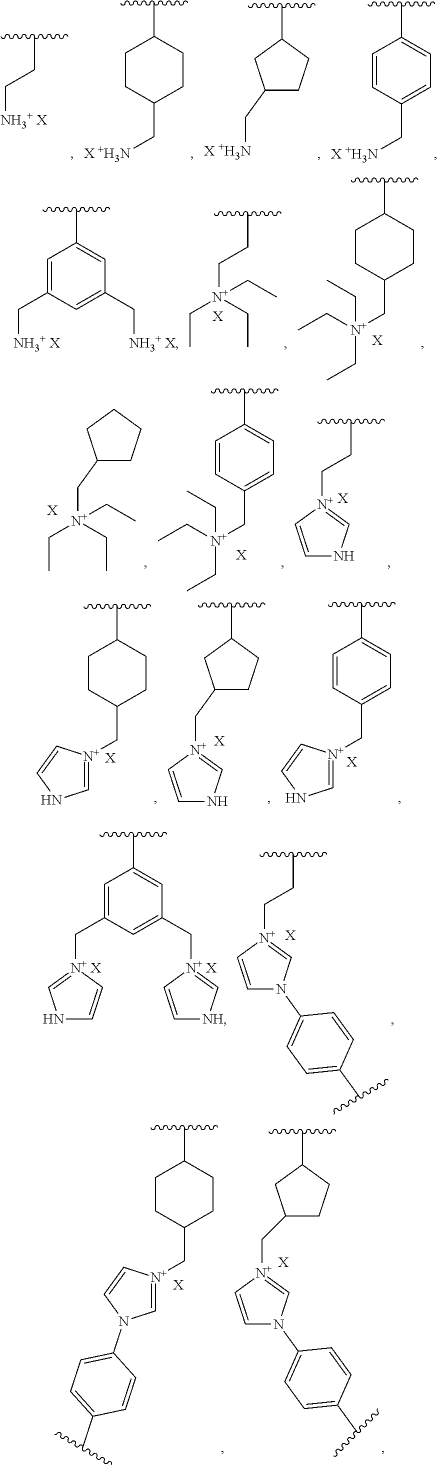

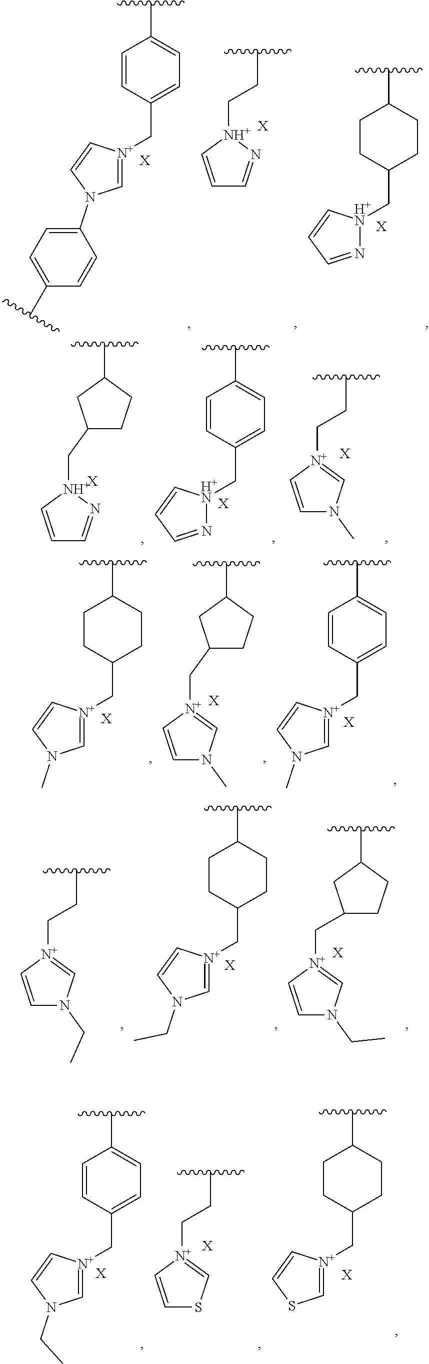

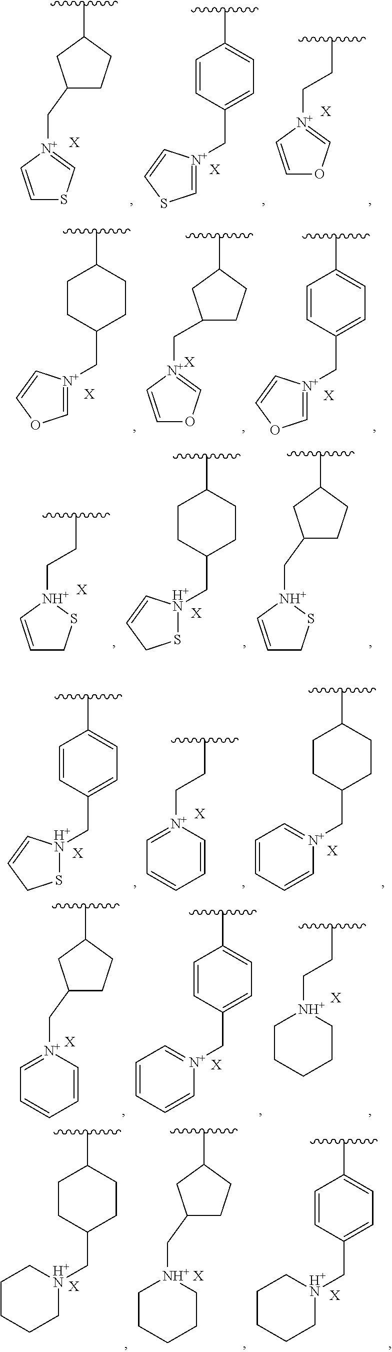

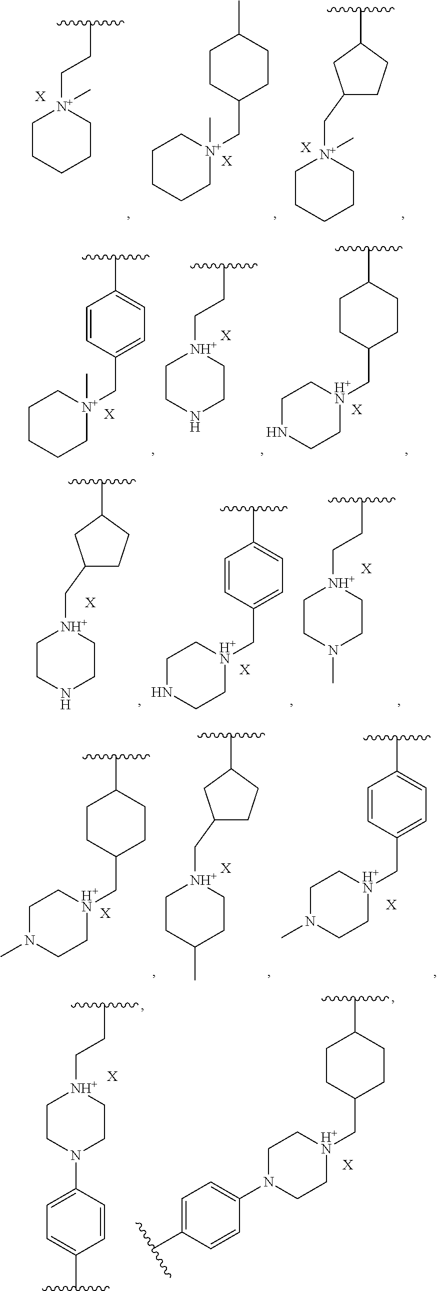

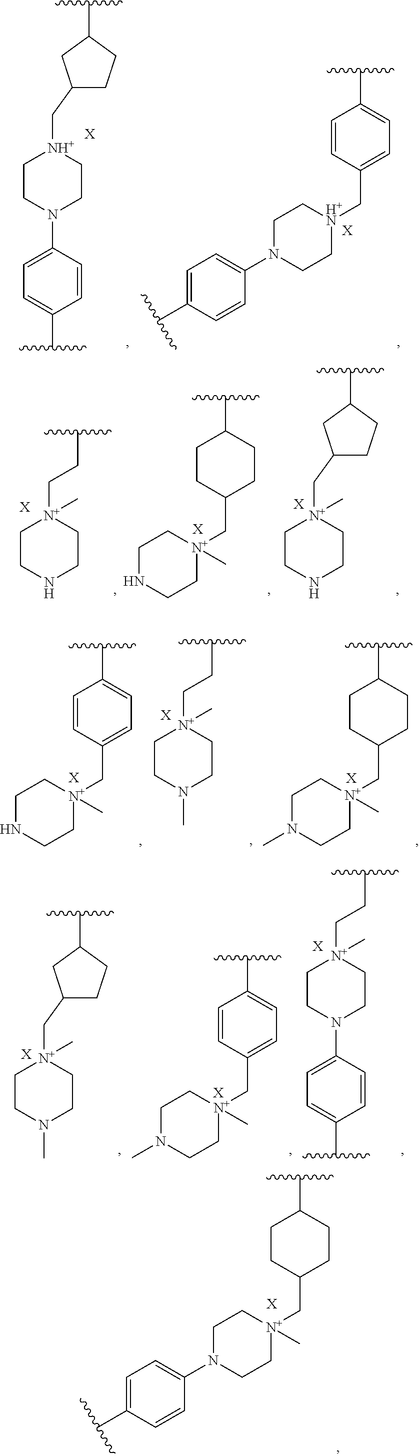

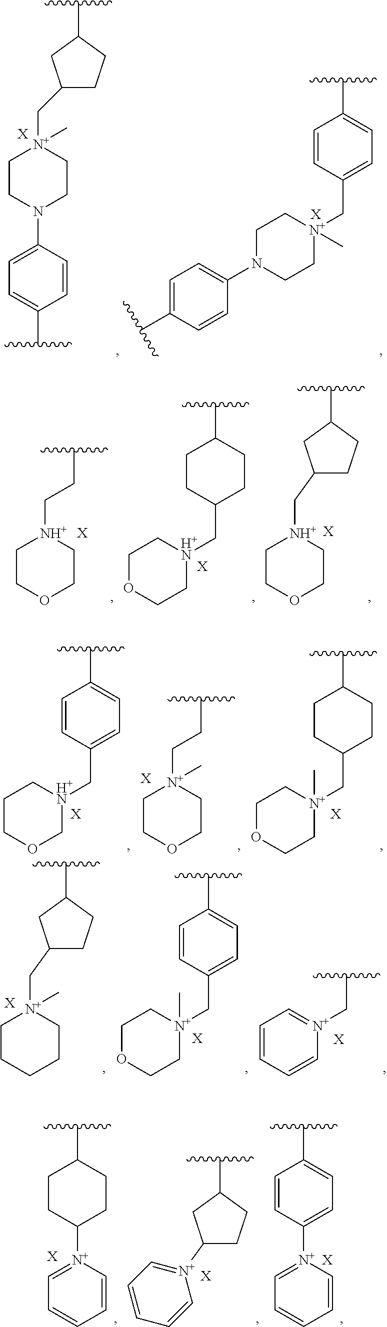

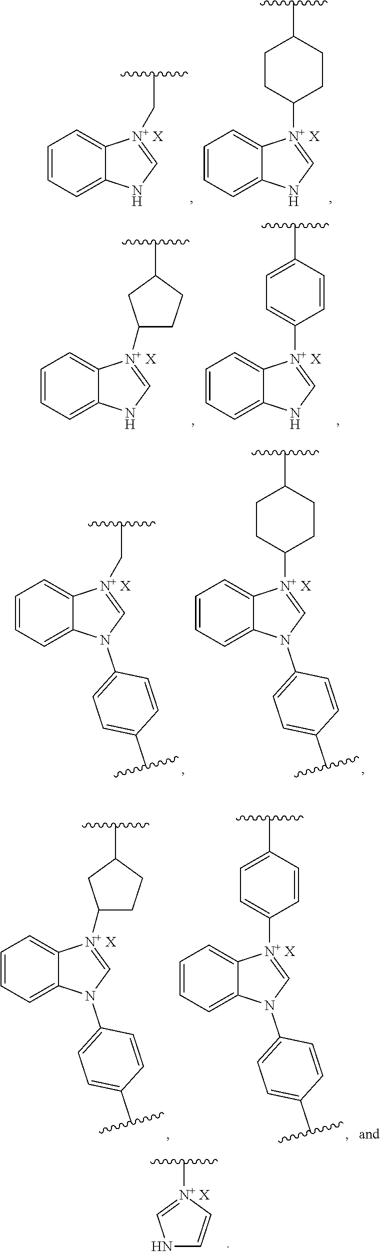

12. The polymer according to embodiment 11, wherein each nitrogen-containing side chain is independently selected from:

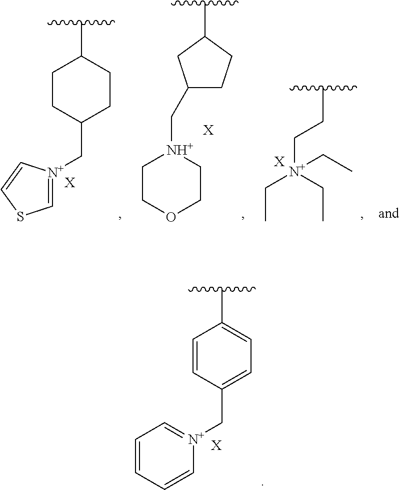

13. The polymer according to embodiment 11, wherein each nitrogen-containing side chain is independently selected from:

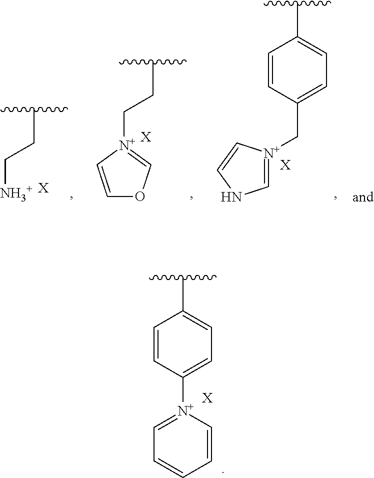

14. The polymer according to embodiment 11, wherein each nitrogen-containing side chain is independently selected from:

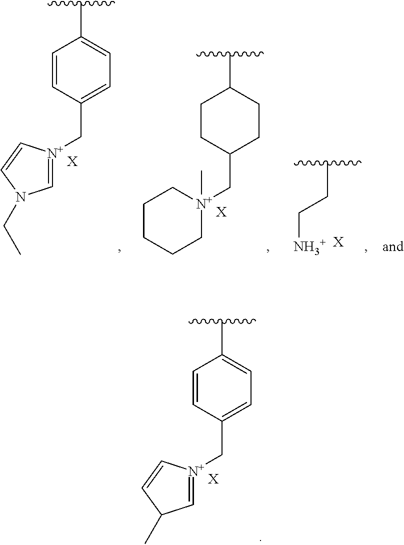

15. The polymer according to embodiment 11, wherein each nitrogen-containing side chain is independently selected from:

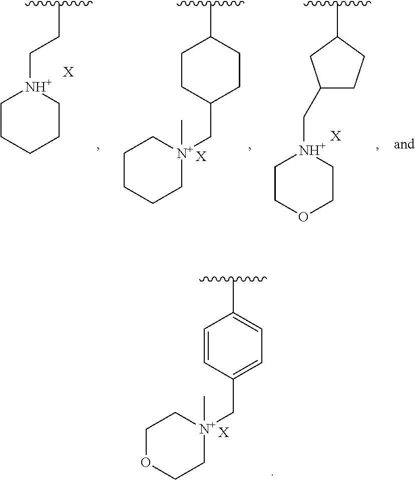

16. The polymer according to embodiment 11, wherein each nitrogen-containing side chain is independently selected from:

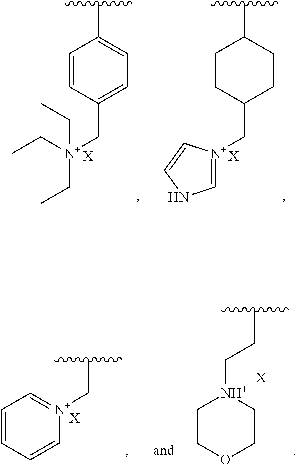

17. The polymer of embodiment 11, wherein each nitrogen-containing side chain is independently selected from:

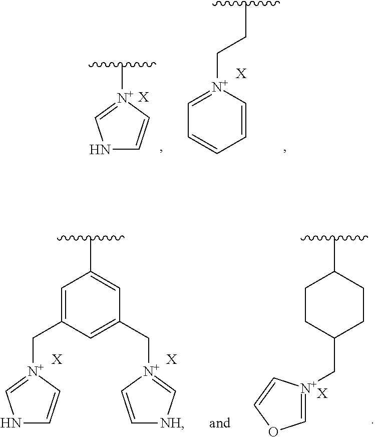

18. The polymer according to embodiment 11, wherein each X is independently selected from Cl⁻, Br⁻, I⁻, HSO₄⁻, HCO₂⁻, CH₃CO₂⁻, and NO₃⁻.
19. The polymer according to any one of embodiments 1 to 10, wherein the phosphorous-containing cationic group and the linker form a phosphorous-containing side chain, wherein each phosphorous-containing side chain is independently selected from:

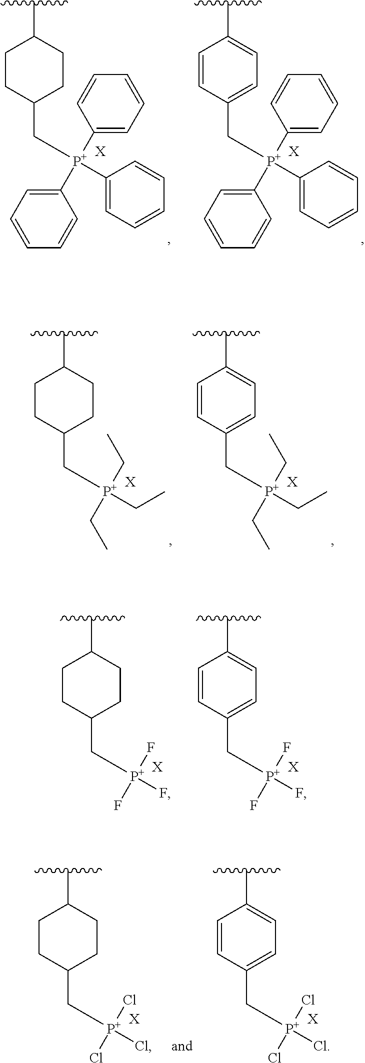

20. The polymer according to embodiment 19, wherein each phosphorous-containing side chain is independently selected from:

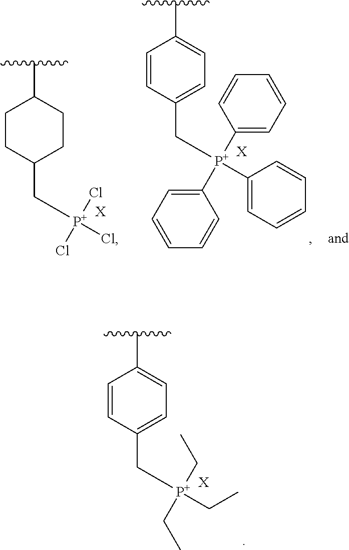

21. The polymer according to embodiment 19, wherein each phosphorous-containing side chain is independently selected from:

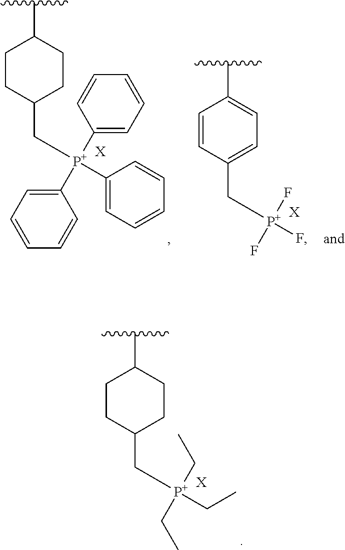

22. The polymer according to embodiment 19, wherein each X is independently selected from Cl⁻, Br⁻, I⁻, HSO₄⁻, HCO₂⁻, CH₃CO₂⁻, and NO₃⁻.
23. The polymer according to any one of embodiments 1 to 22, wherein each linker is independently selected from unsubstituted or substituted alkylene, unsubstituted or substituted arylalkylene, unsubstituted or substituted cycloalkylene, unsubstituted or substituted alkenylene, unsubstituted or substituted arylene, and unsubstituted or substituted heteroarylene.
24. The polymer according to any one of embodiments 1 to 23, wherein the polymeric backbone comprises two or more substituted or unsubstituted monomers, wherein the monomers are each independently formed from one or more moieties selected from ethylene, propylene, hydroxyethylene, acetaldehyde, styrene, divinyl benzene, isocyanates, vinyl chloride, vinyl phenols, tetrafluoroethylene, butylene, terephthalic acid, caprolactam, acrylonitrile, butadiene, ammonias, diammonias, pyrrole, imidazole, pyrazole, oxazole, thiazole, pyridine, pyrimidine, pyrazine, pyradizinine, thiazine, morpholine, piperidine, piperizine, pyrollizine, triphenylphosphonate, trimethylphosphonate, triethylphosphonate, tripropylphosphonate, tributylphosphonate, trichlorophosphonate, trifluorophosphonate, and diazole.
25. The polymer according to embodiment 24, wherein the polymeric backbone is selected from polyethylene, polypropylene, polyvinyl alcohol, polystyrene, polyurethane, polyvinyl chloride, polyphenol-aldehyde, polytetrafluoroethylene, polybutylene terephthalate, polycaprolactam, poly(acrylonitrile butadiene styrene), polyalkyleneammonium, polyalkylenediammonium, polyalkylenepyrrolium, polyalkyleneimidazolium, polyalkylenepyrazolium, polyalkyleneoxazolium, polyalkylenethiazolium, polyalkylenepyridinium, polyalkylenepyrimidinium, polyalkylenepyrazinium, polyalkylenepyradizimium, polyalkylenethiazinium, polyalkylenemorpholinium, polyalkylenepiperidinium, polyalkylenepiperizinium, polyalkylenepyrollizinium, polyalkylenetriphenylphosphonium, polyalkylenetrimethylphosphonium, polyalkylenetriethylphosphonium, polyalkylenetripropylphosphonium, polyalkylenetributylphosphonium, polyalkylenetrichlorophosphonium, polyalkylenetrifluorophosphonium, and polyalkylenediazolium, polyarylalkyleneammonium, polyarylalkylenediammonium, polyarylalkylenepyrrolium, polyarylalkyleneimidazolium, polyarylalkylenepyrazolium, polyarylalkyleneoxazolium, polyarylalkylenethiazolium, polyarylalkylenepyridinium, polyarylalkylenepyrimidinium, polyarylalkylenepyrazinium, polyarylalkylenepyradizimium, polyarylalkylenethiazinium, polyarylalkylenemorpholinium, polyarylalkylenepiperidinium, polyarylalkylenepiperizinium, polyarylalkylenepyrollizinium, polyarylalkylenetriphenylphosphonium, polyarylalkylenetrimethylphosphonium, polyarylalkylenetriethylphosphonium, polyarylalkylenetripropylphosphonium, polyarylalkylenetributylphosphonium, polyarylalkylenetrichlorophosphonium, polyarylalkylenetrifluorophosphonium, and polyarylalkylenediazolium;

wherein cationic polymeric backbones are associated with one or more anions selected from F⁻, Cl⁻, Br⁻, I⁻, NO₂⁻, NO₃⁻, SO₄²⁻, R⁷SO₄⁻, R⁷CO₂⁻, PO₄²⁻, R⁷PO₃⁻, and R⁷PO₂⁺ where R⁷ is selected from hydrogen, C₁₋₄alkyl, and C₁₋₄heteroalkyl.

26. The polymer according to embodiment 24 or 25, wherein the polymeric backbone is a heteropolymer that has at least one monomeric unit that differs from the other monomeric units in the polymer.
27. The polymer according to embodiment 26, wherein the heteropolymer is formed from styrene and divinylbenzene monomers to give poly(styrene-co-divinylbenzene).
28. The polymer according to any one of embodiments 1 to 27, wherein the polymer is cross-linked.
29. The polymer according to any one of embodiments 1 to 27, wherein the polymer is substantially not cross-linked.
30. The polymer according to any one of embodiments 1 to 29, wherein the acidic monomers and the ionic monomers are randomly arranged in an alternating sequence or in blocks of monomers.
31. The polymer according to embodiment 30, wherein each block has no more than twenty monomers.
32. The polymer according to any one of embodiments 1 to 31, further comprising at least one hydrophobic monomer.
33. The polymer according to embodiment 32, wherein each hydrophobic monomer is selected from an unsubstituted or substituted alkyl, an unsubstituted or substituted cycloalkyl, an unsubstituted or substituted aryl, and an unsubstituted or substituted heteroaryl.
34. The polymer according to any one of embodiments 1 to 33, further comprising at least one acidic-ionic monomer connected to the polymeric backbone, wherein at least one acidic-ionic monomer comprises at least one Bronsted-Lowry acid in conjugate base form having at least one associated cationic moiety, and at least one cationic group, and wherein at least one of the acidic-ionic monomers comprises a linker connecting the acidic-ionic monomer to the polymeric backbone.
35. The polymer according to embodiment 34, wherein the cationic group is a nitrogen-containing cationic group or a phosphorous-containing cationic group.
36. The polymer according to embodiment 34 or 35, wherein the linker at each occurrence is independently selected from unsubstituted or substituted alkylene, unsubstituted or substituted cycloalkylene, unsubstituted or substituted alkenylene, unsubstituted or substituted arylene, and unsubstituted or substituted heteroarylene.
37. The polymer according to any one of embodiments 34 to 36, wherein the Bronsted-Lowry acid in conjugate base form having at least one associated cationic moiety, the cationic group and the linker form an acidic-ionic side chain, wherein each acidic-ionic side chain is independently selected from:

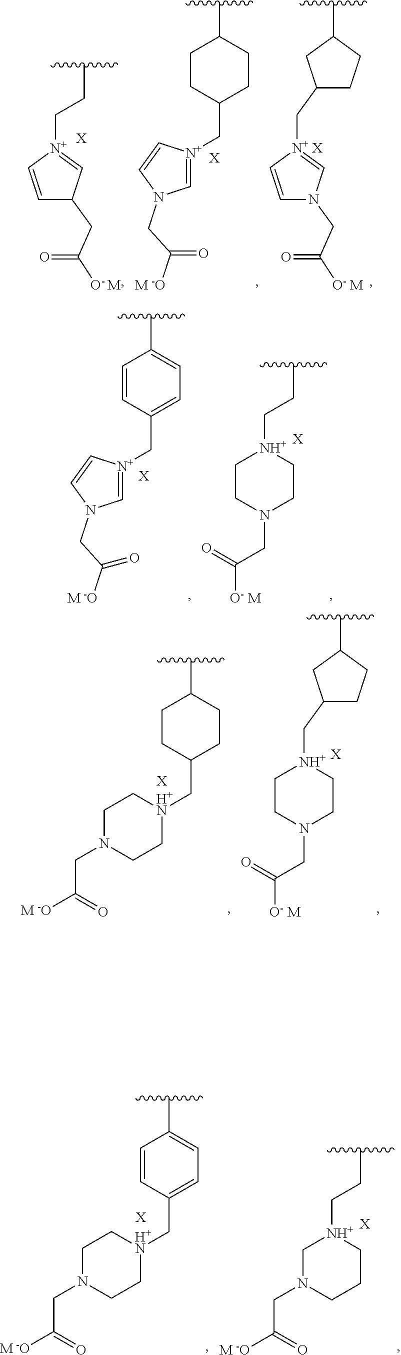

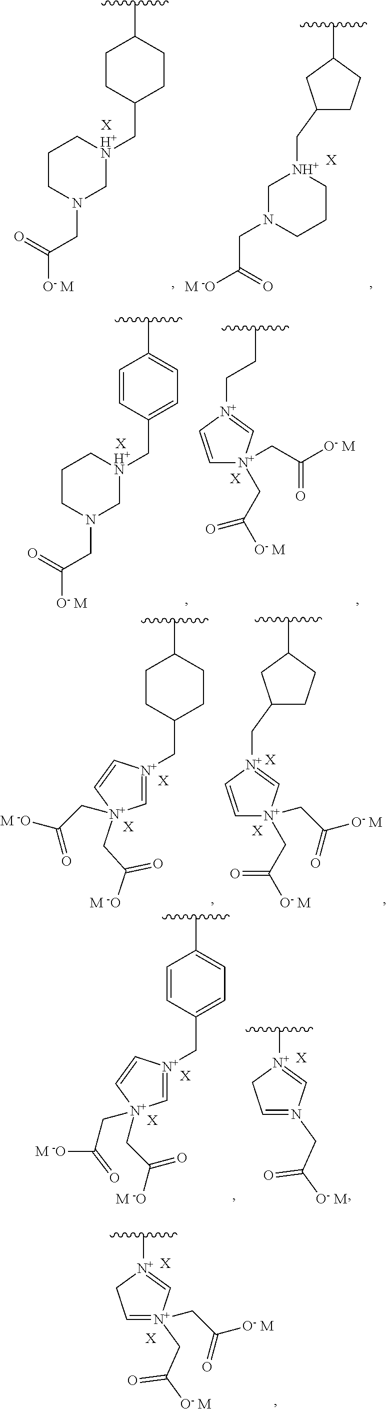

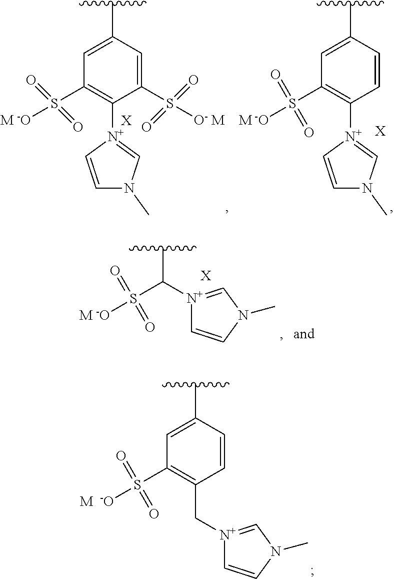

wherein each M is independently selected from Li⁺, Na⁺, K⁺, N(R¹)₄⁺, Zn²⁺, Me, and Ca²⁺, where Zn²⁺, Mg²⁺ and Ca²⁺ are each independently associated with at least two cationic groups at any M position on any ionic monomer;

each R¹ is independently selected from hydrogen, alkyl, heteroalkyl, cycloalkyl, heterocyclyl, aryl, and heteroaryl;

each X is independently selected from F⁻, Cl⁻, Br⁻, I⁻, NO₂⁻, NO₃⁻, SO₄²⁻, R⁷SO₄⁻, R⁷CO₂⁻, PO₄²⁻, R⁷PO₃⁻, and R⁷PO₄²⁻, where SO₄²⁻ and PO₄²⁻ are each independently associated with at least two Bronsted-Lowry acids in conjugate base form at any X position on any side chain, and

each R⁷ is independently selected from hydrogen, C₁₋₄alkyl, and C₁₋₄heteroalkyl.

38. The polymer according to embodiment 37, wherein each acidic-ionic side chain is independently selected from:

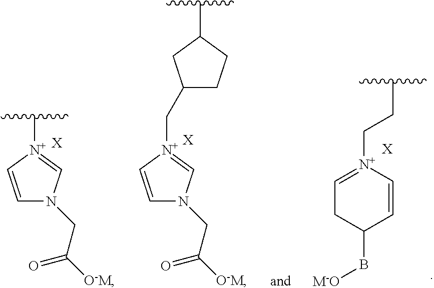

39. The polymer according to embodiment 37, wherein each acidic-ionic side chain is independently selected from:

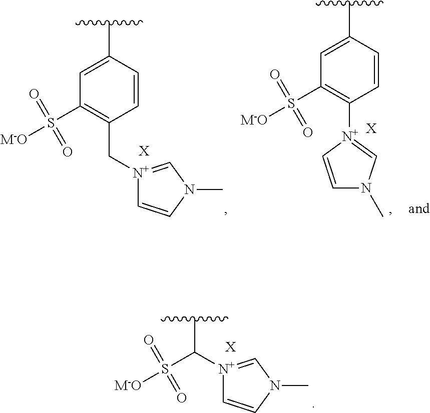

40. The polymer according to embodiment 37, wherein each X is independently selected from Cl⁻, Br⁻, I⁻, HSO₄⁻, HCO₂⁻, CH₃CO₂⁻, and NO₃⁻.
41. The polymer according to any one of embodiments 1 to 40, wherein the polymer has a total amount of Bronsted-Lowry acid of between 0.1 and 20 mmol per gram of polymer, wherein the Bronsted-Lowry acid comprises at least one Bronsted-Lowry acid in acidic form and at least one Bronsted-Lowry acid in conjugate base form having at least one associated cationic moiety.
42. The polymer according to any one of embodiments 1 to 41, wherein the polymer has a total amount of nitrogen-containing cationic groups or a total amount of phosphorous-containing cationic groups of between 0.01 and 10 mmol per gram of polymer, wherein the cationic groups are each independently associated with at least one counterion.
43. The polymer according to embodiment 1, wherein the polymer is selected from:
poly[styrene-co-4-vinylbenzeneR⁸ sulfonate-co-3-methyl-1-(4-vinylbenzyl)-3H-imidazol-1-ium chloride-co-divinylbenzene];
poly[styrene-co-4-vinylbenzeneR⁸ sulfonate-co-3-methyl-1-(4-vinylbenzyl)-3H-imidazol-1-ium bisulfate-co-divinylbenzene];
poly[styrene-co-4-vinylbenzeneR⁸ sulfonate-co-3-methyl-1-(4-vinylbenzyl)-3H-imidazol-1-ium acetate-co-divinylbenzene];
poly[styrene-co-4-vinylbenzeneR⁸ sulfonate-co-3-methyl-1-(4-vinylbenzyl)-3H-imidazol-1-ium nitrate-co-divinylbenzene];
poly[styrene-co-4-vinylbenzeneR⁸ sulfonate-co-3-ethyl-1-(4-vinylbenzyl)-3H-imidazol-1-ium chloride-co-divinylbenzene];
poly[styrene-co-4-vinylbenzeneR⁸ sulfonate-co-3-ethyl-1-(4-vinylbenzyl)-3H-imidazol-1-ium bisulfate-co-divinylbenzene];
poly[styrene-co-4-vinylbenzeneR⁸ sulfonate-co-3-ethyl-1-(4-vinylbenzyl)-3H-imidazol-1-ium acetate-co-divinylbenzene];
poly[styrene-co-4-vinylbenzeneR⁸ sulfonate-co-3-ethyl-1-(4-vinylbenzyl)-3H-imidazol-1-ium nitrate-co-divinylbenzene];
poly[styrene-co-4-vinylbenzeneR⁸ sulfonate-co-1-(4-vinylbenzyl)-3H-imidazol-1-ium chloride-co-divinylbenzene];
poly[styrene-co-4-vinylbenzeneR⁸ sulfonated-co-1-(4-vinylbenzyl)-3H-imidazol-1-ium iodide-co-divinylbenzene];
poly[styrene-co-4-vinylbenzeneR⁸ sulfonate-co-1-(4-vinylbenzyl)-3H-imidazol-1-ium bromide-co-divinylbenzene];
poly[styrene-co-4-vinylbenzeneR⁸ sulfonate-co-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-3H-imidazol-1-ium acetate-co-divinylbenzene];
poly[styrene-co-4-vinylbenzeneR⁸ sulfonate-co-3-methyl-1-(4-vinylbenzyl)-3H-benzoimidazol-1-ium chloride-co-divinylbenzene];
poly[styrene-co-4-vinylbenzeneR⁸ sulfonate-co-3-methyl-1-(4-vinylbenzyl)-3H-benzoimidazol-1-ium bisulfate-co-divinylbenzene];
poly[styrene-co-4-vinylbenzeneR⁸ sulfonate-co-3-methyl-1-(4-vinylbenzyl)-3H-benzoimidazol-1-ium acetate-co-divinylbenzene];
poly[styrene-co-4-vinylbenzeneR⁸ sulfonate-co-3-methyl-1-(4-vinylbenzyl)-3H-benzoimidazol-1-ium formate-co-divinylbenzene];
poly[styrene-co-4-vinylbenzeneR⁸ sulfonate-co-1-(4-vinylbenzyl)-pyridinium-chloride-co-divinylbenzene];
poly[styrene-co-4-vinylbenzeneR⁸ sulfonate-co-1-(4-vinylbenzyl)-pyridinium-bisulfate-co-divinylbenzene];
poly[styrene-co-4-vinylbenzeneR⁸ sulfonate-co-1-(4-vinylbenzyl)-pyridinium-acetate-co-divinylbenzene];
poly[styrene-co-4-vinylbenzeneR⁸ sulfonate-co-1-(4-vinylbenzyl)-pyridinium-nitrate-co-divinylbenzene];
poly[styrene-co-4-vinylbenzeneR⁸ sulfonate-co-1-(4-vinylbenzyl)-pyridinium-chloride-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bromide-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-iodide-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bisulfate-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-acetate-co-3-methyl-1-(4-vinylbenzyl)-3H-imidazol-1-ium bisulfate-co-divinylbenzene];
poly[styrene-co-4-vinylbenzeneR⁸ sulfonate-co-4-methyl-4-(4-vinylbenzyl)-morpholin-4-ium chloride-co-divinylbenzene];
poly[styrene-co-4-vinylbenzeneR⁸ sulfonate-co-4-methyl-4-(4-vinylbenzyl)-morpholin-4-ium bisulfate-co-divinylbenzene];
poly[styrene-co-4-vinylbenzeneR⁸ sulfonate-co-4-methyl-4-(4-vinylbenzyl)-morpholin-4-ium acetate-co-divinylbenzene];
poly[styrene-co-4-vinylbenzeneR⁸ sulfonate-co-4-methyl-4-(4-vinylbenzyl)-morpholin-4-ium formate-co-divinylbenzene];
poly[styrene-co-4-vinylbenzeneR⁸ sulfonate-co-triphenyl-(4-vinylbenzyl)-phosphonium chloride-co-divinylbenzene];
poly[styrene-co-4-vinylbenzeneR⁸ sulfonate-co-triphenyl-(4-vinylbenzyl)-phosphonium bisulfate-co-divinylbenzene];
poly[styrene-co-4-vinylbenzeneR⁸ sulfonate-co-triphenyl-(4-vinylbenzyl)-phosphonium acetate-co-divinylbenzene];
poly[styrene-co-4-vinylbenzeneR⁸ sulfonate-co-1-methyl-1-(4-vinylbenzyl)-piperdin-1-ium chloride-co-divinylbenzene];
poly[styrene-co-4-vinylbenzeneR⁸ sulfonate-co-1-methyl-1-(4-vinylbenzyl)-piperdin-1-ium bisulfate-co-divinylbenzene];
poly[styrene-co-4-vinylbenzeneR⁸ sulfonate-co-1-methyl-1-(4-vinylbenzyl)-piperdin-1-ium acetate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-4-vinylbenzeneR⁸ sulfonate-co-triethyl-(4-vinylbenzyl)-ammonium chloride-co-divinylbenzene];
poly[styrene-co-4-vinylbenzeneR⁸ sulfonate-co-triethyl-(4-vinylbenzyl)-ammonium bisulfate-co-divinylbenzene];
poly[styrene-co-4-vinylbenzeneR⁸ sulfonate-co-triethyl-(4-vinylbenzyl)-ammonium acetate-co-divinylbenzene];
poly[styrene-co-3-methyl-1-(4-vinylbenzyl)-3H-imidazol-1-ium chloride-co-4-R⁸ boronate-1-(4-vinylbenzyl)-pyridinium chloride-co-divinylbenzene];
poly[styrene-co-3-methyl-1-(4-vinylbenzyl)-3H-imidazol-1-ium chloride-co-1-(4-vinylphenyl)methylR⁸ phosphonate-co-divinylbenzene];
poly[styrene-co-3-methyl-1-(4-vinylbenzyl)-3H-imidazol-1-ium bisulfate-co-1-(4-vinylphenyl)methylR⁸ phosphonate-co-divinylbenzene];
poly[styrene-co-3-methyl-1-(4-vinylbenzyl)-3H-imidazol-1-ium acetate-co-1-(4-vinylphenyl)methylR⁸ phosphonate-co-divinylbenzene];
poly[styrene-co-3-methyl-1-(4-vinylbenzyl)-3H-imidazol-1-ium nitrate-co-1-(4-vinylphenyl)methylR⁸ phosphonate-co-divinylbenzene];
poly[styrene-co-4-vinylbenzeneR⁸ sulfonate-co-vinylbenzylchloride-co-1-methyl-2-vinyl-pyridinium chloride-co-divinylbenzene];
poly[styrene-co-4-vinylbenzeneR⁸ sulfonate-co-vinylbenzylchloride-co-1-methyl-2-vinyl-pyridinium bisulfate-co-divinylbenzene];
poly[styrene-co-4-vinylbenzeneR⁸ sulfonate-co-vinylbenzylchloride-co-1-methyl-2-vinyl-pyridinium acetate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-4-vinylphenylR⁸ phosphonate-co-3-methyl-1-(4-vinylbenzyl)-3H-imidazol-1-ium chloride-co-divinylbenzene];
poly[styrene-co-4-vinylphenylR⁸ phosphonate-co-3-methyl-1-(4-vinylbenzyl)-3H-imidazol-1-ium bisulfate-co-divinylbenzene];
poly[styrene-co-4-vinylphenylR⁸ phosphonate-co-3-methyl-1-(4-vinylbenzyl)-3H-imidazol-1-ium acetate-co-divinylbenzene];
poly[styrene-co-3-R⁸ methylcarboxylate-1-(4-vinylbenzyl)-3H-imidazol-1-ium chloride-co-divinylbenzene];
poly[styrene-co-3-R⁸ methylcarboxylate-1-(4-vinylbenzyl)-3H-imidazol-1-ium bisulfate-co-divinylbenzene];
poly[styrene-co-3-R⁸ methylcarboxylate-1-(4-vinylbenzyl)-3H-imidazol-1-ium acetate-co-divinylbenzene];
poly[styrene-co-5-(4-vinylbenzylamino)-R⁸ isophthalate-co-3-methyl-1-(4-vinylbenzyl)-3H-imidazol-1-ium chloride-co-divinylbenzene];
poly[styrene-co-5-(4-vinylbenzylamino)-R⁸ isophthalate-co-3-methyl-1-(4-vinylbenzyl)-3H-imidazol-1-ium bisulfate-co-divinylbenzene];
poly[styrene-co-5-(4-vinylbenzylamino)-R⁸ isophthalate-co-3-methyl-1-(4-vinylbenzyl)-3H-imidazol-1-ium acetate-co-divinylbenzene];
poly[styrene-co-(4-vinylbenzylamino)-R⁸ acetate-co-3-methyl-1-(4-vinylbenzyl)-3H-imidazol-1-ium chloride-co-divinylbenzene];
poly[styrene-co-(4-vinylbenzylamino)-R⁸ acetate-co-3-methyl-1-(4-vinylbenzyl)-3H-imidazol-1-ium bisulfate-co-divinylbenzene];
poly[styrene-co-(4-vinylbenzylamino)-R⁸ acetate-co-3-methyl-1-(4-vinylbenzyl)-3H-imidazol-1-ium acetate-co-divinylbenzene];
poly(styrene-co-4-vinylbenzeneR⁸ sulfonate-co-vinylbenzylmethylimidazolium chloride-co-vinylbenzylmethylmorpholinium chloride-co-vinylbenzyltriphenyl phosphonium chloride-co-divinylbenzene);
poly(styrene-co-4-vinylbenzeneR⁸ phosphonate-co-vinylbenzylmethylimidazolium chloride-co-vinylbenzylmethylmorpholinium chloride-co-vinylbenzyltriphenyl phosphonium chloride-co-divinylbenzene);
poly(styrene-co-4-vinylbenzeneR⁸ sulfonate-co-vinylbenzylmethylimidazolium bisulfate-co-vinylbenzylmethylmorpholinium bisulfate-co-vinylbenzyltriphenyl phosphonium bisulfate-co-divinylbenzene);
poly(styrene-co-4-vinylbenzeneR⁸ phosphonate-co-vinylbenzylmethylimidazolium bisulfate-co-vinylbenzylmethylmorpholinium bisulfate-co-vinylbenzyltriphenyl phosphonium bisulfate-co-divinylbenzene);
poly(styrene-co-4-vinylbenzeneR⁸ sulfonate-co-vinylbenzylmethylimidazolium acetate-co-vinylbenzylmethylmorpholinium acetate-co-vinylbenzyltriphenyl phosphonium acetate-co-divinylbenzene);
poly(styrene-co-4-vinylbenzeneR⁸ phosphonate-co-vinylbenzylmethylimidazolium acetate-co-vinylbenzylmethylmorpholinium acetate-co-vinylbenzyltriphenyl phosphonium acetate-co-divinylbenzene);
poly(styrene-co-4-vinylbenzeneR⁸ sulfonate-co-vinylbenzylmethylmorpholinium chloride-co-vinylbenzyltriphenylphosphonium chloride-co-divinylbenzene);
poly(styrene-co-4-vinylbenzeneR⁸ phosphonate-co-vinylbenzylmethylmorpholinium chloride-co-vinylbenzyltriphenylphosphonium chloride-co-divinylbenzene);
poly(styrene-co-4-vinylbenzeneR⁸ sulfonate-co-vinylbenzylmethylmorpholinium bisulfate-co-vinylbenzyltriphenylphosphonium bisulfate-co-divinylbenzene);
poly(styrene-co-4-vinylbenzeneR⁸ phosphonate-co-vinylbenzylmethylmorpholinium bisulfate-co-vinylbenzyltriphenylphosphonium bisulfate-co-divinylbenzene);
poly(styrene-co-4-vinylbenzeneR⁸ sulfonate-co-vinylbenzylmethylmorpholinium acetate-co-vinylbenzyltriphenylphosphonium bisulfate-co-divinylbenzene);
poly(styrene-co-4-vinylbenzeneR⁸ phosphonate-co-vinylbenzylmethylmorpholinium acetate-co-vinylbenzyltriphenylphosphonium bisulfate-co-divinylbenzene)
poly(styrene-co-4-vinylbenzeneR⁸ sulfonate-co-vinylmethylimidazolium chloride-co-divinylbenzene);
poly(styrene-co-4-vinylbenzeneR⁸ sulfonate-co-vinylmethylimidazolium bisulfate-co-divinylbenzene);
poly(styrene-co-4-vinylbenzeneR⁸ sulfonate-co-vinylmethylimidazolium acetate-co-divinylbenzene);
poly(styrene-co-4-vinylbenzeneR⁸ sulfonate-co-vinylmethylimidazolium nitrate-co-divinylbenzene);
poly(styrene-co-4-vinylbenzeneR⁸ phosphonate-co-vinylmethylimidazolium chloride-co-divinylbenzene);
poly(styrene-co-4-vinylbenzeneR⁸ phosphonate-co-vinylmethylimidazolium bisulfate-co-divinylbenzene);
poly(styrene-co-4-vinylbenzeneR⁸ phosphonate-co-vinylmethylimidazolium acetate-co-divinylbenzene);
poly(styrene-co-4-vinylbenzeneR⁸ sulfonate-co-vinylbenzyltriphenylphosphonium chloride-co-divinylbenzene);
poly(styrene-co-4-vinylbenzeneR⁸ sulfonate-co-vinylbenzyltriphenylphosphonium bisulfate-co-divinylbenzene);
poly(styrene-co-4-vinylbenzeneR⁸ sulfonate-co-vinylbenzyltriphenylphosphonium acetate-co-divinylbenzene);
poly(styrene-co-4-vinylbenzeneR⁸ phosphonate-co-vinylbenzyltriphenylphosphonium chloride-co-divinylbenzene);
poly(styrene-co-4-vinylbenzeneR⁸ phosphonate-co-vinylbenzyltriphenylphosphonium bisulfate-co-divinylbenzene);
poly(styrene-co-4-vinylbenzeneR⁸ phosphonate-co-vinylbenzyltriphenylphosphonium acetate-co-divinylbenzene);
poly(styrene-co-4-vinylbenzeneR⁸ sulfonate-co-vinylbenzylmethylimidazolium chloride-co-divinylbenzene);
poly(styrene-co-4-vinylbenzeneR⁸ sulfonate-co-vinylbenzylmethylimidazolium bisulfate-co-divinylbenzene);
poly(styrene-co-4-vinylbenzeneR⁸ sulfonate-co-vinylbenzylmethylimidazolium acetate-co-divinylbenzene);
poly(styrene-co-4-vinylbenzeneR⁸ phosphonate-co-vinylbenzylmethylimidazolium chloride-co-divinylbenzene);
poly(styrene-co-4-vinylbenzeneR⁸ phosphonate-co-vinylbenzylmethylimidazolium bisulfate-co-divinylbenzene);
poly(styrene-co-4-vinylbenzeneR⁸ phosphonate-co-vinylbenzylmethylimidazolium acetate-co-divinylbenzene);
poly(styrene-co-4-vinylbenzeneR⁸ sulfonate-co-vinylbenzyltriphenylphosphonium chloride-co-divinylbenzene);
poly(styrene-co-4-vinylbenzeneR⁸ sulfonate-co-vinylbenzyltriphenylphosphonium bisulfate-co-divinylbenzene);
poly(styrene-co-4-vinylbenzeneR⁸ sulfonate-co-vinylbenzyltriphenylphosphonium acetate-co-divinylbenzene);
poly(styrene-co-4-vinylbenzeneR⁸ phosphonate-co-vinylbenzyltriphenylphosphonium chloride-co-divinylbenzene);
poly(styrene-co-4-vinylbenzeneR⁸ phosphonate-co-vinylbenzyltriphenylphosphonium bisulfate-co-divinylbenzene);
poly(styrene-co-4-vinylbenzeneR⁸ phosphonate-co-vinylbenzyltriphenylphosphonium acetate-co-divinylbenzene);
poly(butyl-vinylimidazolium chloride-co-butylimidazolium bisulfate-co-4-vinylbenzeneR⁸ sulfonate);
poly(butyl-vinylimidazolium bisulfate-co-butylimidazolium bisulfate-co-4-vinylbenzeneR⁸ sulfonate);
poly(benzyl alcohol-co-4-vinylbenzylalcohol R⁸ sulfonate-co-vinylbenzyltriphenylphosphonium chloride-co-divinylbenzyl alcohol); and
poly(benzyl alcohol-co-4-vinylbenzylalcohol R⁸ sulfonate-co-vinylbenzyltriphenylphosphonium bisulfate-co-divinylbenzyl alcohol);

wherein R⁸ is selected from Li⁺, K⁺, N(H)₄⁺, N(Me)₄⁺, N(Et)₄⁺, Zn²⁺, Mg²⁺, and Ca²⁺, where Zn²⁺, Mg²⁺ and Ca²⁺ are each independently associated with at least two Bronsted-Lowry acids in conjugate base form on any acidic monomer.

44. The polymer of embodiment 1, wherein the polymer is selected from:
poly[styrene-co-4-vinylbenzeneR⁸ sulfonate-co-3-methyl-1-(4-vinylbenzyl)-3H-imidazol-1-ium nitrate-co-divinylbenzene];
poly[styrene-co-4-vinylbenzeneR⁸ sulfonate-co-1-(4-vinylbenzyl)-3H-imidazol-1-ium iodide-co-divinylbenzene];
poly[styrene-co-4-vinylbenzeneR⁸ sulfonate-co-3-methyl-1-(4-vinylbenzyl)-3H-benzoimidazol-1-ium chloride-co-divinylbenzene];
poly[styrene-co-4-vinylbenzeneR⁸ sulfonate-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bisulfate-co-divinylbenzene];
poly[styrene-co-4-vinylbenzeneR⁸ sulfonate-co-1-(4-vinylbenzyl)-pyridinium-chloride-co-3-methyl-1-(4-vinylbenzyl)-3H-imidazol-1-ium bisulfate-co-divinylbenzene];
poly[styrene-co-4-vinylbenzeneR⁸ sulfonate-co-4-methyl-4-(4-vinylbenzyl)-morpholin-4-ium chloride-co-divinylbenzene];
poly[styrene-co-4-vinylbenzeneR⁸ sulfonate-co-1-(4-vinylbenzyl)-3H-imidazol-1-ium bisulfate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-3-methyl-1-(4-vinylbenzyl)-3H-imidazol-1-ium bisulfate-co-1-(4-vinylphenyl)methylR⁸ phosphonate-co-divinylbenzene];
poly[styrene-co-4-vinylbenzeneR⁸ sulfonate-co-vinylbenzylchloride-co-1-methyl-2-vinyl-pyridinium bisulfate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-4-vinylbenzeneR⁸ sulfonate-co-triphenyl-(4-vinylbenzyl)-phosphonium bisulfate-co-divinylbenzene];
poly[styrene-co-5-(4-vinylbenzylamino)-R⁸ isophthalate acid-co-3-methyl-1-(4-vinylbenzyl)-3H-imidazol-1-ium chloride-co-divinylbenzene];
poly(styrene-co-4-vinylbenzeneR⁸ sulfonate-co-vinylbenzylmethylimidazolium chloride-co-vinylbenzylmethylmorpholinium chloride-co-vinylbenzyltriphenyl phosphonium chloride-co-divinylbenzene);
poly(styrene-co-4-vinylbenzeneR⁸ sulfonate-co-vinylmethylimidazolium acetate-co-divinylbenzene);
poly(styrene-co-4-vinylbenzeneR⁸ sulfonate-co-vinylbenzyltriphenylphosphonium chloride-co-divinylbenzene);
poly(styrene-co-4-vinylbenzeneR⁸ phosphate-co-vinylbenzyltriphenylphosphonium chloride-co-divinylbenzene);
poly(styrene-co-4-vinylbenzeneR⁸ phosphate-co-vinylbenzyltriphenylphosphonium bisulfate-co-divinylbenzene); and
poly(styrene-co-4-vinylbenzeneR⁸ sulfonate-co-vinylbenzyltriphenylphosphonium chloride-co-divinylbenzene);

wherein R⁸ is selected from Li⁺, K⁺, N(H)₄⁺, N(Me)₄⁺, N(Et)₄⁺, Zn²⁺, Mg²⁺, and Ca²⁺, where Zn²⁺, Mg²⁺ and Ca²⁺ are each independently associated with at least two Bronsted-Lowry acids in conjugate base form on any acidic monomer.

45. The polymer according to embodiment 1, wherein the polymer is selected from:
poly[styrene-co-4-vinylbenzeneR⁸ sulfonate-co-1-(4-vinylbenzyl)-pyridinium-chloride-co-3-methyl-1-(4-vinylbenzyl)-3H-imidazol-1-ium bisulfate-co-divinylbenzene];
poly[styrene-co-4-vinylbenzeneR⁸ sulfonate-co-vinylbenzylchloride-co-1-methyl-2-vinyl-pyridinium bisulfate-co-divinylbenzene];
poly(styrene-co-4-vinylbenzeneR⁸ phosphonate-co-vinylbenzyltriphenylphosphonium chloride-co-divinylbenzene);
poly[styrene-co-4-vinylbenzeneR⁸ sulfonate-co-1-(4-vinylbenzyl)-3H-imidazol-1-ium bisulfate-co-divinylbenzene]; and
poly(styrene-co-4-vinylbenzeneR⁸ sulfonate-co-vinylmethylimidazolium acetate-co-divinylbenzene);

wherein R⁸ is selected from Li⁺, K⁺, N(H)₄⁺, N(Me)₄⁺, N(Et)₄⁺, Zn²⁺, Mg²⁺, and Ca²⁺, where Zn²⁺, Mg²⁺ and Ca²⁺ are each independently associated with at least two Bronsted-Lowry acids in conjugate base form on any acidic monomer.

46. The polymer according to embodiment 1, wherein the polymer is selected from:
poly[styrene-co-4-vinylbenzeneR⁸ sulfonate-co-3-methyl-1-(4-vinylbenzyl)-3H-benzoimidazol-1-ium chloride-co-divinylbenzene];
poly[styrene-co-4-vinylbenzeneR⁸ sulfonate-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bisulfate-co-divinylbenzene];
poly(styrene-co-4-vinylbenzeneR⁸ sulfonate-co-vinylbenzylmethylimidazolium chloride-co-vinylbenzylmethylmorpholinium chloride-co-vinylbenzyltriphenyl phosphonium chloride-co-divinylbenzene); and
poly[styrene-co-4-vinylbenzeneR⁸ sulfonate-co-4-(4-vinylbenzyl)-morpholine-4-oxide-co-divinyl benzene];

wherein R⁸ is selected from Li⁺, K⁺, N(H)₄⁺, N(Me)₄⁺, N(Et)₄⁺, Zn²⁺, Mg²⁺, and Ca²⁺, where Zn²⁺, Mg²⁺ and Ca²⁺ are each independently associated with at least two Bronsted-Lowry acids in conjugate base form on any acidic monomer.

47. The polymer according to embodiment 1, wherein the polymer is selected from:
poly[styrene-co-4-vinylbenzeneR⁸ sulfonate-co-4-(4-vinylbenzyl)-morpholine-4-oxide-co-divinyl benzene];
poly(styrene-co-4-vinylbenzeneR⁸ sulfonate-co-vinylbenzyltriphenylphosphonium chloride-co-divinylbenzene);
poly[styrene-co-4-vinylbenzeneR⁸ sulfonate-1-(4-vinylbenzyl)-3H-imidazol-1-ium iodide-co-divinylbenzene];
poly[styrene-co-4-vinylbenzeneR⁸ sulfonate-co-triphenyl-(4-vinylbenzyl)-phosphonium bisulfate-co-divinylbenzene]; and
poly[styrene-co-3-methyl-1-(4-vinylbenzyl)-3H-imidazol-1-ium bisulfate-co-1-(4-vinylphenyl)methylR⁸ phosphonate-co-divinylbenzene];

wherein R⁸ is selected from Li⁺, K⁺, N(H)₄⁺, N(Me)₄⁺, N(Et)₄⁺, Zn²⁺, Mg²⁺, and Ca²⁺, where Zn²⁺, Mg²⁺ and Ca²⁺ are each independently associated with at least two Bronsted-Lowry acids in conjugate base form on any acidic monomer.

48. The polymer according to any one of embodiments 43 to 47, wherein each R⁸ is Li⁺.
49. The polymer according to any one of embodiments 43 to 47, wherein each R⁸ is Na⁺.
50. The polymer according to any one of embodiments 43 to 47, wherein each R⁸ is K.
51. The polymer according to any one of embodiments 43 to 47, wherein each R⁸ is N(H)₄⁺.
52. The polymer according to any one of embodiments 43 to 47, wherein each R⁸ is N(Me)₄⁺.
53. The polymer according to any one of embodiments 43 to 47, wherein each R⁸ is N(Et)₄⁺.
54. The polymer according to any one of embodiments 43 to 47, wherein each R⁸ is Zn²⁺.
55. The polymer according to any one of embodiments 43 to 47, wherein each R⁸ is Mg²⁺.
56. The polymer according to any one of embodiments 43 to 47, wherein each R⁸ is Ca²⁺.
57. The polymer according to any one of embodiments 1 to 56, wherein the polymer has at least one catalytic property selected from:

a) disruption of at least one hydrogen bond in cellulosic materials;

b) intercalation of the polymer into crystalline domains of cellulosic materials; and

c) cleavage of at least one glycosidic bond in cellulosic materials.

58. A solid particle comprising a solid core and at least one polymer according to any one of embodiments 1 to 57 coated on the surface of the solid core.
59. The solid particle according to embodiment 58, wherein the solid core comprises an inert material or a magnetic material.
60. The solid particle according to embodiment 58 or 59, wherein the solid particle is substantially free of pores.
61. The solid particle according to any one of embodiments 58 to 60, wherein the solid particle has at least one catalytic property selected from:

a) disruption of at least one hydrogen bond in cellulosic materials;

b) intercalation of the polymer into crystalline domains of cellulosic materials; and

c) cleavage of at least one glycosidic bond in cellulosic materials.

62. The solid particle according to embodiment 61, wherein at least about 50% of the catalytic activity of the solid particle is present on or near the exterior surface of the solid particle.
63. A composition comprising:

biomass; and

at least one polymer according to any one of embodiments 1 to 57.

64. The composition according to embodiment 63, further comprising a solvent.
65. The composition according to embodiment 64, wherein the solvent comprises water.
66. The composition according to any one of embodiments 63 to 65, wherein the biomass comprises cellulose, hemicellulose, or a combination thereof.
67. A chemically-hydrolyzed biomass composition comprising:

at least one polymer according to any one of embodiments 1 to 57;

one or more sugars; and

residual biomass.

68. The composition according to embodiment 67, wherein the one or more sugars are one or more monosaccharides, one or more oligosaccharides, or a mixture thereof.
69. The composition according to embodiment 67, wherein the one or more sugars are two or more sugars comprising at least one C4-C6 monosaccharide and at least one oligosaccharide.
70. The composition according to embodiment 67, wherein the one or more sugars are selected from glucose, galactose, fructose, xylose, and arabinose.
71. A method for degrading biomass into one or more sugars, comprising:

a) providing biomass;

b) combining the biomass with a polymer according to any one of embodiments 1 to 57 for a period of time sufficient to produce a degraded mixture, wherein the degraded mixture comprises a liquid phase and a solid phase, wherein the liquid phase comprises one or more sugars, and wherein the solid phase comprises residual biomass;

c) isolating at least a portion of the liquid phase from the solid phase; and

d) recovering the one or more sugars from the isolated portion of the liquid phase.

72. The method according to embodiment 71, wherein the biomass comprises cellulose, hemicellulose, or a combination thereof.
73. The method according to embodiment 71, further comprising combining the biomass with a composition comprising an effective amount of the polymer according to any one of embodiments 1 to 57.
74. The method according to embodiment 73, wherein the residual biomass comprises at least a portion of the composition.
75. The method according to embodiment 74, further comprising isolating at least a portion of the composition from the residual biomass.
76. The method according to embodiment 75, further comprising isolating the portion of the composition from the solid phase before recovering the one or more sugars from the isolated liquid phase.
77. The method according to embodiment 75, further comprising isolating the portion of the composition from the solid phase after recovering the one or more sugars from the isolated liquid phase.
78. The method according to embodiment 75, further comprising isolating the portion of the composition from the solid phase substantially contemporaneously with the recovering the one or more sugars from the isolated liquid phase.
79. The method according to any one of embodiment 71 to 78, further comprising combining the biomass and the polymer according to any one of embodiments 1 to 57 with a solvent.
80. The method according to embodiment 79, wherein the solvent comprises water.
81. The method according to any one of embodiments 71 to 80, wherein the isolating of at least a portion of the liquid phase from the solid phase produces a residual biomass mixture, and wherein the method further comprises:

i) providing a second biomass;

ii) combining the second biomass with the residual biomass mixture for a period of time sufficient to produce a second degraded mixture, wherein the second degraded mixture comprises a second liquid phase and a second solid phase, wherein the second liquid phase comprises one or more second sugars, and wherein the second solid phase comprises second residual biomass;

iii) isolating at least a portion of the second liquid phase from the second solid phase; and

iv) recovering the one or more second sugars from the isolated second liquid phase.

82. The method according to embodiment 81, wherein the second biomass comprises cellulose, hemicellulose, or a combination thereof.
83. The method according to embodiment 81 or 82, wherein the residual biomass mixture comprises at least a portion of the composition according to embodiment 73.
84. The method according to any one of embodiments 81 to 83, further comprising combining the second biomass and the residual biomass mixture with a second polymer that is a polymer according to embodiment 1.
85. The method according to any one of embodiments 81 to 84, further comprising combining the second biomass and the residual biomass mixture with a second solvent.
86. The method according to any one of embodiments 81 to 85, wherein the second solvent comprises water.
87. The method according to any one of embodiments 81 to 86, wherein the second residual biomass comprises at least a portion of the composition according to embodiment 73.
88. The method according to embodiment 87, further comprising isolating at least a portion of the composition according to embodiment 73 from the second residual biomass.
89. The method according to embodiment 88, further comprising isolating the portion of the composition from the second solid phase before recovering the one or more second sugars from the isolated second liquid phase.
90. The method according to embodiment 88, further comprising isolating the portion of the composition from the second solid phase after recovering the one or more second sugars from the isolated second liquid phase.
91. The method according to embodiment 88, further comprising isolating the portion of the composition from the second solid phase substantially contemporaneously with the recovering the one or more second sugars from the isolated second liquid phase.
92. The method according to any one of embodiments 71 to 91, wherein the biomass comprises cellulose and hemicellulose, and wherein the biomass is combined with the polymer at a temperature and at a pressure suitable to

a) hydrolyze the cellulose to a greater extent than the hemicellulose, or

b) hydrolyze the hemicellulose to a greater extent than the cellulose.

93. The method according to any one of embodiments 71 to 92, wherein the one or more sugars are selected from one or more monosaccharides, one or more oligosaccharides, or a combination thereof.
94. The method according to any one of embodiments 81 to 93, wherein the one or more second sugars are selected from one or more monosaccharides, one or more oligosaccharides, or a combination thereof.
95. The method according to embodiment 93 or 94, wherein the one or more monosaccharides comprise one or more C4-C6 monosaccharides.
96. The method according to embodiment 95, wherein the monosaccharides are selected from glucose, galactose, fructose, xylose, and arabinose.
97. The method according to any one of embodiments 71 to 96, further comprising pretreating the biomass before combining the biomass with the polymer.
98. The method according to embodiment 81, further comprising pretreating the second biomass before combining the second biomass with the residual biomass mixture.
99. The method according to embodiment 97 or 98, wherein the pretreatment of the biomass is selected from washing, solvent-extraction, solvent-swelling, comminution, milling, steam pretreatment, explosive steam pretreatment, dilute acid pretreatment, hot water pretreatment, alkaline pretreatment, lime pretreatment, wet oxidation, wet explosion, ammonia fiber explosion, organosolvent pretreatment, biological pretreatment, ammonia percolation, ultrasound, electroporation, microwave, supercritical CO₂, supercritical H₂O, ozone, and gamma irradiation, or any combination thereof.
100. A method for pretreating biomass before hydrolysis of the biomass to produce one or more sugars, comprising:

a) providing biomass;

b) combining the biomass with a polymer according to any one of embodiments 1 to 57 for a period of time sufficient to partially degrade the biomass; and

c) pretreating the partially degraded biomass before hydrolysis to produce one or more sugars.

101. The method according to embodiment 100, further comprising combining the biomass and the polymer with a solvent.
102. The method according to embodiment 101, wherein the solvent comprises water.
103. The method according to embodiment 100 or 101, wherein the biomass comprises cellulose, hemicellulose, or a combination thereof.
104. The method according to any one of embodiments 100 to 103, wherein the pretreatment of the partially degraded biomass is selected from washing, solvent-extraction, solvent-swelling, comminution, milling, steam pretreatment, explosive steam pretreatment, dilute acid pretreatment, hot water pretreatment, alkaline pretreatment, lime pretreatment, wet oxidation, wet explosion, ammonia fiber explosion, organosolvent pretreatment, biological pretreatment, ammonia percolation, ultrasound, electroporation, microwave, supercritical CO₂, supercritical H₂O, ozone, and gamma irradiation, or a combination thereof.
105. A method of hydrolyzing pretreated biomass to produce one or more sugars, comprising:

a) providing biomass pretreated according to any one of embodiments 100 to 104; and

b) hydrolyzing the pretreated biomass to produce one or more sugars.

106. The method according to embodiment 105, wherein the pretreated biomass is chemically hydrolyzed or enzymatically hydrolyzed.
107. The method according to embodiment 105 or 106, wherein the one or more sugars are selected from glucose, galactose, fructose, xylose, and arabinose.
108. A method of preparing a polymer according to any one of embodiments 1 to 57, comprising:

a) providing a starting polymer;

b) combining the starting polymer with a nitrogen-containing compound or a phosphorous-containing compound to produce an ionic polymer having at least one cationic group;

c) combining the ionic polymer with an effective acidifying reagent to produce an intermediate polymer; and

d) combining the intermediate polymer with an effective amount of one or more ionic salts to produce the polymer according to any one of embodiments 1 to 57;

wherein the steps a), b), c), and d) are performed in the order a), b), c), and d); or in the order a), c), d), and b); or in the order a), c), b), and d).

109. The method according to embodiment 108, wherein the starting polymer is selected from polyethylene, polypropylene, polyvinyl alcohol, polycarbonate, polystyrene, polyurethane, or a combination thereof.
110. The method according to embodiment 109, wherein the starting polymer is a polystyrene.
111. The method according to embodiment 110, wherein the starting polymer is poly(styrene-co-vinylbenzylhalide-co-divinylbenzene).
112. The method according to embodiment 111, wherein the starting polymer is poly(styrene-co-vinylbenzylchloride-co-divinylbenzene).
113. The method according to any one of embodiments 108 to 112, wherein the nitrogen-containing compound is selected from a pyrrolium compound, an imidazolium compound, a pyrazolium compound, an oxazolium compound, a thiazolium compound, a pyridinium compound, a pyrimidinium compound, a pyrazinium compound, a pyradizimium compound, a thiazinium compound, a morpholinium compound, a piperidinium compound, a piperizinium compound, and a pyrollizinium compound.
114. The method according to any one of embodiments 108 to 113, wherein the phosphorous-containing compound is selected from a triphenyl phosphonium compound, a trimethyl phosphonium compound, a triethyl phosphonium compound, a tripropyl phosphonium compound, a tributyl phosphonium compound, a trichloro phosphonium compound, and a trifluoro phosphonium compound.
115. The method according to any one of embodiments 108 to 114, wherein the Bronsted-Lowry acid is selected from sulfuric acid, phosphoric acid, hydrochloric acid, acetic acid and boronic acid.
116. The method according to any one of embodiments 108 to 115, wherein the ionic salt is selected from lithium chloride, lithium bromide, lithium nitrate, lithium sulfate, lithium phosphate, sodium chloride, sodium bromide, sodium sulfate, sodium hydroxide, sodium phosphate, potassium chloride, potassium bromide, potassium nitrate, potassium sulfate, potassium phosphate, ammonium chloride, ammonium bromide, ammonium phosphate, ammonium sulfate, tetramethylammonium chloride, tetramethylammonium bromide, tetraethylammonium chloride, di-methylimidazolium chloride, methylbutylimidazoliumchloride, methylmorpholinium chloride, zinc (II) chloride, zinc (II) bromide, magnesium (II) chloride, and calcium (II) chloride.
117. The method according to any one of embodiments 108 to 116, wherein the polymer has one or more catalytic properties selected from:

a) disruption of at least one hydrogen bond in cellulosic materials;

b) intercalation of the polymer into crystalline domains of cellulosic materials; and

c) cleavage of at least one glycosidic bond in cellulosic materials.

118. A polymer comprising acidic monomers and ionic monomers connected to form a polymeric backbone,

wherein a plurality of acidic monomers independently comprises at least one Bronsted-Lowry acid in acidic form, and at least one Bronsted-Lowry acid in conjugate base form having at least one associated cationic moiety, and

wherein at least one ionic monomer comprises at least one cationic group.

### EXAMPLES

### Preparation of Polymeric Materials

Except where otherwise indicated, commercial reagents can be obtained from Sigma-Aldrich, St. Louis, Mo., USA, and were purified prior to use following the guidelines of Perrin and Armarego. See Perrin, D. D. & Armarego, W. L. F., Purification of Laboratory Chemicals, 3rd ed.; Pergamon Press, Oxford, 1988. Nitrogen gas for use in chemical reactions was of ultra-pure grade, and was dried by passing it through a drying tube containing phosphorous pentoxide. Unless indicated otherwise, all non-aqueous reagents were transferred under an inert atmosphere via syringe or Schlenk flask. Organic solutions were concentrated under reduced pressure on a Buchi rotary evaporator. Where necessary, chromatographic purification of reactants or products was accomplished using forced-flow chromatography on 60 mesh silica gel according to the method described of Still et al., See Still et al., J. Org. Chem., 43: 2923 (1978). Thin-layer chromatography (TLC) was performed using silica-coated glass plates. Visualization of the developed chromatogram was performed using either Cerium Molybdate (i.e., Hanessian) stain or KMnO₄ stain, with gentle heating, as required. Fourier-Transform Infrared (FTIR) spectroscopic analysis of solid samples was performed on a Perkin-Elmer 1600 instrument equipped with a horizontal attenuated total reflectance (ATR) attachment using a Zinc Selenide (ZnSe) crystal.

### Example 1

### Preparation of poly[styrene-co-vinylbenzylchloride-co-divinylbenzene]

To a 500 mL round bottom flask (RBF) containing a stirred solution of 1.08 g of poly(vinylalcohol) in 250.0 mL of deionized H₂O at 0° C., was gradually added a solution containing 50.04 g (327.9 mmol) of vinylbenzyl chloride (mixture of 3- and 4-isomers), 10.13 g (97.3 mmol) of styrene, 1.08 g (8.306 mmol) of divinylbenzene (DVB, mixture of 3- and 4-isomers) and 1.507 g (9.2 mmol) of azobisisobutyronitrile (AIBN) in 150 mL of a 1:1 (by volume) mixture of benzene/tetrahydrofuran (THF) at 0° C. After 2 hours of stirring at 0° C. to homogenize the mixture, the reaction flask was transferred to an oil bath to increase the reaction temperature to 75° C., and the mixture was stirred vigorously for 28 hours. The resulting polymer beads were vacuum filtered using a fritted-glass funnel to collect the polymer product. The beads were washed repeatedly with 20% (by volume) methanol in water, THF, and MeOH, and dried overnight at 50° C. under reduced pressure to yield 59.84 g of polymer. The polymer beads were separated by size using sieves with mesh sizes 100, 200, and 400.

### Example 2

### Preparation of poly[styrene-co-3-methyl-1-(4-vinylbenzyl)-3H-imidazol-1-ium chloride-co-divinylbenzene]

Poly(styrene-co-vinylbenzylchloride-co-divinylbenzene) (Cl⁻ density=˜4.0 mmol/g, 50 g, 200 mmol) was charged into a 500 mL three neck flask (TNF) equipped with a mechanical stirrer, a dry nitrogen line, and purge valve. Dry dimethylformamide (185 ml) was added into the flask (via cannula under N₂) and stirred to form a viscous slurry of polymer resin. 1-Methylimidazole (36.5 g, 445 mmol) was then added and stirred at 95° C. for 8 h. After cooling, the reaction mixture was filtered using a fritted glass funnel under vacuum, washed sequentially with de-ionized water and ethanol, and finally air dried.

The chemical functionalization of the polymer material, expressed in millimoles of functional groups per gram of dry polymer resin (mmol/g) was determined by ion exchange titrimetry. For the determination of cation-exchangeable acidic protons, a known dry mass of polymer resin was added to a saturated aqueous solution of sodium chloride and titrated against a standard sodium hydroxide solution to the phenolphthalein end point. For the determination of anion-exchangeable ionic chloride content, a known dry mass of polymer resin was added to an aqueous solution of sodium nitrate and neutralized with sodium carbonate. The resulting mixture was titrated against a standardized solution of silver nitrate to the potassium chromate endpoint. For polymeric materials in which the exchangeable anion was not chloride, the polymer was first treated by stirring the material in aqueous hydrochloric acid, followed by washing repeatedly with water until the effluent was neutral (as determined by pH paper). The chemical functionalization of the polymer resin with methylimidazolium chloride groups was determined to be 2.60 mmol/g via gravimetry and 2.61 mmol/g via titrimetry.

### Example 3

### Preparation of poly[styrene-co-4-vinylbenzenesulfonic acid-co-3-methyl-1-(4-vinylbenzyl)-3H-imidazol-1-ium bisulfate-co-divinylbenzene]

Poly[styrene-co-3-methyl-1-(4-vinylbenzyl)-3H-imidazol-1-iumchloride-co-divinylbenzene] (63 g) was charged into a 500 mL flask equipped with a magnetic stir bar and condenser. Cold concentrated sulfuric acid (>98% w/w, H₂SO₄, 300 mL) was gradually added into the flask under stirring which resulted in formation of dark-red colored slurry of resin. The slurry was stirred at 85° C. for 4 h. After cooling to room temperature, the reaction mixture was filtered using fritted glass funnel under vacuum and then washed repeatedly with de-ionized water until the effluent was neutral, as determined by pH paper. The sulfonated resin beads were finally washed with ethanol and air dried. The chemical functionalization of the polymer resin with sulfonic acid groups was determined to be 1.60 mmol/g, as determined by titrimetry following the procedure of Example 2.

### Example 4

### Preparation of poly[styrene-co-4-vinylbenzenesulfonic acid-co-3-methyl-1-(4-vinylbenzyl)-3H-imidazol-1-ium chloride-co-divinylbenzene]

Poly[styrene-co-4-vinylbenzenesulfonic acid-co-3-methyl-1-(4-vinylbenzyl)-3H-imidazol-1-ium bisulfate-co-divinylbenzene] (sample of Example 3), contained in fritted glass funnel, was washed repeatedly with 0.1 M HCl solution to ensure complete exchange of HSO₄⁻ with Cl⁻. The resin was then washed with de-ionized water until the effluent was neutral, as determined by pH paper. The resin was finally air-dried.

### Example 5

### Preparation of poly[styrene-co-4-vinylbenzenesulfonic acid-co-3-methyl-1-(4-vinylbenzyl)-3H-imidazol-1-ium acetate-co-divinylbenzene]

The suspension of poly[styrene-co-4-vinylbenzenesulfonic acid-co-3-methyl-1-(4-vinylbenzyl)-3H-imidazol-1-ium bisulfate-co-divinylbenzene] (sample of Example 3) in 10% aqueous acetic acid solution was stirred for 2 h at 60° C. to ensure complete exchange of HSO₄⁻ with AcO⁻. The resin was filtered using fritted glass funnel and then washed multiple times with de-ionized water until the effluent was neutral. The resin was finally air-dried.

### Example 6

### Preparation of poly[styrene-co-3-ethyl-1-(4-vinylbenzyl)-3H-imidazol-1-ium chloride-co-divinylbenzene]

Poly(styrene-co-vinylbenzylchloride-co-divinylbenzene) (Cl⁻ density=˜4.0 mmol/g, 10 g, 40 mmol) was charged into a 250 three neck flask (TNF) equipped with a mechanical stirrer, a dry nitrogen line, and purge valve. Dry dimethylformamide (80 ml) was added into the flask (via cannula under N₂) and stirred to give viscous resin slurry. 1-Ethylimidazole (4.3 g, 44.8 mmol) was then added to the resin slurry and stirred at 95° C. under 8 h. After cooling, the reaction mixture was filtered using fritted glass funnel under vacuum, washed sequentially with de-ionized water and ethanol, and finally air dried. The chemical functionalization of the polymer resin with ethylimidazolium chloride groups was determined to be 1.80 mmol/g, as determined by titrimetry following the procedure of Example 1.

### Example 7

### Preparation of poly[styrene-co-4-vinylbenzenesulfonic acid-co-3-ethyl-1-(4-vinylbenzyl)-3H-imidazol-1-ium bisulfate-co-divinylbenzene]

Poly[styrene-co-3-ethyl-1-(4-vinylbenzyl)-3H-imidazol-1-ium chloride-co-divinylbenzene] (5 g) was charged into a 100 mL flask equipped with a magnetic stir bar and condenser. Cold concentrated sulfuric acid (>98% w/w, H₂SO₄, 45 mL) was gradually added into the flask under stirring which resulted in the formation of dark-red colored uniform slurry of resin. The slurry was stirred at 95-100° C. for 6 h. After cooling, the reaction mixture was filtered using fritted glass funnel under vacuum and then washed repeatedly with de-ionized water until the effluent was neutral, as determined by pH paper. The sulfonated beads were finally washed with ethanol and air dried. The chemical functionalization of the polymer with sulfonic acid groups was determined to be 1.97 mmol/g, as determined by titrimetry following the procedure of Example 2.

### Example 8

### Preparation of poly[styrene-co-4-vinylbenzenesulfonic acid-co-3-ethyl-1-(4-vinylbenzyl)-3H-imidazol-1-ium chloride-co-divinylbenzene]

Poly[styrene-co-4-vinylbenzenesulfonic acid-co-3-ethyl-1-(4-vinylbenzyl)-3H-imidazol-1-ium bisulfate-co-divinylbenzene] resin beads (sample of Example 7) contained in fritted glass funnel was washed multiple times with 0.1 M HCl solution to ensure complete exchange of HSO₄⁻ with Cl⁻. The resin was then washed with de-ionized water until the effluent was neutral, as determined by pH paper. The resin was finally washed with ethanol and air dried.

### Example 9

### Preparation of poly[styrene-co-1-(4-vinylbenzyl)-3H-imidazol-1-ium chloride-co-divinylbenzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Chloroform (50 ml) was added into the flask and stirred to form slurry of resin. Imidazole (2.8 g, 41.13 mmol) was then added to the resin slurry and stirred at 40° C. for 18 h. After completion of reaction, the reaction mixture was filtered using fritted glass funnel under vacuum, washed sequentially with de-ionized water and ethanol, and finally air dried. The chemical functionalization of the polymer resin with imidazolium chloride groups was determined to be 2.7 mmol/g, as determined by titrimetry following the procedure of Example 2.

### Example 10

### Preparation of poly[styrene-co-4-vinylbenzenesulfonic acid-co-1-(4-vinylbenzyl)-3H-imidazol-1-ium bisulfate-co-divinylbenzene]

Poly[styrene-co-1-(4-vinylbenzyl)-3H-imidazol-1-ium chloride-co-divinylbenzene] (5 g) was charged into a 100 mL flask equipped with a magnetic stir bar and condenser. Cold concentrated sulfuric acid (>98% w/w, H₂SO₄, 80 mL) was gradually added into the flask and stirred to form dark-red colored slurry of resin. The slurry was stirred at 95° C. for 8 h. After cooling, the reaction mixture was filtered using fritted glass funnel under vacuum and then washed repeatedly with de-ionized water until the effluent was neutral, as determined by pH paper. The sulfonated beads were finally washed with ethanol and air dried. The chemical functionalization of the polymer resin with sulfonic acid groups was determined to be 1.26 mmol/g, as determined by titrimetry following the procedure of Example 2.

### Example 11

### Preparation of poly[styrene-co-3-methyl-1-(4-vinylbenzyl)-3H-benzoimidazol-1-ium chloride-co-divinylbenzene]

Poly(styrene-co-vinylbenzylchloride-co-divinylbenzene) (Cl⁻ density=˜4.0 mmol/g, 4 g, 16 mmol) was charged into a 100 mL flask equipped with a magnetic stir bar and condenser. Dry dimethylformamide (50 ml) was added into the flask (via cannula under N₂) and stirred to form viscous slurry of polymer resin. 1-Methylbenzimidazole (3.2 g, 24.2 mmol) was then added to the resin slurry and the resulting reaction mixture was stirred at 95° C. for 18 h. After cooling, the reaction mixture was filtered using fritted glass funnel under vacuum, washed sequentially with de-ionized water and ethanol, and finally air dried. The chemical functionalization of the polymer with methylbenzimidazolium chloride groups was determined to be 1.63 mmol/g, as determined by titrimetry following the procedure of Example 2.

### Example 12

### Preparation of poly[styrene-co-4-vinylbenzenesulfonic acid-co-3-methyl-1-(4-vinylbenzyl)-3H-benzoimidazol-1-ium bisulfate-co-divinylbenzene]

Poly[styrene-co-3-methyl-1-(4-vinylbenzyl)-3H-benzoimidazol-1-ium chloride-co-divinylbenzene] (5.5 g) was charged into a 100 mL flask equipped with a magnetic stir bar and condenser. Cold concentrated sulfuric acid (>98% w/w, H₂SO₄, 42 mL) and fuming sulfuric acid (20% free SO₃, 8 mL) was gradually added into the flask and stirred to form dark-red colored slurry of resin. The slurry was stirred at 85° C. for 4 h. After cooling, the reaction mixture was filtered using fritted glass funnel under vacuum and then washed repeatedly with de-ionized water until the effluent was neutral, as determined by pH paper. The sulfonated beads were finally washed with ethanol and air dried. The chemical functionalization of the polymer with sulfonic acid groups was determined to be 1.53 mmol/g, as determined by titrimetry following the procedure of Example 2.

### Example 13

### Preparation of poly[styrene-co-1-(4-vinylbenzyl)-pyridinium chloride-co-divinylbenzene]

Poly(styrene-co-vinylbenzylchloride-co-divinylbenzene) (Cl⁻ density=˜4.0 mmol/g, 5 g, 20 mmol) was charged into a 100 mL flask equipped with a magnetic stir bar and condenser. Dry dimethylformamide (45 ml) was added into the flask (via cannula under N₂) while stirring and consequently, the uniform viscous slurry of polymer resin was obtained. Pyridine (3 mL, 37.17 mmol) was then added to the resin slurry and stirred at 85-90° C. for 18 h. After cooling, the reaction mixture was filtered using fritted glass funnel under vacuum, washed sequentially with de-ionized water and ethanol, and finally air dried. The chemical functionalization of the polymer resin with pyridinium chloride groups was determined to be 3.79 mmol/g, as determined by titrimetry following the procedure of Example 2.

### Example 14

### Preparation of poly[styrene-co-4-vinylbenzenesulfonic acid-co-1-(4-vinylbenzyl)-pyridinium-bisulfate-co-divinylbenzene]

Poly[styrene-co-1-(4-vinylbenzyl)-pyridinium chloride-co-divinylbenzene] (4 g) resin beads were charged into a 100 mL flask equipped with a magnetic stir bar and condenser. Cold concentrated sulfuric acid (>98% w/w, H₂SO₄, 45 mL) was gradually added into the flask under stirring which consequently resulted in the formation of dark-red colored uniform slurry of resin. The slurry was heated at 95-100° C. under continuous stirring for 5 h. After completion of reaction, the cooled reaction mixture was filtered using fritted glass funnel under vacuum and then washed repeatedly with de-ionized water until the effluent was neutral, as determined by pH paper. The resin beads were finally washed with ethanol and air dried. The chemical functionalization of the polymer with sulfonic acid groups was determined to be 0.64 mmol/g, as determined by titrimetry following the procedure of Example 2.

### Example 15

### Preparation of poly[styrene-co-1-(4-vinylbenzyl)-pyridinium chloride-co-3-methyl-1-(4-vinylbenzyl)-3H-imidazol-1-ium chloride-co-divinylbenzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Dry dimethylformamide (80 ml) was added into the flask (via cannula under N₂) while stirring which resulted in the formation of viscous slurry of polymer resin. Pyridine (1.6 mL, 19.82 mmol) and 1-methylimidazole (1.7 mL, 21.62 mmol) were then added to the resin slurry and the resulting reaction mixture was stirred at 95° C. for 18 h. After completion of reaction, the reaction mixture was cooled, filtered using fritted glass funnel under vacuum, washed sequentially with de-ionized water and ethanol, and finally air dried. The chemical functionalization of the polymer with pyridinium chloride and 1-methylimidazolium chloride groups was determined to be 3.79 mmol/g, as determined by titrimetry following the procedure of Example 2.

### Example 16

### Preparation of poly[styrene-co-4-vinylbenzenesulfonic acid-co-1-(4-vinylbenzyl)-pyridiniumchloride-co-3-methyl-1-(4-vinylbenzyl)-3H-imidazol-1-ium bisulfate-co-divinylbenzene]

Poly[styrene-co-1-(4-vinylbenzyl)-pyridinium chloride-co-3-methyl-1-(4-vinylbenzyl)-3H-imidazol-1-ium chloride-co-divinylbenzene] (5 g) was charged into a 100 mL flask equipped with a magnetic stir bar and condenser. Cold concentrated sulfuric acid (>98% w/w, H₂SO₄, 75 mL) and fuming sulfuric acid (20% free SO₃, 2 mL) were then gradually added into the flask under stirring which consequently resulted in the formation of dark-red colored uniform slurry of resin. The slurry was heated at 95-100° C. under continuous stirring for 12 h. After completion of reaction, the cooled reaction mixture was filtered using fritted glass funnel under vacuum and then washed repeatedly with de-ionized water until the effluent was neutral, as determined by pH paper. The sulfonated resin beads were finally washed with ethanol and air dried. The chemical functionalization of the polymer resin with sulfonic acid groups was determined to be 1.16 mmol/g, as determined by titrimetry following the procedure of Example 2.

### Example 17

### Preparation of poly[styrene-co-4-methyl-4-(4-vinylbenzyl)-morpholin-4-ium chloride-co-divinylbenzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Dry dimethylformamide (85 ml) was added into the flask (via cannula under N₂) while stirring which resulted in the formation of uniform viscous slurry of polymer resin. 1-Methylmorpholine (5.4 mL, 49.12 mmol) were then added to the resin slurry and the resulting reaction mixture was stirred at 95° C. for 18 h. After cooling, the reaction mixture was filtered using fritted glass funnel under vacuum, washed sequentially with de-ionized water and ethanol, and finally air dried. The chemical functionalization of the polymer with methylmorpholinium chloride groups was determined to be 3.33 mmol/g, as determined by titrimetry following the procedure of Example 2.

### Example 18

### Preparation of poly[styrene-co-4-vinylbenzenesulfonic acid-co-4-methyl-4-(4-vinylbenzyl)-morpholin-4-ium bisulfate-co-divinylbenzene]

Poly[styrene-co-1-4-methyl-4-(4-vinylbenzyl)-morpholin-4-ium chloride-co-divinylbenzene] (8 g) was charged into a 100 mL flask equipped with a magnetic stir bar and condenser. Cold concentrated sulfuric acid (>98% w/w, H₂SO₄, 50 mL) was gradually added into the flask under stirring which consequently resulted in the formation of dark-red colored slurry. The slurry was stirred at 90° C. for 8 h. After cooling, the reaction mixture was filtered using fritted glass funnel under vacuum, washed repeatedly with de-ionized water until the effluent was neutral, as determined by pH paper. The sulfonated resin beads were finally washed with ethanol and air dried. The chemical functionalization of the polymer with sulfonic acid groups was determined to be 1.18 mmol/g, as determined by titrimetry following the procedure of Example 2.

### Example 19

### Preparation of [polystyrene-co-triphenyl-(4-vinylbenzyl)-phosphoniumchloride-co-divinylbenzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Dry dimethylformamide (80 ml) was added into the flask (via cannula under N₂) while stirring and the uniform viscous slurry of polymer resin was obtained. Triphenylphosphine (11.6 g, 44.23 mmol) was then added to the resin slurry and the resulting reaction mixture was stirred at 95° C. for 18 h. After cooling, the reaction mixture was filtered using fritted glass funnel under vacuum, washed sequentially with de-ionized water and ethanol, and finally air dried. The chemical functionalization of the polymer with triphenylphosphonium chloride groups was determined to be 2.07 mmol/g, as determined by titrimetry following the procedure of Example 2.

### Example 20

### Preparation of poly[styrene-co-4-vinylbenzenesulfonic acid-co-triphenyl-(4-vinylbenzyl)-phosphonium bisulfate-co-divinylbenzene]

Poly(styrene-co-triphenyl-(4-vinylbenzyl)-phosphonium chloride-co-divinylbenzene) (7 g) was charged into a 100 mL flask equipped with a magnetic stir bar and condenser. Cold concentrated sulfuric acid (>98% w/w, H₂SO₄, 40 mL) and fuming sulfuric acid (20% free SO₃, 15 mL) were gradually added into the flask under stirring which consequently resulted in the formation of dark-red colored slurry. The slurry was stirred at 95° C. for 8 h. After cooling, the reaction mixture was filtered using fritted glass funnel under vacuum, washed repeatedly with de-ionized water until the effluent was neutral, as determined by pH paper. The sulfonated resin beads were finally washed with ethanol and air dried. The chemical functionalization of the polymer with sulfonic acid groups was determined to be 2.12 mmol/g, as determined by titrimetry following the procedure of Example 2.

### Example 21

### Preparation of poly[styrene-co-1-(4-vinylbenzyl)-piperidine-co-divinylbenzene]

Poly(styrene-co-vinylbenzyl chloride-co-divinylbenzene) (Cl⁻ density=˜4.0 mmol/g, 10 g, 40 mmol) was charged into a 100 mL flask equipped with a magnetic stir bar and condenser. Dry dimethylformamide (50 ml) was added into the flask (via cannula under N₂) while stirring which resulted in the formation of uniform viscous slurry of polymer resin. Piperidine (4 g, 46.98 mmol) was then added to the resin slurry and the resulting reaction mixture was stirred at 95° C. for 16 h. After cooling, the reaction mixture was filtered using fritted glass funnel under vacuum, washed sequentially with de-ionized water and ethanol, and finally air dried.

### Example 22

### Preparation of poly[styrene-co-4-vinylbenzenesulfonic acid-co-1-(4-vinylbenzyl)-piperidine-co-divinyl benzene]

Poly[styrene-co-1-(4-vinylbenzyl)-piperidine-co-divinyl benzene] (7 g) was charged into a 100 mL flask equipped with a magnetic stir bar and condenser. Cold concentrated sulfuric acid (>98% w/w, H₂SO₄, 45 mL) and fuming sulfuric acid (20% free SO₃, 12 mL) were gradually added into the flask under stirring which consequently resulted in the formation of dark-red colored slurry. The slurry was stirred at 95° C. for 8 h. After completion of reaction, the cooled reaction mixture was filtered using fritted glass funnel under vacuum and then washed repeatedly with de-ionized water until the effluent was neutral, as determined by pH paper. The resin beads were finally washed with ethanol and air dried. The chemical functionalization of the polymer with sulfonic acid groups was determined to be 0.72 mmol/g, as determined by titrimetry following the procedure of Example 2.

### Example 23

### Preparation of poly[styrene-co-4-vinylbenzenesulfonic acid-co-1-methyl-1-(4-vinylbenzyl)-piperdin-1-ium chloride-co-divinyl benzene]

Poly(styrene-co-4-(1-piperidino)methylstyrene-co-divinylbenzene) (4 g) was charged into a 100 mL flask equipped with a magnetic stir bar and condenser. Dry dimethylformamide (40 ml) was added into the flask (via cannula under N₂) under stirring to obtain uniform viscous slurry. Iodomethane (1.2 ml) and potassium iodide (10 mg) were then added into the flask. The reaction mixture was stirred at 95° C. for 24 h. After cooling, the reaction mixture was filtered using fritted glass funnel under vacuum and then washed multiple times with dilute HCl solution to ensure complete exchange of I⁻ with Cl⁻. The resin was finally washed with de-ionized water until the effluent was neutral, as determined by pH paper. The resin was finally air-dried.

### Example 24

### Preparation of poly[styrene-co-4-(4-vinylbenzyl)-morpholine-co-divinyl benzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Dry dimethylformamide (50 ml) was added into the flask (via cannula under N₂) while stirring and consequently, the uniform viscous slurry of polymer resin was obtained. Morpholine (4 g, 45.92 mmol) was then added to the resin slurry and the resulting reaction mixture was heated at 95° C. under continuous stirring for 16 h. After completion of reaction, the reaction mixture was cooled, filtered using fritted glass funnel under vacuum, washed sequentially with de-ionized water and ethanol, and finally air dried.

### Example 25

### Preparation of poly[styrene-co-4-vinylbenzenesulfonic acid-co-4-(4-vinylbenzyl)-morpholine-co-divinyl benzene]

Poly[styrene-co-4-(4-vinylbenzyl)-morpholine-co-divinyl benzene] (10 g) was charged into a 200 mL flask equipped with a magnetic stir bar and condenser. Cold concentrated sulfuric acid (>98% w/w, H₂SO₄, 90 mL) and fuming sulfuric acid (20% free SO₃, 10 mL) were gradually added into the flask while stirring which consequently resulted in the formation of dark-red colored slurry. The slurry was stirred at 95° C. for 8 h. After cooling, the reaction mixture was filtered using fritted glass funnel under vacuum and then washed repeatedly with de-ionized water until the effluent was neutral, as determined by pH paper. The sulfonated resin beads were finally washed with ethanol and air dried. The chemical functionalization of the polymer with sulfonic acid groups was determined to be 0.34 mmol/g, as determined by titrimetry following the procedure of Example 2.

### Example 26

### Preparation of poly[styrene-co-4-vinylbenzenesulfonic acid-co-4-(4-vinylbenzyl)-morpholine-4-oxide-co-divinyl benzene]

Poly[styrene-co-4-vinylbenzenesulfonic acid-co-4-(4-vinylbenzyl)-morpholine-co-divinyl benzene] (6 g) was charged into a 100 mL flask equipped with a magnetic stir bar and condenser. Methanol (60 mL) was then charged into the flask, followed by addition of hydrogen peroxide (30% solution in water, 8.5 mL). The reaction mixture was refluxed under continuous stirring for 8 h. After cooling, the reaction mixture was filtered, washed sequentially with de-ionized water and ethanol, and finally air dried.

### Example 27

### Preparation of poly[styrene-co-4-vinylbenzyl-triethylammonium chloride-co-divinylbenzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Dry dimethylformamide (80 ml) was added into the flask (via cannula under N₂) while stirring and consequently the uniform viscous slurry of polymer resin was obtained. Triethylamine (5 mL, 49.41 mmol) was then added to the resin slurry and the resulting reaction mixture was stirred at 95° C. for 18 h. After cooling, the reaction mixture was filtered using fritted glass funnel under vacuum, washed sequentially with de-ionized water and ethanol, and finally air dried. The chemical functionalization of the polymer resin with triethylammonium chloride groups was determined to be 2.61 mmol/g, as determined by titrimetry following the procedure of Example 2.

### Example 28

### Preparation of poly[styrene-co-4-vinylbenzenesulfonic acid-co-triethyl-(4-vinylbenzyl)-ammonium chloride-co-divinylbenzene]

Poly[styrene-co-triethyl-(4-vinylbenzyl)-ammonium chloride-co-divinylbenzene] (6 g) was charged into a 100 mL flask equipped with a magnetic stir bar and condenser. Cold concentrated sulfuric acid (>98% w/w, H₂SO₄, 60 mL) was gradually added into the flask under stirring which consequently resulted in the formation of dark-red colored uniform slurry of resin. The slurry was stirred at 95-100° C. for 8 h. After cooling, the reaction mixture was filtered using fritted glass funnel under vacuum and then washed repeatedly with de-ionized water until the effluent was neutral, as determined by pH paper. The sulfonated resin beads were finally washed with ethanol and air dried. The chemical functionalization of the polymer with sulfonic acid groups was determined to be 0.31 mmol/g, as determined by titrimetry following the procedure of Example 2.

### Example 29

### Preparation of poly[styrene-co-4-vinylbenzenesulfonic acid-co-vinylbenzylchloride-co-divinylbenzene]

Poly(styrene-co-vinylbenzyl chloride-co-divinylbenzene) (6 g) was charged into a 100 mL flask equipped with a magnetic stir bar and condenser. Fuming sulfuric acid (20% free SO₃, 25 mL) was gradually added into the flask under stirring which consequently resulted in the formation of dark-red colored slurry. The slurry was stirred at 90° C. for 5 h. After cooling, the reaction mixture was filtered using fritted glass funnel under vacuum, washed sequentially with de-ionized water and ethanol, and finally air dried. The chemical functionalization of the polymer with sulfonic acid groups was determined to be 0.34 mmol/g, as determined by titrimetry following the procedure of Example 2.

### Example 30

### Preparation of poly[styrene-co-4-vinylbenzenesulfonic acid-co-3-methyl-1-(4-vinylbenzyl)-3H-imidazol-1-ium chloride-co-divinylbenzene]

Poly[styrene-co-4-vinylbenzenesulfonic acid-co-vinylbenzylchloride-co-divinylbenzene] (5 g) was charged into a 100 mL flask equipped with a magnetic stir bar and condenser. Dry dimethylformamide (20 ml) was added into the flask (via cannula under N₂) while stirring and the uniform viscous slurry of polymer resin was obtained. 1-Methylimidazole (3 mL, 49.41 mmol) was then added to the resin slurry and the resulting reaction mixture was stirred at 95° C. for 18 h. After cooling, reaction mixture was filtered using fritted glass funnel under vacuum and then washed repeatedly with de-ionized water. The resin beads were finally washed with ethanol and air dried. The chemical functionalization of the polymer with sulfonic acid group and methylimidiazolium chloride groups was determined to be 0.23 mmol/g and 2.63 mmol/g, respectively, as determined by titrimetry following the procedure of Example 2.

### Example 31

### Preparation of poly[styrene-co-3-methyl-1-(4-vinylbenzyl)-3H-imidazol-1-ium chloride-co-4-boronyl-1-(4-vinylbenzyl)-pyridinium chloride-co-divinylbenzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Dry dimethylformamide (80 ml) was added into the flask (via cannula under N₂) while stirring and consequently the uniform viscous slurry of polymer resin was obtained. 4-Pyridyl-boronic acid (1.8 g, 14.6 mmol) was then added to the resin slurry and the resulting reaction mixture was stirred at 95° C. for 2 days. 1-Methylimidazole (3 mL, 49.41 mmol) was then added to the reaction mixture and stirred further at 95° C. for 1 day. After cooling to room temperature, the reaction mixture was filtered using fritted glass funnel under vacuum, washed sequentially with de-ionized water and ethanol, and finally air dried. The chemical functionalization of the polymer with boronic acid group was determined to be 0.28 mmol/g respectively, as determined by titrimetry following the procedure of Example 2.

### Example 32

### Preparation of poly[styrene-co-3-methyl-1-(4-vinylbenzyl)-3H-imidazol-1-ium chloride-co-1-(4-vinylphenyl)methylphosphonic acid-co-divinylbenzene]

Poly[styrene-co-3-methyl-1-(4-vinylbenzyl)-3H-imidazol-1-ium chloride-co-divinylbenzene](Cl⁻ density=˜2.73 mmol/g, 5 g) was charged into a 100 mL flask equipped with a magnetic stir bar and condenser. Triethylphosphite (70 ml) was added into the flask and the resulting suspension was stirred at 120° C. for 2 days. The reaction mixture was filtered using fritted glass funnel and the resin beads were washed repeatedly with de-ionized water and ethanol. These resin beads were then suspended in concentrated HCl (80 ml) and refluxed at 115° C. under continuous stirring for 24 h. After cooling to room temperature, the reaction mixture was filtered using fritted glass funnel under vacuum and then washed repeatedly with de-ionized water. The resin beads were finally washed with ethanol and air dried. The chemical functionalization of the polymer with phosphonic acid group and methylimidiazolium chloride groups was determined to be 0.11 mmol/g and 2.81 mmol/g, respectively, as determined by titrimetry following the procedure of Example 2.

### Example 33

### Preparation of poly[styrene-co-4-vinylbenzenesulfonic acid-co-vinylbenzylchloride-co-vinyl-2-pyridine-co-divinylbenzene]

Poly(styrene-co-vinylbenzylchloride-co-vinyl-2-pyridine-co-divinylbenzene) (5 g) was charged into a 100 mL flask equipped with a magnetic stir bar and condenser. Cold concentrated sulfuric acid (>98% w/w, H₂SO₄, 80 mL) was gradually added into the flask under stirring which consequently resulted in the formation of dark-red colored slurry. The slurry was stirred at 95° C. for 8 h. After cooling to room temperature, the reaction mixture was filtered using fritted glass funnel under vacuum, washed repeatedly with de-ionized water until the effluent was neutral, as determined by pH paper. The sulfonated beads were finally washed with ethanol and air dried. The chemical functionalization of the polymer with sulfonic acid groups was determined to be 3.49 mmol/g, as determined by titrimetry following the procedure of Example 2.

### Example 34

### Preparation of poly[styrene-co-4-vinylbenzenesulfonic acid-co-vinylbenzylchloride-co-1-methyl-2-vinyl-pyridinium chloride-co-divinylbenzene]

Poly[styrene-co-4-vinylbenzenesulfonic acid-co-vinylbenzylchloride-co-vinyl-2-pyridine-co-divinylbenzene] (4 g) was charged into a 100 mL flask equipped with a magnetic stir bar and condenser. Dry dimethylformamide (80 ml) was added into the flask (via cannula under N₂) under stirring to obtain uniform viscous slurry. Iodomethane (1.9 ml) was then gradually added into the flask followed by addition of potassium iodide (10 mg). The reaction mixture was stirred at 95° C. for 24 h. After cooling to room temperature, the cooled reaction mixture was filtered using fritted glass funnel under vacuum and then washed multiple times with dilute HCl solution to ensure complete exchange of I⁻ with Cl⁻. The resin beads were finally washed with de-ionized water until the effluent was neutral, as determined by pH paper and then air-dried.

### Example 35

### Preparation of poly[styrene-co-4-vinylbenzenesulfonic acid-co-4-(4-vinylbenzyl)-morpholine-4-oxide-co-divinyl benzene]

Poly[styrene-co-4-(4-vinylbenzyl)-morpholine-4-oxide-co-divinyl benzene] (3 g) was charged into a 100 mL flask equipped with a magnetic stir bar and condenser. Cold concentrated sulfuric acid (>98% w/w, H₂SO₄, 45 mL) was gradually added into the flask under stirring which consequently resulted in the formation of dark-red colored slurry. The slurry was stirred at 95° C. for 8 h. After cooling to room temperature, the reaction mixture was filtered using fritted glass funnel under vacuum, washed repeatedly with de-ionized water until the effluent was neutral, as determined by pH paper. The sulfonated beads were finally washed with ethanol and air dried.

### Example 36

### Preparation of poly[styrene-co-4-vinylphenylphosphonic acid-co-3-methyl-1-(4-vinylbenzyl)-3H-imidazol-1-ium chloride-co-divinylbenzene]

Poly[styrene-co-3-methyl-1-(4-vinylbenzyl)-3H-imidazol-1-iumchloride-co-divinylbenzene] (Cl⁻ density=˜2.73 mmol/g, 5 g) was charged into a 100 mL flask equipped with a magnetic stir bar and condenser. Diethylphosphite (30 ml) and t-butylperoxide (3.2 ml) were added into the flask and the resulting suspension was stirred at 120° C. for 2 days. The reaction mixture was filtered using fritted glass funnel and the resin beads were washed repeatedly with de-ionized water and ethanol. These resin beads were then suspended in concentrated HCl (80 ml) and refluxed at 115° C. under continuous stirring for 2 days. After cooling to room temperature, the reaction mixture was filtered using fritted glass funnel under vacuum and then washed repeatedly with de-ionized water. The resin beads were finally washed with ethanol and air dried. The chemical functionalization of the polymer with aromatic phosphonic acid group was determined to be 0.15 mmol/g, as determined by titrimetry following the procedure of Example 2.

### Example 37

### Preparation of poly[styrene-co-3-carboxymethyl-1-(4-vinylbenzyl)-3H-imidazol-1-ium chloride-co-divinylbenzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Dimethylformamide (50 ml) was added into the flask and stirred to form a slurry of resin. Imidazole (2.8 g, 41.13 mmol) was then added to the resin slurry and stirred at 80° C. for 8 h. The reaction mixture was then cooled to 40° C. and t-butoxide (1.8 g) was added into the reaction mixture and stirred for 1 h. Bromoethylacetate (4 ml) was then added to and the reaction mixture was stirred at 80° C. for 6 h. After cooling to room temperature, the reaction mixture was filtered using fritted glass funnel under vacuum and then washed repeatedly with de-ionized water. The washed resin beads were suspended in the ethanolic sodium hydroxide solution and refluxed overnight. The resin beads were filtered and successively washed with deionized water multiple times and ethanol, and finally air dried. The chemical functionalization of the polymer with carboxylic acid group was determined to be 0.09 mmol/g, as determined by titrimetry following the procedure of Example 2.

### Example 38

### Preparation of poly[styrene-co-5-(4-vinylbenzylamino)-isophthalic acid-co-3-methyl-1-(4-vinylbenzyl)-3H-imidazol-1-ium chloride-co-divinylbenzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Dry dimethylformamide (80 ml) was added into the flask (via cannula under N₂) while stirring and consequently the uniform viscous slurry of polymer resin was obtained. Dimethyl aminoisophthalate (3.0 g, 14.3 mmol) was then added to the resin slurry and the resulting reaction mixture was stirred at 95° C. for 16 h. 1-Methylimidazole (2.3 mL, 28.4 mmol) was then added to the reaction mixture and stirred further at 95° C. for 1 day. After cooling to room temperature, the reaction mixture was filtered using fritted glass funnel under vacuum, washed sequentially with de-ionized water and ethanol. The washed resin beads were suspended in the ethanolic sodium hydroxide solution and refluxed overnight. The resin beads were filtered and successively washed with deionized water multiple times and ethanol, and finally air dried. The chemical functionalization of the polymer with carboxylic acid group was determined to be 0.16 mmol/g, as determined by titrimetry following the procedure of Example 2.

### Example 39

### Preparation of poly[styrene-co-(4-vinylbenzylamino)-acetic acid-co-3-methyl-1-(4-vinylbenzyl)-3H-imidazol-1-ium chloride-co-divinylbenzene]

Poly(styrene-co-vinylbenzylchloride-co-divinylbenzene) (Cl⁻ density=˜4.0 mmol/g, 10 g, 40 mmol) was charged into a 100 mL flask equipped with a magnetic stir bar and condenser. Dry dimethylformamide (80 ml) was added into the flask (via cannula under N₂) while stirring and consequently the uniform viscous slurry of polymer resin was obtained. Glycine (1.2 g, 15.9 mmol) was then added to the resin slurry and the resulting reaction mixture was stirred at 95° C. for 2 days. 1-Methylimidazole (2.3 mL, 28.4 mmol) was then added to the reaction mixture and stirred further at 95° C. for 12 hours. After cooling to room temperature, the reaction mixture was filtered using fritted glass funnel under vacuum, washed sequentially with de-ionized water and ethanol, and finally air dried. The chemical functionalization of the polymer with carboxylic acid group was determined to be 0.05 mmol/g, as determined by titrimetry following the procedure of Example 2.

### Example 40

### Preparation of poly[styrene-co-(1-vinyl-1H-imidazole)-co-divinylbenzene]

To a 500 mL round bottom flask (RBF) containing a stirred solution of 1.00 g of poly(vinylalcohol) in 250.0 mL of deionized H₂O at 0° C. is gradually added a solution containing 35 g (371 mmol) of 1-vinylimidazole, 10 g (96 mmol) of styrene, 1 g (7.7 mmol) of divinylbenzene (DVB) and 1.5 g (9.1 mmol) of azobisisobutyronitrile (AIBN) in 150 mL of a 1:1 (by volume) mixture of benzene/tetrahydrofuran (THF) at 0° C. After 2 hours of stirring at 0° C. to homogenize the mixture, the reaction flask is transferred to an oil bath to increase the reaction temperature to 75° C., and the mixture is stirred vigorously for 24 hours. The resulting polymer is vacuum filtered using a fritted-glass funnel, washed repeatedly with 20% (by volume) methanol in water, THF, and MeOH, and then dried overnight at 50° C. under reduced pressure.

### Example 41

### Preparation of poly(styrene-co-vinylbenzylmethylimidazolium chloride-co-vinylbenzylmethylmorpholinium chloride-co-vinylbenzyltriphenylphosphonium chloride-co-divinylbenzene)

1-methylimidazole (4.61 g, 56.2 mmol), 4-methylmorpholine (5.65 g, 56.2 mmol), and triphenylphosphine (14.65, 55.9 mmol) were charged into a 500 mL flask equipped with a magnetic stir bar and a condenser. Acetone (100 ml) was added into the flask and mixture was stirred at 50° C. for 10 min. Poly(styrene-co-vinylbenzylchloride-co-divinylbenzene) (1% DVB, Cl⁻ density=4.18 mmol/g dry resin, 40.22 g, 168 mmol) was charged into the flask while stirring until a uniform polymer suspension was obtained. The resulting reaction mixture was refluxed for 24 h. After cooling, the reaction mixture was filtered using a fritted glass funnel under vacuum, washed sequentially with acetone and ethyl acetate, and dried overnight at 70° C. The chemical functionalization of the polymer resin with chloride groups was determined to be 2.61 mmol/g dry resin via titrimetry.

### Example 42

### Preparation of sulfonated poly(styrene-co-vinylbenzylmethylimidazolium bisulfate-co-vinylbenzylmethylmorpholinium bisulfate-co-vinylbenzyltriphenyl phosphonium bisulfate-co-divinylbenzene)

Poly(styrene-co-vinylbenzylmethylimidazolium chloride-co-vinylbenzylmethylmorpholinium chloride-co-vinylbenzyltriphenylphosphonium chloride-co-divinylbenzene) (35.02 g) was charged into a 500 mL flask equipped with a magnetic stir bar and condenser. Fuming sulfuric acid (20% free SO₃, 175 mL) was gradually added into the flask and stirred to form dark-red resin suspension. The mixture was stirred overnight at 90° C. After cooling to room temperature, the reaction mixture was filtered using fritted glass funnel under vacuum and then washed repeatedly with de-ionized water until the effluent was neutral, as determined by pH paper. The sulfonated polymer resin was air dried to a final moisture content of 56% g H₂O/g wet polymer. The chemical functionalization of the polymer resin with sulfonic acid groups was determined to be 3.65 mmol/g dry resin.

### Example 43

### Preparation of poly(styrene-co-vinylbenzylmethylimidazolium chloride-co-vinylbenzylmethylmorpholinium chloride-co-vinylbenzyltriphenylphosphonium chloride-co-divinylbenzene)

1-methylimidazole (7.02 g, 85.5 mmol), 4-methylmorpholine (4.37 g, 43.2 mmol) and triphenylphosphine (11.09, 42.3 mmol) were charged into a 500 mL flask equipped with a magnetic stir bar and condenser. Acetone (100 ml) was added into the flask and mixture was stirred at 50° C. for 10 min. Poly(styrene-co-vinylbenzylchloride-co-divinylbenzene) (1% DVB, Cl⁻ density=4.18 mmol/g dry resin, 40.38 g, 169 mmol) was charged into flask while stirring until a uniform suspension was obtained. The resulting reaction mixture was refluxed for 18 h. After cooling, the reaction mixture was filtered using fritted glass funnel under vacuum, washed sequentially with acetone and ethyl acetate, and dried at 70° C. overnight. The chemical functionalization of the polymer resin with chloride groups was determined to be 2.36 mmol/g dry resin dry resin via titrimetry.

### Example 44

### Preparation of sulfonated poly(styrene-co-vinylbenzylmethylimidazolium bisulfate-co-vinylbenzylmethylmorpholinium bisulfate-co-vinylbenzyltriphenyl phosphonium bisulfate-co-divinylbenzene)

Poly(styrene-co-vinylbenzylmethylimidazolium chloride-co-vinylbenzylmethylmorpholinium chloride-co-vinylbenzyltriphenylphosphonium chloride-co-divinylbenzene) (35.12 g) was charged into a 500 mL flask equipped with a magnetic stir bar and condenser. Fuming sulfuric acid (20% free SO₃, 175 mL) was gradually added into the flask and stirred to form dark-red colored slurry of resin. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated beads were finally air dried. The chemical functionalization of the polymer resin with sulfonic acid groups was determined to be 4.38 mmol/g dry resin.

### Example 45

### Preparation of poly(styrene-co-vinylbenzylmethylmorpholinium chloride-co-vinylbenzyltriphenylphosphonium chloride-co-divinylbenzene)

4-methylmorpholine (8.65 g, 85.5 mmol) and triphenylphosphine (22.41, 85.3 mmol) were charged into a 500 mL flask equipped with a magnetic stir bar and condenser. Acetone (100 ml) was added into the flask and mixture was stirred at 50° C. for 10 min. Poly(styrene-co-vinylbenzylchloride-co-divinylbenzene) (1% DVB, Cl⁻ density=4.18 mmol/g dry resin, 40.12 g, 167 mmol) was charged into flask while stirring until a uniform suspension was obtained. The resulting reaction mixture was refluxed for 24 h. After cooling, the reaction mixture was filtered using fritted glass funnel under vacuum, washed sequentially with acetone and ethyl acetate, and dried at 70° C. overnight. The chemical functionalization of the polymer resin with chloride groups was determined to be 2.22 mmol/g dry resin via titrimetry.

### Example 46

### Preparation of sulfonated poly(styrene-co-vinylbenzylmethylmorpholinium bisulfate-co-vinylbenzyltriphenylphosphonium bisulfate-co-divinylbenzene)

Poly(styrene-co-vinylbenzylmethylimidazolium chloride-co-vinylbenzylmethylmorpholinium chloride-co-vinylbenzyltriphenylphosphonium chloride-co-divinylbenzene) (35.08 g) was charged into a 500 mL flask equipped with a magnetic stir bar and condenser. Fuming sulfuric acid (20% free SO₃, 175 mL) was gradually added into the flask and stirred to form dark-red colored slurry of resin. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated beads were dried under air to a final moisture content of 52% g H₂O/g wet resin. The chemical functionalization of the polymer resin with sulfonic acid groups was determined to be 4.24 mmol/g dry resin.

### Example 47

### Preparation of Phenol-Formaldehyde Resin

Phenol (12.87 g, 136.8 mmol) was dispensed into a 100 mL round bottom flask (RBF) equipped with a stir bar and condenser. De-ionized water (10 g) was charged into the flask. 37% Formalin solution (9.24 g, 110 mmol) and oxalic acid (75 mg) were added. The resulting reaction mixture was refluxed for 30 min. Additional oxalic acid (75 mg) was then added and refluxing was continued for another 1 hour. Chunk of solid resin was formed, which was ground to a coarse powder using a mortar and pestle. The resin was repeatedly washed with water and methanol and then dried at 70° C. overnight.

### Example 48

### Preparation of chloromethylated phenol-formaldehyde resin

Phenol-formaldehyde resin (5.23 g, 44 mmol) was dispensed into a 100 mL three neck round bottom flask (RBF) equipped with a stir bar, condenser and nitrogen line. Anhydrous dichloroethane (DCE, 20 ml) was then charged into the flask. To ice-cooled suspension of resin in DCE, zinc chloride (6.83 g, 50 mmol) was added. Chloromethyl methyl ether (4.0 ml, 51 mmol) was then added dropwise into the reaction. The mixture was warmed to room temperature and stirred at 50° C. for 6 h. The product resin was recovered by vacuum filtration and washed sequentially with water, acetone and dichloromethane. The washed resin was dried at 40° C. overnight.

### Example 49

### Preparation of triphenylphosphine functionalized phenol-formaldehyde resin

Triphenylphosphine (10.12, 38.61 mmol) were charged into a 100 mL flask equipped with a magnetic stir bar and condenser. Acetone (30 ml) was added into the flask and mixture was stirred at 50° C. for 10 min. Chloromethylated phenol-formaldehyde resin (4.61 g, 38.03 mmol) was charged into flask while stirring. The resulting reaction mixture was refluxed for 24 h. After cooling, the reaction mixture was filtered using fritted glass funnel under vacuum, washed sequentially with acetone and ethyl acetate, and dried at 70° C. overnight.

### Example 50

### Preparation of sulfonated triphenylphosphine-functionalized phenol-formaldehyde resin

Triphenylphosphine-functionalized phenol-formaldeyde resin (5.12 g, 13.4 mmol) was charged into a 100 mL flask equipped with a magnetic stir bar and condenser. Fuming sulfuric acid (20% free SO₃, 25 mL) was gradually added into the flask and stirred to form dark-red colored slurry of resin. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated resin was dried under air to a final moisture content of 49% g H₂O/g wet resin. The chemical functionalization of the polymer resin with sulfonic acid groups was determined to be 3.85 mmol/g dry resin.

### Example 51

### Preparation of Poly(Styrene-Co-Vinylimidazole-Co-Divinylbenzene)

De-ionized water (75 mL) was charged into flask into a 500 mL three neck round bottom flask equipped with a mechanical stirrer, condenser and N₂ line. Sodium chloride (1.18 g) and carboxymethylcellulose (0.61 g) were charged into the flask and stirred for 5 min. The solution of vinylimidazole (3.9 mL, 42.62 mmol), styrene (4.9 mL, 42.33 mmol) and divinylbenzene (0.9 mL, 4.0 mmol) in iso-octanol (25 mL) was charged into flask. The resulting emulsion was stirred at 500 rpm at room temperature for 1 h. Benzoyl peroxide (75%, 1.205 g) was added, and temperature was raised to 80° C. The reaction mixture was heated for 8 h at 80° C. with stirring rate of 500 rpm. The polymer product was recovered by vacuum filtration and washed with water and acetone multiple times. The isolated polymer was purified by soxhlet extraction with water and acetone. The resin was dried at 40° C. overnight.

### Example 52

### Preparation of poly(styrene-co-vinylmethylimidazolium iodide-co-divinylbenzene)

Poly(styrene-co-vinylimidazole-co-divinylbenzene) (3.49 g, 39 mmol) was dispensed into a 100 mL three neck round bottom flask (RBF) equipped with a stir bar, condenser and nitrogen line. Anhydrous tetrahydrofuran (20 ml) was then charged into the flask. To ice-cooled suspension of resin in tetrahydrofuran, potassium t-butoxide (5.62 g, 50 mmol) was added and stirred for 30 min. Iodomethane (3.2 ml, 51 mmol) was then added dropwise into the reaction. The mixture was warmed to room temperature and stirred at 50° C. for 6 h. The product resin was recovered by vacuum filtration and washed sequentially with water, acetone and dichloromethane. The washed resin was dried at 40° C. overnight.

### Example 53

### Preparation of sulfonated poly(styrene-co-vinylmethylimidazolium bisulfate-co-divinylbenzene)

Poly(styrene-co-vinylmethylimidazolium iodide-co-divinylbenzene) (3.89 g, 27.8 mmol) was charged into a 100 mL flask equipped with a magnetic stir bar and condenser. Fuming sulfuric acid (20% free SO₃, 20 mL) was gradually added into the flask and stirred to form dark-red colored slurry. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated polymer was dried under air to a final moisture content of 51% g H₂O/g wet resin.

### Example 54

### Preparation of poly(styrene-co-vinylbenzyltriphenylphosphonium chloride-co-divinylbenzene)

To a 250 mL flask equipped with a magnetic stir bar and condenser was charged triphenylphosphine (38.44 g, 145.1 mmol). Acetone (50 mL) was added into the flask and mixture was stirred at 50° C. for 10 min. Poly(styrene-co-vinylbenzylchloride-co-divinylbenzene) (8% DVB, Cl⁻ density=4.0 mmol/g dry resin, 30.12 g, 115.6 mmol) was charged into flask while stirring until a uniform suspension was obtained. The resulting reaction mixture was refluxed for 24 h. After cooling, the reaction mixture was filtered using fritted glass funnel under vacuum, washed sequentially with acetone and ethyl acetate, and dried at 70° C. overnight. The chemical functionalization of the polymer resin with triphenylphosphonium chloride groups was determined to be 1.94 mmol/g dry resin via titrimetry.

### Example 55

### Preparation of sulfonated poly(styrene-co-vinylbenzyltriphenyl phosphonium bisulfate-co-divinylbenzene)

Poly(styrene-co-vinylbenzyltriphenylphosphonium chloride-co-divinylbenzene) (40.12 g) was charged into a 500 mL flask equipped with a magnetic stir bar and condenser. Fuming sulfuric acid (20% free SO₃, 160 mL) was gradually added into the flask and stirred to form dark-red colored slurry of resin. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated beads were dried under air to a final moisture content of 54% g H₂O/g wet resin. The chemical functionalization of the polymer resin with sulfonic acid groups was determined to be 4.39 mmol/g dry resin.

### Example 56

### Preparation of poly(styrene-co-vinylbenzyltriphenylphosphonium chloride-co-divinylbenzene

To a 250 mL flask equipped with a magnetic stir bar and condenser was charged triphenylphosphine (50.22 g, 189.6 mmol). Acetone (50 mL) was added into the flask and mixture was stirred at 50° C. for 10 min. Poly(styrene-co-vinylbenzylchloride-co-divinylbenzene) (4% DVB, Cl⁻ density=5.2 mmol/g dry resin, 30.06 g, 152.08 mmol) was charged into flask while stirring until a uniform suspension was obtained. The resulting reaction mixture was refluxed for 24 h. After cooling, the reaction mixture was filtered using fritted glass funnel under vacuum, washed sequentially with acetone and ethyl acetate, and dried at 70° C. overnight. The chemical functionalization of the polymer resin with triphenylphosphonium chloride groups was determined to be 2.00 mmol/g dry resin via titrimetry.

### Example 57

### Preparation of sulfonated poly(styrene-co-vinylbenzyltriphenyl phosphonium bisulfate-co-divinylbenzene)

Poly(styrene-co-vinylbenzyltriphenylphosphonium chloride-co-divinylbenzene) (40.04 g) was charged into a 500 mL flask equipped with a magnetic stir bar and condenser. Fuming sulfuric acid (20% free SO₃, 160 mL) was gradually added into the flask and stirred to form dark-red colored slurry of resin. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated beads were dried under air to a final moisture content of 47% g H₂O/g wet resin. The chemical functionalization of the polymer resin with sulfonic acid groups was determined to be 4.36 mmol/g dry resin.

### Example 58

### Preparation of poly(styrene-co-vinylbenzylmethylimidazolium chloride-co-divinylbenzene)

To a 250 mL flask equipped with a magnetic stir bar and condenser was charged 1-methylimidazole (18 mL, 223.5 mmol). Acetone (75 mL) was added into the flask and mixture was stirred at 50° C. for 10 min. Poly(styrene-co-vinylbenzylchloride-co-divinylbenzene) (8% DVB, Cl⁻ density=4.0 mmol/g dry resin, 40.06, 153.7 mmol) was charged into flask while stirring until a uniform suspension was obtained. The resulting reaction mixture was refluxed for 24 h. After cooling, the reaction mixture was filtered using fritted glass funnel under vacuum, washed sequentially with acetone and ethyl acetate, and dried at 70° C. overnight. The chemical functionalization of the polymer resin with methylimidazolium chloride groups was determined to be 3.54 mmol/g dry resin via titrimetry.

### Example 59

### Preparation of sulfonated poly(styrene-co-vinylbenzylmethylimidazolium bisulfate-co-divinylbenzene)

Poly(styrene-co-vinylbenzylmethylimidazolium chloride-co-divinylbenzene) (30.08 g) was charged into a 500 mL flask equipped with a magnetic stir bar and condenser. Fuming sulfuric acid (20% free SO₃, 120 mL) was gradually added into the flask and stirred to form dark-red colored slurry of resin. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated beads were dried under air to a final moisture content of 50% g H₂O/g wet resin. The chemical functionalization of the polymer resin with sulfonic acid groups was determined to be 2.87 mmol/g dry resin.

### Example 60

### Preparation of poly(styrene-co-vinylbenzylmethylimidazolium chloride-co-divinylbenzene)

To a 250 mL flask equipped with a magnetic stir bar and condenser was charged 1-methylimidazole (20 mL, 248.4 mmol). Acetone (75 mL) was added into the flask and mixture was stirred at 50° C. for 10 min. Poly(styrene-co-vinylbenzylchloride-co-divinylbenzene) (4% DVB, Cl⁻ density=5.2 mmol/g dry resin, 40.08, 203.8 mmol) was charged into flask while stirring until a uniform suspension was obtained. The resulting reaction mixture was refluxed for 24 h. After cooling, the reaction mixture was filtered using fritted glass funnel under vacuum, washed sequentially with acetone and ethyl acetate, and dried at 70° C. overnight. The chemical functionalization of the polymer resin with methylimidazolium chloride groups was determined to be 3.39 mmol/g dry resin via titrimetry.

### Example 61

### Preparation of sulfonated poly(styrene-co-vinylbenzylmethylimidazolium bisulfate-co-divinylbenzene)

Poly(styrene-co-vinylbenzylmethylimidazolium chloride-co-divinylbenzene) (30.14 g) was charged into a 500 mL flask equipped with a magnetic stir bar and condenser. Fuming sulfuric acid (20% free SO₃, 120 mL) was gradually added into the flask and stirred to form dark-red colored slurry of resin. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated beads were dried under air to a final moisture content of 55% g H₂O/g wet resin. The chemical functionalization of the polymer resin with sulfonic acid groups was determined to be 2.78 mmol/g dry resin.

### Example 62

### Preparation of poly(styrene-co-vinylbenzyltriphenylphosphonium chloride-co-divinylbenzene)

To a 250 mL flask equipped with a magnetic stir bar and condenser was charged triphenylphosphine (44.32 g, 163.9 mmol). Acetone (50 mL) was added into the flask and mixture was stirred at 50° C. for 10 min. Poly(styrene-co-vinylbenzylchloride-co-divinylbenzene) (13% DVB macroporous resin, Cl⁻ density=4.14 mmol/g dry resin, 30.12 g, 115.6 mmol) was charged into flask while stirring until a uniform suspension was obtained. The resulting reaction mixture was refluxed for 24 h. After cooling, the reaction mixture was filtered using fritted glass funnel under vacuum, washed sequentially with acetone and ethyl acetate, and dried at 70° C. overnight.

### Example 63

### Preparation of sulfonated poly(styrene-co-vinylbenzyltriphenyl phosphonium bisulfate-co-divinylbenzene)

Poly(styrene-co-vinylbenzyltriphenylphosphonium chloride-co-divinylbenzene) (30.22 g) was charged into a 500 mL flask equipped with a magnetic stir bar and condenser. Fuming sulfuric acid (20% free SO₃, 90 mL) was gradually added into the flask and stirred to form dark-red colored slurry of resin. The slurry was stirred at 90° C. for 1 hour. After cooling, the reaction mixture was filtered using fritted glass funnel under vacuum and then washed repeatedly with de-ionized water until the effluent was neutral, as determined by pH paper. The sulfonated beads were dried under air to a final moisture content of 46% g H₂O/g wet resin. The chemical functionalization of the polymer resin with sulfonic acid groups was determined to be 2.82 mmol/g dry resin.

### Example 64

### Preparation of poly(styrene-co-vinylbenzyltriphenylphosphonium chloride-co-divinylbenzene)

To a 250 mL flask equipped with a magnetic stir bar and condenser was charged triphenylphosphine (55.02 g, 207.7 mmol). Acetone (50 mL) was added into the flask and mixture was stirred at 50° C. for 10 min. Poly(styrene-co-vinylbenzylchloride-co-divinylbenzene) (6.5% DVB macroporous resin, Cl⁻ density=5.30 mmol/g dry resin, 30.12 g, 157.4 mmol) was charged into flask while stirring until a uniform suspension was obtained. The resulting reaction mixture was refluxed for 24 h. After cooling, the reaction mixture was filtered using fritted glass funnel under vacuum, washed sequentially with acetone and ethyl acetate, and dried at 70° C. overnight.

### Example 65

### Preparation of sulfonated poly(styrene-co-vinylbenzyltriphenyl phosphonium bisulfate-co-divinylbenzene)

Poly(styrene-co-vinylbenzyltriphenylphosphonium chloride-co-divinylbenzene) (30.12 g) was charged into a 500 mL flask equipped with a magnetic stir bar and condenser. Fuming sulfuric acid (20% free SO₃, 90 mL) was gradually added into the flask and stirred to form dark-red colored slurry of resin. The slurry was stirred at 90° C. for 1 hour. After cooling, the reaction mixture was filtered using fritted glass funnel under vacuum and then washed repeatedly with de-ionized water until the effluent was neutral, as determined by pH paper. The sulfonated beads were dried under air to a final moisture content of 49% g H₂O/g wet resin. The chemical functionalization of the polymer resin with sulfonic acid groups was determined to be 2.82 mmol/g dry resin.

### Example 66

### Preparation of poly(styrene-co-vinylbenzyltriphenylphosphonium chloride-co-divinylbenzene)

To a 250 mL flask equipped with a magnetic stir bar and condenser was charged triphenylphosphine (38.42 g, 145.0 mmol). Acetone (50 mL) was added into the flask and mixture was stirred at 50° C. for 10 min. Poly(styrene-co-vinylbenzylchloride-co-divinylbenzene) (4% DVB, Cl⁻ density=4.10 mmol/g dry resin, 30.12 g, 115.4 mmol) was charged into flask while stirring until a uniform suspension was obtained. The resulting reaction mixture was refluxed for 24 h. After cooling, the reaction mixture was filtered using fritted glass funnel under vacuum, washed sequentially with acetone and ethyl acetate, and dried at 70° C. overnight.

### Example 67

### Preparation of sulfonated poly(styrene-co-vinylbenzyltriphenylphosphonium bisulfate-co-divinylbenzene)

Poly(styrene-co-vinylbenzyltriphenylphosphonium chloride-co-divinylbenzene) (30.18 g) was charged into a 500 mL flask equipped with a magnetic stir bar and condenser. Fuming sulfuric acid (20% free SO₃, 120 mL) was gradually added into the flask and stirred to form dark-red colored slurry of resin. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated beads were dried under air to a final moisture content of 59% g H₂O/g wet resin. The chemical functionalization of the polymer resin with sulfonic acid groups was determined to be 3.03 mmol/g dry resin.

### Example 68

### Preparation of poly(styrene-co-vinylbenzyltriphenylphosphonium chloride-co-divinylbenzene)

To a 500 mL flask equipped with a magnetic stir bar and condenser was charged triphenylphosphine (44.22 g, 166.9 mmol). Acetone (70 mL) was added into the flask and mixture was stirred at 50° C. for 10 min. Poly(styrene-co-vinylbenzylchloride-co-divinylbenzene) (4% DVB, Cl⁻ density=3.9 mmol/g dry resin, 35.08 g, 130.4 mmol) was charged into flask while stirring until a uniform suspension was obtained. The resulting reaction mixture was refluxed for 24 h. After cooling, the reaction mixture was filtered using fritted glass funnel under vacuum, washed sequentially with acetone and ethyl acetate, and dried at 70° C. overnight.

### Example 69

### Preparation of sulfonated poly(styrene-co-vinylbenzyltriphenyl phosphonium bisulfate-co-divinylbenzene)

Poly(styrene-co-vinylbenzyltriphenylphosphonium chloride-co-divinylbenzene) (30.42 g) was charged into a 500 mL flask equipped with a magnetic stir bar and condenser. Fuming sulfuric acid (20% free SO₃, 120 mL) was gradually added into the flask and stirred to form dark-red colored slurry of resin. The slurry was stirred at 90° C. overnight. After cooling, the reaction mixture was filtered using fritted glass funnel under vacuum and then washed repeatedly with de-ionized water until the effluent was neutral, as determined by pH paper. The sulfonated beads were dried under air to a final moisture content of 57% g H₂O/g wet resin. The chemical functionalization of the polymer resin with sulfonic acid groups was determined to be 3.04 mmol/g dry resin.

### Example 70

### Preparation of poly(butyl-vinylimidazolium chloride-co-butylimidazolium chloride-co-styrene)

To a 500 mL flask equipped with a mechanical stirrer and reflux condenser is added 250 mL of acetone, 10 g of imidzole, 14 g of vinylimidazole, 15 g of styrene, 30 g of dichlorobutane and 1 g of azobisisobutyronitrile (AIBN). The solution is stirred under reflux conditions for 12 hours to produce a solid mass of polymer. The solid polymer is removed from the flask, washed repeatedly with acetone, and ground to a coarse powder using a mortar and pestle to yield the product.

### Example 71

### Preparation of sulfonated poly(butyl-vinylimidazolium bisulfate-co-butylimidazolium bisulfate-co-styrene)

Poly(butyl-vinylimidazolium chloride-co-butylimidazolium chloride-co-styrene) 30.42 g) is charged into a 500 mL flask equipped with a mechanical stirrer. Fuming sulfuric acid (20% free SO3, 120 mL) is gradually added into the flask until the polymer is fully suspended. The resulting slurry is stirred at 90° C. for 5 hours. After cooling, the reaction mixture is filtered using fritted glass funnel under vacuum and then washed repeatedly with de-ionized water until the effluent is neutral, as determined by pH paper.

### Preparation of Polymers Containing a Bronsted-Lowry Acid in Conjugate Base Form

In the following exemplary procedures, Groups A, B, and C refer to the following:

Group A:

Any of the polymers disclosed herein which have one or more acidic groups on one or more monomers.

Group B:

Any acid selected from hydrofluoric acid, hydrochloric acid, hydrobromic acid, hydroioidic acid, nitric acid, nitrous acid, sulfuric acid, carbonic acid, phosphoric acid, phosphorous acid, acetic acid, formic acid, citric acid, methanesulfonic acid, ethanesulfonic acid, benzenesulfonic acid, dodecylsulfonic acid, and benzene phosphonic acid.

Group C:

Any salt selected from lithium chloride, lithium bromide, lithium nitrate, lithium sulfate, lithium phosphate, sodium chloride, sodium bromide, sodium sulfate, sodium hydroxide, sodium phosphate, potassium chloride, potassium bromide, potassium nitrate, potassium sulfate, potassium phosphate, ammonium chloride, ammonium bromide, ammonium phosphate, ammonium sulfate, tetramethylammonium chloride, tetramethylammonium bromide, tetraethylammonium chloride, di-methylimidazolium chloride, methylbutylimidazoliumchloride, methylmorpholinium chloride, zinc (II) chloride, zinc (II) bromide, magnesium (II) chloride, and calcium (II) chloride.

It should be understood that the species in Groups A, B, and C are not intended as a limitation on the scope of the present disclosure but is instead provided as a description of exemplary embodiments.

### Example A1

### Addition of Anionic Species Via Ion Exchange by Immersion in an Acid Solution

To a 100 mL flask is added 25 mL of 5% g/g aqueous acid solution selected from Group B. The solution is stirred and 1.0 gram (measured on a dry basis) of cationic-functionalized polymer selected from Group A is added to the stirred acid solution to form a suspension. The suspension is stirred gently for 15 minutes. The ion exchanged polymer is recovered by vacuum filtration with a fritted glass funnel. Excess aqueous acid solution is removed by washing the recovered polymer with five 25 mL volumes of distilled, de-ionized water (di-H₂O). For each washing, the liquids are removed by vacuum filtration for at least 5 minutes. The total dry mass of anion-exchanged resin is determined by drying the wet resin to constant mass at 105° C.

### Example A2

### Addition of Anionic Species Via Column Ion Exchange

To a 500 mL column equipped with a fritted glass output filter and containing 200 mL of distilled, deionized water (di-H₂O) is added 100 grams of cationic-functionalized polymer selected from Group A. Additional di-H₂O is added until free water appears above the resin packed in the column. The resulting slurry is mixed gently to homogenize the solution and remove any trapped air. 500 mL of 5% g/g aqueous acid solution selected from Group B is added to the column reservoir and is gradually eluted from the column over a 15 minute period. Three volumes of 500 mL of di-H₂O are then added to the column reservoir and gradually eluted, each over a 15 minute period. The resulting resin slurry is transferred to a fritted glass filter funnel and the residual liquids are removed by vacuum filtration. The total dry mass of anionic-exchanged resin is determined by drying the wet resin to constant mass at 105° C.

### Example A3

### Addition of Cationic Species Via Ion Exchange by Immersion in a Salt Solution

To a 100 mL flask is added 25 mL of 5% g/g aqueous salt solution selected from Group C. The solution is stirred and 1.0 gram (measured on a dry basis) of acid functionalized polymer selected from Group A is added to the stirred salt solution to form a suspension. The suspension is stirred gently for 15 minutes. The ion exchanged polymer is recovered by vacuum filtration with a fritted glass funnel. Excess aqueous salt solution is removed by washing the recovered polymer with five 25 mL volumes of distilled, de-ionized water (di-H₂O). For each washing, the liquids are removed by vacuum filtration for at least 5 minutes. The total dry mass of cation-exchanged resin is determined by drying the wet resin to constant mass at 105° C.

### Example A4

### Addition of Cationic Species Via Column Ion Exchange

To a 500 mL column equipped with a fritted glass output filter and containing 200 mL of distilled, deionized water (di-H₂O) is added 100 grams of acid functionalized polymer selected from Group A. Additional di-H₂O is added until free water appears above the resin packed in the column. The resulting slurry is mixed gently to homogenize the solution and remove any trapped air. 500 mL of 5% g/g aqueous salt solution selected from Group C is added to the column reservoir and is gradually eluted from the column over a 15 minute period. Three volumes of 500 mL of di-H₂O are then added to the column reservoir and gradually eluted, each over a 15 minute period. The resulting resin slurry is transferred to a fritted glass filter funnel and the residual liquids are removed by vacuum filtration. The total dry mass of cation-exchanged resin is determined by drying the wet resin to constant mass at 105° C.

### Example A5

### Determination of the Extent of Anionic Replacement Via Ion-Exchange Back-Titration

A known mass of dry resin (approximately 0.25 g) from either of Example B1 or Example B2 is added to an ion exchange column. 50 mL of 0.1 Normal sodium hydroxide solution is eluted through the ion exchange resin and collected in a 250 mL Erlenmeyer flask. 100 mL of distilled, deionized water (di-H₂O) is then eluted through the ion exchange column and collected in the same 250 mL flask. A known mass (approximately 1 g) of potassium hydrogen phthalate is added to the 250 mL flask and stirred to dissolve. The anion content of the resin is determined by back-titration of the proton content of the 250 mL Erlenmeyer flask against 0.01N aqueous sodium hydroxide solution.

### Example A6

### Determination of the Extent of Cationic Replacement Via Ion-Exchange Titration

A known mass of dry resin (approximately 0.25 g) from either of Example B3 or Example B4 is added to an ion exchange column. 50 mL of 0.1 Normal hydrochloric acid is eluted through the ion exchange resin and collected in a 250 mL Erlenmeyer flask. 100 mL of distilled, deionized water (di-H₂O) is then eluted through the ion exchange column and collected in the same 250 mL flask. The cation content of the resin is determined by titration of the proton content of the 250 mL Erlenmeyer flask against 0.01N aqueous sodium hydroxide solution.

### Catalytic Digestion of Lignocellulosic Materials

### Example B1

### Digestion of Sugarcane Bagasse Using Catalyst Described in Example 3

Sugarcane bagasse (50% g H₂O/g wet bagasse, with a dry-matter composition of: 39.0% g glucan/g dry biomass, 17.3% g xylan/g dry biomass, 5.0% g arabinan/g dry biomass, 1.1% g galactan/g dry biomass, 5.5% g acetate/g dry biomass, 5.0% g soluble extractives/g dry biomass, 24.1% g lignin/g dry biomass, and 3.1% g ash/g dry biomass) is cut such that the maximum particle size is no greater than 1 cm. The composition of the lignocellulosic biomass is determined using a method based on the procedures known in the art. See R. Ruiz and T. Ehrman, “Determination of Carbohydrates in Biomass by High Performance Liquid Chromatography,” NREL Laboratory Analytical Procedure LAP-002 (1996); D. Tempelton and T. Ehrman, “Determination of Acid-Insoluble Lignin in Biomass,” NREL Laboratory Analytical Procedure LAP-003 (1995); T. Erhman, “Determination of Acid-Soluble Lignin in Biomass,” NREL Laboratory Analytical Procedure LAP-004 (1996); and T. Ehrman, “Standard Method for Ash in Biomass,” NREL Laboratory Analytical Procedure LAP-005 (1994).

To a 15 mL cylindrical glass reaction vial is added: 0.50 g of the cane bagasse sample, 0.30 g of Catalyst as prepared in Example 3 (initial moisture content: 12% g H₂O/g dispensed catalyst), and 800 μL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 120° C. for four hours.

### Example B2

### Separation of Catalyst/Product Mixture from the Hydrolysis of Sugarcane Bagasse

The cylindrical glass reactor from Example B1 is cooled to room temperature and unsealed. 5.0 mL of distilled H₂O is added to the vial reactor and the resulting mixture of liquids and solids is agitated for 2 minutes by magnetic stirring. Following agitation, the solids are allowed to sediment for 30 seconds to produce the layered mixture. The solid catalyst forms a layer at the bottom of the vial reactor. Lignin and residual biomass forms a solid layer above the solid catalyst. The short-chained beta-glucans forms a layer of amorphous solids above the lignin and residual biomass. Finally, the soluble sugars forms a liquid layer above the short-chained beta-glucans.

### Example B3

### Recovery of Sugars and Soluble Carbohydrates from the Hydrolysis of Sugarcane Bagasse

The supernatant and residual insoluble materials from Example B2 are separated by decantation. The soluble-sugar content of hydrolysis products is determined by a combination of high performance liquid chromatography (HPLC) and spectrophotometric methods. HPLC determination of soluble sugars and oligosaccharides is performed on a Hewlett-Packard 1050 Series instrument equipped with a refractive index (RI) detector using a 30 cm×7.8 mm Phenomenex HPB column with water as the mobile phase. The sugar column is protected by both a lead-exchanged sulfonated-polystyrene guard column and a tri-alkylammoniumhydroxide anionic-exchange guard column. All HPLC samples are microfiltered using a 0.2 μm syringe filter prior to injection. Sample concentrations are determined by reference to a calibration generated from known standards.

The ability of the catalyst to hydrolyze the cellulose and hemicellulose components of the biomass to soluble sugars is measured by determining the effective first-order rate constant. The extent of reaction for a chemical species (e.g., glucan, xylan, arabinan) is determined by calculating the ratio of moles of the recovered species to the theoretical moles of the species that would be obtained as a result of complete conversion of the input reactant based on the known composition of the input biomass and the known molecular weights of the reactants and products and the known stoichiometries of the reactions under consideration.

### Example B4

### Recovery of Insoluble Oligo-Glucans from Hydrolyzed Sugarcane Bagasse

An additional 5.0 mL of water is added to the residual solids from Example B3 and the mixture is gently agitated to suspend only the lightest particles. The suspension is decanted to remove the light particles from the residual lignin and residual catalyst, which remained in the solid sediment at the bottom of the reactor. The solid particles are concentrated by centrifugation.

The number average degree of polymerization (DOP_{N}) of residual water-insoluble glucans (including short-chain oligosaccharides) is determined by extracting the glucans into ice-cold phosphoric acid, precipitating the extracted carbohydrates into water, and measuring the ratio of terminal reducing sugars to the number of total sugar monomers using the method of Zhang and Lynd. See Y.-H. Percival Zhang and Lee R. Lynd, “Determination of the Number-Average Degree of Polymerization of Cellodextrins and Cellulose with Application to Enzymatic Hydrolysis,” Biomacromolecules, 6, 1510-1515 (2005). UV-Visible spectrophotometric analysis can be performed on a Beckman DU-640 instrument. In cases where the digestion of hemicellulose is complete (as determined by HPLC), DOP determination of the residual cellulose is performed without the need for phosphoric acid extraction. In some cases, the number average degree of polymerization is verified by Gel Permeation Chromatography (GPC) analysis of cellulose and is performed using a procedure adapted from the method of Evans et al. See R. Evans, R. Wearne, A. F. A. Wallis, “Molecular Weight Distribution of Cellulose as Its Tricarbanilate by High Performance Size Exclusion Chromatography,” J. Appl. Pol. Sci., 37, 3291-3303 (1989).

In a 20 mL reaction vial containing 3 mL of dry DMSO, is suspended an approximately 50 mg sample of cellulose (dried overnight at 50° C. under reduced pressure). The reaction vial is sealed with a PTFE septum, flushed with dry N₂, followed by addition of 1.0 mL phenylisocyanate via syringe. The reaction mixture is incubated at 60° C. for 4 hours with periodic mixing, until the majority of cellulose is dissolved. Excess isocyanate is quenched by addition of 1.0 mL of dry MeOH. Residual solids are pelletized by centrifugation, and a 1 mL aliquot of the supernatant is added to 5 mL of 30% v/v MeOH/dH₂O to yield the carbanilated cellulose. The product is recovered by centrifugation, and repeatedly washed with 30% v/v MeOH, followed by drying for 10 hours at 50° C. under reduced pressure. GPC can be performed on a Hewlett-Packard 1050 Series HPLC using a series of TSK-Gel (G3000Hhr, G4000Hhr, G5000Hhr) columns and tetrahydrofuran (THF) as the mobile phase with UV/Vis detection. The molecular weight distribution of the cellulose is determined using a calibration based on polystyrene standards of known molecular weight.

For the digestion of sugarcane bagasse using catalyst as shown in Example 3, the number average degree of polymerization of the oligo-glucans can be determined. An observed reduction of the degree of polymerization of the residual cellulose to a value significantly lower than the degree of polymerization for the crystalline domains of the input cellulose (for which DOP_{N}>200 AHG units) indicates that the catalyst successfully hydrolyzed crystalline cellulose.

### Example B5

### Separation and Recovery of Lignin, Residual Unreacted Biomass and Catalyst from Hydrolyzed Sugarcane Bagasse

An additional 10 mL of water is added to the residual solids in Example B4. The mixture is agitated to suspend the residual lignin (and residual unreacted biomass particles) without suspending the catalyst. The recovered catalyst is washed with water and then dried to constant mass at 110° C. in a gravity oven. The functional density of sulfonic acid groups on the recovered catalyst is determined by titration of the recovered catalyst indicating negligible loss of acid functionalization.

### Example B6

### Reuse of Recovered Catalyst

A portion of the catalyst recovered from Example B5 (0.250 g dry basis) is returned to the 15 mL cylindrical vial reactor. 0.50 g of additional biomass (composition identical to that in Example 45) and 800 μL of deionized H₂O are added to the reactor, and the contents are mixed thoroughly, as described in Example 41. The reactor is sealed and incubated at 115° C. for four hours. Following the reaction, the product mixture is separated following the procedure described in Examples B2-B5. The first-order rate constant for conversion of xylan to xylose is determined. The first-order rate constant for conversion of glucan to soluble monosaccharides and oligosaccharides (including disaccharides) is also determined. The number average degree of polymerization of residual cellulose is determined, as well as the first order rate constant for conversion of β-glucan to short-chain oligo-glucans.

### Example B7

### Hydrolysis of Corn Stover Using Catalyst as Prepared in Example 34

Corn stover (7.2% g H₂O/g wet biomass, with a dry-matter composition of: 33.9% g glucan/g dry biomass, 24.1% g xylan/g dry biomass, 4.8% g arabinan/g dry biomass, 1.5% g galactan/g dry biomass, 4.0% g acetate/g dry biomass, 16.0% g soluble extractives/g dry biomass, 11.4% g lignin/g dry biomass, and 1.4% g ash/g dry biomass) is cut such that the maximum particle size is no greater than 1 cm. To a 15 mL cylindrical glass reaction vial is added: 0.45 g of the cane bagasse sample, 0.22 g of Catalyst as prepared in Example 34 (initial moisture content: 0.8% g H₂O/g dispensed catalyst), and 2.3 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 110° C. for five hours. Following the reaction, the product mixture is separated following the procedure described in Examples B2-B5.

### Example B8

### Hydrolysis of Oil Palm Empty Fruit Bunches Using Catalyst as Prepared in Example 20

Shredded oil palm empty fruit bunches (8.7% g H₂O/g wet biomass, with a dry-matter composition of: 35.0% g glucan/g dry biomass, 21.8% g xylan/g dry biomass, 1.8% g arabinan/g dry biomass, 4.8% g acetate/g dry biomass, 9.4% g soluble extractives/g dry biomass, 24.2% g lignin/g dry biomass, and 1.2% g ash/g dry biomass) is cut such that the maximum particle size is no greater than 1 cm. To a 15 mL cylindrical glass reaction vial is added: 0.46 g of the cane bagasse sample, 0.43 g of Catalyst as prepared in Example 20 (initial moisture content: 18.3% g H₂O/g dispensed catalyst), and 1.3 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 110° C. for five hours. Following the reaction, the product mixture is separated following the procedure described in Examples B2-B5.

### Example B9A

### Hydrolysis of Sugarcane Bagasse Using Catalyst as Prepared in Example 32

Sugarcane bagasse (12.5% g H₂O/g wet bagasse, with a dry-matter composition of: 39.0% g glucan/g dry biomass, 17.3% g xylan/g dry biomass, 5.0% g arabinan/g dry biomass, 1.1% g galactan/g dry biomass, 5.5% g acetate/g dry biomass, 5.0% g soluble extractives/g dry biomass, 24.1% g lignin/g dry biomass, and 3.1% g ash/g dry biomass) is cut such that the maximum particle size is no greater than 1 cm. To a 15 mL cylindrical glass reaction vial is added: 0.53 g of the cane bagasse sample, 0.52 g of Catalyst as prepared in Example 32 (initial moisture content: 3.29% g H₂O/g dispensed catalyst), and 1.4 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 115° C. for four hours. Following the reaction, the product mixture is separated following the procedure described in Examples B2-B5.

### Example B9B

### Hydrolysis of Sugarcane Bagasse Using Catalyst as Prepared in Example 32

Sugarcane bagasse (12.5% g H₂O/g wet bagasse, with a dry-matter composition of: 39.0% g glucan/g dry biomass, 17.3% g xylan/g dry biomass, 5.0% g arabinan/g dry biomass, 1.1% g galactan/g dry biomass, 5.5% g acetate/g dry biomass, 5.0% g soluble extractives/g dry biomass, 24.1% g lignin/g dry biomass, and 3.1% g ash/g dry biomass) is cut such that the maximum particle size is no greater than 1 cm. To a 15 mL cylindrical glass reaction vial is added: 0.53 g of the cane bagasse sample, 0.52 g of Catalyst as prepared in Example 32 (initial moisture content: 3.29% g H₂O/g dispensed catalyst), and 1.4 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 135° C. for forty minutes. Following the reaction, the product mixture is separated following the procedure described in Examples B2-B5.

### Example B10

### Hydrolysis of Sugarcane Bagasse Using Catalyst as Prepared in Example 18

Sugarcane bagasse (12.5% g H₂O/g wet bagasse, with a dry-matter composition of: 39.0% g glucan/g dry biomass, 17.3% g xylan/g dry biomass, 5.0% g arabinan/g dry biomass, 1.1% g galactan/g dry biomass, 5.5% g acetate/g dry biomass, 5.0% g soluble extractives/g dry biomass, 24.1% g lignin/g dry biomass, and 3.1% g ash/g dry biomass) is cut such that the maximum particle size is no greater than 1 cm. To a 15 mL cylindrical glass reaction vial is added: 0.51 g of the cane bagasse sample, 0.51 g of Catalyst as prepared in Example 18 (initial moisture content: 7.9% g H₂O/g dispensed catalyst), and 1.4 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 115° C. for four hours. Following the reaction, the product mixture is separated following the procedure described in Examples B2-B5.

### Example B11

### High-Selectivity to Sugars

Shredded oil palm empty fruit bunches (8.7% g H₂O/g wet biomass, with a dry-matter composition of: 35.0% g glucan/g dry biomass, 21.8% g xylan/g dry biomass, 1.8% g arabinan/g dry biomass, 4.8% g acetate/g dry biomass, 9.4% g soluble extractives/g dry biomass, 24.2% g lignin/g dry biomass, and 1.2% g ash/g dry biomass) is cut such that the maximum particle size is no greater than 1 cm. To a 15 mL cylindrical glass reaction vial is added: 0.51 g of the cane bagasse sample, 0.51 g of Catalyst as prepared in Example 3 (initial moisture content: 8.9% g H₂O/g dispensed catalyst), and 2.6 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 115° C. for four hours. Following the reaction, 10.0 mL of deionized H₂O is added to the product mixture to dissolve the soluble species and the solids are allowed to sediment. HPLC determination of sugar dehydration products and organic acids liberated from biomass samples can be performed on an Agilent 1100 Series instrument using a 30 cm×7.8 mm Supelcogel™ H column (or a Phenomenex HOA column in some cases) with 0.005N sulfuric acid in water as the mobile phase. Quantitation of sugar degradation products: formic acid, levulinic acid, 5-hydroxymethylfurfural, and 2-furaldehyde, is performed by reference to a calibration curve generated from high-purity solutions of known concentration.

### Example B12

### Fermentation of Cellulosic Sugars from Sugarcane Bagasse

Sugarcane bagasse (12.5% g H₂O/g wet bagasse, with a dry-matter composition of: 39.0% g glucan/g dry biomass, 17.3% g xylan/g dry biomass, 5.0% g arabinan/g dry biomass, 1.1% g galactan/g dry biomass, 5.5% g acetate/g dry biomass, 5.0% g soluble extractives/g dry biomass, 24.1% g lignin/g dry biomass, and 3.1% g ash/g dry biomass) is cut such that the maximum particle size is no greater than 1 cm. To a 15 mL cylindrical glass reaction vial is added: 1.6 g of the cane bagasse sample, 1.8 g of Catalyst as prepared in Example 3 (initial moisture content: 12.1% g H₂O/g dispensed catalyst), and 5.0 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 110° C. for five hours. After five hours, an additional 1.0 mL of distilled H₂O is added to the reaction mixture, which is then incubated at 105° C. for an additional 2 hours. The wet reactant cake is loaded into a syringe equipped with a 0.2 micrometer filter and the hydrolysate is pressed out of the product mixture into a sterile container. To a culture tube is added 2.5 mL of culture media (prepared by diluting 10 g of yeast extract and 20 g peptone to 500 mL in distilled water, followed by purification by sterile filtration), 2.5 mL of the hydrolysate, and 100 mL of yeast slurry (prepared by dissolving 500 mg of Alcotec 24 hour Turbo Super yeast into 5 mL of 30° C. of sterile H₂O. The culture is grown at 30° C. in a shaking incubator, with 1 mL aliquots removed at 24, 48 and 72 hours. For each aliquot, the optical density of the culture is determined by spectrophotometer aliquot. The aliquot is purified by centrifugation and the supernatant is analyzed by HPLC to determine the concentrations of glucose, xylose, galactose, arabinose, ethanol, and glycerol.

### Example B13

### Fermentation of Cellulosic Sugars from Cassava Stem

Cassava stem (2.0% g H₂O/g wet cassava stem, with a dry-matter composition of: 53.0% g glucan/g dry biomass, 6.0% g xylan/g dry biomass, 2.5% g arabinan/g dry biomass, 5.5% g acetate/g dry biomass, 5.9% g soluble extractives/g dry biomass, 24.2% g lignin/g dry biomass, and 2.1% g ash/g dry biomass) is shredded in a coffee-grinder such that the maximum particle size is no greater than 2 mm. To a 15 mL cylindrical glass reaction vial is added: 1.9 g of the shredded cassava stem, 2.0 g of Catalyst as prepared in Example 3 (initial moisture content: 12.0% g H₂O/g dispensed catalyst), and 8.0 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 110° C. for five hours. After five hours, an additional 2.0 mL of distilled H₂O is added to the reaction mixture, which is then incubated at 105° C. for an additional 2 hours. The wet reactant cake is loaded into a syringe equipped with a 0.2 micrometer filter and the hydrolysate is pressed out of the product mixture into a sterile container. To a culture tube is added 2.5 mL of culture media (prepared by diluting 10 g of yeast extract and 20 g peptone to 500 mL in distilled water, followed by purification by sterile filtration), 2.5 mL of the hydrolysate, and 100 mL of yeast slurry (prepared by dissolving 500 mg of Alcotec 24 hour Turbo Super yeast into 5 mL of 30° C. of sterile H₂O). The culture is grown at 30° C. in a shaking incubator, with 1 mL aliquots removed at 24, 48 and 72 hours. For each aliquot, the optical density of the culture is determined by spectrophotometer aliquot. The aliquot is purified by centrifugation and the supernatant is analyzed by HPLC to determine the concentrations of glucose, xylose, galactose, arabinose, ethanol, and glycerol.

### Example B14

### Fermentation of Glucose Obtained from Insoluble Starch

To 15 mL cylindrical glass reaction vial is added: 4.0 g of corn starch (3% g H₂O/g wet starch, with a dry-matter composition of: 98% g glucan/g dry biomass), 3.9 g of Catalyst as prepared in Example 3 (initial moisture content: 12.25% g H₂O/g dispensed catalyst), and 12.0 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 110° C. for five hours. After five hours, an additional 2.0 mL of distilled H₂O is added to the reaction mixture, which is then incubated at 105° C. for an additional 2 hours. The wet reactant cake is loaded into a syringe equipped with a 0.2 micrometer filter and the hydrolysate is pressed out of the product mixture into a sterile container. To a culture tube is added 2.5 mL of culture media (prepared by diluting 10 g of yeast extract and 20 g peptone to 500 mL in distilled water, followed by purification by sterile filtration), 2.5 mL of the hydrolysate, and 100 mL of yeast slurry (prepared by dissolving 500 mg of Alcotec 24 hour Turbo Super yeast into 5 mL of 30° C. of sterile H₂O). The culture is grown at 30° C. in a shaking incubator, with 1 mL aliquots removed at 24, 48 and 72 hours. For each aliquot, the optical density of the culture is determined by spectrophotometer aliquot. The aliquot is purified by centrifugation and the supernatant is analyzed by HPLC to determine the concentrations of glucose, xylose, galactose, arabinose, ethanol, and glycerol.

### Example B15

### Enzymatic Saccharification of Oligo-Glucans Obtained from Digestion of Sugarcane Bagasse with Catalyst as Prepared in Example 3

50.0 mg of the oligo-gucans obtained in Example B4 is suspended in 0.4 mL of 0.05 molar acetate buffer solution at pH 4.8 in a culture tube. The suspension is pre-warmed to 40° C., after which, 0.5 FPU of Celluclast® cellulase enzyme from Trichoderma reesei and 2 IU of cellobiase enzyme from Aspergillus niger (diluted in 0.1 mL of citrate buffer at 40° C.) is added. A 50.0 mL aliquot is sampled from the enzymatic reaction every hour for five hours. For each aliquot, the reaction is terminated by diluting the 50.0 mL sample to 0.7 mL in distilled water and adding 0.3 mL of DNS reagent (prepared by diluting 91 g of potassium sodium tartrate, 3.15 g dinitrosalicylic acid, 131 mL of 2 molar sodium hydroxide 2.5 g phenol and 2.5 g sodium sulfite to 500 mL with distilled H₂O). The 1 mL mixture is sealed in a microcentrifuge tube and boiled for exactly 5 minutes in water. The appearance of reducing sugars is measured by comparing the absorbance at 540 nm to a calibration curve generated from glucose samples of known concentration.

### Comparative Example B16

### Attempted Hydrolysis of Sugarcane Bagasse with Cross-Linked, Sulfonated-Polystyrene (Negative Control 1)

The cellulose digestion capability of the catalysts described herein is compared to that of conventional acidified polymer-resins used for catalysis in organic and industrial chemistry (T. Okuhara, “Water-Tolerant Polymeric Catalysts,” Chem. Rev., 102, 3641-3666 (2002)). Sugarcane bagasse (12.5% g H₂O/g wet bagasse, with a dry-matter composition of: 39.0% g glucan/g dry biomass, 17.3% g xylan/g dry biomass, 5.0% g arabinan/g dry biomass, 1.1% g galactan/g dry biomass, 5.5% g acetate/g dry biomass, 5.0% g soluble extractives/g dry biomass, 24.1% g lignin/g dry biomass, and 3.1% g ash/g dry biomass) is cut such that the maximum particle size is no greater than 1 cm. To a 15 mL cylindrical glass reaction vial is added: 0.51 g of the cane bagasse sample, 0.53 g of sulfonated polystyrene (Dowex® 50WX2 resin, acid functionalization: 4.8 mmol/g, initial moisture content: 19.6% g H₂O/g dispensed catalyst), and 1.4 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 115° C. for six hours. Following the reaction, the product mixture is separated following the procedure described in Examples B2-B5.

### Comparative Example B17

### Attempted Hydrolysis of Sugarcane Bagasse with Sulfonated Polystyrene (Negative Control 2)

Sugarcane bagasse (12.5% g H₂O/g wet bagasse, with a dry-matter composition of: 39.0% g glucan/g dry biomass, 17.3% g xylan/g dry biomass, 5.0% g arabinan/g dry biomass, 1.1% g galactan/g dry biomass, 5.5% g acetate/g dry biomass, 5.0% g soluble extractives/g dry biomass, 24.1% g lignin/g dry biomass, and 3.1% g ash/g dry biomass) is cut such that the maximum particle size is no greater than 1 cm. To a 15 mL cylindrical glass reaction vial is added: 0.52 g of the cane bagasse sample, 0.55 g of sulfonated polystyrene (Amberlyst® 15, acid functionalization: 4.6 mmol/g, initial moisture content: 10.8% g H₂O/g dispensed catalyst), and 1.8 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 115° C. for six hours. Following the reaction, the product mixture is separated following the procedure described in Examples B2-B5.

### Comparative Example B18

### Attempted Hydrolysis of Sugarcane Bagasse with Cross-Linked Polyacrylic Acid (Negative Control 3)

Sugarcane bagasse (12.5% g H₂O/g wet bagasse, with a dry-matter composition of: 39.0% g glucan/g dry biomass, 17.3% g xylan/g dry biomass, 5.0% g arabinan/g dry biomass, 1.1% g galactan/g dry biomass, 5.5% g acetate/g dry biomass, 5.0% g soluble extractives/g dry biomass, 24.1% g lignin/g dry biomass, and 3.1% g ash/g dry biomass) is cut such that the maximum particle size is no greater than 1 cm. To a 15 mL cylindrical glass reaction vial is added: 0.50 g of the cane bagasse sample, 0.50 g of polyacrylic acid beads (Amberlite® IRC86 resin, acid functionalization: 10.7 mmol/g, initial moisture content: 5.2% g H₂O/g dispensed catalyst), and 1.8 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 115° C. for six hours. Following the reaction, the product mixture is separated following the procedure described in Examples B2-B5.

### Comparative Example B19

### Attempted Hydrolysis of Sugarcane Bagasse with a Non-Acidic Ionomer as Prepared in Example 2 (Negative Control 4)

Sugarcane bagasse (12.5% g H₂O/g wet bagasse, with a dry-matter composition of: 39.0% g glucan/g dry biomass, 17.3% g xylan/g dry biomass, 5.0% g arabinan/g dry biomass, 1.1% g galactan/g dry biomass, 5.5% g acetate/g dry biomass, 5.0% g soluble extractives/g dry biomass, 24.1% g lignin/g dry biomass, and 3.1% g ash/g dry biomass) is cut such that the maximum particle size is no greater than 1 cm. To a 15 mL cylindrical glass reaction vial is added: 0.50 g of the cane bagasse sample, 0.50 g of poly[styrene-co-3-methyl-1-(4-vinylbenzyl)-3H-imidazol-1-ium chloride-co-divinylbenzene] (Catalyst as described in Example 2, Acid functionalization: 0.0 mmol/g, initial moisture content: 4.0% g H₂O/g dispensed polymer), and 1.8 mL of deionized H₂O. The reactants are mixed thoroughly with a glass stir rod to distribute the catalyst particles evenly throughout the biomass. The resulting mixture is gently compacted to yield a solid reactant cake. The glass reactor is sealed with a phenolic cap and incubated at 115° C. for six hours. Following the reaction, the product mixture is separated following the procedure described in Examples B2-B5.

### Example B20

### Preparation of a Saccharide Composition from Lignocellulosic Biomass Using Catalyst Described in Example 3

A lignocellulosic biomass is provided for saccharification using the Catalyst described in Example 3. The composition of the lignocellulosic biomass is determined using the methods described in Example B1 above.

To a 15 mL cylindrical glass reaction vial is added: 0.50 g of the lignocellulosic biomass sample, 0.30 g of Catalyst as prepared in Example 3, and 800 μL of deionized H₂O. The reactants are mixed thoroughly with a glass stir rod to distribute the catalyst particles evenly throughout the lignocellulosic biomass. The resulting mixture is gently compacted to yield a solid reactant cake. The glass reactor is sealed with a phenolic cap and incubated at 120° C. for four hours.

The cylindrical glass reactor is then cooled to room temperature and unsealed. 5.0 mL of distilled H₂O is added to the vial reactor and the resulting mixture of liquids and solids is agitated for 2 minutes by magnetic stirring. Following agitation, the solids are allowed to sediment for 30 seconds to produce the layered mixture. The solid catalyst is observed to form a layer at the bottom of the vial reactor. Lignin and residual biomass from the biomass is observed to form a solid layer above the solid catalyst. The short-chained beta-glucans are observed to form a layer of amorphous solids above the lignin and residual biomass. Finally, the soluble sugars are observed to form a liquid layer above the short-chained beta-glucans.

The supernatant and residual insoluble materials are then separated by decantation. The soluble-sugar content of hydrolysis products are determined by a combination of high performance liquid chromatography (HPLC) and spectrophotometric methods. HPLC determination of soluble sugars and oligosaccharides is performed on a Hewlett-Packard 1050 Series instrument that is equipped with a refractive index (RI) detector using a 30 cm×7.8 mm Phenomenex HPB column with water as the mobile phase. The sugar column is protected by both a lead-exchanged sulfonated-polystyrene guard column and a tri-alkylammoniumhydroxide anionic-exchange guard column. All HPLC samples are microfiltered using a 0.2 μm syringe filter prior to injection. Sample concentrations are determined by reference to a calibration generated from known standards.

The recovered hydrolysate is determined to contain a mixture of xylose, arabinose, and glucose in the proportions of about 10:1:1, with a total sugar concentration of 1% g sugars/g hydrolysate. The total concentration of 5-hydroxymethylfurfural, 2-furaldehyde, and levulinic acid is less than 0.05% g analyte/g hydrolysate. The total hydrolysate is concentrated by evaporation under vacuum to produce a solution with 10% g sugars/g hydrolysate.

1. A polymer comprising acidic monomers and ionic monomers connected to form a polymeric backbone,
wherein a plurality of acidic monomers independently comprises at least one Bronsted-Lowry acid in acidic form, and at least one Bronsted-Lowry acid in conjugate base form having at least one associated cationic moiety, wherein at least one of the acidic monomers comprises a linker connecting the Bronsted-Lowry acid in conjugate base form to the polymeric backbone,
wherein each ionic monomer independently comprises at least one nitrogen-containing cationic group or phosphorous-containing cationic group, and
wherein at least one of the ionic monomers comprises a linker connecting the nitrogen-containing cationic group or the phosphorous-containing cationic group to the polymeric backbone.

2. The polymer according to claim 1, wherein the acidic monomers are each independently selected from Formulas IA-VIA: 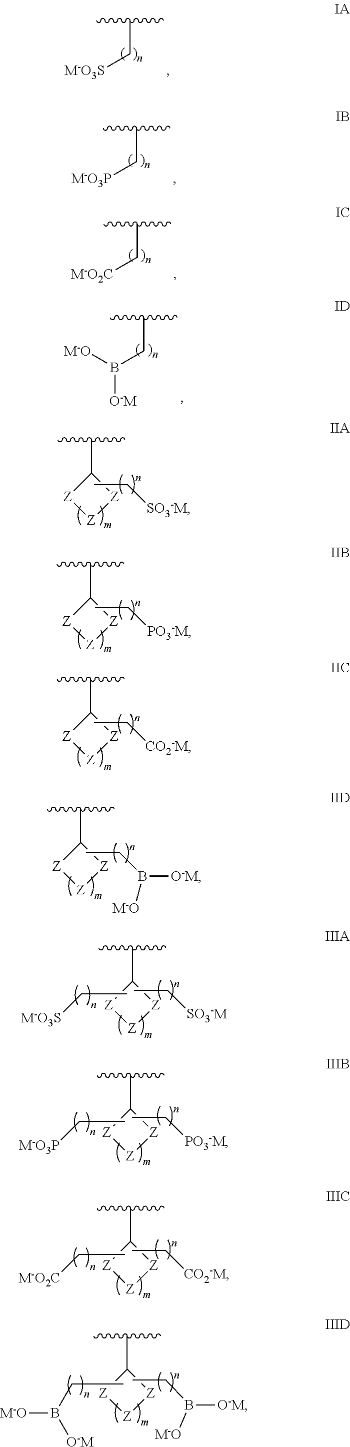 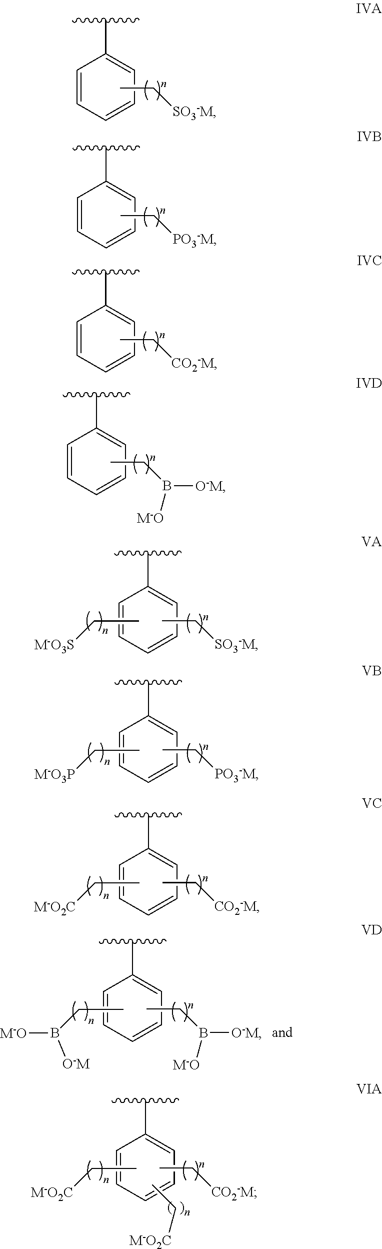
wherein for the Bronsted-Lowry acid in acidic form, at least one M in a Formula selected from IA-VIA is hydrogen;
wherein for the Bronsted-Lowry acid in conjugate base form having at least one associated cationic moiety, each M is independently Li⁺, Na⁺, K⁺, N(R¹)₄⁺, Zn²⁺, Mg²⁺, or Ca²⁺, where Zn²⁺, Mg²⁺ and Ca²⁺ are each independently associated with at least two Bronsted-Lowry acids in conjugate base form at any M position on any acidic monomer;
each Z is independently C(R²)(R³), N(R⁴), S, S(R⁵)(R⁶), S(O)(R⁵)(R⁶), SO₂, or O, wherein any two adjacent Z may be joined by a double bond;
each m is independently 0, 1, 2, or 3;
each n is independently 0, 1, 2, or 3;
each R¹, R², R³ and R⁴ is independently hydrogen, alkyl, heteroalkyl, cycloalkyl, heterocyclyl, aryl, or heteroaryl;
each R⁵ and R⁶ is independently alkyl, heteroalkyl, cycloalkyl, heterocyclyl, aryl, or heteroaryl; and
where any two adjacent Z can be taken together to form a group selected from the group consisting of cycloalkyl, heterocycloalkyl, aryl and heteroaryl.

3. The polymer according to claim 2, wherein at least one of the acidic monomers comprises a linker to form an acidic side chain, wherein each acidic side chain is independently selected from the group consisting of:

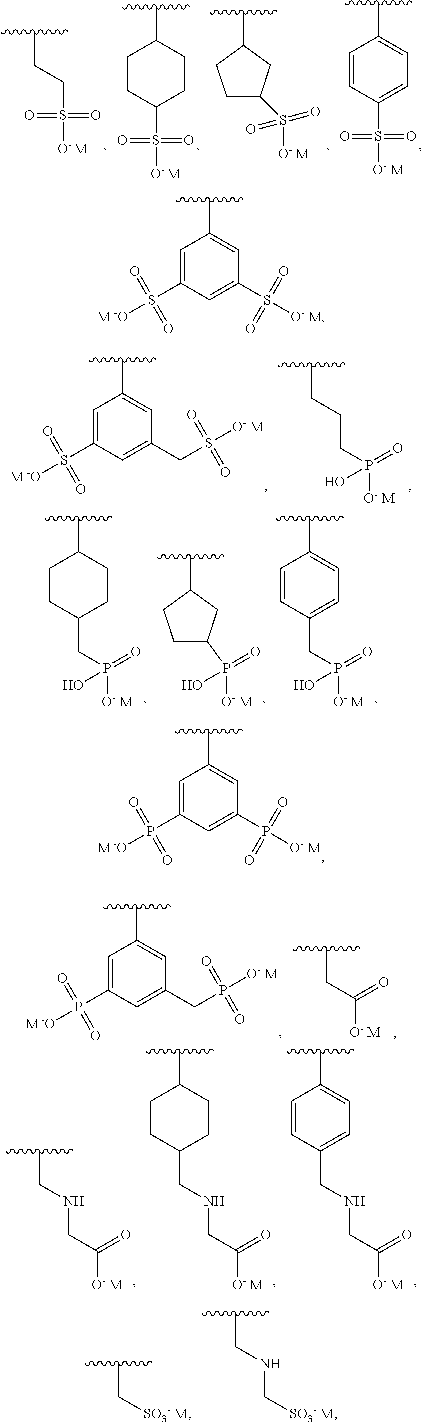

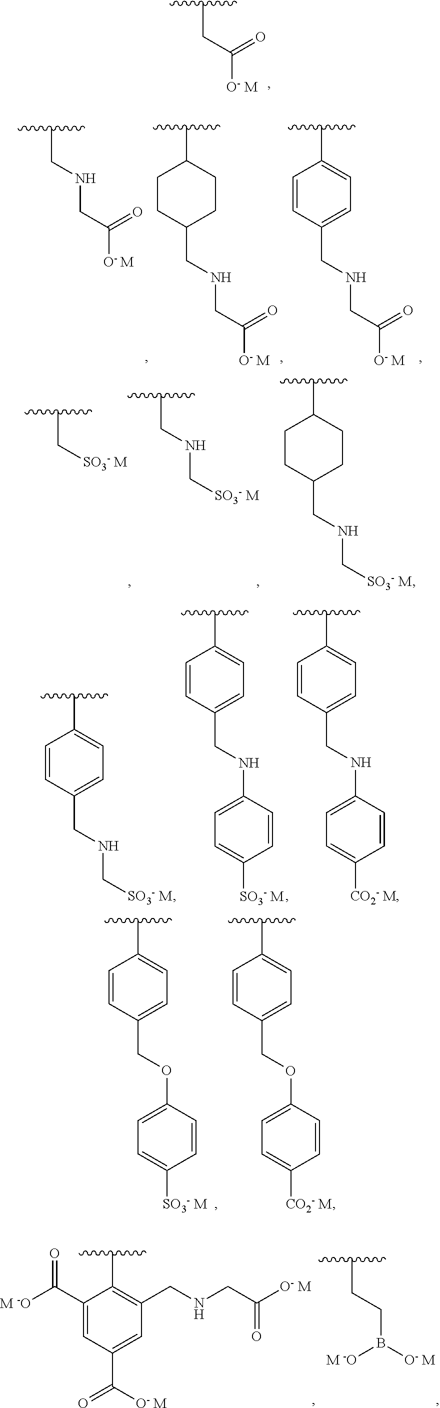

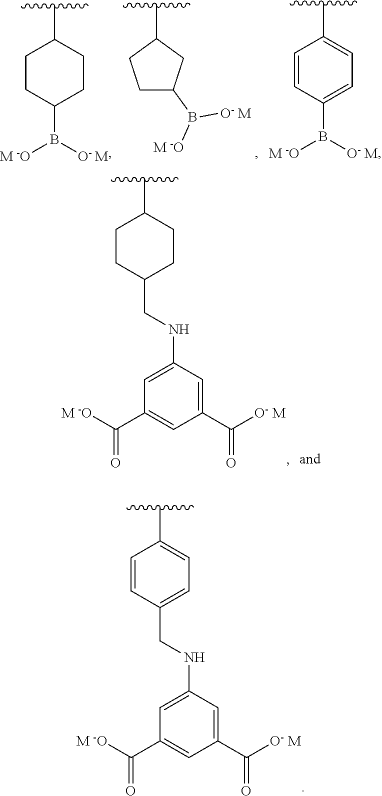

4. The polymer according to claim 2 wherein each M is independently Mg²⁺ or Ca²⁺.

5. The polymer according to claim 1, wherein:
the nitrogen-containing cationic group at each occurrence is independently pyrrolium, imidazolium, pyrazolium, oxazolium, thiazolium, pyridinium, pyrimidinium, pyrazinium, pyridazinium, thiazinium, morpholinium, piperidinium, piperizinium, or pyrollizinium; and
the phosphorous-containing cationic group at each occurrence is independently triphenyl phosphonium, trimethyl phosphonium, triethyl phosphonium, tripropyl phosphonium, tributyl phosphonium, trichloro phosphonium, or trifluoro phosphonium.

6. The polymer according to claim 1, wherein each ionic monomer is independently selected from Formulas VIIA-XIB: 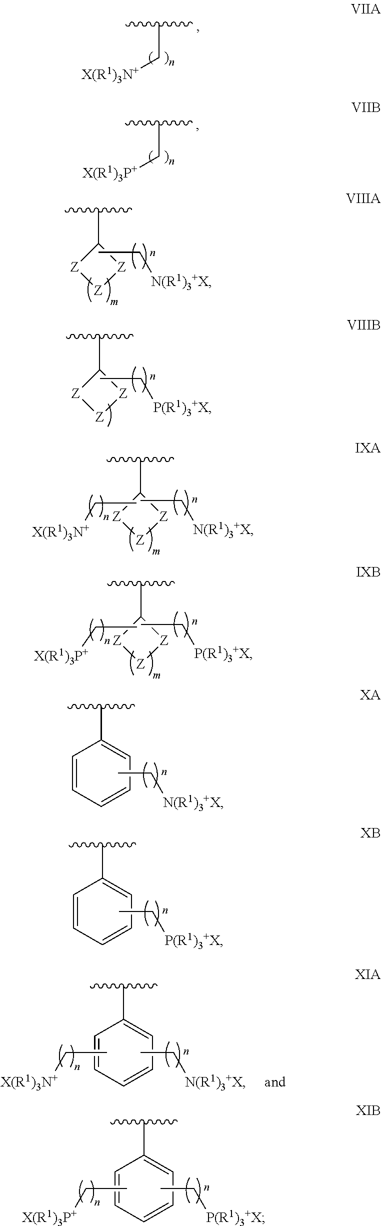
wherein each Z is independently C(R²)(R³), N(R⁴), S, S(R⁵)(R⁶), S(O)(R⁵)(R⁶), SO₂, or O, wherein any two adjacent Z can be joined by a double bond;
each X is independently F⁻, Cl⁻, Br⁻, I⁻, NO₂⁻, NO₃⁻, SO₄²⁻, R⁷SO₄⁻, R⁷CO₂⁻, PO₄²⁻, R⁷PO₃, or R⁷PO₂⁻, wherein SO₄²⁻ and PO₄²⁻ are each independently associated with at least two cationic groups at any X position on any ionic monomer, and
each m is independently 0, 1, 2, or 3;
each n is independently 0, 1, 2, or 3;
each R¹, R², R³ and R⁴ is independently hydrogen, alkyl, heteroalkyl, cycloalkyl, heterocyclyl, aryl, or heteroaryl;
each R⁵ and R⁶ is independently alkyl, heteroalkyl, cycloalkyl, heterocyclyl, aryl, or heteroaryl;
where any two adjacent Z can be taken together to form a group selected from the group consisting of cycloalkyl, heterocycloalkyl, aryl and heteroaryl; and
each R⁷ is independently hydrogen, C₁₋₄alkyl, or C₁₋₄heteroalkyl.

7. The polymer according to claim 1, wherein the nitrogen-containing cationic group and the linker form a nitrogen-containing side chain, wherein each nitrogen-containing side chain is independently selected from the group consisting of:

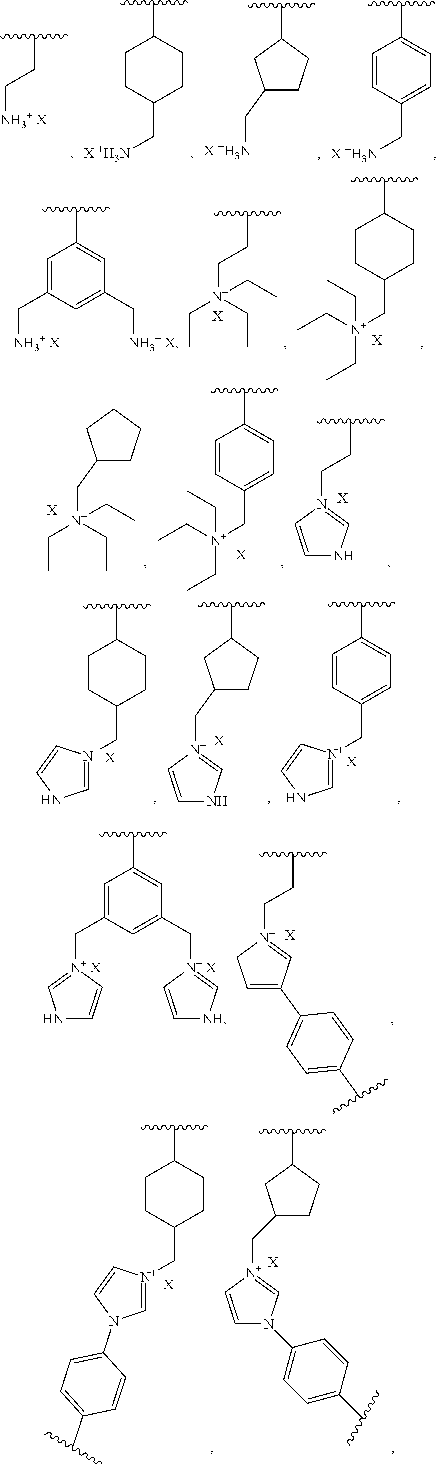

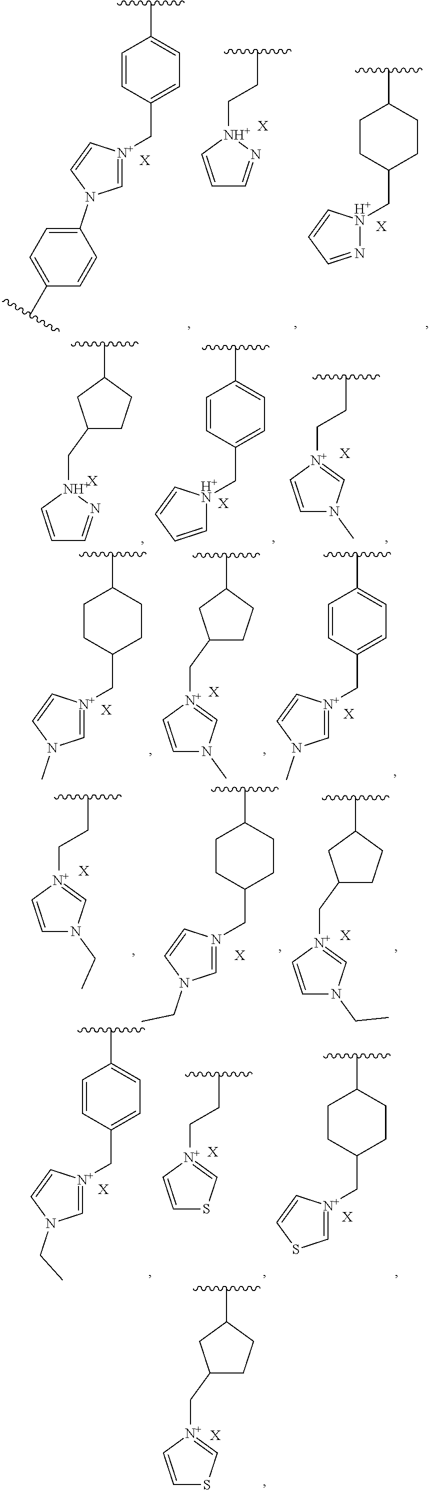

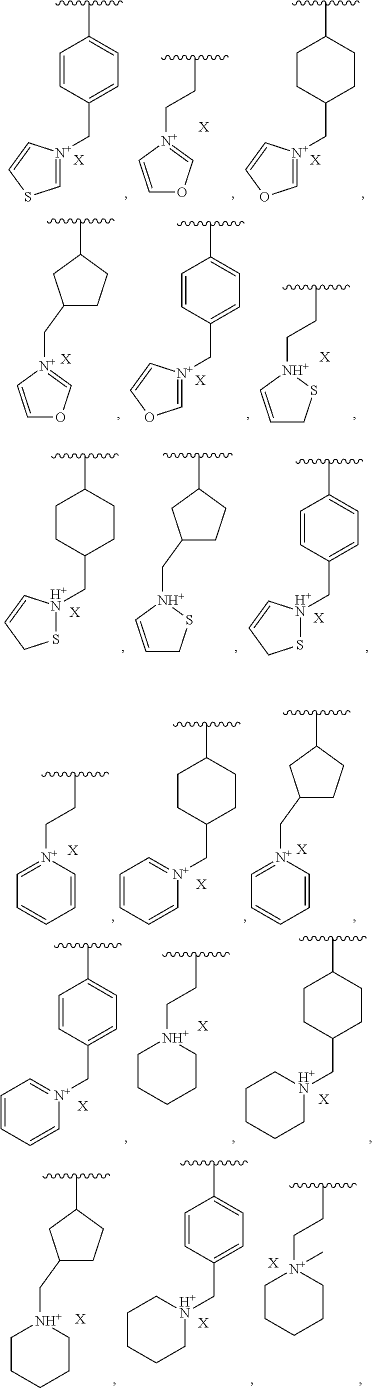

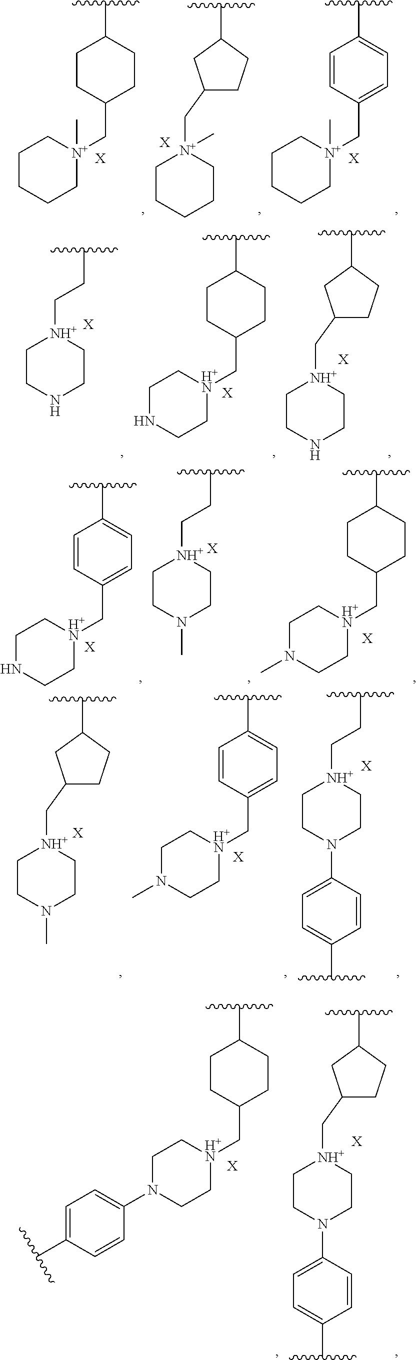

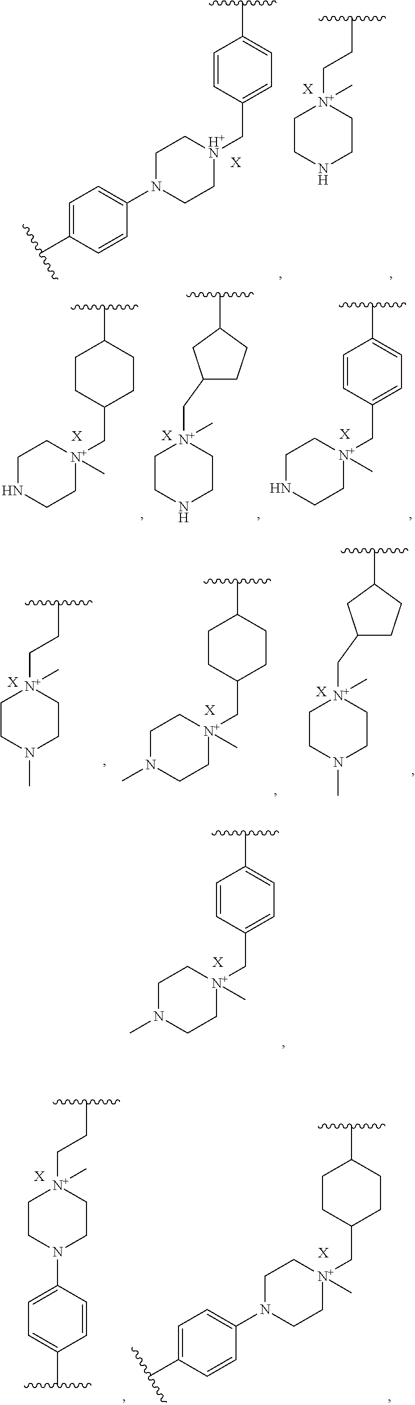

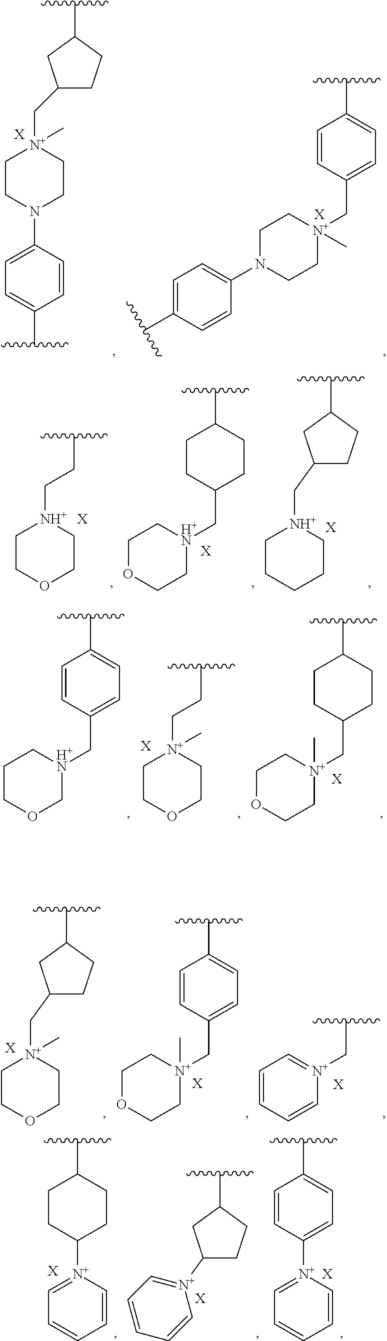

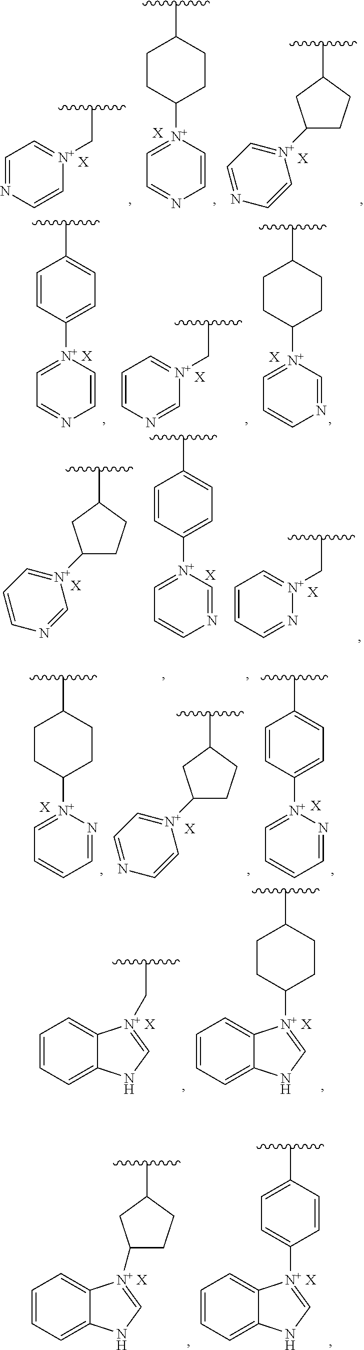

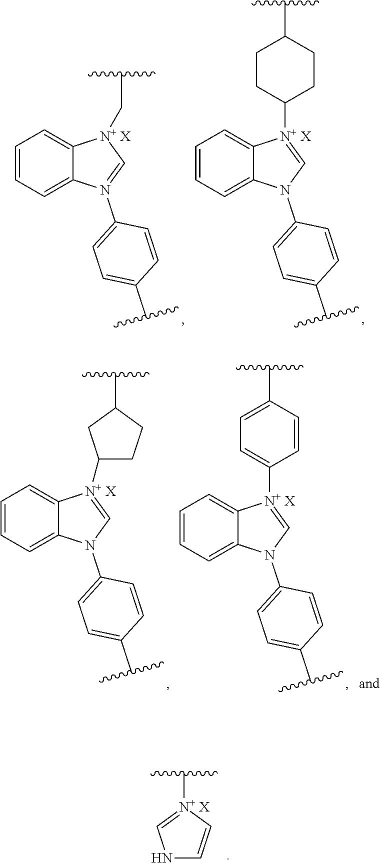

8. The polymer according to claim 1, wherein the phosphorous-containing cationic group and the linker form a phosphorous-containing side chain, wherein each phosphorous-containing side chain is independently selected from the group consisting of:

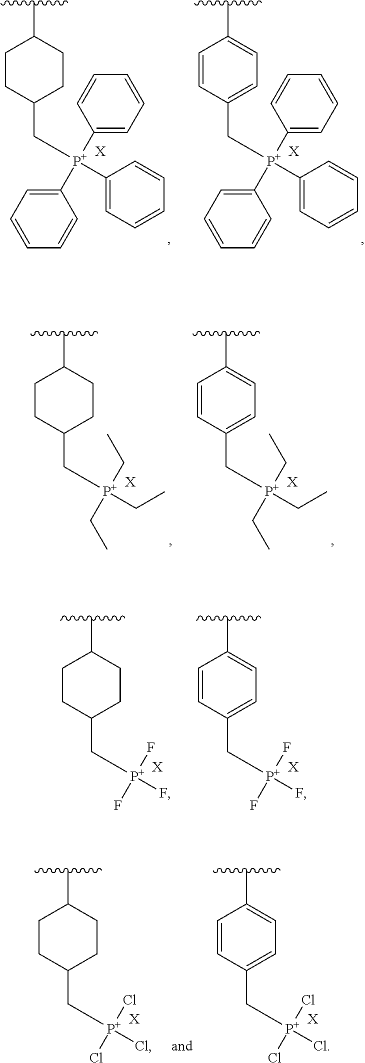

9. The polymer according to claim 6, wherein each X is independently Cl⁻, Br⁻, I⁻, HSO₄⁻, HCO₂⁻, CH₃CO₂⁻, or NO₃⁻.

10. The polymer according to claim 1, wherein each linker is independently unsubstituted or substituted alkylene, unsubstituted or substituted arylalkylene, unsubstituted or substituted cycloalkylene, unsubstituted or substituted alkenylene, unsubstituted or substituted arylene, or unsubstituted or substituted heteroarylene.

11. The polymer according to claim 1, wherein the polymeric backbone is polyethylene, polypropylene, polyvinyl alcohol, polystyrene, polyurethane, polyvinyl chloride, polyphenol-aldehyde, polytetrafluoroethylene, polybutylene terephthalate, polycaprolactam, poly(acrylonitrile butadiene styrene), polyalkyleneammonium, polyalkylenediammonium, polyalkylenepyrrolium, polyalkyleneimidazolium, polyalkylenepyrazolium, polyalkyleneoxazolium, polyalkylenethiazolium, polyalkylenepyridinium, polyalkylenepyrimidinium, polyalkylenepyrazinium, polyalkylenepyridazinium, polyalkylenethiazinium, polyalkylenemorpholinium, polyalkylenepiperidinium, polyalkylenepiperizinium, polyalkylenepyrollizinium, polyalkylenetriphenylphosphonium, polyalkylenetrimethylphosphonium, polyalkylenetriethylphosphonium, polyalkylenetripropylphosphonium, polyalkylenetributylphosphonium, polyalkylenetrichlorophosphonium, polyalkylenetrifluorophosphonium, and polyalkylenediazolium, polyarylalkyleneammonium, polyarylalkylenediammonium, polyarylalkylenepyrrolium, polyarylalkyleneimidazolium, polyarylalkylenepyrazolium, polyarylalkyleneoxazolium, polyarylalkylenethiazolium, polyarylalkylenepyridinium, polyarylalkylenepyrimidinium, polyarylalkylenepyrazinium, polyarylalkylenepyridazinium, polyarylalkylenethiazinium, polyarylalkylenemorpholinium, polyarylalkylenepiperidinium, polyarylalkylenepiperizinium, polyarylalkylenepyrollizinium, polyarylalkylenetriphenylphosphonium, polyarylalkylenetrimethylphosphonium, polyarylalkylenetriethylphosphonium, polyarylalkylenetripropylphosphonium, polyarylalkylenetributylphosphonium, polyarylalkylenetrichlorophosphonium, polyarylalkylenetrifluorophosphonium, or polyarylalkylenediazolium;
wherein cationic polymeric backbones are associated with one or more anions selected from the group consisting of F⁻, Cl⁻, Br⁻, I⁻, NO₂⁻, NO₃⁻, SO₄²⁻, R⁷SO₄⁻, R⁷CO₂⁻, PO₄²⁻, R⁷PO₃⁻, and R⁷PO₂⁻, wherein R⁷ is hydrogen, C₁₋₄alkyl, or C₁₋₄heteroalkyl.

12. The polymer according to claim 1, further comprising at least one hydrophobic monomer.

13. The polymer according to claim 1, further comprising at least one acidic-ionic monomer connected to the polymeric backbone, wherein at least one acidic-ionic monomer comprises at least one Bronsted-Lowry acid in conjugate base form having at least one associated cationic moiety, and at least one cationic group, and wherein at least one of the acidic-ionic monomers comprises a linker connecting the acidic-ionic monomer to the polymeric backbone.

14. A polymer selected from the group consisting of:
poly[styrene-co-4-vinylbenzeneR⁸ sulfonate-co-3-methyl-1-(4-vinylbenzyl)-3H-imidazol-1-ium chloride-co-divinylbenzene];
poly[styrene-co-4-vinylbenzeneR⁸ sulfonate-co-3-methyl-1-(4-vinylbenzyl)-3H-imidazol-1-ium bisulfate-co-divinylbenzene];
poly[styrene-co-4-vinylbenzeneR⁸ sulfonate-co-3-methyl-1-(4-vinylbenzyl)-3H-imidazol-1-ium acetate-co-divinylbenzene];
poly[styrene-co-4-vinylbenzeneR⁸ sulfonate-co-3-methyl-1-(4-vinylbenzyl)-3H-imidazol-1-ium nitrate-co-divinylbenzene];
poly[styrene-co-4-vinylbenzeneR⁸ sulfonate-co-3-ethyl-1-(4-vinylbenzyl)-3H-imidazol-1-ium chloride-co-divinylbenzene];
poly[styrene-co-4-vinylbenzeneR⁸ sulfonate-co-3-ethyl-1-(4-vinylbenzyl)-3H-imidazol-1-ium bisulfate-co-divinylbenzene];
poly[styrene-co-4-vinylbenzeneR⁸ sulfonate-co-3-ethyl-1-(4-vinylbenzyl)-3H-imidazol-1-ium acetate-co-divinylbenzene];
poly[styrene-co-4-vinylbenzeneR⁸ sulfonate-co-3-ethyl-1-(4-vinylbenzyl)-3H-imidazol-1-ium nitrate-co-divinylbenzene];
poly[styrene-co-4-vinylbenzeneR⁸ sulfonate-co-1-(4-vinylbenzyl)-3H-imidazol-1-ium chloride-co-divinylbenzene];
poly[styrene-co-4-vinylbenzeneR⁸ sulfonated-co-1-(4-vinylbenzyl)-3H-imidazol-1-ium iodide-co-divinylbenzene];
poly[styrene-co-4-vinylbenzeneR⁸ sulfonate-co-1-(4-vinylbenzyl)-3H-imidazol-1-ium bromide-co-divinylbenzene];
poly[styrene-co-4-vinylbenzeneR⁸ sulfonate-co-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-3H-imidazol-1-ium acetate-co-divinylbenzene];
poly[styrene-co-4-vinylbenzeneR⁸ sulfonate-co-3-methyl-1-(4-vinylbenzyl)-3H-benzoimidazol-1-ium chloride-co-divinylbenzene];
poly[styrene-co-4-vinylbenzeneR⁸ sulfonate-co-3-methyl-1-(4-vinylbenzyl)-3H-benzoimidazol-1-ium bisulfate-co-divinylbenzene];
poly[styrene-co-4-vinylbenzeneR⁸ sulfonate-co-3-methyl-1-(4-vinylbenzyl)-3H-benzoimidazol-1-ium acetate-co-divinylbenzene];
poly[styrene-co-4-vinylbenzeneR⁸ sulfonate-co-3-methyl-1-(4-vinylbenzyl)-3H-benzoimidazol-1-ium formate-co-divinylbenzene];
poly[styrene-co-4-vinylbenzeneR⁸ sulfonate-co-1-(4-vinylbenzyl)-pyridinium-chloride-co-divinylbenzene];
poly[styrene-co-4-vinylbenzeneR⁸ sulfonate-co-1-(4-vinylbenzyl)-pyridinium-bisulfate-co-divinylbenzene];
poly[styrene-co-4-vinylbenzeneR⁸ sulfonate-co-1-(4-vinylbenzyl)-pyridinium-acetate-co-divinylbenzene];
poly[styrene-co-4-vinylbenzeneR⁸ sulfonate-co-1-(4-vinylbenzyl)-pyridinium-nitrate-co-divinylbenzene];
poly[styrene-co-4-vinylbenzeneR⁸ sulfonate-co-1-(4-vinylbenzyl)-pyridinium-chloride-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bromide-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-iodide-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-bisulfate-co-3-methyl-1-(4-vinylbenzyl)-3H-imidazol-1-ium bisulfate-co-divinylbenzene];
poly[styrene-co-4-vinylbenzeneR⁸ sulfonate-co-1-(4-vinylbenzyl)-pyridinium-acetate-co-3-methyl-1-(4-vinylbenzyl)-3H-imidazol-1-ium bisulfate-co-divinylbenzene];
poly[styrene-co-4-vinylbenzeneR⁸ sulfonate-co-4-methyl-4-(4-vinylbenzyl)-morpholin-4-ium chloride-co-divinylbenzene];
poly[styrene-co-4-vinylbenzeneR⁸ sulfonate-co-4-methyl-4-(4-vinylbenzyl)-morpholin-4-ium bisulfate-co-divinylbenzene];
poly[styrene-co-4-vinylbenzeneR⁸ sulfonate-co-4-methyl-4-(4-vinylbenzyl)-morpholin-4-ium acetate-co-divinylbenzene];
poly[styrene-co-4-vinylbenzeneR⁸ sulfonate-co-4-methyl-4-(4-vinylbenzyl)-morpholin-4-ium formate-co-divinylbenzene];
poly[styrene-co-4-vinylbenzeneR⁸ sulfonate-co-triphenyl-(4-vinylbenzyl)-phosphonium chloride-co-divinylbenzene];
poly[styrene-co-4-vinylbenzeneR⁸ sulfonate-co-triphenyl-(4-vinylbenzyl)-phosphonium bisulfate-co-divinylbenzene];
poly[styrene-co-4-vinylbenzeneR⁸ sulfonate-co-triphenyl-(4-vinylbenzyl)-phosphonium acetate-co-divinylbenzene];
poly[styrene-co-4-vinylbenzeneR⁸ sulfonate-co-1-methyl-1-(4-vinylbenzyl)-piperdin-1-ium chloride-co-divinylbenzene];
poly[styrene-co-4-vinylbenzeneR⁸ sulfonate-co-1-methyl-1-(4-vinylbenzyl)-piperdin-1-ium bisulfate-co-divinylbenzene];
poly[styrene-co-4-vinylbenzeneR⁸ sulfonate-co-1-methyl-1-(4-vinylbenzyl)-piperdin-1-ium acetate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-4-vinylbenzeneR⁸ sulfonate-co-triethyl-(4-vinylbenzyl)-ammonium chloride-co-divinylbenzene];
poly[styrene-co-4-vinylbenzeneR⁸ sulfonate-co-triethyl-(4-vinylbenzyl)-ammonium bisulfate-co-divinylbenzene];
poly[styrene-co-4-vinylbenzeneR⁸ sulfonate-co-triethyl-(4-vinylbenzyl)-ammonium acetate-co-divinylbenzene];
poly[styrene-co-3-methyl-1-(4-vinylbenzyl)-3H-imidazol-1-ium chloride-co-4-R⁸ boronate-1-(4-vinylbenzyl)-pyridinium chloride-co-divinylbenzene];
poly[styrene-co-3-methyl-1-(4-vinylbenzyl)-3H-imidazol-1-ium chloride-co-1-(4-vinylphenyl)methylR⁸ phosphonate-co-divinylbenzene];
poly[styrene-co-3-methyl-1-(4-vinylbenzyl)-3H-imidazol-1-ium bisulfate-co-1-(4-vinylphenyl)methylR⁸ phosphonate-co-divinylbenzene];
poly[styrene-co-3-methyl-1-(4-vinylbenzyl)-3H-imidazol-1-ium acetate-co-1-(4-vinylphenyl)methylR⁸ phosphonate-co-divinylbenzene];
poly[styrene-co-3-methyl-1-(4-vinylbenzyl)-3H-imidazol-1-ium nitrate-co-1-(4-vinylphenyl)methylR⁸ phosphonate-co-divinylbenzene];
poly[styrene-co-4-vinylbenzeneR⁸ sulfonate-co-vinylbenzylchloride-co-1-methyl-2-vinyl-pyridinium chloride-co-divinylbenzene];
poly[styrene-co-4-vinylbenzeneR⁸ sulfonate-co-vinylbenzylchloride-co-1-methyl-2-vinyl-pyridinium bisulfate-co-divinylbenzene];
poly[styrene-co-4-vinylbenzeneR⁸ sulfonate-co-vinylbenzylchloride-co-1-methyl-2-vinyl-pyridinium acetate-co-divinylbenzene];
poly[styrene-co-4-vinylbenzeneR⁸ sulfonate-co-4-(4-vinylbenzyl)-morpholine-4-oxide-co-divinyl benzene];
poly[styrene-co-4-vinylphenylR⁸ phosphonate-co-3-methyl-1-(4-vinylbenzyl)-3H-imidazol-1-ium chloride-co-divinylbenzene];
poly[styrene-co-4-vinylphenylR⁸ phosphonate-co-3-methyl-1-(4-vinylbenzyl)-3H-imidazol-1-ium bisulfate-co-divinylbenzene];
poly[styrene-co-4-vinylphenylR⁸ phosphonate-co-3-methyl-1-(4-vinylbenzyl)-3H-imidazol-1-ium acetate-co-divinylbenzene];
poly[styrene-co-3-R⁸ methylcarboxylate-1-(4-vinylbenzyl)-3H-imidazol-1-ium chloride-co-divinylbenzene];
poly[styrene-co-3-R⁸ methylcarboxylate-1-(4-vinylbenzyl)-3H-imidazol-1-ium bisulfate-co-divinylbenzene];
poly[styrene-co-3-R⁸ methylcarboxylate-1-(4-vinylbenzyl)-3H-imidazol-1-ium acetate-co-divinylbenzene];
poly[styrene-co-5-(4-vinylbenzylamino)-R⁸ isophthalate-co-3-methyl-1-(4-vinylbenzyl)-3H-imidazol-1-ium chloride-co-divinylbenzene];
poly[styrene-co-5-(4-vinylbenzylamino)-R⁸ isophthalate-co-3-methyl-1-(4-vinylbenzyl)-3H-imidazol-1-ium bisulfate-co-divinylbenzene];
poly[styrene-co-5-(4-vinylbenzylamino)-R⁸ isophthalate-co-3-methyl-1-(4-vinylbenzyl)-3H-imidazol-1-ium acetate-co-divinylbenzene];
poly[styrene-co-(4-vinylbenzylamino)-R⁸ acetate-co-3-methyl-1-(4-vinylbenzyl)-3H-imidazol-1-ium chloride-co-divinylbenzene];
poly[styrene-co-(4-vinylbenzylamino)-R⁸ acetate-co-3-methyl-1-(4-vinylbenzyl)-3H-imidazol-1-ium bisulfate-co-divinylbenzene];
poly[styrene-co-(4-vinylbenzylamino)-R⁸ acetate-co-3-methyl-1-(4-vinylbenzyl)-3H-imidazol-1-ium acetate-co-divinylbenzene];
poly(styrene-co-4-vinylbenzeneR⁸ sulfonate-co-vinylbenzylmethylimidazolium chloride-co-vinylbenzylmethylmorpholinium chloride-co-vinylbenzyltriphenyl phosphonium chloride-co-divinylbenzene);
poly(styrene-co-4-vinylbenzeneR⁸ phosphonate-co-vinylbenzylmethylimidazolium chloride-co-vinylbenzylmethylmorpholinium chloride-co-vinylbenzyltriphenyl phosphonium chloride-co-divinylbenzene);
poly(styrene-co-4-vinylbenzeneR⁸ sulfonate-co-vinylbenzylmethylimidazolium bisulfate-co-vinylbenzylmethylmorpholinium bisulfate-co-vinylbenzyltriphenyl phosphonium bisulfate-co-divinylbenzene);
poly(styrene-co-4-vinylbenzeneR⁸ phosphonate-co-vinylbenzylmethylimidazolium bisulfate-co-vinylbenzylmethylmorpholinium bisulfate-co-vinylbenzyltriphenyl phosphonium bisulfate-co-divinylbenzene);
poly(styrene-co-4-vinylbenzeneR⁸ sulfonate-co-vinylbenzylmethylimidazolium acetate-co-vinylbenzylmethylmorpholinium acetate-co-vinylbenzyltriphenyl phosphonium acetate-co-divinylbenzene);
poly(styrene-co-4-vinylbenzeneR⁸ phosphonate-co-vinylbenzylmethylimidazolium acetate-co-vinylbenzylmethylmorpholinium acetate-co-vinylbenzyltriphenyl phosphonium acetate-co-divinylbenzene);
poly(styrene-co-4-vinylbenzeneR⁸ sulfonate-co-vinylbenzylmethylmorpholinium chloride-co-vinylbenzyltriphenylphosphonium chloride-co-divinylbenzene);
poly(styrene-co-4-vinylbenzeneR⁸ phosphonate-co-vinylbenzylmethylmorpholinium chloride-co-vinylbenzyltriphenylphosphonium chloride-co-divinylbenzene);
poly(styrene-co-4-vinylbenzeneR⁸ sulfonate-co-vinylbenzylmethylmorpholinium bisulfate-co-vinylbenzyltriphenylphosphonium bisulfate-co-divinylbenzene);
poly(styrene-co-4-vinylbenzeneR⁸ phosphonate-co-vinylbenzylmethylmorpholinium bisulfate-co-vinylbenzyltriphenylphosphonium bisulfate-co-divinylbenzene);
poly(styrene-co-4-vinylbenzeneR⁸ sulfonate-co-vinylbenzylmethylmorpholinium acetate-co-vinylbenzyltriphenylphosphonium bisulfate-co-divinylbenzene);
poly(styrene-co-4-vinylbenzeneR⁸ phosphonate-co-vinylbenzylmethylmorpholinium acetate-co-vinylbenzyltriphenylphosphonium bisulfate-co-divinylbenzene)
poly(styrene-co-4-vinylbenzeneR⁸ sulfonate-co-vinylmethylimidazolium chloride-co-divinylbenzene);
poly(styrene-co-4-vinylbenzeneR⁸ sulfonate-co-vinylmethylimidazolium bisulfate-co-divinylbenzene);
poly(styrene-co-4-vinylbenzeneR⁸ sulfonate-co-vinylmethylimidazolium acetate-co-divinylbenzene);
poly(styrene-co-4-vinylbenzeneR⁸ sulfonate-co-vinylmethylimidazolium nitrate-co-divinylbenzene);
poly(styrene-co-4-vinylbenzeneR⁸ phosphonate-co-vinylmethylimidazolium chloride-co-divinylbenzene);
poly(styrene-co-4-vinylbenzeneR⁸ phosphonate-co-vinylmethylimidazolium bisulfate-co-divinylbenzene);
poly(styrene-co-4-vinylbenzeneR⁸ phosphonate-co-vinylmethylimidazolium acetate-co-divinylbenzene);
poly(styrene-co-4-vinylbenzeneR⁸ sulfonate-co-vinylbenzyltriphenylphosphonium chloride-co-divinylbenzene);
poly(styrene-co-4-vinylbenzeneR⁸ sulfonate-co-vinylbenzyltriphenylphosphonium bisulfate-co-divinylbenzene);
poly(styrene-co-4-vinylbenzeneR⁸ sulfonate-co-vinylbenzyltriphenylphosphonium acetate-co-divinylbenzene);
poly(styrene-co-4-vinylbenzeneR⁸ phosphonate-co-vinylbenzyltriphenylphosphonium chloride-co-divinylbenzene);
poly(styrene-co-4-vinylbenzeneR⁸ phosphonate-co-vinylbenzyltriphenylphosphonium bisulfate-co-divinylbenzene);
poly(styrene-co-4-vinylbenzeneR⁸ phosphonate-co-vinylbenzyltriphenylphosphonium acetate-co-divinylbenzene);
poly(styrene-co-4-vinylbenzeneR⁸ sulfonate-co-vinylbenzylmethylimidazolium chloride-co-divinylbenzene);
poly(styrene-co-4-vinylbenzeneR⁸ sulfonate-co-vinylbenzylmethylimidazolium bisulfate-co-divinylbenzene);
poly(styrene-co-4-vinylbenzeneR⁸ sulfonate-co-vinylbenzylmethylimidazolium acetate-co-divinylbenzene);
poly(styrene-co-4-vinylbenzeneR⁸ phosphonate-co-vinylbenzylmethylimidazolium chloride-co-divinylbenzene);
poly(styrene-co-4-vinylbenzeneR⁸ phosphonate-co-vinylbenzylmethylimidazolium bisulfate-co-divinylbenzene);
poly(styrene-co-4-vinylbenzeneR⁸ phosphonate-co-vinylbenzylmethylimidazolium acetate-co-divinylbenzene);
poly(styrene-co-4-vinylbenzeneR⁸ sulfonate-co-vinylbenzyltriphenylphosphonium chloride-co-divinylbenzene);
poly(styrene-co-4-vinylbenzeneR⁸ sulfonate-co-vinylbenzyltriphenylphosphonium bisulfate-co-divinylbenzene);
poly(styrene-co-4-vinylbenzeneR⁸ sulfonate-co-vinylbenzyltriphenylphosphonium acetate-co-divinylbenzene);
poly(styrene-co-4-vinylbenzeneR⁸ phosphonate-co-vinylbenzyltriphenylphosphonium chloride-co-divinylbenzene);
poly(styrene-co-4-vinylbenzeneR⁸ phosphonate-co-vinylbenzyltriphenylphosphonium bisulfate-co-divinylbenzene);
poly(styrene-co-4-vinylbenzeneR⁸ phosphonate-co-vinylbenzyltriphenylphosphonium acetate-co-divinylbenzene);
poly(butyl-vinylimidazolium chloride-co-butylimidazolium bisulfate-co-4-vinylbenzeneR⁸ sulfonate);
poly(butyl-vinylimidazolium bisulfate-co-butylimidazolium bisulfate-co-4-vinylbenzeneR⁸ sulfonate);
poly(benzyl alcohol-co-4-vinylbenzylalcohol R⁸ sulfonate-co-vinylbenzyltriphenylphosphonium chloride-co-divinylbenzyl alcohol); and
poly(benzyl alcohol-co-4-vinylbenzylalcohol R⁸ sulfonate-co-vinylbenzyltriphenylphosphonium bisulfate-co-divinylbenzyl alcohol),
wherein R⁸ is Li⁺, K⁺, N(H)₄⁺, N(Me)₄⁺, N(Et)₄⁺, Zn²⁺, Mg²⁺, or Ca²⁺, and wherein Zn²⁺, Mg²⁺ and Ca²⁺ are each independently associated with at least two Bronsted-Lowry acids in conjugate base form on any acidic monomer.

15. A composition comprising:
biomass; and
at least one polymer according to claim 1.

16. A chemically-hydrolyzed biomass composition comprising:
at least one polymer according to claim 1;
one or more sugars; and
residual biomass.

17. The composition according to claim 16, wherein the one or more sugars are selected from the group consisting glucose, galactose, fructose, xylose, and arabinose.

18. A method for degrading biomass into one or more sugars, comprising:
a) combining the biomass with a polymer according to claim 1 for a period of time sufficient to produce a degraded mixture, wherein the degraded mixture comprises a liquid phase and a solid phase, wherein the liquid phase comprises one or more sugars, and wherein the solid phase comprises residual biomass;
b) isolating at least a portion of the liquid phase from the solid phase; and
c) recovering the one or more sugars from the isolated portion of the liquid phase.
